(19) United States
(12) Patent Application Publication
(10) Pub. No.: US 2017/0221066 A1
(43) Pub. Date: Aug. 3, 2017

(54) REAL-TIME PAYMENT SYSTEM, METHOD, APPARATUS, AND COMPUTER PROGRAM

(71) Applicant: The Clearing House Payments Company, L.L.C., New York, NY (US)

(72) Inventors: Stephen Ledford, Alpharetta, GA (US); Irfan Ahmad, New York, NY (US)

(21) Appl. No.: 15/488,848

(22) Filed: Apr. 17, 2017

Related U.S. Application Data
(63) Continuation-in-part of application No. 15/200,340, filed on Jul. 1, 2016.
(60) Provisional application No. 62/286,738, filed on Jan. 25, 2016.
(60) Provisional application No. 62/187,406, filed on Jul. 1, 2015.

(51) Int. Cl. G06Q 20/40

(52) U.S. Cl. CPC G06Q 20/4037; G06Q 20/4016; G06Q 20/407

(57) ABSTRACT

A method, system, apparatus, and computer program for conducting a real-time payment settlement transaction. The method includes determining a prefunded requirement for one or more financial institutions. A prefunded balance is stored, based on a prefunded payment received in a separate funding account, for each of the one or more financial institutions. The method further includes receiving an electronic request for payment message from at least one creditor financial institution, and forwarding the electronic request for payment message to at least one debtor financial institution, the electronic request for payment message requesting that a payment be made to the at least one creditor financial institution and comparing the amount of payment requested in an electronic payment transaction to the prefunded balance of the at least one debtor financial institution. A real-time financial settlement transaction is performed based on a result of the comparing step.

### CROSS REFERENCE TO RELATED APPLICATION

The present application is a continuation-in-part of copending U.S. patent application Ser. No. 15/200,340, filed Jul. 1, 2016, which is incorporated by reference in its entirety, and which claims priority to U.S. Provisional Patent Application No. 62/187,406, filed Jul. 1, 2015, and U.S. Provisional Patent Application No. 62/286,738, filed Jan. 25, 2016, the contents of which are also incorporated by reference herein in their entirety, as if set forth fully herein.

### BACKGROUND

Field

Example aspects herein relate generally to electronic transactions and, more specifically, to electronic real-time payment and non-payment transactions.

Description of the Related Art

The average banking customer interacts with his or her bank or financial institution at least twice a day for payment-related matters, such as buying a financial product, checking on a payment, or paying a bill. These interactions represent more than 80 percent of customer interactions with banks, making payments a superb platform, or beachhead, for deepening customer relationships with regard to financial services. Indeed, payment revenue is increasingly targeted by non-banks, and, missing out on these fees could detrimentally impact the capture of all possible banking related revenue.

However, the competition for the beachhead is intensifying, particularly in the area of mobile payments and digital payments.

Financial transfers today take place more quickly than before, but consumers are still burdened with needing to review their accounts to identify unauthorized or false transactions, and disputing such transactions with their financial institutions. Faster payment capabilities, along with robust consumer protections against fraud, unauthorized transactions, and erroneous debits, can help to alleviate these limitations at least somewhat.

Indeed, the Federal Reserve itself has developed a roadmap for a “near real time” payments system, and has noted that the financial services industry has a sense of urgency in pursuing this objective. The Federal Reserve has created task forces charged with advisory roles focused on defining faster payments capabilities, and payment security.

Various countries (e.g., Singapore, South Africa, Sweden, Switzerland, and the United Kingdom (UK)) offer a real-time credit push and a debit capability. A so-called Fast Payment service exists in the United Kingdom (UK), as does a FAST service in Singapore. Both follow a typical model for providing immediate funds availability. For example, 97% of payment transactions are made available to a recipient within 60 seconds of receipt. For transactions not posted within 60 seconds, the payer is informed that transaction is under review.

To meet this standard, a receiving financial institution (FI) must have real-time screening for suspected fraud, AML, and sanctions (FIG. 47 represents known automated fraud detection systems and their capabilities). The remaining 3% of transactions are reviewed within 2 hours and are either ultimately rejected or posted.

Swish and PayM mobile P2P in Sweden and the UK purportedly provide immediate notification and credit, ClearXchange and PopMoney in the U.S. purportedly provide immediate notification with deferred credit, and Venmo and Square Cash purportedly provide immediate notification and immediate/or deferred credit. However, none of those services actually provide a service with a real-time crediting and settlement capability (i.e., posting of funds immediately to a creditor's account).

Instead, settlement often occurs within hours of a payment initiation. The UK Faster Payments service moved to full cash pre-funding of net settlement liabilities in November of 2014, effectively using a central bank balance as a net debit cap (i.e., a defaulter pays). Prior to that date, a multilateral debit cap was employed. For cXc banks that have bilateral agreements, funds can be posted to customer accounts immediately.

In a credit push scenario, a sending FI can verify and secure good funds. By not having debits, the risk of a reversal due to fraudulent and/or unauthorized debits is removed.

The Clearing House Interbank Payments System (CHIPS) addresses the risk of unsettled debit positions for wholesale wire transfers by requiring participants to prefund a settlement pool, while using an algorithm that continuously nets positions to reduce a funding requirement.

Also, currently, in the case of a payment error, existing processes for returning funds are manual, costly, and unsatisfying for consumers. PayM purportedly has features to reduce sending errors. For example, a payer can enter payment instructions and an alias account, and PayM looks up payee information in a database of registered users based on an account alias provided. Payer confirms the name of the payee presented by PayM prior to executing a transaction. Also, PopMoney services enable users to send funds using an email address. PayM and Swish in Sweden enable users to send payments to registered payees by providing a telephone number.

In view of the foregoing, there is a need to develop and implement an actual real-time payment system with real-time settlement on a transaction-by-transaction basis, or otherwise, to better meet consumers' and businesses' expectations in an increasingly digital economy, while minimizing or substantially reducing fraudulent or unauthorized transactions and the like, and streamlining processes for returning funds and correcting errors.

### BRIEF SUMMARY

The example embodiments discussed herein address the challenges in the art discussed above, by providing methods, and systems, apparatuses, computer-readable media, and computer programs that operate in accordance with the methods, for performing real-time clearing and payment settlement transactions.

In accordance with one example embodiment herein, one of the methods comprises determining a prefunded requirement for one or more creditor financial institutions and one or more debtor financial institutions, and storing a prefunded balance, based on a prefunded payment received in a separate funding account, for each of (i) the one or more creditor financial institutions and (ii) the one or more debtor financial institutions. The method further includes receiving an electronic request for payment message from at least one of the creditor financial institutions, and forwarding the electronic request for payment message to at least one of the debtor financial institutions. The electronic request for payment message requests that a payment be made to the at least one creditor financial institution. The method also includes receiving, from the at least one debtor financial institution, an electronic payment transaction message, the electronic payment transaction message including information specifying an amount of payment requested in the electronic request for payment message. The method also includes comparing the amount of payment requested in the electronic payment transaction message to the prefunded balance of the at least one debtor financial institution, and determining whether to perform a real-time financial settlement transaction based on a result of the comparing.

According to an example embodiment herein, the method further comprises forwarding the electronic payment transaction message to the at least one creditor financial institution such that the amount of payment is credited to a position of the at least one creditor financial institution in real-time, when the amount of the payment requested in the electronic payment transaction message is less than the prefunded balance of the at least one debtor financial institution.

According to another example embodiment herein, the method further comprises updating the prefunded balance for at least one of (i) the one or more creditor financial institutions and (ii) the one or more debtor financial institutions based on supplemental funds received in the separate funding account from the at least one of (i) the one or more creditor financial institutions and (ii) the one or more debtor financial institutions. In another example embodiment herein, the at least one of (i) the one or more creditor financial institutions and (ii) the one or more debtor financial institutions provides the supplemental funds in response to a Low Watermark notification. In yet another example embodiment herein, the method further comprises receiving a request for a disbursement from a respective prefunded balance from at least one of (i) the one or more creditor financial institutions and (ii) the one or more debtor financial institutions.

Also, in accordance with another example embodiment herein, the method further comprises calculating a Net Position for each of (i) the one or more creditor financial institutions and (ii) the one or more debtor financial institutions, each Net Position being based upon the prefunded balance of each of the respective financial institutions and any payments credited or debited to a position of the respective financial institution.

In accordance with another example embodiment herein, the method also includes receiving an electronic request for return of funds message from the at least one debtor financial institution. The electronic request for return of funds message requests that the amount of payment be returned to the at least one debtor financial institution. The electronic request for return of funds message is forwarded to the at least one creditor financial institution. For at least one of the electronic request for payment message, the electronic payment transaction message, and the electronic request for return of funds message, at least one token included in the message is correlated to a bank account number and routing number, and the message is forwarded based on at least the routing number. According to another example embodiment herein, the method further comprises receiving an electronic return of funds message from the at least one creditor financial institution and forwarding that message to the at least one debtor financial institution. The electronic return of funds message includes information specifying payment of the amount of payment requested in the electronic request for return of funds message.

Also in accordance with an example embodiment herein, the method also can include determining whether any of the messages is at least one of a duplicate message, an invalid message, and a possible fraudulent transaction, and generating an exception message in response to detecting that any of the messages is at least one of a duplicate message, an invalid message, and a possible fraudulent transaction.

Furthermore, according to another example embodiment herein, the method can further comprise receiving at least one of an accepted without posting message (e.g., a pending status message), an accepted status message, and a rejected status message from the at least one creditor financial institution, in relation to the electronic payment transaction message.

In still a further example embodiment herein, the method further comprises receiving a request for information message from the at least one creditor financial institution and forwarding that message to the at least one debtor financial institution, the request for information message requesting that the at least one creditor financial institution be provided with predetermined information, which can be, for example, input by a user with a provided narrative field. A responsive message to the request for information message is received from the at least one debtor financial institution, and forwarded to the at least one creditor financial institution, wherein the responsive message includes the predetermined information.

Also in an example embodiment herein, the method further comprises receiving an invoice and/or a remittance advice message including remittance advice from the at least one debtor financial institution and forwarding the remittance advice message to the at least one creditor financial institution.

Also in an example embodiment herein, the method further comprises generating a report that includes data relating to at least one of (i) one or more participants, (ii) one or more transactions, (iii) a reconciliation window, (iv) a prefunded balance, and (v) a net position, wherein the report is generated on at least one of a scheduled basis, an on-demand basis, and an end of a reconciliation window.

In still a further example embodiment herein, the method further comprises conducting an inquiry to retrieve stored data relating to at least one of (i) one or more participants, (ii) one or more transactions, and (iii) a reconciliation window, wherein the inquiry is conducted based on a request of at least one of a participant and a system operator.

According to another example aspect herein, one of the methods performs real-time financial settlement. The method according to this example aspect comprises storing a prefunded balance of a prefunded settlement account, receiving an electronic request for payment message from a first financial institution, and forwarding the electronic request for payment message to a second financial institution, the electronic request for payment message requesting that a payment be made to the first financial institution, and comparing the amount of payment requested in the electronic request for payment message to the prefunded balance of the prefunded settlement account. The method also includes determining whether to perform a real-time financial settlement transaction based on a result of the comparing, and performing a financial settlement where it is determined that the amount of payment requested in the electronic request for payment message is not greater than the prefunded balance of the prefunded settlement account, where the financial settlement is performed in real-time.

According to another example embodiment herein, a system for conducting a real-time payment settlement transaction is provided. In this embodiment, the system includes a memory for storing a computer program and a computer processor. The computer processor operates under control of the program stored in the memory to store a prefunded balance for each of (i) one or more creditor financial institutions and (ii) one or more debtor financial institutions, receive an electronic request for payment message from at least one of the creditor financial institutions, and forwarding the electronic request for payment message to at least one of the debtor financial institutions. The electronic request for payment message requests that a payment be made to the at least one creditor financial institution. The computer processor further operates to receive, from the at least one debtor financial institution, an electronic payment transaction message. The electronic payment transaction message includes information specifying an amount of payment requested in the electronic request for payment message. The computer process further operates to compare the amount of payment requested in the electronic payment transaction message to the prefunded balance of the at least one debtor financial institution, and determine whether to perform a real-time financial settlement transaction based on a result of the comparing.

The real-time payments system herein is a safe, sustainable, standards-based retail real-time clearing and payment settlement system(s) that has an ability to reach financial institutions and position them to be pre-eminent providers of innovative payment services to their customers, by providing a fully featured product platform with extensible messaging and robust security.

Further features and advantages, as well as the structure and operation, of various example embodiments are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings. Like reference numbers between two or more drawings can denote identical or functionally similar elements unless the description indicates otherwise.

FIG. 1 is a diagram of an example transaction system that includes a real time payments system according to an example embodiment herein.

FIG. 1A is an example computer system configured in accordance with example embodiments herein.

FIG. 2 illustrates a flow diagram of a process for effecting a real time payment, according to an example embodiment herein.

FIG. 3 illustrates a flow diagram of a process for conducting a system time out and generating a status report, according to another example embodiment herein.

FIG. 4 illustrates a flow diagram of a process for requesting payment, according to an example embodiment herein.

FIG. 5 illustrates a flow diagram of a process for requesting a return of funds, according to an example embodiment herein.

FIG. 6 illustrates a flow diagram of a process for providing a response to a request for return of funds, according to an example embodiment herein.

FIG. 7 illustrates a flow diagram of a process for requesting information, in accordance with an example embodiment herein.

FIG. 8 illustrates a flow diagram of a process for responding to a request for information, in accordance with an example embodiment herein.

FIG. 9 illustrates a flow diagram of a process for providing remittance advice, in accordance with an example embodiment herein.

FIG. 10 illustrates a flow diagram of a process for providing status updates, in accordance with an example embodiment herein.

FIG. 11 illustrates a process flow for a credit transfer process, according to an example embodiment herein.

FIG. 12 illustrates a process flow for a credit transfer and system timeout, according to an example embodiment herein.

FIG. 13 illustrates a process flow for requesting payment, according to an example embodiment herein.

FIG. 14 illustrates another process flow for requesting payment, according to an example embodiment herein.

FIG. 15 illustrates a process flow for requesting a return of funds, according to an example embodiment herein.

FIG. 16 illustrates a process flow for requesting information, in accordance with an example embodiment herein.

FIG. 17 illustrates a process flow for providing remittance advice, in accordance with an example embodiment herein.

FIG. 18 illustrates a process flow for providing exception messages, in accordance with an example embodiment herein.

FIGS. 19a and 19c are further diagrams of an example real time payments system and related entities according to example embodiments herein.

FIGS. 19b and 19d show examples of various messages that can be used in the procedures described herein, according to example embodiments herein.

FIGS. 20a-20c show various message types, IDS codes, message names, and definitions of message types, for messages that can be employed in the procedures herein, according to example embodiments herein.

FIG. 21 shows an example of a multiple message process flow for a business to business transaction scenario herein.

FIG. 22 shows an example of a hybrid real time payment service according to an example scenario herein.

FIG. 23 shows an example of a business to person transaction scenario.

FIG. 24 shows an example of a person to person transaction scenario.

FIG. 25 shows an example of a person to business transaction scenario.

FIG. 26 shows an example of a business to business transaction scenario.

FIG. 27 represents another example of a business to person context, such as a case where a payment is made of a temporary employee's wages, according to an example embodiment herein.

FIG. 28 represents a person to person context for non-commerce payments, according to an example embodiment herein.

FIG. 29 is an example representation of a business to person scenario, such as, for example, an urgent disaster relief payment process according to an example embodiment herein.

FIG. 30 represents a further example of a person to person context, such as a case where an urgent account-to-account payment is made, according to an example embodiment herein.

FIG. 31 shows an example fraud detection process, according to an example embodiment herein.

FIG. 32 represents still a further person to person context, such as for payment for an informal service, according to an example embodiment herein.

FIG. 33 represents a person to business context, such as for an immediate bill payment, according to an example embodiment herein.

FIG. 34 represents a business to business scenario, such as a just in time payment to a supplier, according to an example embodiment herein.

FIG. 35 represents a business to business context, such as for an immediate bill payment, according to an example embodiment herein.

FIG. 36 represents an example of a request for return of funds procedure context, according to an example embodiment herein.

FIG. 37 represents an example process herein for detecting duplicate transactions.

FIG. 38 represents an example process herein for detecting an invalid token.

FIG. 39 represents an example of non-payment administrative messages that can be employed in the procedures herein.

FIG. 40 represents an example process for rejecting a payment.

FIG. 41 represents an example process for making an e-commerce payment, and providing fulfillment advice.

FIG. 42 shows an example where timeouts are employed with regard to payment instructions.

FIG. 43 represents an example of the impact on a total settlement capacity a financial institution, in a case where pre-funding is employed in conjunction with a net debit cap, or where only one of those is employed.

FIG. 44 represents example types of financial settlement procedures that can be employed herein.

FIG. 45 shows examples of various types of messages and certain characteristics thereof.

FIG. 46 shows a flow diagram of a settlement procedure according to an example embodiment herein.

FIG. 47 represents known automated fraud detection systems and their capabilities.

FIG. 48 is a diagram of an example real time settlement system according to an example embodiment herein.

FIGS. 49A and 49B are diagrams of an example real time settlement system according to another example embodiment herein.

FIGS. 50A and 50B show an example representation of a prefunded balance in view of a reconciliation window.

FIGS. 51A and 51B show an example representation of a prefunded balance in view of a reconciliation window.

FIG. 52 is a diagram of an example real time settlement system according to an example embodiment herein.

FIG. 53 illustrates a flow diagram of a reconciliation checkpoint process according to an example embodiment herein.

FIG. 54 illustrates a flow diagram of a supplemental funding process according to an example embodiment herein.

FIG. 55 illustrates a flow diagram of a request for disbursement process according to an example embodiment herein.

FIG. 56A illustrates a flow diagram of a Sign-on Request and Response process according to an example embodiment herein.

FIG. 56B illustrates a flow diagram of another Sign-on Request and Response process according to an example embodiment herein.

FIG. 57A illustrates a flow diagram of a Sign-off Request and Response process according to an example embodiment herein.

FIG. 57B illustrates a flow diagram of another Sign-off Request and Response process according to an example embodiment herein.

FIGS. 58A and 58B illustrate flow diagrams of two different Echo Request processes according to example embodiments herein.

FIGS. 59A and 59B illustrate flow diagrams of two different Echo Request processes according to example embodiments herein.

FIG. 60 shows examples of various types of System Notification Messages used within the real time payment (RTP) system according to an example embodiment herein.

FIG. 61 illustrates a flow diagram of a System Notification Message (SNM) process according to an example embodiment herein.

FIG. 62 illustrates a flow diagram of another System Notification Message (SNM) process according to an example embodiment herein.

FIG. 63 illustrates a flow diagram of an Administration Advice message process according to an example embodiment herein.

FIG. 64 illustrates a flow diagram of another Administration Advice message process according to an example embodiment herein.

FIG. 65 illustrates a flow diagram of another Administration Advice message process according to an example embodiment herein.

FIG. 66 illustrates a flow diagram of another Administration Advice message process according to an example embodiment herein.

FIG. 67 illustrates a flow diagram of another Administration Advice message process according to an example embodiment herein.

FIG. 68 illustrates a flow diagram of a Scheduled Report process according to an example embodiment herein.

FIG. 69 illustrates a flow diagram of an Inquiry (or Enquiry) Request process according to an example embodiment herein.

Again, identical portions of the various figures have been identified with the same reference numerals in order to simplify the descriptions thereof, and a detailed description may not be provided with respect to each figure.

### DETAILED DESCRIPTION

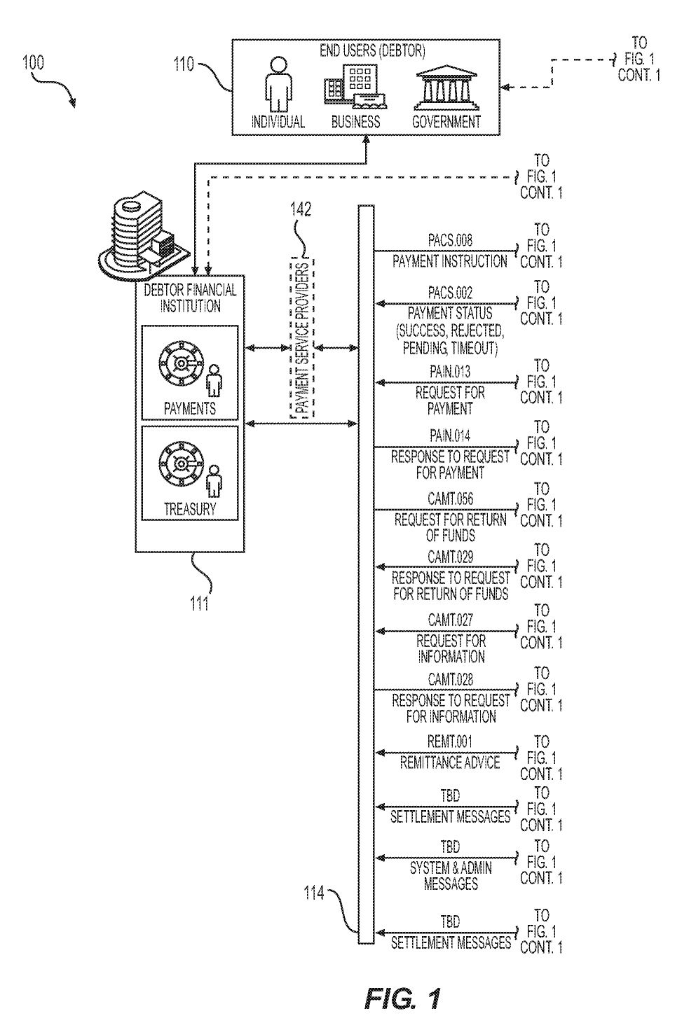

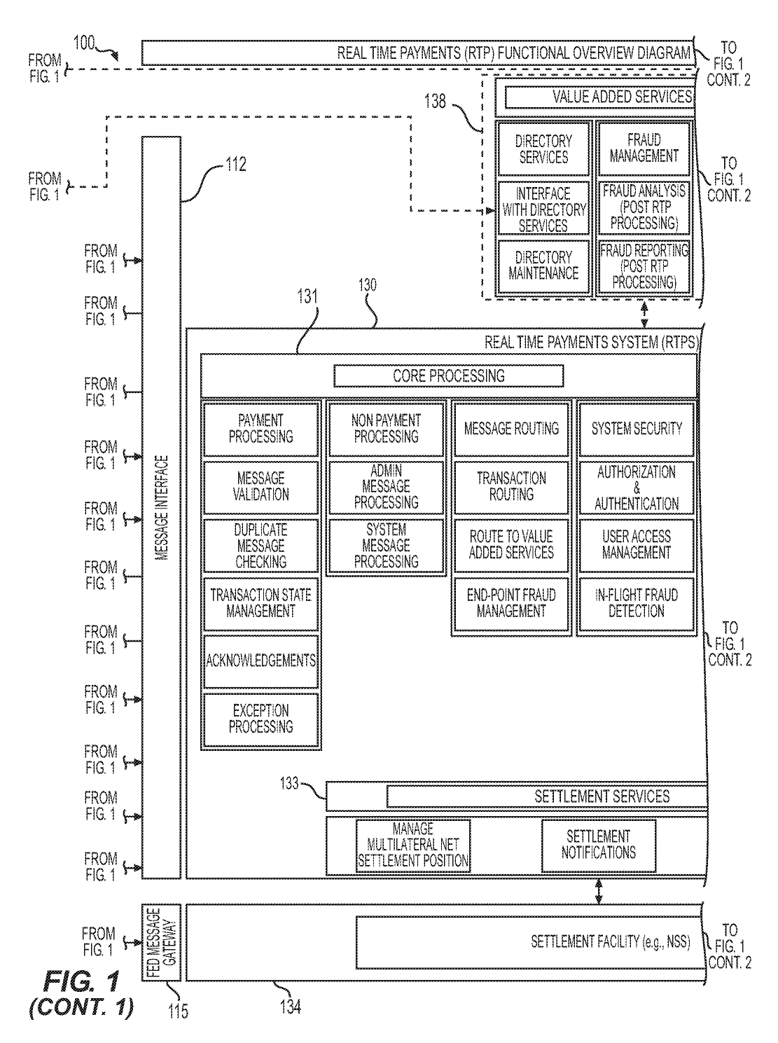

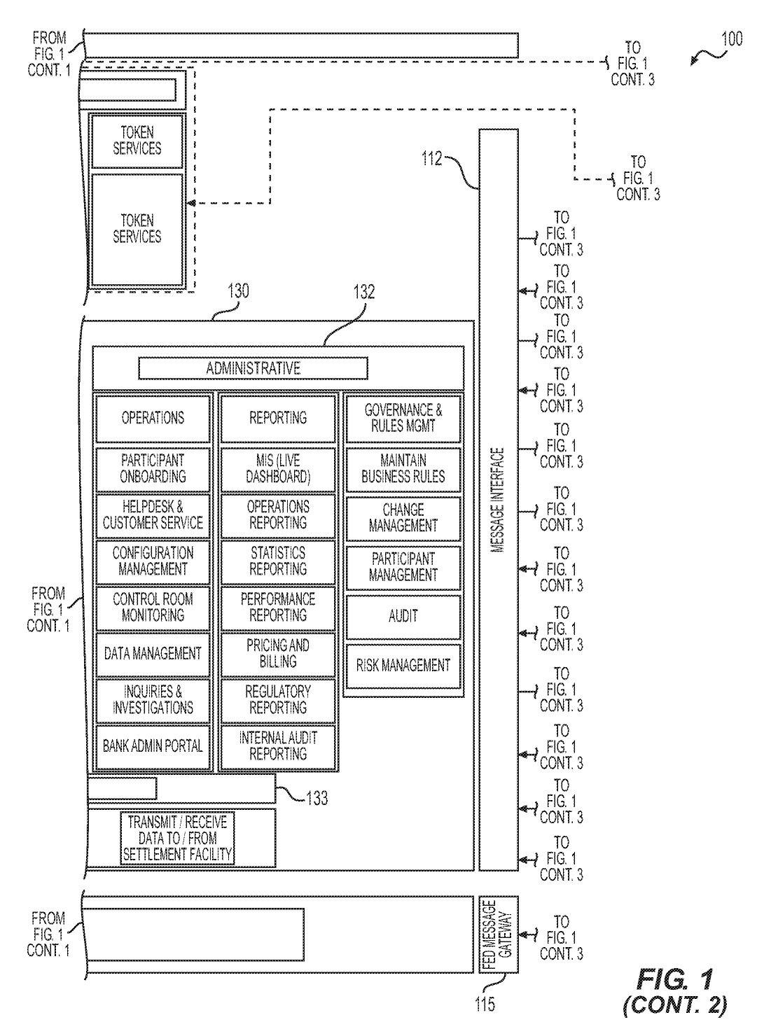

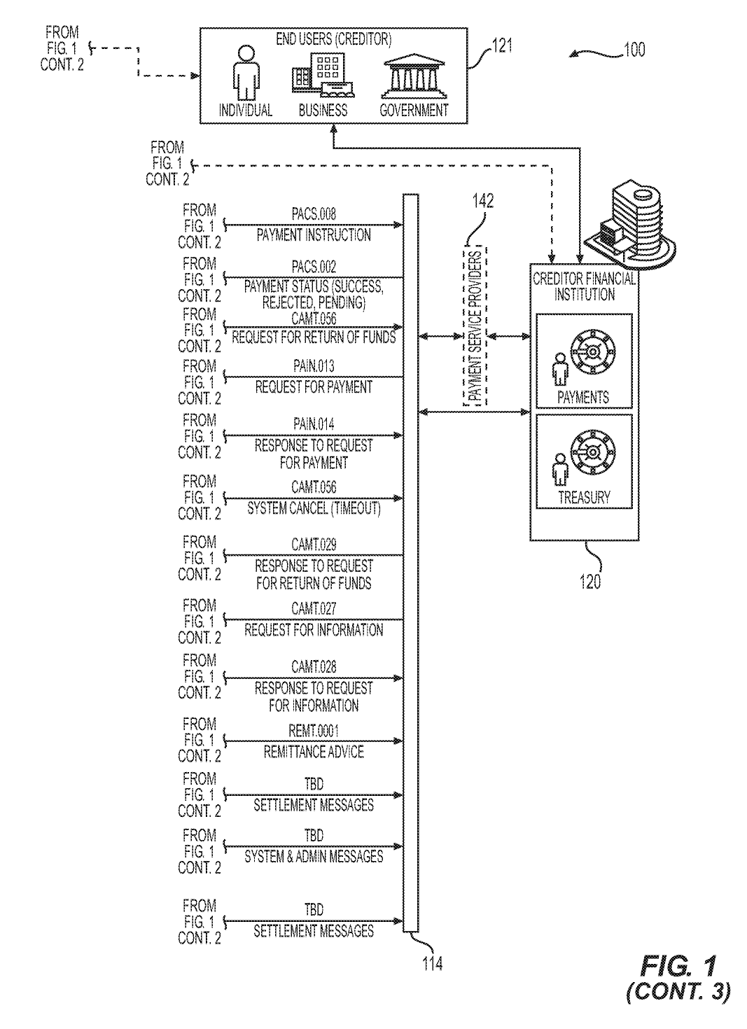

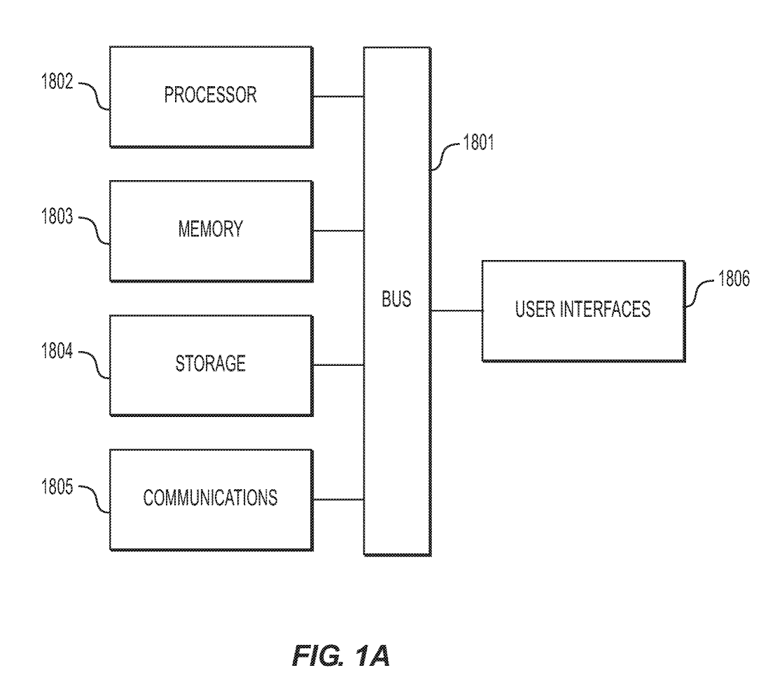

FIG. 1 is a diagram of a transaction system 100 configured in accordance with an example embodiment herein. The transaction system 100 includes user stations 110 and 121. In an example embodiment, user station 110 is operated by, under the authorization of, or on behalf of a debtor (e.g., an individual, business, government, etc.), and user station 121 is operated by, under the authorization of, or on behalf of a creditor (e.g., an individual, business, government, etc.). In this example, the debtor may owe one or more debts to the creditor. Accordingly, user station 110 can be referred to as a “debtor station,” and user station 121 can be referred to as a “creditor station.” Each user station may be, for example, a personal computer, a tablet computer, a smartphone, a standalone computer terminal such as a kiosk or ATM, or any other suitable type of electronic device for receiving, transmitting, storing, and/or processing information.

The transaction system 100 also includes financial institutions (FIs) 111 and 120. In an example embodiment, a user associated with station 110 can receive banking services (e.g., account services such as access to demand deposit accounts and savings accounts, brokerage services, and electronic bill payment and present services and the like) from FI 111. Similarly, a user associated with station 121 receives banking services from FI 120. Accordingly, FI 111 can be referred to as a “debtor FI,” and FI 120 can be referred to as a “creditor FI.” Each FI includes one or more computers and/or servers, such as, for example, the system of FIG. 1A, which are configured to handle electronic financial transactions.

Debtor station 110 is connected to (e.g., can electronically communicate with) debtor FI 111. Accordingly, the debtor may use station 110 to access banking services provided by FI 111 through, for example, an online banking portal available through, for example, a mobile application and/or a web browser running on station 110, banking software loaded on to station 110, or any other banking service provided by FI 111 on station 110. Similarly, creditor station 121 is connected to creditor FI 120. Station 110 and 121 also may connect to other elements as well, such as other elements of system 100.

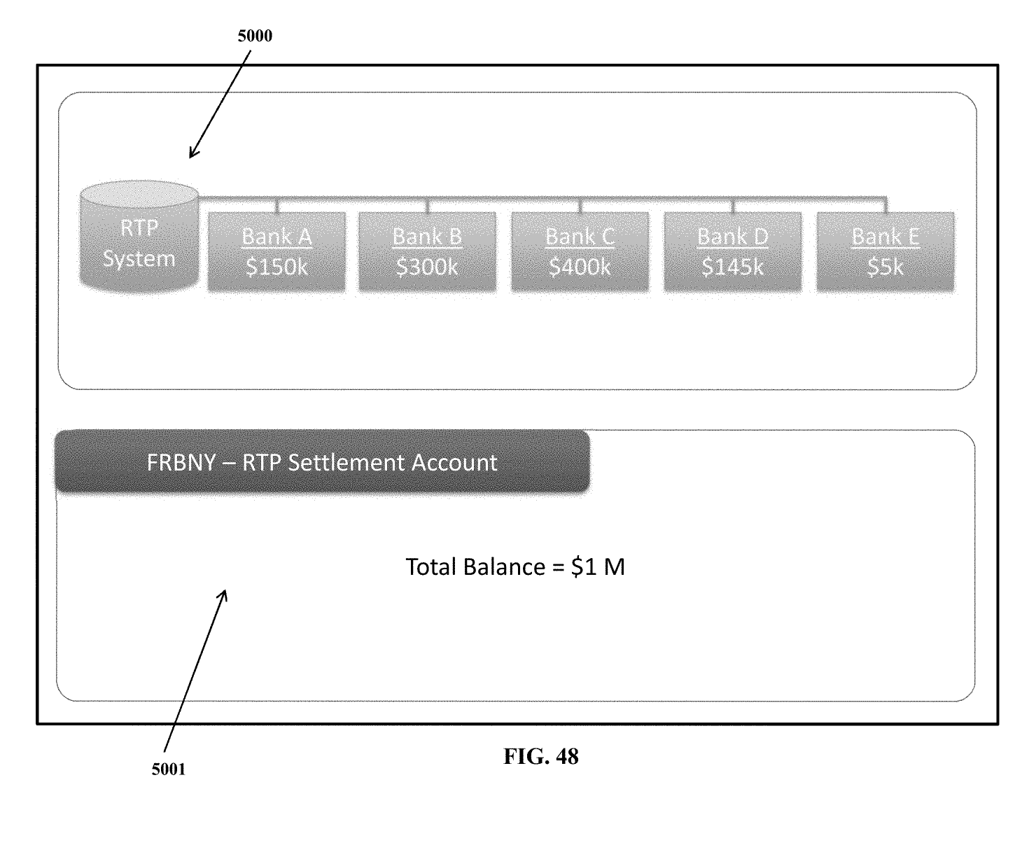

Debtor FI 111 and creditor FI 120 are connected to each other by a network 130 (also referred to as a Real Time Payment (RTP) network, such as system 5000 described below in connection with FIG. 48). In one example embodiment, the network 130 is not an automated clearinghouse (ACH) network, although in other embodiments it can be an ACH network (e.g., such as, without limitation, one or more of the Electronic Payments Network (EPN) and the FedACH). The network 130 can route (e.g., receive and transmit) electronic transactions and various types of messages between FIs via message interfaces 112 and 114, as described hereinbelow. The network 130 can include one or more computers and/or servers (such as, for example, the system shown in FIG. 1A) which are configured to handle electronic financial transactions. The network 130 also can include one or more databases. The network 130 also is referred to as system 130 or RTP system 130 herein. Also, although represented as a single network 130, there may be more than one such networks. For example, one such network can include the RTP network and another such network can include an ACH network.

Each connection (as indicated by a dual-headed arrow) illustrated in FIG. 1 can be any suitable type of existing or later-developed connection between one or more computers (or computing devices). In one example, at least part of one or more of such connections may include a network such as a local-area network (LAN), wide-area network (WAN), or the Internet. For example, station 110 may be a computing device (e.g., a PC or smartphone) that connects, via the Internet, to one or more web pages maintained or hosted by or on behalf of FI 111.

In one example embodiment, stations 110 and 121 can be connected by a secure communication channel (as indicated by the dashed arrow) on which communications may proceed after a single sign-on (SSO) procedure is performed in which a member using station 110 logs in to an online banking service provided by FI 111, although this example is neither limiting nor exclusive. In such a procedure, debtor FI 111 can be configured as a SAML identity provider, and station 121 can be configured as a SAML service provider. Accordingly, through communication between FI 111 (as the SAML identity provider) and station 121 (as the SAML service provider), a secure communication channel between station 110 and 121 can be established. In one example embodiment, such a secure communication channel is provided by way of network 130, which enables the SSO procedure to be effected.

Network 130 also includes a core processing system 131, an administrative system 132, and a settlement system 133. Network 130 also can include one or more databases. Generally, core processing system 131 performs processes such as payment processing, message validation, duplicate message checking, transaction state management, acknowledgements, non-payment messaging processing, administrative message processing, and system message processing. The core processing system 131 also performs processes such as message routing, transaction routing, routing to a value added service system (to be described below), and end-point fraud management. The system 131 also performs processes such as system security processes, authorization and authentication, user access management, and fraud detection.

The administrative system 132 performs administrative processes such as operations processing, participant onboarding, helpdesk and customer service, control room system monitoring, data management, conducting inquiries and investigations, and bank administration. Additionally, system 132 performs reporting processes such as a dashboard, operations reporting, statistics reporting, performance reporting, pricing and billing, regulatory reporting, and internal audit reporting. System 132 also performs governance and rules management processing, maintains business rules, effects change management, participant management, audits, and risk management. The settlement service system 133 performs settlement processing to enable financial transactions to be settled, (and, in one embodiment) manages multilateral net settlement positions and/or non-multilateral net settlement positions (such as, e.g. on a transaction-by-transaction basis, settlement notifications, and transmits/receives data to/from at least one settlement facility 134. That facility 134 also can communicate with the FIs 111 and 120 by way of gateways 115 and interfaces 114.

The transaction system 100 also can include a value added service system 138 connected to (or within) the network 130 and the FIs 111 and 120. The system 138 performs various valued-added services such as, for example, directory services and maintenance, fraud management, analysis, and reporting, and token services. The transaction system 100 can include one or more computers and/or servers, such as, for example, the system shown in FIG. 1A.

The transaction system 100 further can include elements 142 such as, for example, service providers and/or other entities. Elements 142 can be those which, for example, provide a technical connection and gateway (application interface) services, and, in some cases, other value add/back office services. In other embodiments, elements 142 can be, for example, payment service providers, a third party service provider, a biller or a clearinghouse. In the transaction system 100, the third party and/or other entity can receive bills and payments from FIs and send them to other FIs 111. Element 142 can include one or more computers and/or servers, such as, for example, the system shown in FIG. 1A.

In the illustrated example, the systems 138 and 134 are represented as being separate from the network 130, and at least some parts of the below description is made in the context of that example embodiment. However, it should be understood that the scope of the invention is not limited to that example only. For example, it is also within the scope of the invention for the systems 138 and 134 to be included in, operated by, or otherwise be a part of the network 130, and one skilled in the art would understand in view of this description how to adapt the functionalities described herein where needed to accommodate such an embodiment.

Elements of transaction system 100 can be configured to perform one or more of the steps or functions associated with any of the processes discussed herein, including those illustrated in the flow diagrams shown in the Figures and those discussed in connection therewith.

### Example Computer Systems

FIG. 1A is a diagram of an example computer system. In example embodiments, the computer system may form at least part of one or more of the components illustrated in FIG. 1, and may be configured to perform one or more steps of the processes illustrated in the Figures. For example, a debtor FI and creditor FI can include one or more servers, each which can include one or more computer systems like that of FIG. 1A. As another example, a user station (e.g. stations 110 and/or 121) can include one or more computer systems.

The system of FIG. 1A includes a processor 1802, a memory 1803, a storage device 1804, a communications device 1805, and one or more user interfaces 1806, all of which are coupled to a bus 1801.

Processor 1802 can communicate with the other components of the computer system through bus 1801. Storage device 1804 includes one or more computer-readable media. Storage device 1804 can be configured to read and write data including program instructions that may be executed by processor 1802 and operating systems (e.g., a general-purpose operating system, such as Microsoft Windows and UNIX, or a custom operating system) that allow processor 1802 to control the operation of the other components. Communications device 1805 can be configured to enable processor 1802 to communicate with, for example, a network and the internet. User interface(s) 1806 can include input devices (e.g., keyboards, mice, joysticks, trackpads, stylus tablets, microphones, and cameras), output devices (e.g., video displays, printers, and speakers), and input/output devices (e.g., touch screens). User interface(s) 1806 can form at least part of any of the devices, components, and/or systems discussed herein.

Processor 1802 is configured to perform part (or all) of any of the processes described herein, depending on which component(s) of FIG. 1 the computer system forms a part of. For example, processes such as all or part of those of the flow diagrams described herein can be stored on storage device 1804 in the form of computer-readable program instructions. To execute a process, the processor loads the appropriate instructions, as stored on storage device 1804, into memory 1803, and then executes the loaded instructions to perform electronic transaction services, such as to, for example, generate, transmit, and/or receive a request for enrollment in the delivery of electronic information, or generate, transmit, and/or receive an electronic EOB, EOP, bill, and/or bill summary, and/or generate, receive, or otherwise process a payment transaction as described above.

### Example Real-Time Payment Procedures

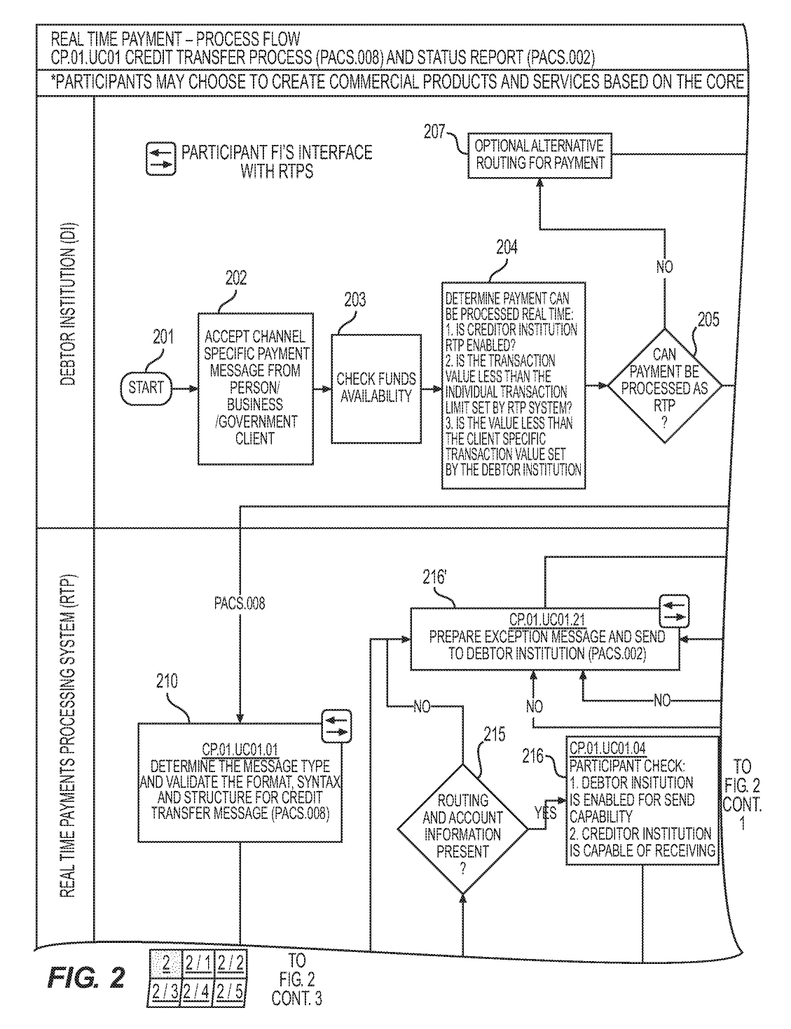

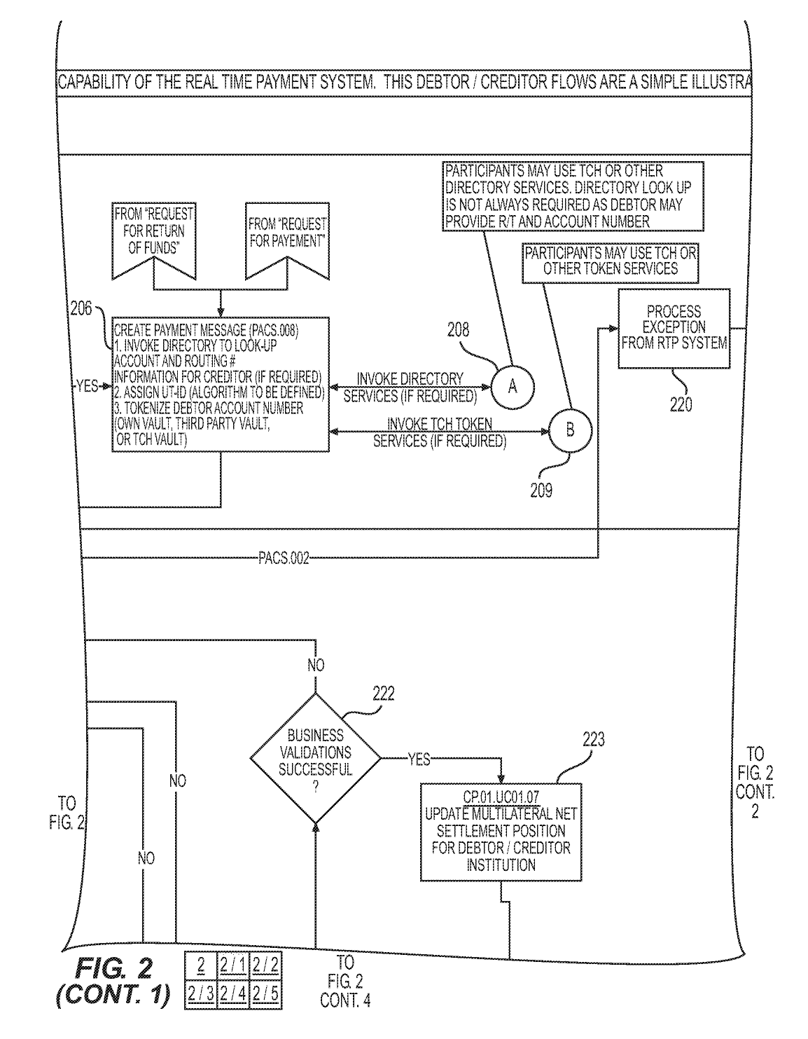

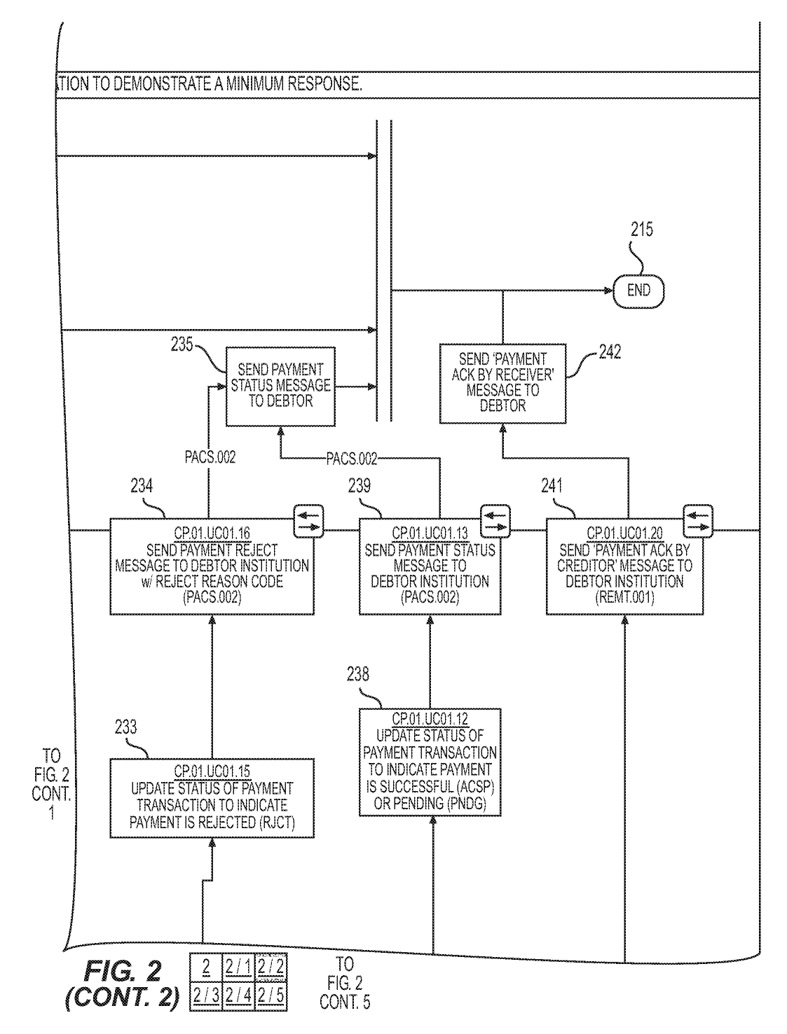

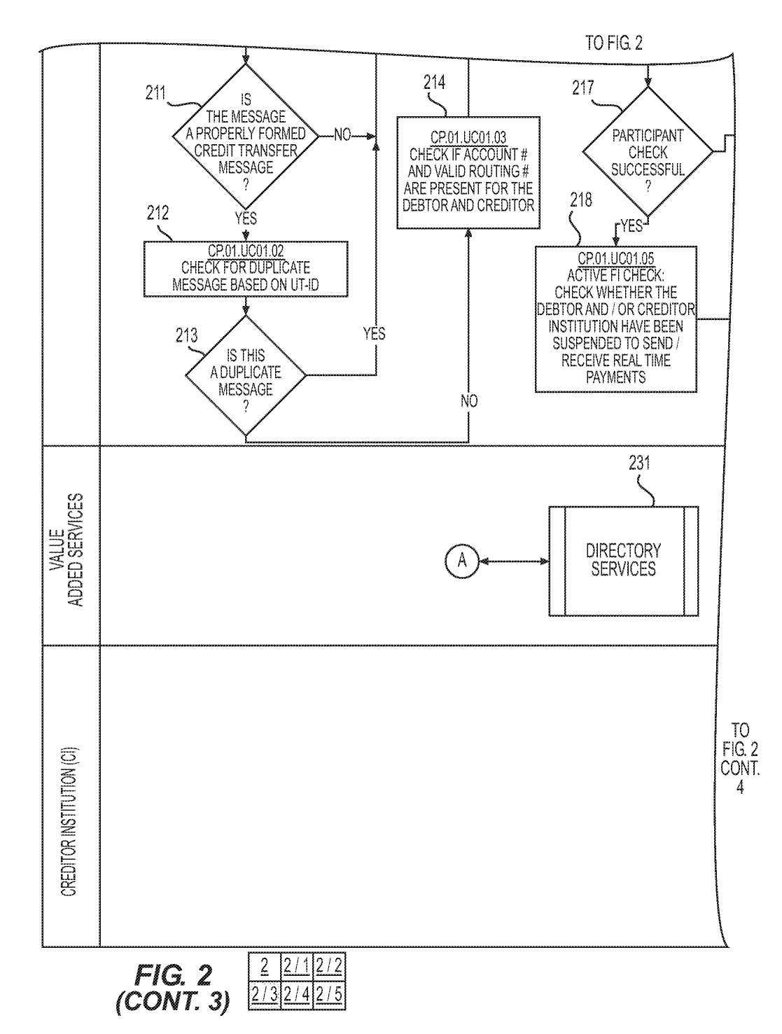

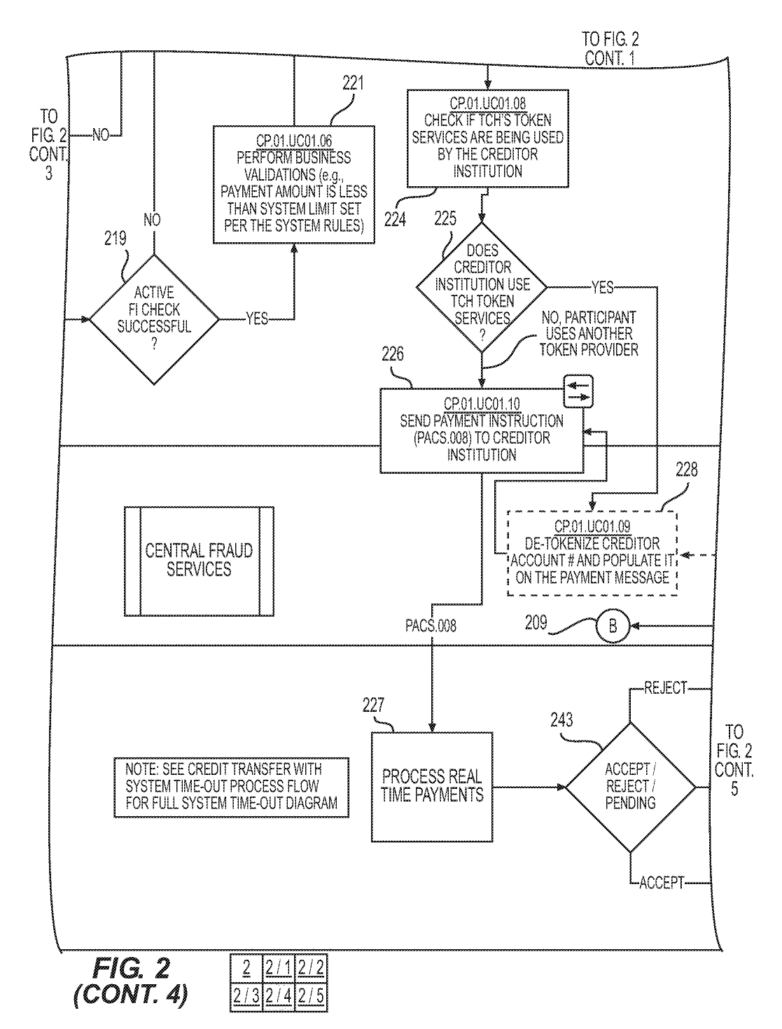

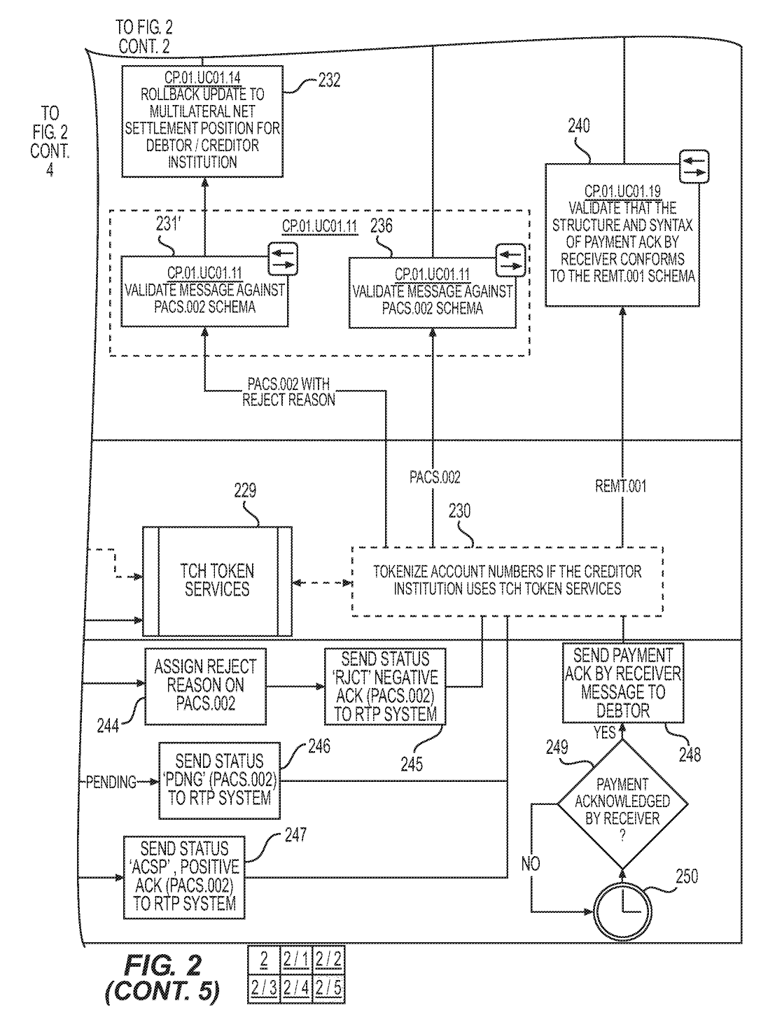

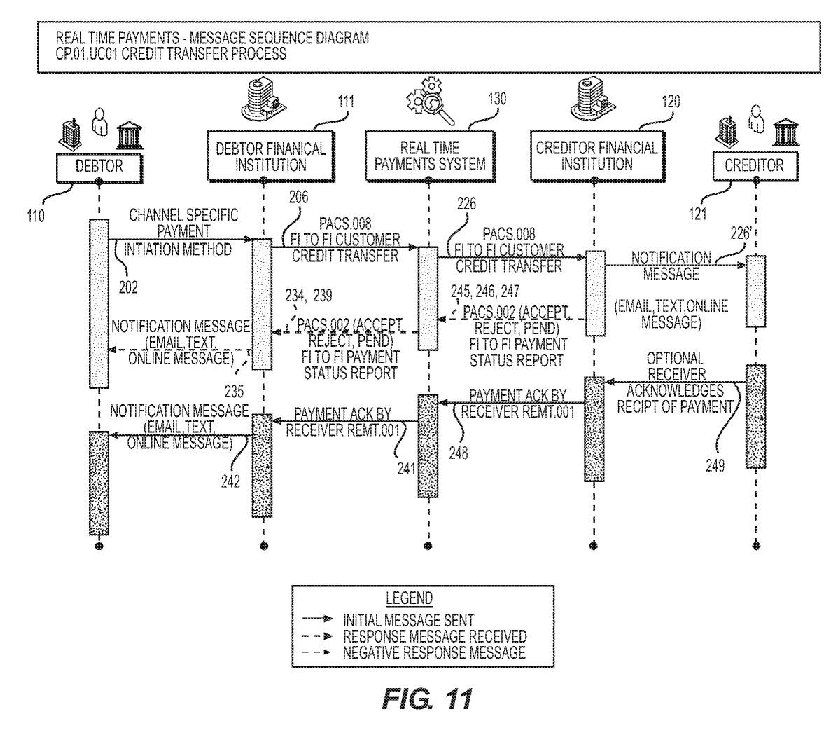

An example real-time payments procedure according to an example embodiment herein will now be described. Referring now to FIG. 2 (and FIG. 11), in addition to being able to obtain access to and view, summary and detailed bills, a user (e.g., associated with station 110) can connect to their FIs' (e.g., via an on-line banking website or mobile application) to authorize a payment of an amount from the user's account with a debtor FI (e.g., FI 111) to creditors, billers, and the like (e.g., associated with station 121), creditor FIs (e.g., FI 120), or other entities, based on the accessed item(s) (step 201). After receiving payment authorization (e.g., a payment authorization message) from a consumer (step 202), such as, for example, via a channel specific message, a FI (e.g., FI 111) checks the account associated with the user to determine whether the account has a sufficient amount of funds available to cover the payment amount (step 203). Where sufficient funds are determined to be available, the debtor FI 111 then determines whether the requested payment can be processed in real time (step 204). In one example embodiment, step 204 is performed by the FI 111 determining (i) whether the creditor FI 120 identified in the payment authorization has a capability to receive real time payments (i.e., is “real time enabled”), (ii) determining whether the payment amount is less than a predetermined individual transaction limit of the transaction system 100, and (iii) determining whether the payment amount is less than a predetermined client specific transaction value set by the FI 111. For example, determination (i) can involve the FI 111 associating an identifier of the creditor FI 121 included in the payment authorization with associated predetermined information stored in the debtor FI 111 indicating whether or not the creditor FI 121 supports real time payment capability. In another example embodiment, the network 130 stores the predetermined information, and the determination is made by the debtor FI 111 communicating with the network 130 to determine whether the predetermined information indicates that the creditor FI 120 supports real time payment capability. In still another example embodiment, the predetermined information is stored elsewhere, in another element, of the transaction system 100, such as in the creditor FI 120, and the determination is made by the debtor FI 111 communicating with that element to determine whether the predetermined information indicates that the creditor FI 120 supports real time payment capability. The determination (ii) similarly can involve similar procedures for determining whether the payment amount is less than a predetermined transaction limit of the transaction system 100 (i.e., the amount included in the payment authorization is checked against a limit that may be included in the FI 111 or 120, the network 130, or in another element of the transaction system 100).

If any of the determinations (i), (ii), and (iii) results in a determination of “No” (“No” in step 205), then control passes to step 207, where the user of station 110 may elect to make the payment via another payment alternative (or not, if the debtor FI does not offer another channel option, or if another payment alternative is not selected), and then the method ends (step 215). On the other hand, if each of the determinations (i), (ii), and (iii) results in a determination of “yes” (“Yes” in step 205), then control passes to step 206, where a payment transaction message (e.g., a pacs.008 message) is generated by the debtor FI 111. The payment transaction message includes, for example, a transaction identifier (e.g., a UT-ID generated by an algorithm), a biller's or creditor's name (and/or other applicable, predetermined information), the biller's account number at the biller's FI (e.g., FI 120), the routing number of the biller's FI (e.g., FI 120), the consumer's name, the payment amount, and a biller remittance identifier (i.e., consumer's account number with the biller) so that the biller can associate the payment with the consumer, and/or the biller's or creditor's information, for posting purposes. Payments made for bills obtained by the consumer may be initiated, where the FI 111 can initiate a payment transaction message for each payment, enabling the consumer to pay bills such as, for example and without limitation, bills for debts owed by the consumer (e.g., user of station 110) to the debtor (e.g., associated with station 121). Payment can be made in response to a request for payment message, although it need not be.

In non-pseudo-identifier payment transactions (i.e., payment transactions not using an alias or token), biller routing numbers are used to determine which biller FI should receive a payment transaction message, and billers' account numbers are used to determine which biller's account at the biller FI should receive the payment, and those numbers, in one example, can be obtained by correlating an identifier of the biller (e.g., whether an alias or non-alias identifier) to those numbers maintained in a database or directory (steps 208, 231). The database or directory may be included in the network 130 (or value added services 138), in one example embodiment, or in another example, it can be included elsewhere in the transaction system 100, such as at a third party or another element.

As an alternative to such payment transactions, the network 130 enables a biller to use a bank account number pseudo-code (BANPC) and a bank routing number pseudo-code (BRNPC) as described below, for an added level of security. Similar functionality also is described in U.S. Pat. Nos. 6,173,272 and 6,317,745, both to Thomas et al. These two patents are hereby incorporated by reference in their entireties, as if set forth fully herein. In the example embodiments herein, the BANPC can be used in effecting credit-only transactions, or both credit and debit transactions.

A BRNPC is a mask identifier for a biller FI's routing number which indicates to the network that a BANPC transaction is present. A BANPC is an account mask identifier for a biller's actual account number at its biller FI (e.g., FI 120). In one example embodiment herein, the mask identifier is in the form of a “token”, such as, e.g., a static “token”. For a BANPC transaction, when an electronic payment is specified to be made by a consumer by way of its FI (e.g., FI 111), instead of using the biller's actual account number and a biller FI's actual routing number (whether obtained in the payment authorization message or obtained from the directory), a BANPC identifier corresponding to that account number and a BRNPC are obtained and inserted by the FI (e.g., FI 111) in the payment transaction message, in step 206 (see also steps 208 and 209). As such, “tokenization” is thereby performed. For security, in one example embodiment, FIs such as FI 111 are provided with BRNPCs and corresponding BANPCs, but not with the biller's actual account and routing numbers. The BANPC and BRNPC collectively protect the biller's banking information and mitigate the opportunity for fraud.

In one example embodiment herein, the BANPC identifier and BRNPC are obtained by the FI 111 by accessing the directory to correlate information identifying the biller (creditor) included in the payment authorization to a corresponding BANPC identifier and BRNPC included in the directory (step 208, 209). (In one example embodiment herein, the information identifying the creditor can be any suitable type of identifier, such as, for example, a name, email address, phone number, or the like). As pointed out above, the directory may be included in the network 130, in one example embodiment, or in another example, it can be included elsewhere in the transaction system 100, such as at a third party or another element.

After step 206 is performed, control passes to step 210 where, in one example embodiment, the network 130 receives the payment transaction from the debtor FI 111 (e.g., in a pacs.008 credit transfer message) and determines whether the transaction is correctly formatted. For example, the network 130 checks the message type of the transaction, and validates the format, syntax, and/or structure of the message. That step can be performed in accordance with any suitable techniques. If it is determined that the message is not properly formatted (“No” in step 211), then control passes to step 216′ which will be described below. If it is determined that the message is properly formatted (“Yes” in step 211), then control passes to step 212 where the network 130 checks to determine whether the message is duplicative of one already received, based on, for example, whether a UT-ID included in the message was already received. If it is determined that the message is duplicative (“Yes” in step 213), then control passes to step 216′, which will be described below. If, on the other hand, the message is determined to not be duplicative (“No” in step 213), then control passes to step 214 where the network 130 checks the message to determine whether it includes valid account and routing numbers (e.g., whether valid tokens or actual account and routing numbers). If not (“No” in step 215), then control passes to step 216′ which is performed in a manner to be described below. If “Yes” in step 215, then in step 216 the network 130 makes a determination as to whether the debtor FI 111 is enabled for sending payment transactions, and whether the creditor FI 120 is enabled to receive payment transactions. For example, this step can include the network 130 checking a look-up table to determine whether information in the table indicates that those FIs have such respective capabilities.

If the FIs are determined not to be enabled (No” in step 217), then control passes to step 216′ which will be described below. If, on the other hand, the FIs are determined to be enabled (“Yes” in step 217), then the network 130 makes a determination as to whether the debtor FI 111 or creditor FI 120 have been suspended to participate in electronic payment transactions (step 218). If either of those FIs are determined to be suspended (and thus the check is determined not to be successful (“No” in step 219)), then control passes to step 216′. That step 216′ will now be described. In step 216′, the network 130 generates an exception message (e.g., a pacs.002 message) and forwards it to the debtor FI 111, and then, in step 220 the debtor FI 111 responds by processing the exception, whereafter the method then ends in step 215.

If, on the other hand, either of the FIs 111 or 120 is determined not to be suspended (and thus the check is determined to be successful (“Yes” in step 219)), then control passes to step 221 where the network 130 performs various business validations. As an example, the validations can include determining whether the payment amount of the payment transaction is less than a predetermined individual transaction limit of the transaction system 100. If the validation(s) performed in step 221 are determined not to be successful (“No” in step 222), then control passes to step 216′ which is performed in the manner described above.

If the validation(s) performed in step 221 are determined to be successful (“Yes” in step 222), then control passes to step 223 where the network 130 updates at least one settlement position. In one example embodiment herein, the network 130 updates a multilateral net settlement position for at least one of the debtor FI 111 and the creditor FI 120. In another example embodiment herein, the network 130 updates the debtor FI 111's Position (i.e. by deducting the amount of credit transfer from the Debtor FI's available balance/position). Then, in step 224 the network 130 checks to determine whether a token service is being employed in the payment transaction (i.e., the network 130 detects whether a BANPC transaction or a non-BANPC transaction is present). The presence of a BANPC transaction is detected based on a result of the network comparing the BRNPC of the consumer's payment request to a list of routing numbers designated by the network for BANPC transactions. If no match exists (“No” in step 225), then processing proceeds where the network 130 sends the payment transaction to the creditor FI 120 (step 226) to attempt effecting a payment based on the routing number and account number included in the payment transaction message (a pacs.008 message), whereafter the creditor FI 120 begins processing the payment transaction (step 227). That FI 120 determines whether to accept or reject the payment (step 243) based on predetermined criteria, or whether the payment is pending (e.g., perhaps owing to an anti-fraud, AML, or OFAC investigation, etc.). In the case where the payment is rejected (e.g., perhaps a relevant account is closed, a token is not recognized, etc.), the FI 120 assigns a reason for rejecting the payment (step 244) and then sends a status “RJCT” negative ACK (e.g., a pacs.002 message) to the network 110 in step 245. Control then passes to step 230 which performs a tokenizing procedure (although in other embodiments it is not performed), and then control passes to step 231′ which will be described below. In the case where the FI 120 determines that the payment is pending in step 243, then in step 246 the FI 120 sends a status “PDNG” (e.g., a pacs.002 message) to the network 110. The pending status message may also be, in one embodiment, an accepted without posting message. Control then passes to step 230 which performs a tokenizing procedure (although in other embodiments it is not performed), and control then passes to step 236 which will be described below. In the case where the FI 120 determines that the payment is accepted in step 243, then in step 247 the FI 120 sends a status “ACSP” positive ACK message (e.g., a pacs.002 message) to the network 110. Control then passes to step 230 which performs a tokenizing procedure (although in other embodiments it is not performed), and control then passes to step 236 which will be described below. In one example embodiment, the FI 120 also can notify the station 121 of the status of the payment (e.g., via text message, email, an online message or other form of communication) (see step 226′ of FIG. 11).

Referring back again to step 225, a case where token services are determined to have been used in the payment transaction will now be described. If a match is determined to exist in step 225 (i.e., if the routing number is a BRNPC in the list, or the originator and/or receiver is otherwise known to use token services), and thus token services are determined to have been used in the transaction (i.e., “Yes” in step 225), then a BANPC transaction is deemed present and the network 130 in step 228 (and involving step 229) performs a detokenization procedure. In this particular example, the detokenization procedure includes a reversal of the tokenization procedure performed in step 206, and thus includes a translation from the BANPC included in the payment transaction to (1) a biller's account number at their biller FI (e.g., FI 120) and (2) a routing number for the biller's FI (e.g., FI 120). To perform this translation, the network 130 and/or value added services 138, maintains a BANPC database that associates each biller's BANPC with that biller's account number at their FI (e.g., FI 120) and the routing number to the biller's FI (e.g., FI 120). Using the directory (also referred to as a BANPC database, which may be maintained by the network 130 or value added service 138 or another element) and the BANPC included in the payment transaction, the network 130 correlates the BANPC included in the transaction to a corresponding BANPC included in the directory, and to that latter BANPC's associated biller account number and routing number of the biller's FI (e.g., FI 120), in the directory (step 229).

The BANPC's associated biller account number and routing number of the biller's FI (e.g., FI 120) are inserted into the payment transaction, and the BANPC and BRNPC are removed from the transaction. Then the network 130 routes the payment transaction, including the inserted account number and routing number, to the biller's FI (e.g., FI 120) based on the inserted routing number, in step 226. Control then passes to step 227 where the process proceeds in the above described manner. It is noted that, when a payment is accepted (in step 243), the biller FI (e.g., FI 120) posts the credit to the biller's account (corresponding to the biller account number) to complete payment. In another example embodiment herein, however, before the credit is posted in that manner, the creditor FI sends a message (e.g., a pacs.002 accept message), the network 130 recognizes that the transaction is complete, and the credit is posted to the creditor FI's position. A notification is then sent to both the debtor FI and creditor FI indicating that the transaction is now complete and settled. In response to the creditor FI receiving that notification, the credit is made available to the applicable customer account.

In accordance with another example embodiment herein, the above translation (de-tokenization) is performed by a FI, such as FI 111, for at least some payment transactions, instead of by the network 130.

Referring now to step 250, in one example embodiment herein, in that step the creditor FI 120 awaits (e.g., for a predetermine time, such as, e.g., 5 seconds) an acknowledgement from the creditor station 121 that it has received the payment (see step 250, and “No” in step 249). In response to receiving such an acknowledgement from the creditor station 121 (“Yes” in step 249), the creditor FI 120 forwards (e.g., by way of network 130) a payment acknowledgement message towards the debtor FI 111 and/or the debtor station 110 (which can be by way of FI 111) in step 248, via the network 130. Control then passes to step 230, which tokenizes that message (although in other embodiments no tokenizing is performed), and control then passes to step 240 which will be described below. In another example embodiment herein, step 250 involves the creditor FI 120 determining if the payment is accepted/rejected and then sending an accept/reject status to the network 130. The creditor FI does not wait for the station 121 to issue the above acknowledgement.

Step 231′ will now be described. In step 231′ the network 130 validates the payment message with reason for rejection to determine that it is in a correct format (e.g., in accordance with pacs.002 schema). Then, in step 232, the network 130 conducts a reversal of the update to the multilateral net settlement position of the debtor FI 111 and/or creditor FI 120 (i.e., a reversal of step 223), and then in step 233 the network 130 updates the status of the payment transaction to indicate that the payment has been rejected. However, in another example embodiment herein, in response to receiving a rejection message (e.g., a pacs.002 “rejection” message) from step 230, the creditor FI 120's position is not altered, the debtor FI 111's position is reversed/credited by the applicable rejected payment amount, and there is no multilateral netting.

In step 234 the network 130 sends a payment reject message (e.g., pacs.002) to the debtor FI 111, including the reason for the rejection, the message is provided from the FI 111 to the station 110, and then the method then terminates (step 215).

Step 236 will now be described. In step 236, the network 130 validates the (a pacs.002 message) from step 246 or 247 to determine that it is in a correct format (e.g., in accordance with pacs.002 schema). Then, in step 238, the network 130 updates the status of the payment transaction as successful (in the case of step 247) or pending (in the case of step 246). In step 239 the network 130 sends a payment status message (e.g., pacs.002) to the debtor FI 111, indicating that the payment was successful or pending, and control then passes to step 235 where the FI 111 sends a message (e.g., a text message, email, online message or other form of communication) to the user station 110 indicating that the payment was successful or pending. Then the method ends at step 215.

Step 240 will now be described. In one example embodiment, in step 240 the network 130 determines whether a payment acknowledgement (e.g., an ACK message) received by the network 130 from the creditor FI 120 is correctly formatted. For example, the network 130 checks the message type of the transaction, and validates the format, syntax, and/or structure of the ACK message. That step can be performed in accordance with any suitable techniques. Then, in step 241 the network 130 forwards the ACK message to the debtor FI 111, which then responds in step 242 by providing a message to the station 110 indicating that the creditor FI 120 has acknowledged receipt of the payment. The method then ends in step 215. According to one example embodiment herein, payment acknowledgement is a separate transaction from a pacs.008/pacs.002 payment and response, and includes an end user (e.g., 120 or 121) acknowledgement that the payment was received and/or applied. In another example embodiment herein, a message such as, e.g., a pacs.002 response is employed, with the exception of “no accept without posting” situation, a payment acknowledgement message involves a camt.035 versus a remt.001 message.

### Time Out and Status Reporting

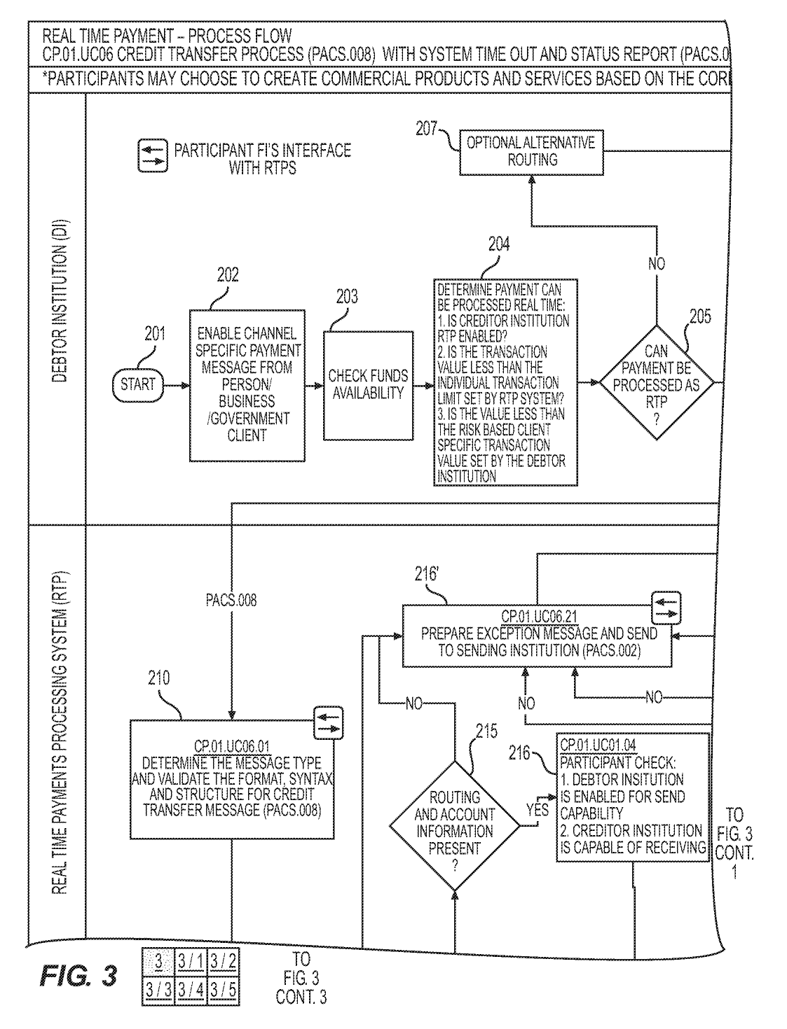

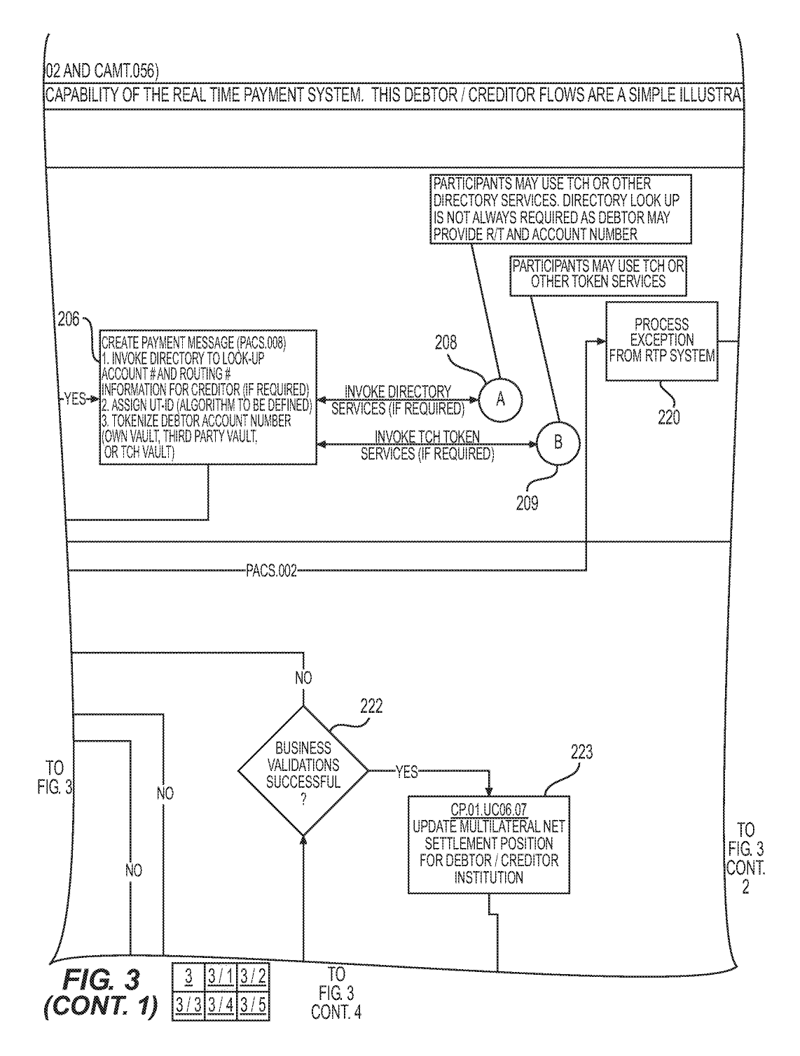

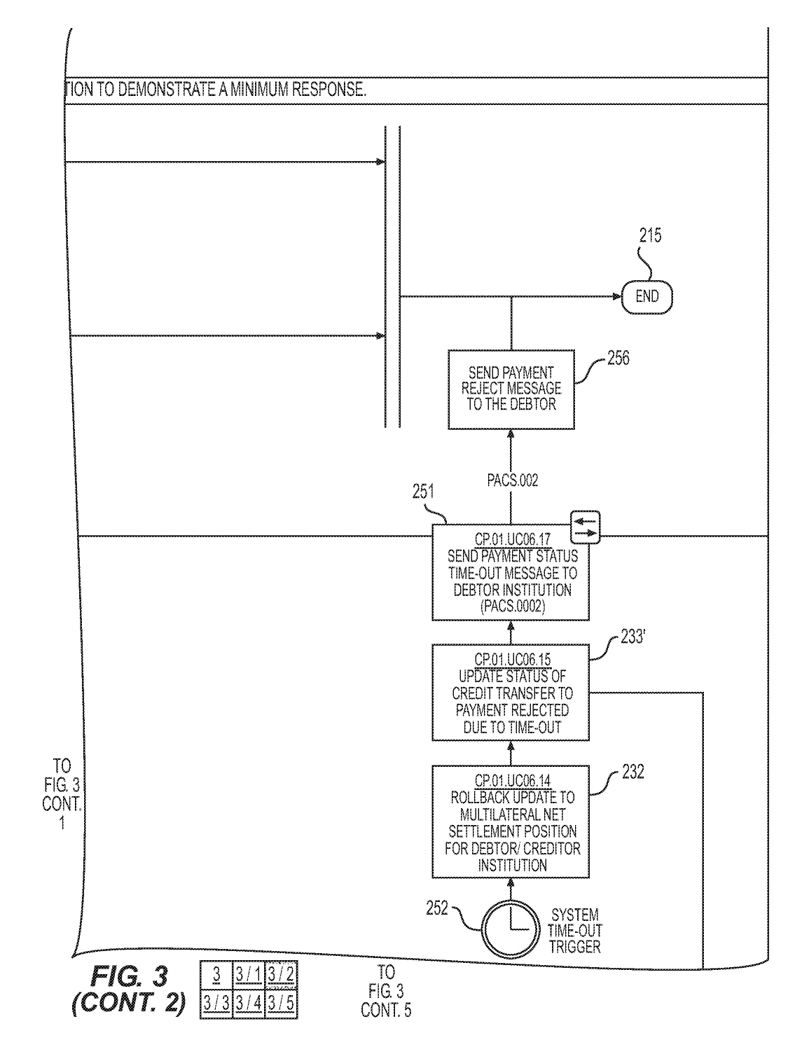

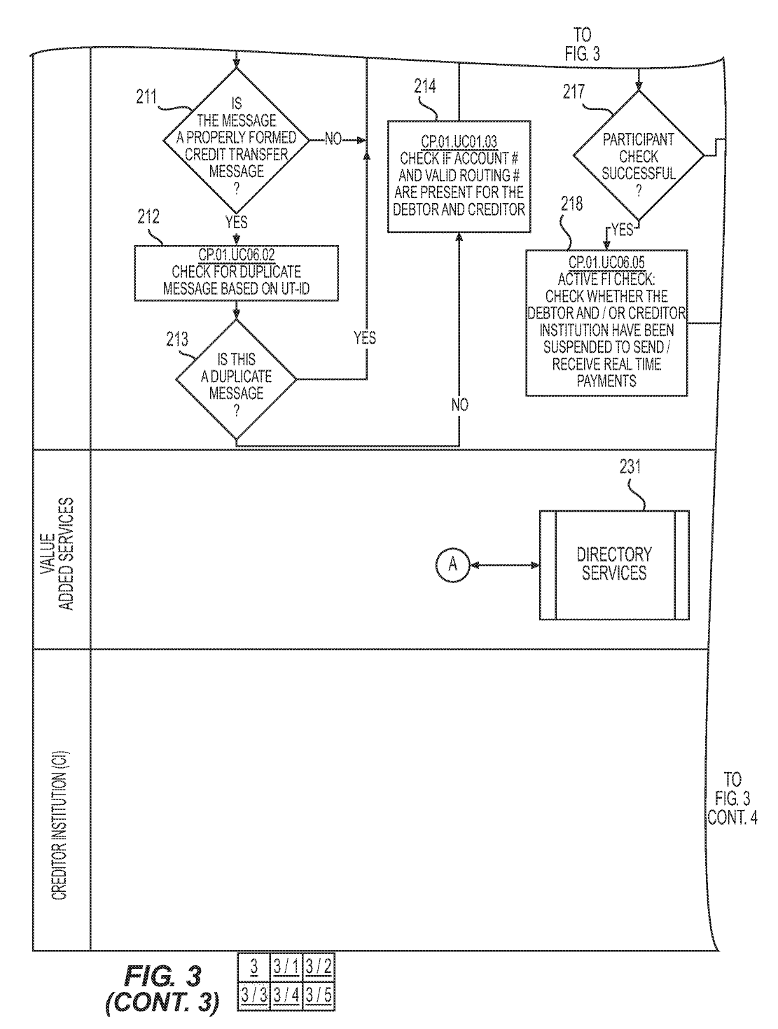

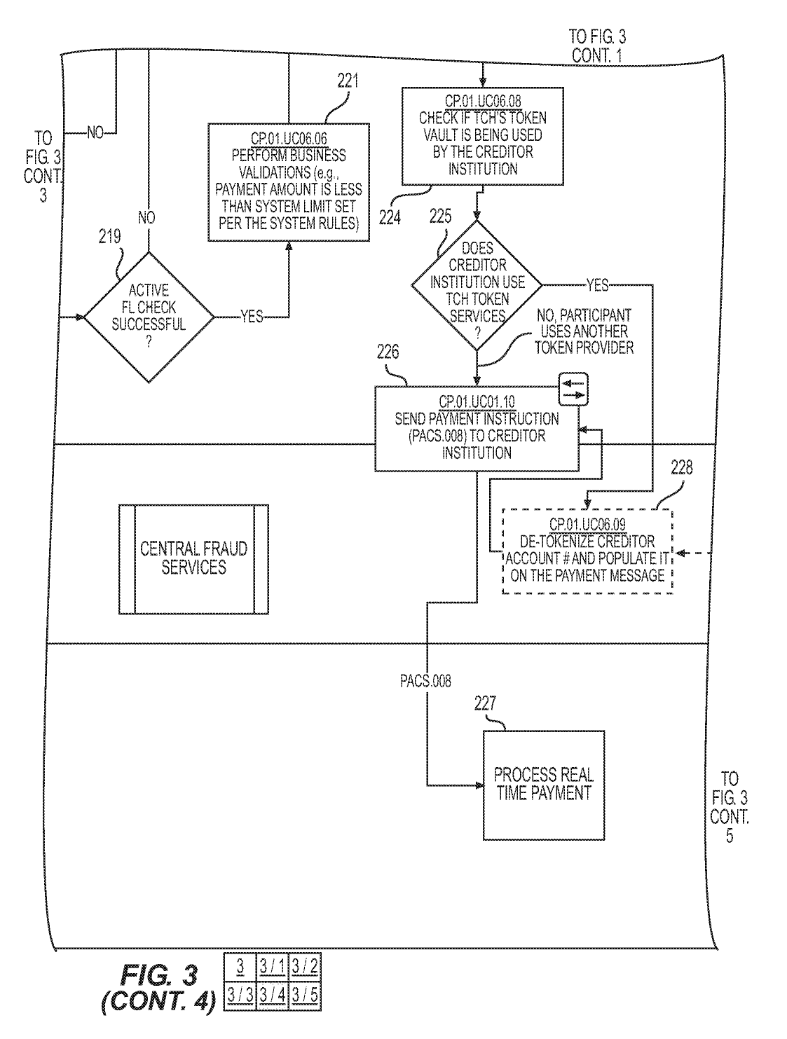

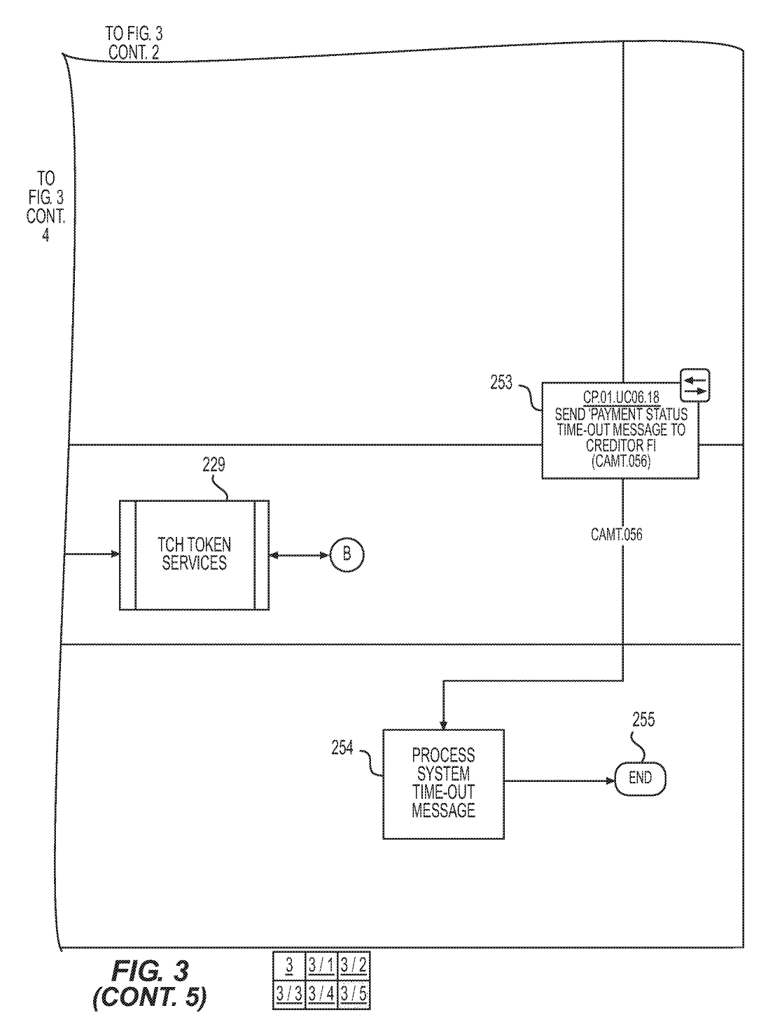

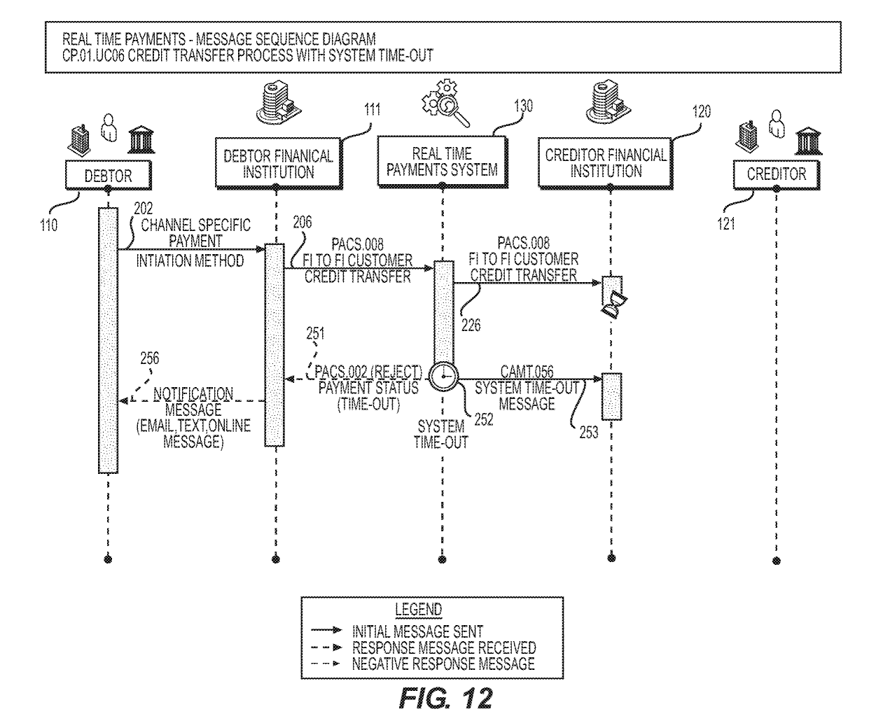

The transaction system 100 also can perform time out and status report processing. Referring now to FIGS. 3 and 12, the manner in which system time out and status report processing are performed in accordance with one example embodiment, will now be described. The procedure of FIG. 3 includes steps similar to those of FIG. 2 (for convenience, those steps will not be further described), but after sending the payment instruction in step 226, the network 130 determines that it has not received a response (e.g., such as a pacs.002 or remt.001 message) thereto within a predetermined time period (step 252). As a result, control passes to step 232 which is performed in the same manner as described above for FIG. 2, and then, in step 233′, the network 130 updates the status of the payment transaction to “Payment Rejected due to Time-Out”. Thereafter, in step 251 the network 130 forwards a payment status time-out message to the debtor FI 111 (e.g., in one embodiment this message can include, e.g., a pacs.002 message), which then provides a payment reject message to the debtor station 110 (step 256). The method then terminates in step 215. Also according to one example embodiment herein, before or simultaneously with the debtor FI being sent a pacs.002 message indicating “Payment Rejected due to Time-Out”, the creditor FI can be sent a camt.056 message indicating the payment was timed-out (FIG. 12, step 253).

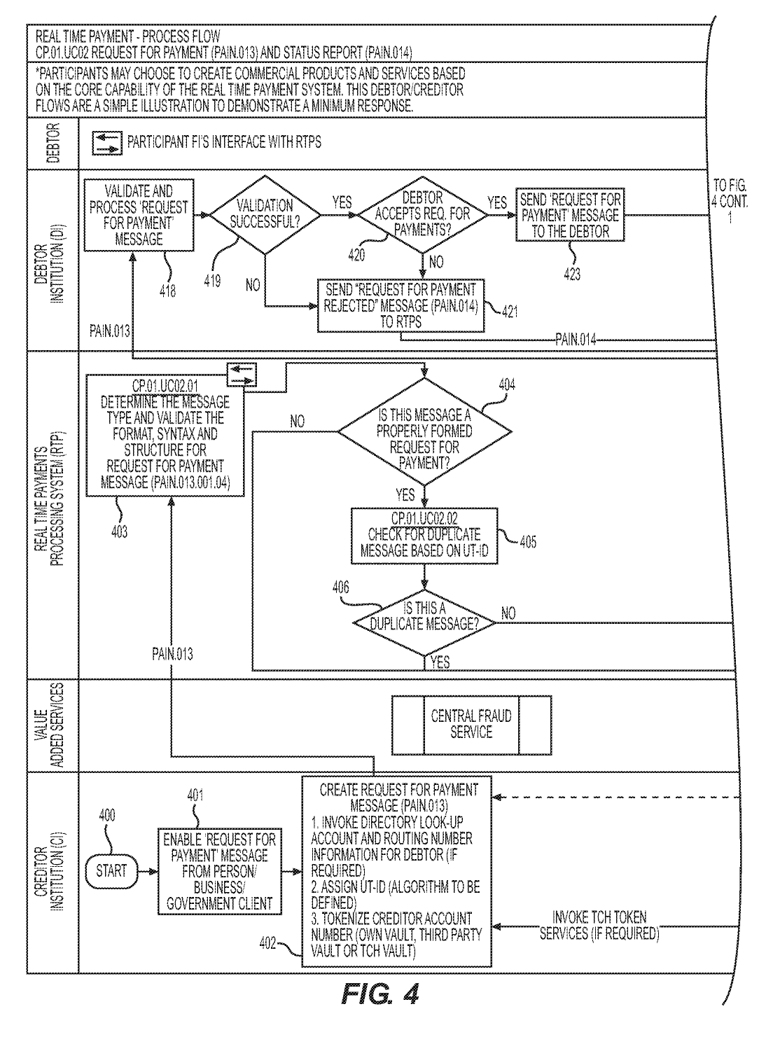

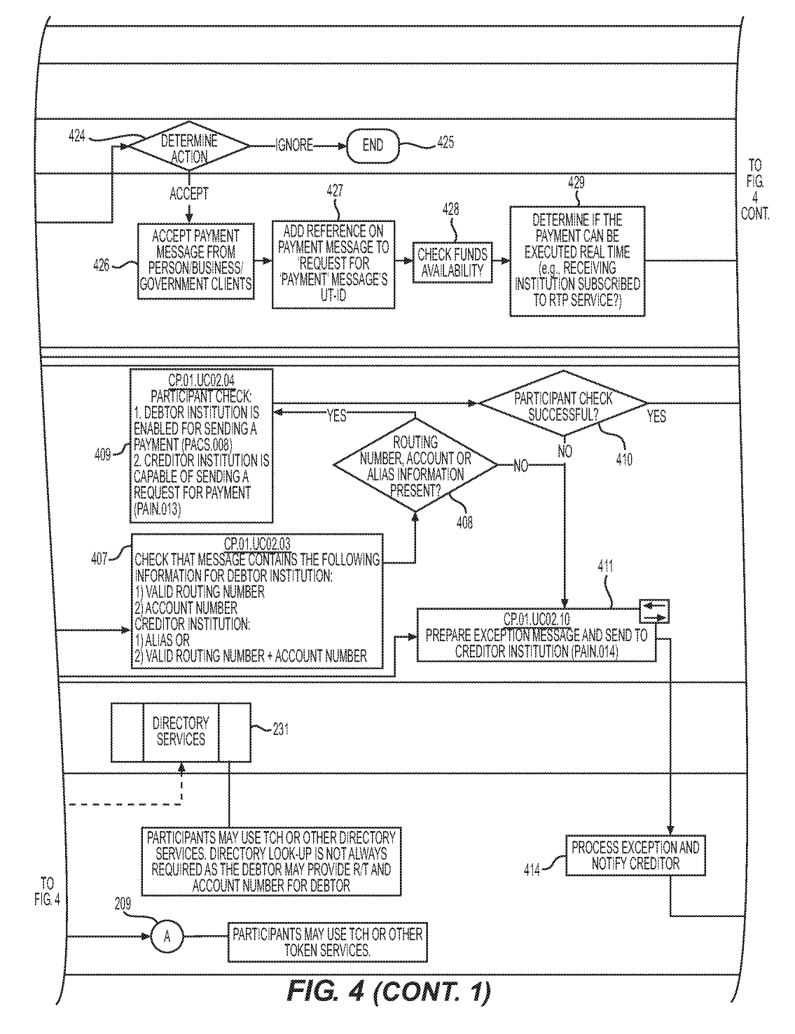

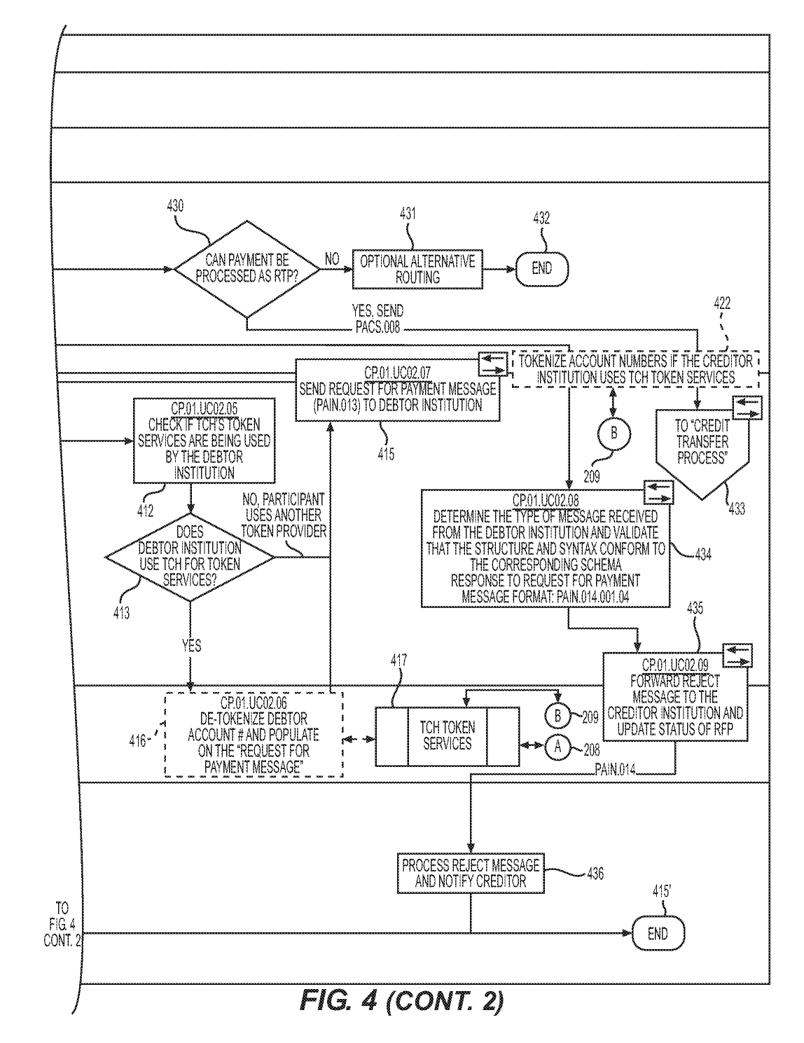

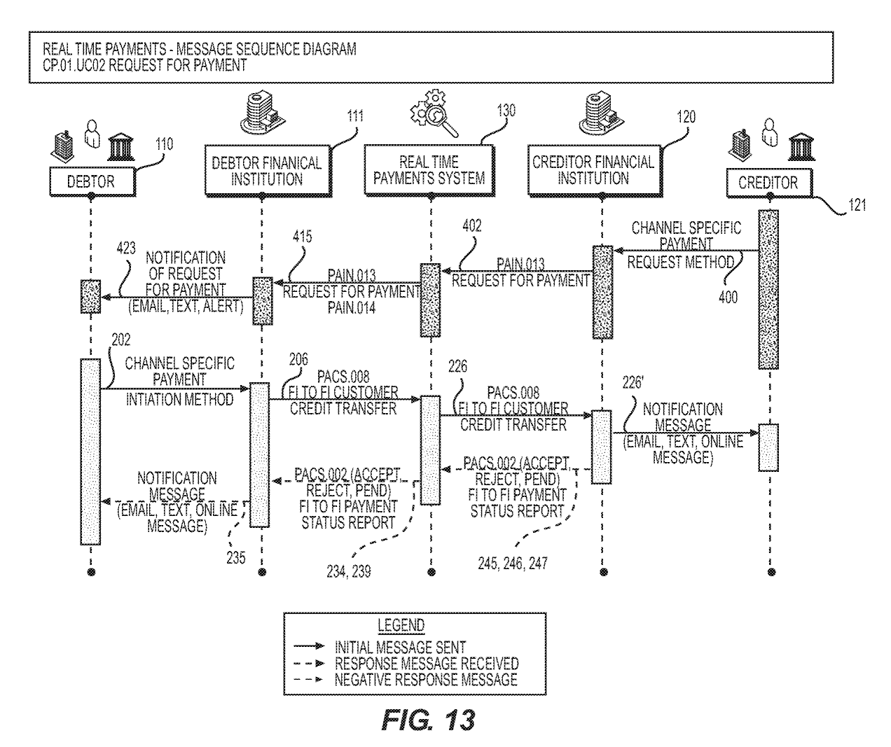

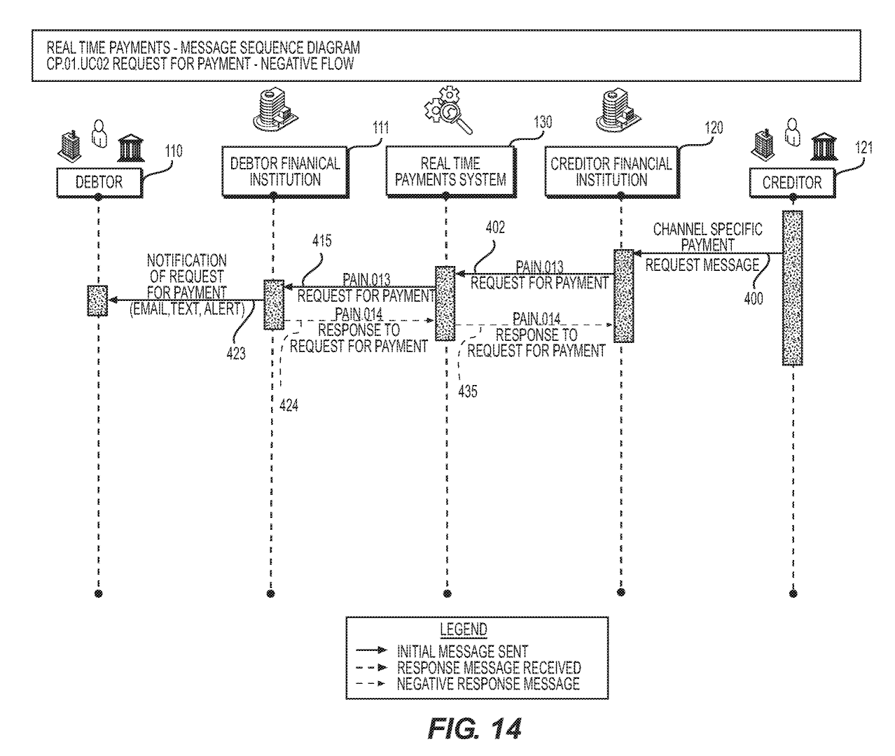

According to another example aspect of the present application, a party, such as, for example, a creditor, can request a payment from another party. Referring now to FIG. 4 (and also FIGS. 13 and 14), a method according to this example aspect will now be described.

In step 400 the creditor station 121 sends a request to the creditor FI 120, requesting that payment be made to a creditor associated with the station 121, from another party, such as a party associated with debtor station 110. The creditor FI 120 then generates a request for payment message in step 401. Thereafter, step 402 is performed is the same manner as step 206 of FIG. 2, except that it is performed by the FI 120 to create a request for payment message (also referred to as a “payment request message”) instead of a payment message itself. Also, in step 402, tokenization is performed to tokenize an identifier associated with station 110 and/or FI 111, with tokens. According to an example embodiment herein, the request for payment message is a pain.013 message, and can involve a pacs.002 message. The pain.013 message can contain an end-to-end reference ID that is populated by the debtor FI customer (e.g., at station 110) and is included in all subsequent messages (i.e., pacs.008 or pain.014 generated messages)

After step 402, step 403 is performed wherein, in one example embodiment, the network 130 receives the payment request message from the creditor FI 120 (e.g., in a pain.013 message) and determines whether the message is correctly formatted. For example, the network 130 checks the message type, and validates the format, syntax, and/or structure of the message. That step can be performed in accordance with any suitable techniques. If it is determined that the message is not properly formatted (“No” in step 404), then control passes to step 411 which will be described below. If it is determined that the message is properly formatted (“Yes” in step 404), then control passes to step 405 where the network 130 checks to determine whether the message is duplicative of one already received, based on, for example, whether a UT-ID included in the message was already received in a previous message. If it is determined that the message is duplicative (“Yes” in step 406), then control passes to step 411, which will be described below. If, on the other hand, the message is determined to not be duplicative (“No” in step 406), then control passes to step 407 where the network 130 checks the message to determine whether it includes valid account and routing numbers for the debtor FI 111, or a valid alias (token). If not (“No” in step 408), then control passes to step 411 which is performed in a manner to be described below. If “Yes” in step 408, then in step 409 the network 130 makes a determination as to whether the debtor FI 111 is enabled for sending payment transactions, and whether the creditor FI 120 is enabled for sending a request for payment. For example, this step can include the network 130 checking a look-up table to determine whether information in the table indicates that those FIs have such respective capabilities.

If the FIs are determined not to be enabled (No” in step 410), then control passes to step 411 which will be described below. If, on the other hand, the FIs are determined to be enabled (“Yes” in step 410), then the network 130 makes a determination as to whether a token service is being employed by the debtor FI 111 (e.g., in one embodiment by checking a look-up table that includes such information) (step 412). In one example embodiment herein that step can be performed like step 224 of FIG. 2, but for the debtor FI 111. If the performance of step 412 results in a determination of “No” (“No” in step 413), then control passes to step 415. In step 415, the network 130 forwards the request for payment (e.g., a pain.013) to the debtor FI 111, and then step 418 is performed in a manner to be described below. In another example embodiment herein, the debtor FI 111 receiving the request for payment message (e.g., pain.013 message) responds with a message (e.g., a pacs.002 message) indicating that it has accepted or rejected the (pain.013) transaction.

Referring back to step 411, that step includes the network 103 generating an exception message (e.g., a pain.014 message) and providing it to the creditor FI 120 (in one example embodiment herein, the message is created by the debtor FI 111 and sent to the network 130 for being sent to the FI 120). Then, in step 414, the creditor FI 120 receives that message and notifies the creditor station 121 of the message, and then the method ends in step 415′.

Referring back again to step 412, a case where token services are determined to be employed by the debtor FI 111 will now be described. In such a case (“Yes” in step 413), control passes to step 416 where the payment request message is de-tokenized. For example, the network 130 (and/or value added services 138) performs a translation from the BANPC included in the request to (1) a debtor's account number with their debtor FI (e.g., FI 111) and (2) a routing number for the debtor's FI (e.g., FI 111). To perform this translation, the network 130 and/or value added services 138, maintains the BANPC database that associates each debtor's BANPC with that debtor's account number at their FI (e.g., FI 111) and the routing number to the debtor's FI (e.g., FI 111). Using the directory and the BANPC included in the payment request, the BANPC included in the transaction is correlated to a corresponding BANPC included in the directory, and to that latter BANPC's associated account number and routing number of the debtor's FI (e.g., FI 111), in the directory (step 417).

The BANPC's associated account number and routing number of the debtor's FI (e.g., FI 111) are inserted into the payment request, and the BANPC and BRNPC are removed from the request. Then the payment request, including the inserted account number and routing number, is routed to the debtor's FI (e.g., FI 111) based on the inserted routing number, in step 415.

After step 415 the payment request is validated in step 418 to confirm that it is in the correct format (step 418). In the case where the validation is not successful (“No” in step 419), then in step 421 the debtor FI 111 sends a “request for payment rejected” message to the network 130 and control passes to step 422 which will be described below. In the case where the validation performed in step 419 is successful (“Yes” in step 419), then the debtor FI 111 determines whether the debtor associated with the debtor station 110 (or the station itself 110) accepts request for payment messages (step 420). If not (“No” in step 420), then control passes to step 421 which is performed in the above-described manner. If step 420 results in a determination of “Yes” (“Yes” in step 420, then control passes to step 423 where the debtor FI 111 forwards a request for payment message to the debtor station 110, where a decision is made (step 424) to accept or ignore the request for payment message (in one example embodiment herein, the debtor FI 111 also provides a pacs.002 “accept”). If it is decided to ignore the message, the method ends in step 425. On the other hand, if the message is accepted (“Yes” in step 424), then the station 110 sends a payment transaction message to the debtor FI 111 requesting that the payment be made. The debtor FI 111 then receives the message (step 426) and adds to the message an indication that the payment transaction is in response to a request for payment message (step 427) (e.g., the indication is added to the UT-ID). In one example this is done by populating the UT-ID of the RFP (pain.013) in an appropriate reference field of the pacs.008 message. Additionally, the pacs.008 message also can carry any end-to-end ID provided by the creditor FI's customer in the original pain.013 message. According to one example embodiment herein, in a case where the message is accepted by the debtor FI 111, then a pacs.002 “accept” is sent to the creditor FI 120 to indicate that the request for payment message was received by the debtor FI 111. Also, the station 110 can respond to a pain.013, and generate a totally separate pacs.008 message (this is not necessarily an “acceptance” of the pain.013 message, and the pain.013 transaction message can end with the debtor FI pacs.002 response back to the creditor FI).

After step 427, step 428 is performed where the debtor FI 111 checks the account of the party associated with the debtor station 110 to determine whether it holds sufficient funds for being able to cover the payment transaction amount indicated in the payment message. Where there are sufficient funds, then in step 429 the FI 111 determines whether the payment can be executed in real time (e.g., whether the receiving institution, such as creditor FI 120, has subscribed to the real time payments service). If it is determined that the payment cannot be executed in real time (“No” in step 430), then the payment can be effected using an alternate routing method (step 431), and the method ends in step 432. If it is determined that the payment can be executed in real time (“Yes” in step 430), then the payment transaction message is sent (e.g., in a pacs.003 message) to the network 130.

Referring now to step 422, the step includes tokenizing the account/routing numbers of the creditor in a similar manner as tokenization is performed in step 206 of FIG. 2. After step 422 for the case where the message was provided from step 430, control passes to step 433 where a credit transfer process is performed. In one example, that process is performed by performing steps that are the same as those starting at step 210 of FIG. 2 (e.g., the process includes all steps of FIG. 2 except for those preceding step 210).

On the other hand, after step 422 for the case where the “request for payment rejected” message is received from debtor FI 111 in step 421 and processed in step 422, control passes to step 434 where, in one example embodiment, the network 130 determines whether the message received from the debtor FI 111 is correctly formatted. For example, the network 130 checks the message type of the transaction, and validates the format, syntax, and/or structure of the message. That step can be performed in accordance with any suitable techniques. Then, in step 435 the network 130 forwards a reject message to the creditor FI 120 and updates a record of the network 130 to indicate that the request for payment message has been rejected. In step 436 the creditor FI 120 receives the reject message and notifies the creditor station 121 that the request for payment has been rejected. The method then ends in step 415′. FIG. 13 also shows steps 400, 402, 415, and 423 described above, in association with steps 202, 206, 226, 234, 235, 239, 245, 246, 247, and 226′ that were described above in connection with FIG. 2. In FIG. 13, step 202 is initiated after the debtor 110 receives a message requesting payment in step 423.

### Return of Funds

The method herein provides certainty and payment finality for receivers. For example, funds are not permitted to be taken back from the receiver. In the case of error, a payer can ability request a return of funds (although in some embodiments there is no obligation to reverse/revoke transaction). In one example embodiment, requests for a return of funds refund can require a new transaction to return the funds to the requester, although this example is not limiting.

In example embodiments herein, between a payer and payee, once funds are sent by sender, funds cannot be pulled back without receiver's permission. Between a payer and payer's FI and between a payer's FI and payee's FI, once a payment message is transmitted to the network operator by the sending FI, the message, in at least some cases, cannot be cancelled or amended (however, in some cases if a payer's FI has not sent the payment to RTP system, the payment can still be stopped, particularly where, for example, it is a future dated payment). Between a payer's FI and payee's FI, once the payment message is transmitted to the network operator by the sending FI, the sending FI has an obligation to complete the payment (unless receiving FI rejects the payment), and, once completed, the sending FI has no ability to pull back funds, although the receiving FI can reject payment and return funds (if received) or never accept them in the first place.

In a credit push scenario, a consumer initiates payment, and, as such, there are no unauthorized debits. Banks are required by regulations to resolve errors related to thefts of account funds, subject to a consumer's responsibility to report the loss or theft of an access device. With respect to errors such as input errors (e.g., transposed account digits), these can be addressed by a process to request the return of funds from the counterparty and the development of payment features to reduce sending errors. In one example, there is an ability for a sending party to validate a name of a receiving party before sending a payment.

As an example of a process to request the return of funds sent in error, in one example embodiment, a return can be requested only for a sender error. For example, a receiver may recognize that a payment was made in error, sends an indication to the payer that the payment is being returned, the payment is returned to the payer, which recognizes that the payment was made in error. In another example embodiment, after the receiver (payee) recognizes that a payment was made in error, it sends a pacs.008 transaction to send the funds back (i.e., “return”) to the payer. The payer can send a message to the payee indicating that the payment was made in error. The receiver receives the message and can agree to return the funds to the payer. If the receiver does not agree to do so, or otherwise does not send a response, then the payer sends a message via the payer's FI to the receiver's FI asking for the return of funds (e.g., the message can be a request for return of funds). All messages reference the universal transaction Id of the original payment.

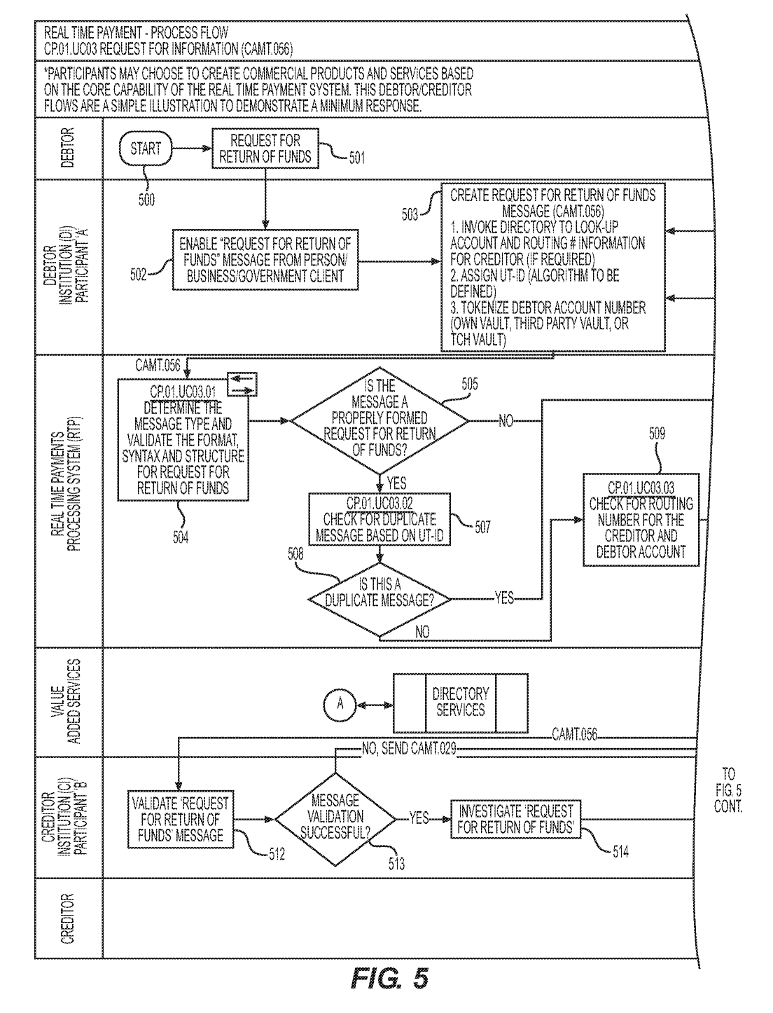

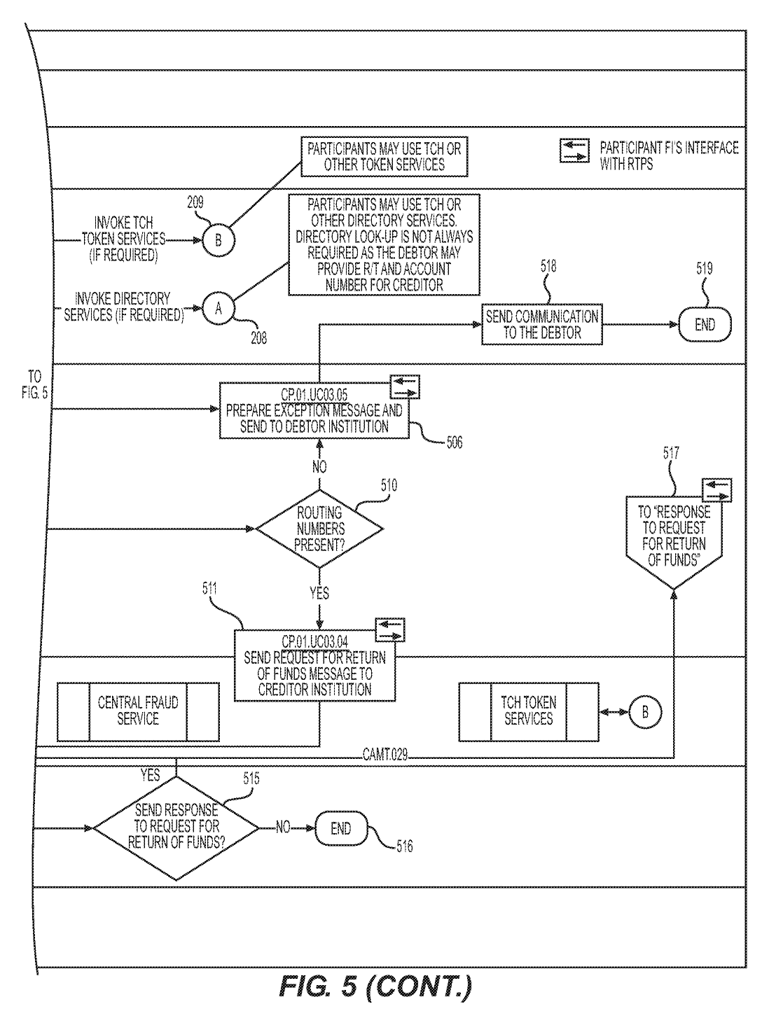

An example aspect of the present application will now be described, with reference to FIG. 5, which shows a flow diagram for requesting a return of funds. This procedure can be useful where, for example, a debtor has paid a creditor perhaps mistakenly, and desires to obtain a return of the funds. The method commences in step 500, and in step 501 the debtor station 110 communicates with debtor FI 111 to request a return of funds from a creditor, such as that associated with creditor station 121. The debtor FI 111 then generates a request for return of funds message in step 502. Then step 503 is performed in a similar manner as step 206 of FIG. 2, except for the newly generated message. Then step 504 is performed in a similar manner as step 210 of FIG. 2 to determine whether the message is correctly formatted. If the message is not correctly formatted (“No” in step 505), then control passes to step 506 which is performed in the same manner as step 216′ of FIG. 2. If the message is determined to be correctly formatted (“Yes” in step 505), then control passes to step 507 where the network 130 checks to determine whether the message is duplicative of one already received, based on, for example, whether a UT-ID included in the message was already received. If it is determined that the message is duplicative (“Yes” in step 508), then control passes to step 506 which is performed as described above, After step 506 the network 130 sends a notification to the debtor FI 111 indicating that the request for return of funds failed, and that FI notifies the debtor station 110 (step 518). The method then ends in step 519. In another example embodiment herein, a message such as, e.g., a pacs.002 message is used to respond to a request for return of funds, as an acknowledgement indicating whether the transaction is accepted or rejected. This is different than a reject message in response to a request for return of funds.

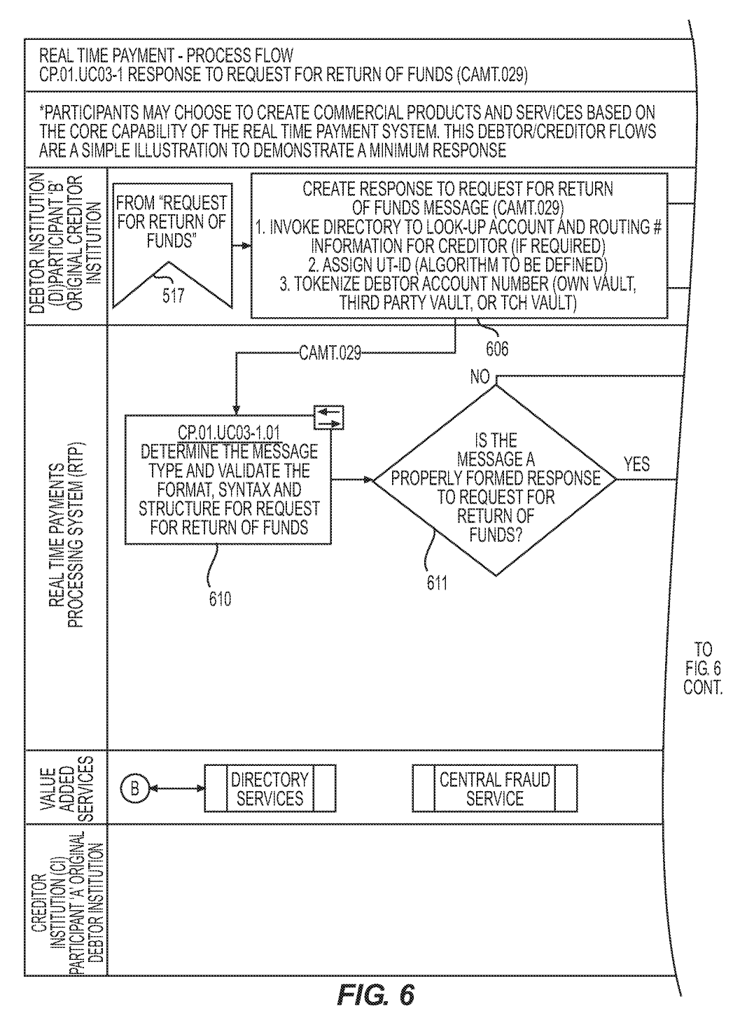

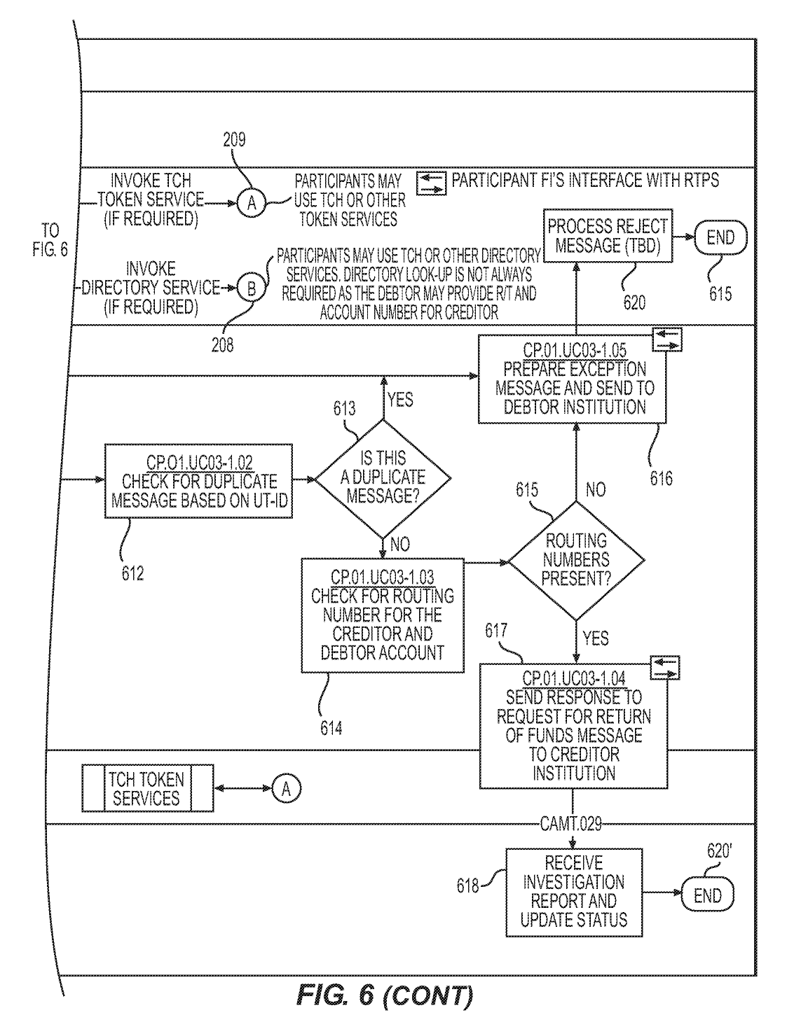

If, on the other hand, the message is determined in step 508 to not be duplicative (“No” in step 508), then control passes to step 509 where the network 130 checks the message to determine whether it includes valid account and routing numbers. If not (“No” in step 510), then control passes to step 506 which is performed in the manner described above. If “Yes” in step 510, then in step 511 the network 130 forwards a request for return of funds message to the creditor FI 120, which then validates the message to check that it is correctly formatted (step 512). If the validation is not successful (“No” in step 513), then a message (e.g., a camt.029 message) indicating that result is provided to network 130 and processing continues in step 517 where, in one example embodiment, the network 130 can notify the debtor FI 111 thereof (which can the notify the station 110 of the same). Additional procedures then can be performed as will be further described with respect to FIG. 6 below.

If, on the other hand, the validation in step 513 is successful, then the creditor FI 120 investigates the situation regarding whether or not the funds should be returned (step 514). If it is decided to respond to the request for return of funds (“Yes” in step 515), then control passes to step 517 where, in one example embodiment, the network 130 can notify the debtor FI 111 of the result of the investigation or that one is being undertaken (the FI 111 also can notify the station 110 of the same). The notification also can provide a message returning the amount requested in the request for return of funds message. (In one example embodiment herein, there are two separate messages provided, such as, e.g., a response to request for return of funds message (camt.029) and an actual return of funds (pacs.008), as represented in FIG. 13.) Additional procedures can then be performed as will be further described with respect to FIG. 6 below. Otherwise, if “No” in step 515, then the method ends in step 516.

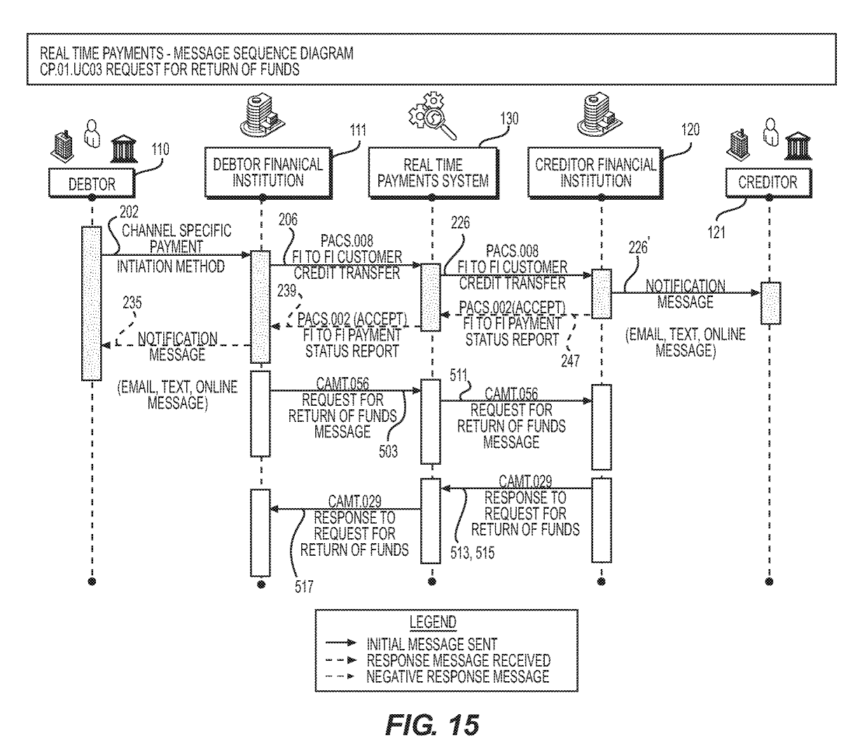

FIG. 13 also shows procedures for making payments, including steps 202, 206, 226, 226′, 235, 239, and 247 that were described above in connection with FIG. 2, and procedures for requesting a return of funds, including steps 503, 511, 513, 515, and 517 described above in connection with FIG. 5, wherein the numbers in FIG. 15 are intended to indicate the messages sent in association with those steps.

FIG. 6 will now be described. After receiving a message in step 517, the debtor FI 111 generates in step 606 a response to request for return of funds message (e.g., camt.029). In one example embodiment herein, the response includes a BANPC identifier and BRNPC obtained by the FI 111 by accessing the directory to correlate information included in the message received in step 517 to a corresponding BANPC identifier and BRNPC included in the directory (step 208, 209). That obtaining can be performed in a similar manner as described above in connection with step 206 of FIG. 2, but for the response to request for return of funds message.

After step 606 is performed, control passes to step 610 where, in one example embodiment, the network 130 receives the message generated in step 606 from the debtor FI 111 (e.g., in a camt.029 message) and determines whether the transaction is correctly formatted. For example, the network 130 checks the message type of the transaction, and validates the format, syntax, and/or structure of the message. That step can be performed in accordance with any suitable techniques. If it is determined that the message is not properly formatted (“No” in step 611), then control passes to step 616 which is performed to generate an exception message like in step 506 of FIG. 5. That message is then provided to the debtor FI 111 where it is processed (step 620), and then the method ends in step 615. If it is determined that the message is properly formatted (“Yes” in step 611), then control passes to step 612 where the network 130 checks to determine whether the message is duplicative of one already received, based on, for example, whether a UT-ID included in the message was already received. If it is determined that the message is duplicative (“Yes” in step 613), then control passes to step 616, which is performed as described above. If, on the other hand, the message is determined to not be duplicative (“No” in step 613), then control passes to step 614 where the network 130 checks the message to determine whether it includes valid account and routing numbers. If not (“No” in step 615), then control passes to step 616 which is performed in a manner as described above. If “Yes” in step 615, then in step 617 the network 130 sends a response to request for return of funds message to the creditor FI 120, which then can investigate the situation relating to the request and updates the status of the request in accordance with the received message and the investigation (step 618). The method ends in step 620′.

### Requests for Information

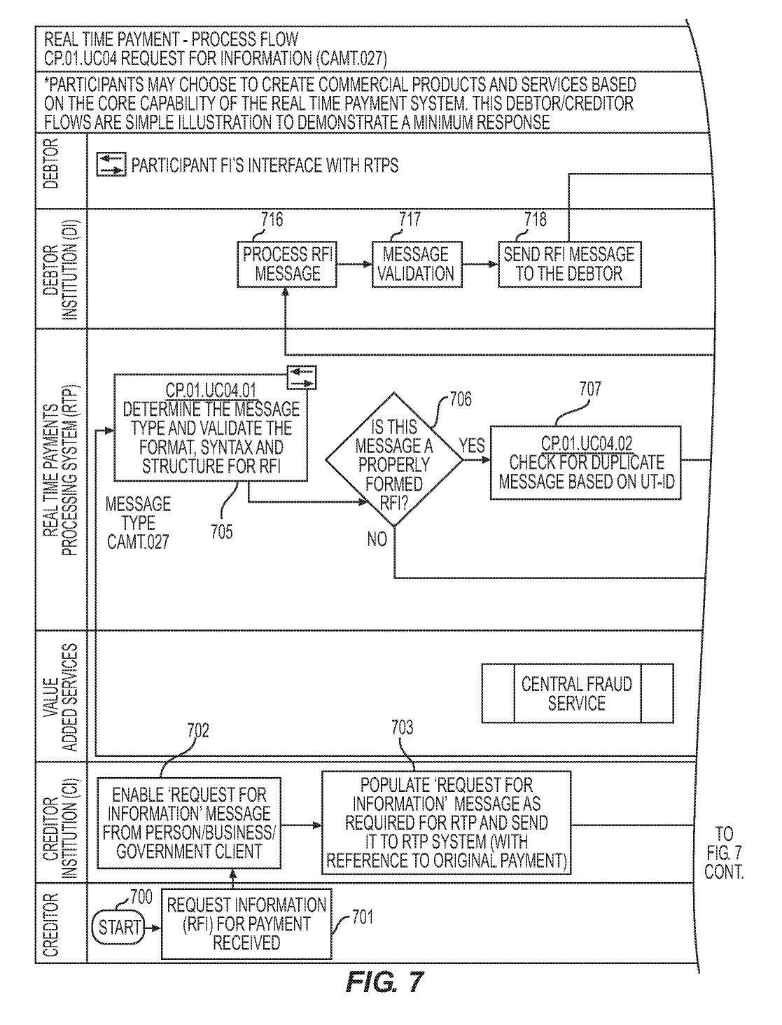

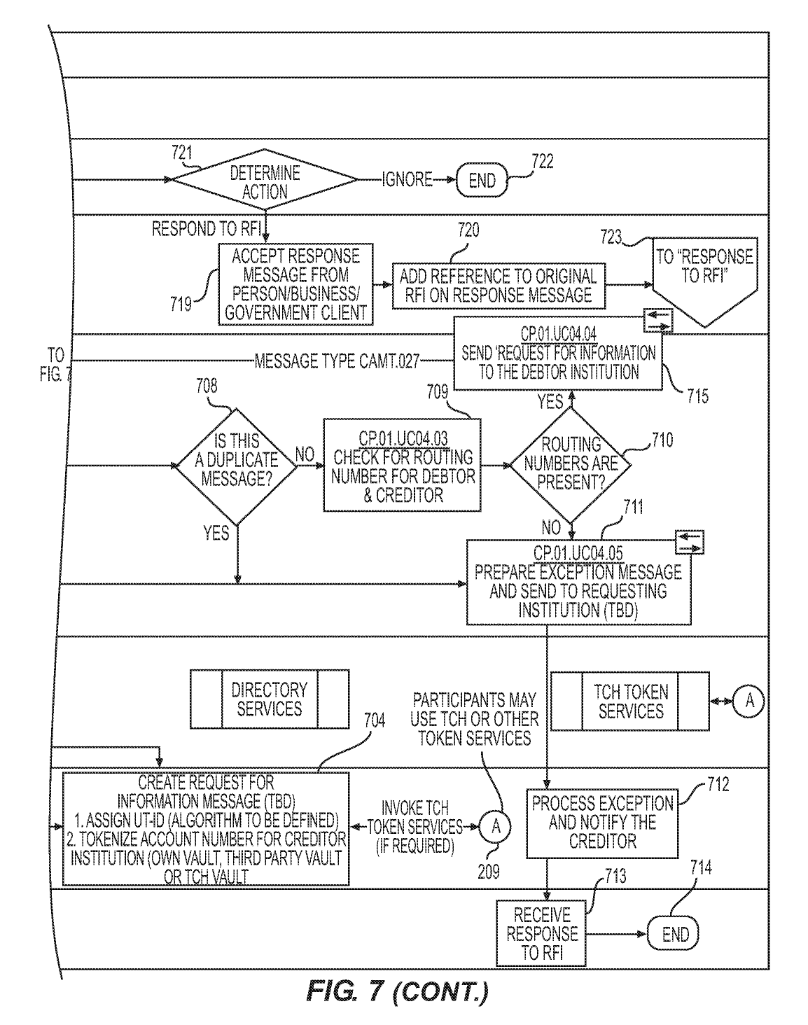

FIG. 7 will now be described. FIG. 7 shows a flow diagram of a procedure enabling a party, such as, for example, a creditor associated with creditor station 121, to request information from an institution association with another party, such as debtor FI 111 associated with debtor station 110, or with debtor station 110 itself. In step 700 the method commences, and creditor station 121 communicates with creditor FI 120 to request information (step 701). In step 702 the creditor FI 120 receives and enables the request, and then in step 703 generates a request for information message. That request may be in association with a specific, original payment (e.g., a request for information can have a reference to a UT-ID from a payment transaction being referenced), such as one made in the procedure of FIG. 2. In step 704 the request for information message is assigned a UT-ID and tokenization is performed. Step 704 can be performed like step 402 of FIG. 4, in one example embodiment.

In one example embodiment herein, for tokenization a BANPC identifier and BRNPC are obtained by the FI 120 and included in the message. For example, the FI 120 can access a directory to correlate information (e.g., a bank account and routing number) included in the message to a corresponding BANPC identifier and BRNPC included in the directory (step 209). The directory may be included in the FI 120, network 130, or in another part of the transaction system 100, such as at a third party or another element.

After step 704 is performed, control passes to step 705 where, in one example embodiment, the network 130 receives the message generated in step 704 from the creditor FI 120 (e.g., in a camt.027 message) and determines whether the transaction is correctly formatted. For example, the network 130 checks the message type of the transaction, and validates the format, syntax, and/or structure of the message. That step can be performed in accordance with any suitable techniques. If it is determined that the message is not properly formatted (“No” in step 706), then control passes to step 711 where the network 130 generates an exception message and provides it to the creditor FI 120, which then processes the message and notifies (step 712) the creditor station 121 of the exception message (step 713). In some example embodiments herein, a pacs.002 message is employed as a positive/negative response to a request for information. The method ends in step 714.

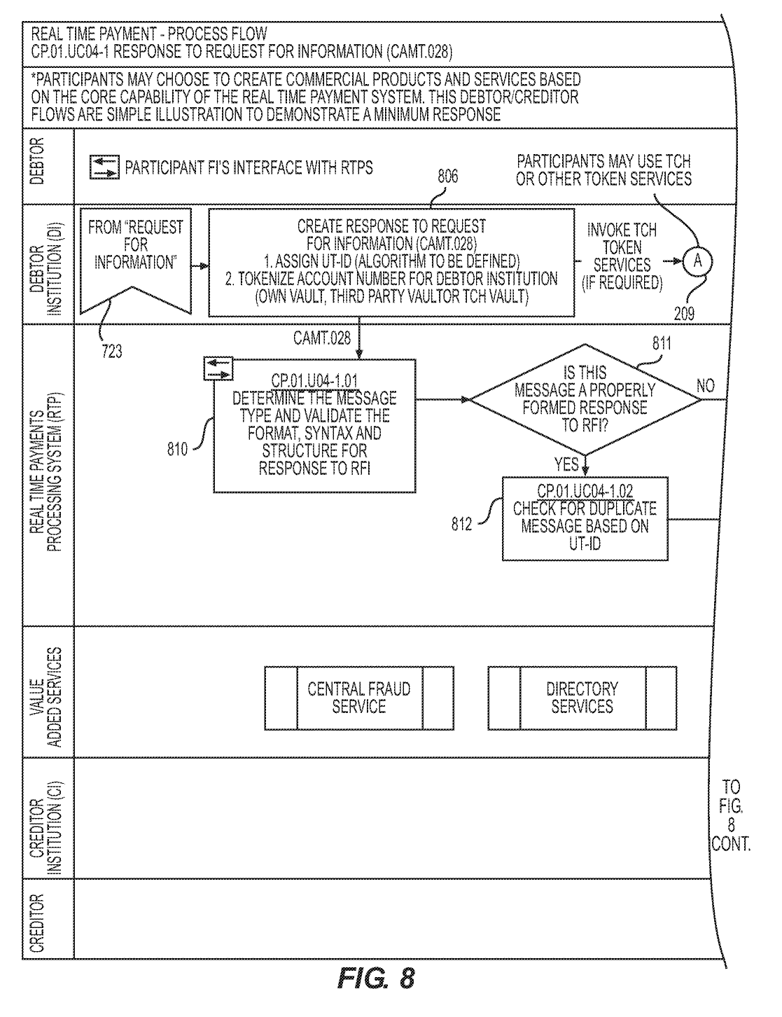

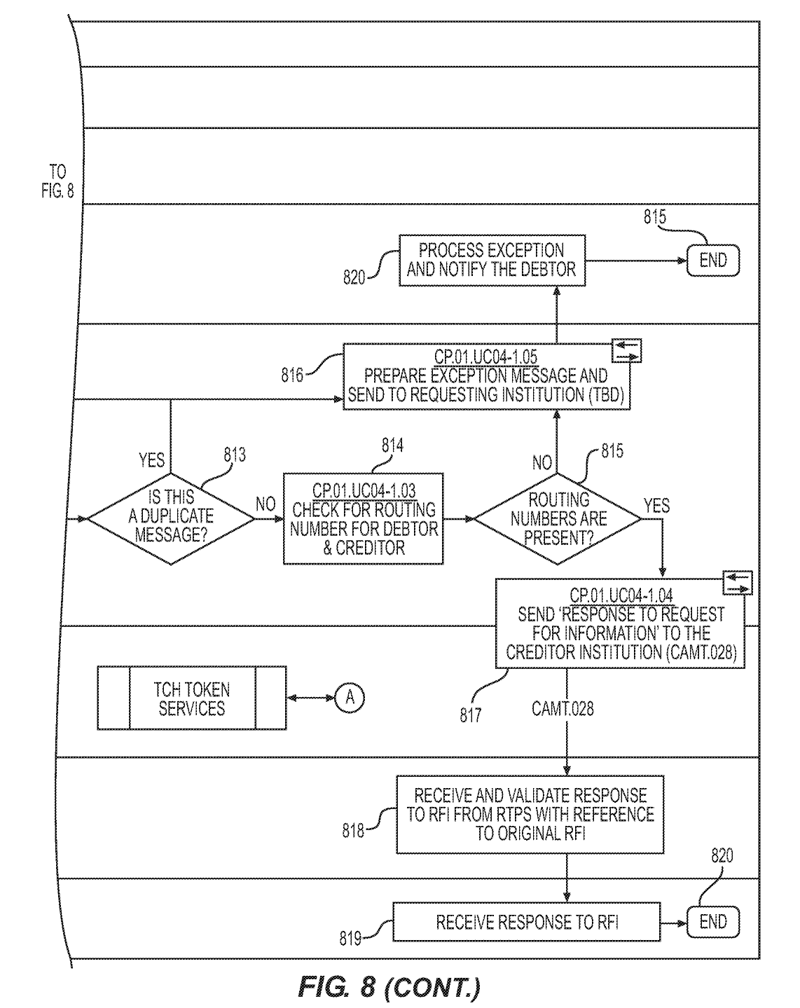

Referring again to steps 705 and 706, if it is determined that the message from step 704 is properly formatted (“Yes” in step 706), then control passes to step 707 where the network 130 checks to determine whether the message is duplicative of one already received, based on, for example, whether a UT-ID included in the message was already received. If it is determined that the message is duplicative (“Yes” in step 708), then control passes to step 711, which is performed as described above. If, on the other hand, the message is determined to not be duplicative (“No” in step 708), then control passes to step 709 where the network 130 checks the message to determine whether it includes valid account and routing numbers. If not (“No” in step 710), then control passes to step 711, which is performed as described above. If “Yes” in step 710, then in step 715 the network 130 sends a request for information message to the debtor FI 111, which then processes the message (step 716) and validates it against predetermined criteria (step 717) (and, in one example embodiment, a pacs.002 acknowledgement is provided from debtor FI 111 to the creditor FI 120). The request or information message is then forwarded to the debtor station 110 in step 718, and the debtor station 110 and/or party associated therewith can decide how to address the request for information (step 721). If it is decided to ignore the request, then the method ends in step 722. In the event were the debtor station 110 provides a respond to the request for information, then the debtor FI 111 receives that response (step 719), adds a reference to the message in step 720 to indicate that it is associated with the original request for information message received in step 716, and then control passes through step 723 to FIG. 8, which will be described below.

FIG. 8 will now be described, and represents a continuance of the procedures from step 723 of FIG. 7. In step 806 a response to request for information message (e.g., camt.028) is generated by the debtor FI 111, based on the message accepted in step 719 and reference added in step 720. In one example embodiment herein, a response to request for information message also involves a pacs.002 status message (from Creditor FI to Debtor FI).

Also, in one example embodiment herein, tokenization is performed wherein a BANPC identifier and BRNPC are obtained by the FI 111 by accessing a directory to correlate information included in the response message (e.g., information identifying the requestor of the request for information) to a corresponding BANPC identifier and BRNPC included in the directory (step 209). The directory may be included in the network 130, in one example embodiment, or in another example, it can be included elsewhere in the transaction system 100, such as at FI 111, a third party, or another element. The obtained BANPC and BRNPC are included in the response message generated in step 806.

After step 806 is performed, control passes to step 810 where, in one example embodiment, the network 130 receives the message generated in step 806 from the debtor FI 111 (e.g., in a camt.028 message) and determines whether the transaction is correctly formatted. For example, the network 130 checks the message type of the transaction, and validates the format, syntax, and/or structure of the message. That step can be performed in accordance with any suitable techniques. If it is determined that the message is not properly formatted (“No” in step 811), then control passes to step 816 where the network 130 generates an exception message and provides it to the debtor FI 111, which then processes the message and notifies (step 820) the debtor station 110 of the exception message. The method ends in step 815.

If performance of step 810 results in a determination that the message is properly formatted (“Yes” in step 811), then control passes to step 812 where the network 130 checks to determine whether the message is duplicative of one already received, based on, for example, whether a UT-ID included in the message was already received. If it is determined that the message is duplicative (“Yes” in step 813), then control passes to step 816, which will be described below. If, on the other hand, the message is determined to not be duplicative (“No” in step 813), then control passes to step 814 where the network 130 checks the message to determine whether it includes valid account and routing numbers. If not (“No” in step 815), then control passes to step 816, which is performed in a manner to be described below. If “Yes” in step 815, then in step 817 the network 130 sends a response to request for return of information message to the creditor FI 120, which then validates that response against predetermined criteria (step 818) and provides it to the creditor station 121 (step 819). The method ends in step 820. In an example embodiment herein, a response to request for information can include a pacs.002 message.

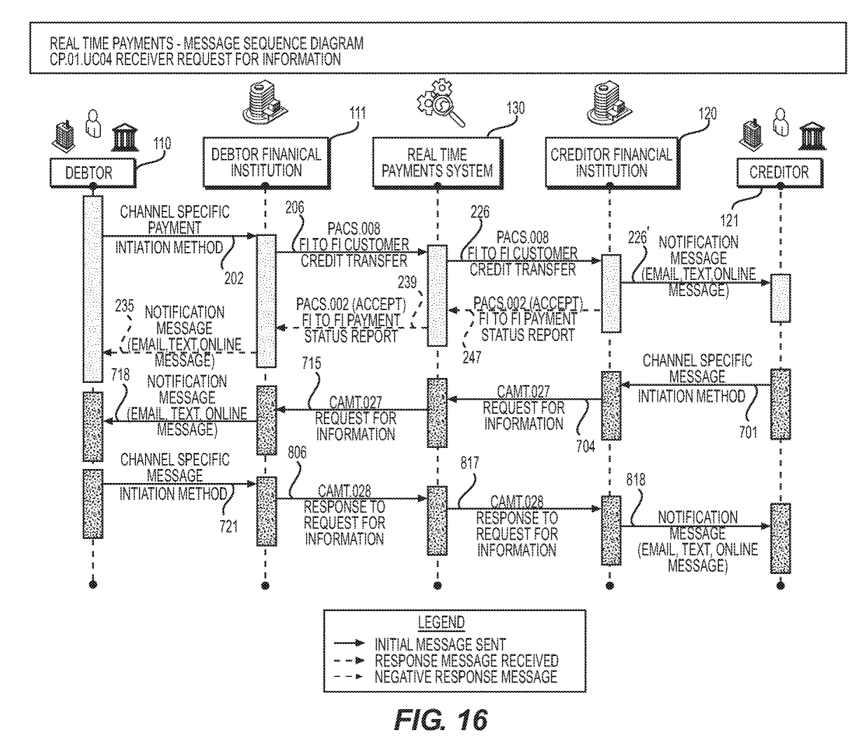

FIG. 16 also shows procedures involved in request for information, in association with those for making payments. For making payment, FIG. 16 further represents steps 202, 206, 226, 226′, 235, 239, and 247 that were described above in connection with FIG. 2. With respect to a request for information, FIG. 16 further represents steps 701, 704, 715, 718, and 721 of FIG. 7, and steps 806, 817, and 818 of FIG. 8, wherein the reference numbers in FIG. 16 are intended to indicate the messages sent in association with those steps.

### Providing Remittance Advice

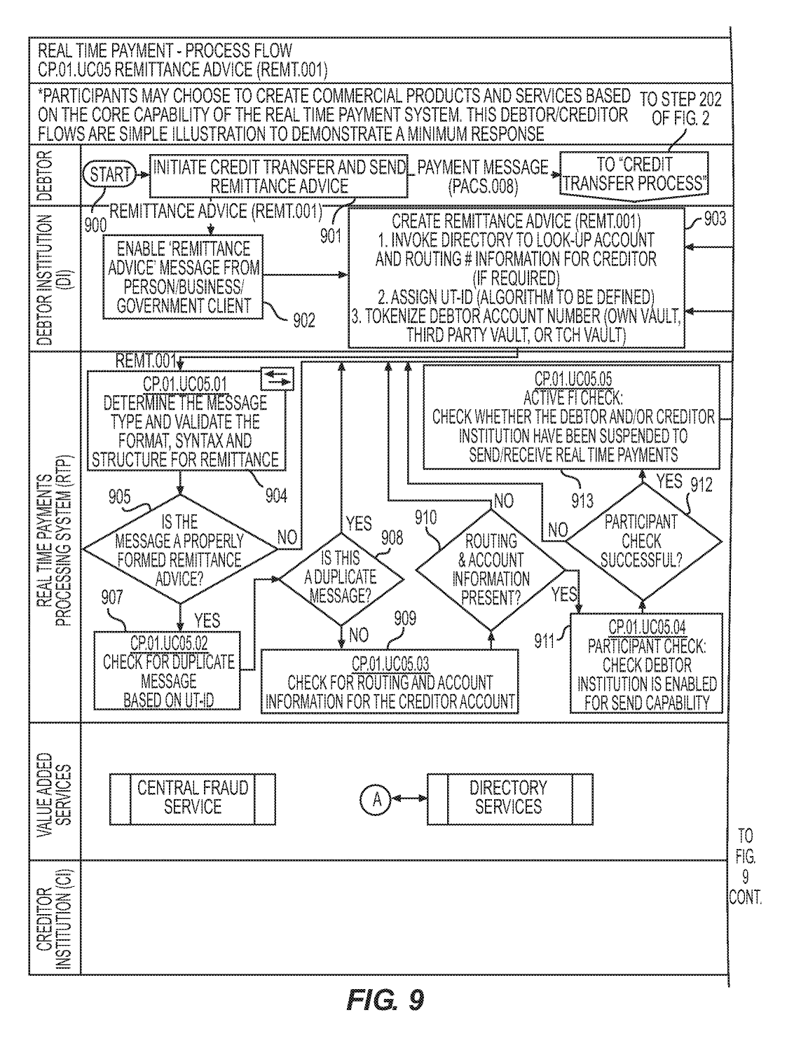

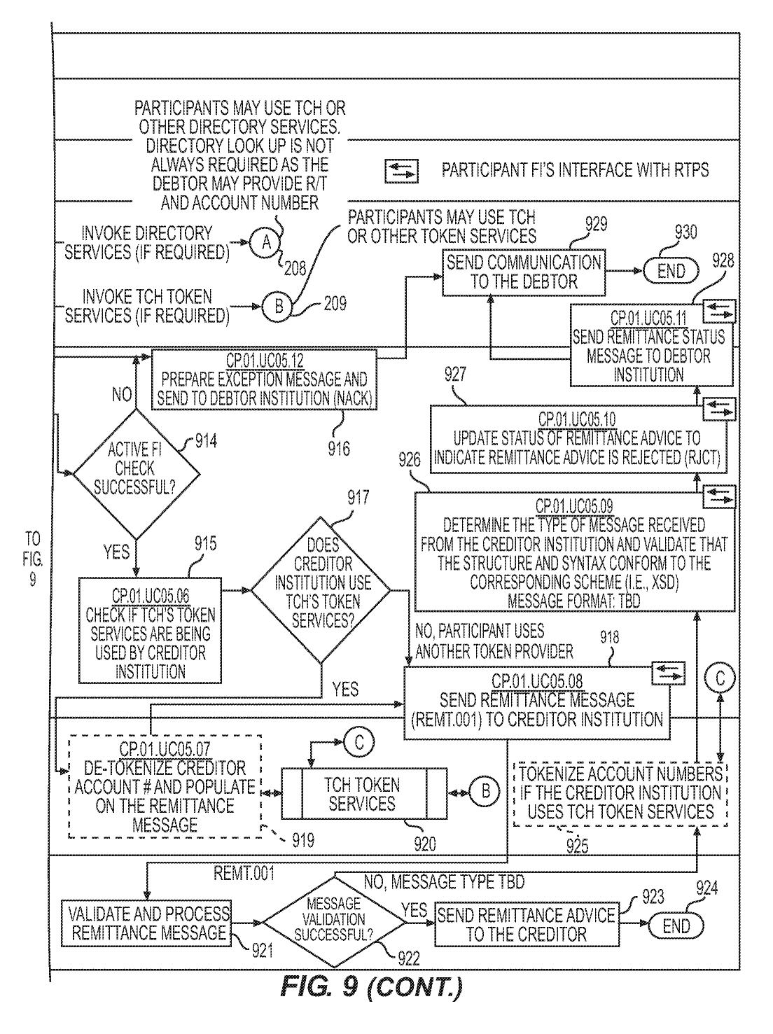

FIG. 9 will now be described, and shows a procedure for sending remittance advice. In one example embodiment herein, remittance advice can be sent with a pacs.008 message, and, when sent with a pain.013 (Request for Payment) message, the advice can be an invoice. Also, depending on whether it is a remittance advice or an invoice, it preferably includes a reference to the UT-ID of either a pacs.008 message or a pain.013 message.

In step 900 the method commences and control passes to step 901. That step 901 can include a step like step 201 of FIG. 2, wherein debtor station 110 requests that a payment be made (e.g., a pacs.008 message), and then control passes to step 202 of FIG. 2, where procedures for making a payment are performed as described above, beginning with that step. Also in step 901, the debtor station 110 provides remittance advice (step 901) (in a remt.001 message) to the debtor FI 111, which receives it in step 902 and generates a remittance advice message.

In one example embodiment herein, a BANPC identifier and BRNPC are obtained by the FI 111 by accessing a directory to correlate information included in the remittance advice (e.g., information associated with station 121 and/or FI 120) to a corresponding BANPC identifier and BRNPC included in the directory (step 903, 208, 209). The directory may be included in the network 130, in one example embodiment, or in another example, it can be included elsewhere in the transaction system 100, such as at the FI 111, a third party or another element. The obtained identifiers are included in the remittance advice message, as is an assigned UT-ID. Step 903 can be performed like step 206 of FIG. 2, but for the remittance advice message. After step 903 is performed, control passes to step 904 where, in one example embodiment, the network 130 receives the message generated in step 904 from the debtor FI 111 (e.g., in a remt.001 message) and determines whether the message is correctly formatted. For example, the network 130 checks the message type, and validates the format, syntax, and/or structure of the message. That step can be performed in accordance with any suitable techniques. If it is determined that the message is not properly formatted (“No” in step 905), then control passes to step 916 which will be described below. If it is determined that the message is properly formatted (“Yes” in step 905), then control passes to step 907 where the network 130 checks to determine whether the message is duplicative of one already received, based on, for example, whether a UT-ID included in the message was already received. If it is determined that the message is duplicative (“Yes” in step 908), then control passes to step 916, which will be described below. If, on the other hand, the message is determined to not be duplicative (“No” in step 908), then control passes to step 909 where the network 130 checks the message to determine whether it includes valid account and routing numbers. If not (“No” in step 910), then control passes to step 916, which is performed in a manner to be described below. If “Yes” in step 910, then in step 911 the network 130 determines whether the debtor FI 111 identified in the message has a capability to receive real time payments (i.e., is “real time enabled”) (step 911). If not (“No” in step 912), then control passes to step 916 which is performed in the manner described below. If “Yes” in step 912, then the network 130 makes a determination as to whether the debtor FI 111 or creditor FI 120 have been suspended to participate in electronic payment transactions (step 913). If either of those FIs are determined to be suspended (and thus the check is determined to not be successful) (“No” in step 914), then control passes to step 916. That step 916 will now be described. In step 916, the network 130 generates an exception message (e.g., a NACK message or pacs.002 message) and forwards it to the debtor FI 111, and then, in step 929 the debtor FI 111 responds by sending the exception message to the debtor station 110 (step 929), whereafter the method then ends in step 930.

If, on the other hand, either of the FIs 111 or 120 is determined not to be suspended (and thus the check is determined to be successful) (“Yes” in step 914), then control passes to step 915 where the network 130 determines whether token services are being employed by the creditor FI 120. If that determination results in a “Yes” decision (“Yes” in step 917), then in step 919 the tokens obtained in step 903 that are aliases of the creditor account and routing numbers are removed from the remittance advice message received from the FI 111 and replaced with their corresponding account and routing numbers (step 919). That step, which can be performed by the value added services 138, in one example embodiment herein, can be performed by invoking a directory (step 920) that may be included in the network 130 or elsewhere in the transaction system 100.

Referring again to steps 915 and 917, if the determination results in a “No” decision (“No” in step 917), then in step 918 the network 130 sends a remittance advice message (e.g., remt.001) to the creditor FI 120, which then processes and validates the message (step 921).

If that message is determined to be valid (“Yes” in step 922) then the remittance advice message is provided to the creditor station 121 (step 923) (and, in one example embodiment, a pacs.002 message also is sent to the debtor FI 111), and then the method ends in step 924. If step 922 results in a determination of “Yes” decision (“Yes” in step 922), then a message indicative thereof (and, in one example, including the remittance advice) is provided by the FI 120 to the value added services 138, and, in step 925 tokenization can be performed by the services 138 to include tokens in the message, corresponding to the debtor FI 111. The inclusion of tokens can be performed in a similar manner as that described above for, by example, step 230 of FIG. 2. The resulting tokenized message is then provided to the network 130 which in step 926 receives the message and determines whether it is correctly formatted. For example, the network 130 checks the message type of the transaction, and validates the format, syntax, and/or structure of the message. That step can be performed in accordance with any suitable techniques. Then in step 927 the network 130 updates a status of the remittance advice to indicate that it is rejected, and sends a remittance status message to the debtor FI 111 (step 928). Thereafter, in step 929 that message is provided to the debtor station 110 and then the method ends (step 930).

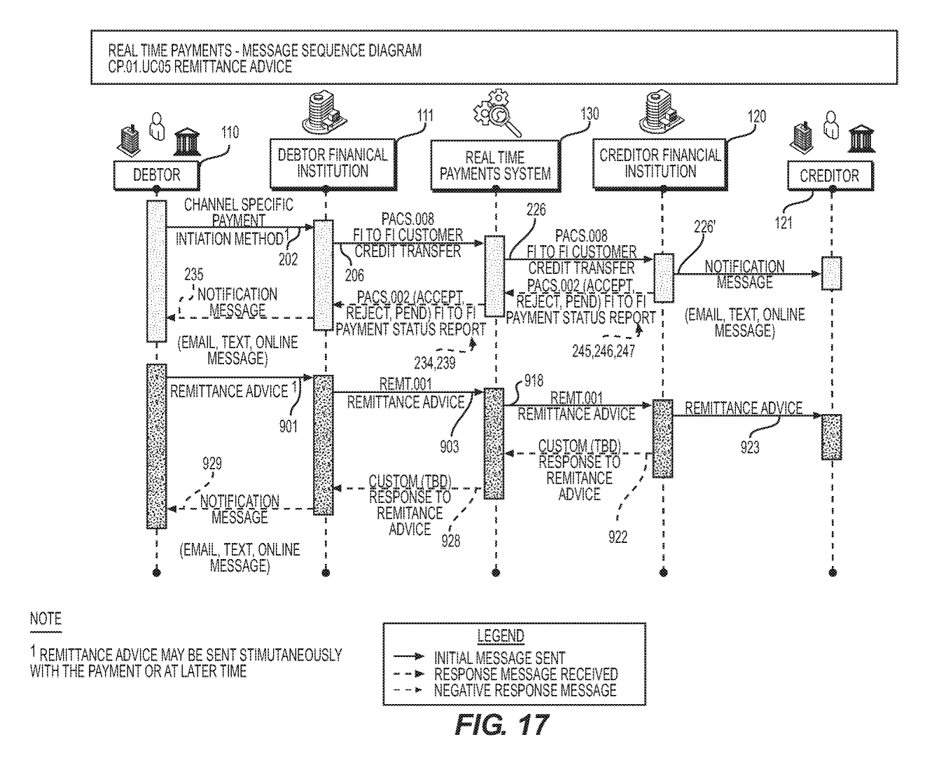

FIG. 17 also shows procedures involved in providing remittance advice, in association with those for making payments, or in association with making a request for payment (pain.013), in a case where the remittance advice is a invoice. For making payment, FIG. 17 further represents steps 202, 206, 226, 226′, 235, 234, 239, 245, 246, and 247 that were described above in connection with FIG. 2. With respect to providing remittance advice, FIG. 17 further represents steps 901, 903, 918, 922, 923, 928, and 929 of FIG. 9, wherein the reference numbers in FIG. 17 are intended to indicate the messages sent in association with those steps.

### Payment States

In one example embodiment herein, a payee receives notification of a payment immediately after a payer initiates a transaction, and the payer can receive timely feedback as to the disposition of the payment. This can be useful because it enables the payee to know when a payment has been initiated, and provides an immediate customer experience, even if settlement is done later. Positive notification may serve as proof of payment.

In one example, embodiment, notification can be provided according to a predetermined standard (e.g., always notify a mobile device if available), or the customer can select the method of being notified. Also, the payer can receive immediate notification as to whether the payment was able to be completed immediately, was delayed for review, or was unsuccessful. Notifications preferably include a Universal Transaction Id. Examples of methods of communication with a customer include a text messages, E-mails, online banking website, telephone (e.g., auto dial), etc.

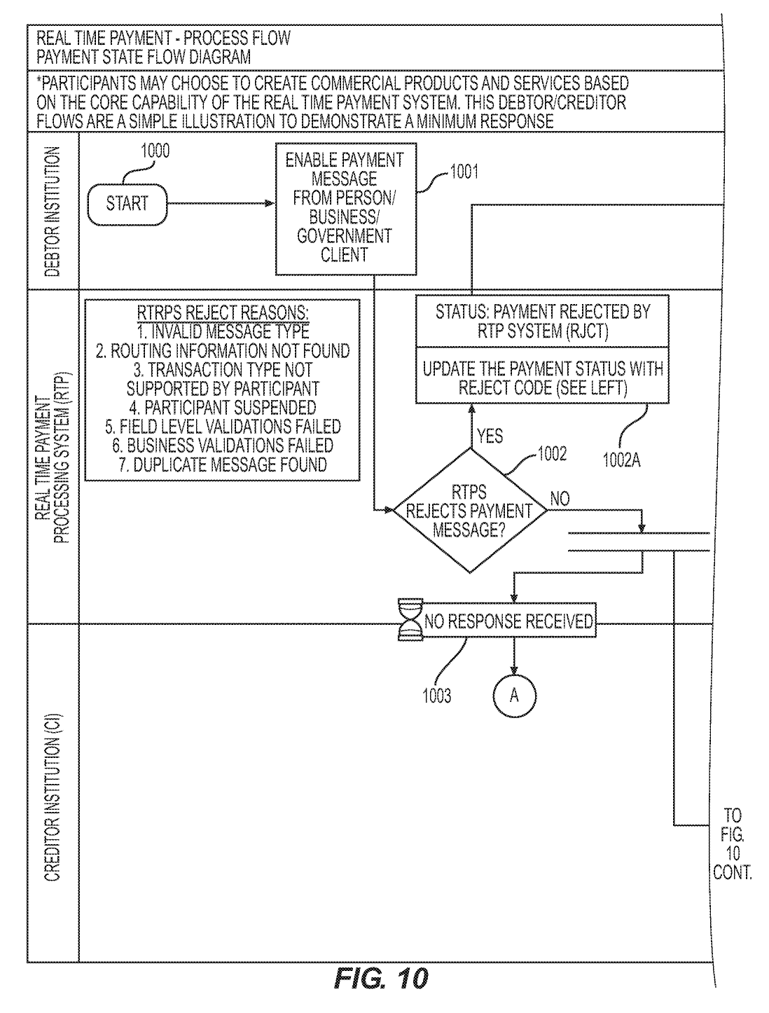

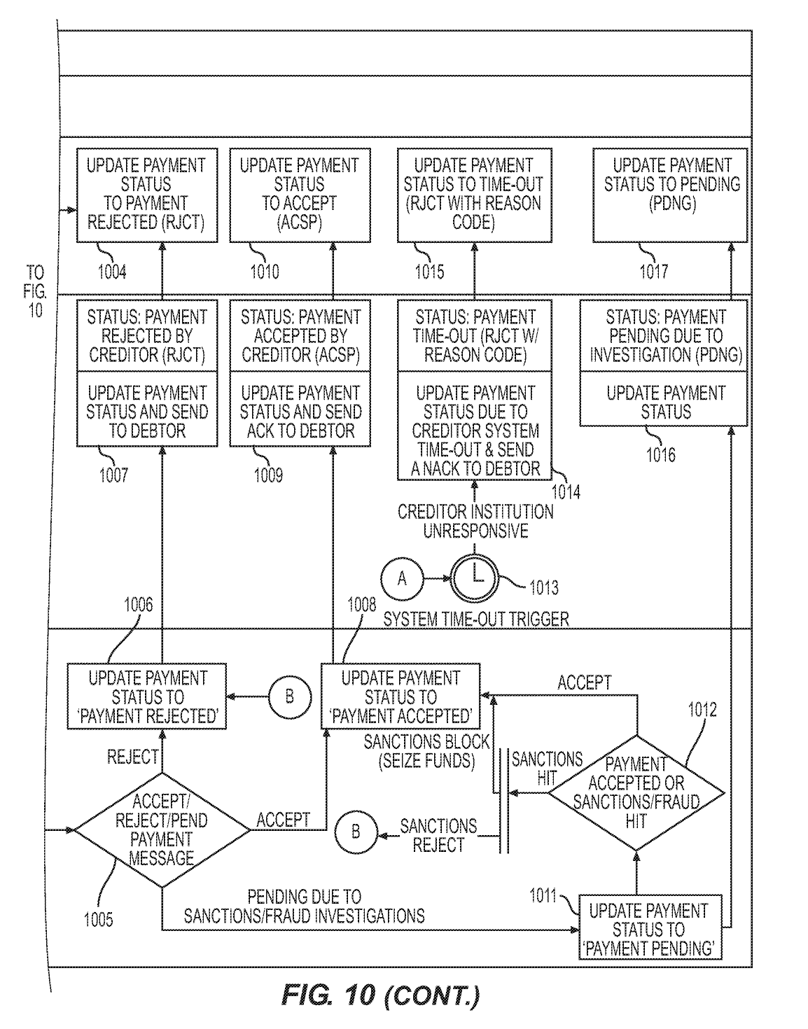

FIG. 10 is a payment state flow diagram which will now be described, according to an example aspect herein. The method starts in step 1000, and in step 1001 a payment message is generated at the debtor FI 111 and forwarded to the network 130 which validates the message in step 1002. For example, the network 130 evaluates the message to determine whether it has a valid message type, whether it includes valid routing information, whether the type of the transaction is supported by the originator FI and/or recipient FI of the message (as identified in the message), whether any of those FIs is suspended from participating in the transaction system 100, whether the various fields in the message include valid information, whether the message complies with business rules, and/or whether the message is a duplicate of one already received. If, based on the evaluation it is determined to reject the payment message (Yes” in step 1002), then in step 1002a a status of the payment message is recorded by the network 130 as being rejected along with the reason for the rejection, and information indicative thereof is provided to the debtor FI 111 which then records that the payment transaction has been rejected (step 1004). If, based on the evaluation in step 1002 it is determined to not reject the payment message (“No” in step 1002), then the payment message is forwarded to the creditor FI 120 by way of the network 130. If the network 130 does not receive a reply in response thereto within a predetermined time period (1003), then control passes through connector A to step 1013 described below. Otherwise, after the creditor FI 120 receives the message and determines whether to accept or reject it (step 1005) (e.g., based on criteria described above for step 1002). If it is determined to reject the message, then in step 1006 the FI 120 records the status of the message as being rejected and provides an indication thereof to the network 130, which also records the status of the message as being rejected and provides an indication thereof to the FI 111 in step 1007. (In one example embodiment herein, a reject reason code also can be employed to specify a reason why an item has been rejected.). Step 1004 is then performed as described above. In the case where performance of step 1005 results in an acceptance of the payment message, then in step 1008 the FI 120 records the status of the message as being accepted and provides an indication thereof to the network 130, which also records the status of the message as being accepted and provides an indication thereof to the debtor FI 111 (step 1009). In step 1010 the debtor FI 111 records that the payment message is accepted. In the case where performance of step 1005 results in a determination that the payment transaction is pending owing to, e.g., a fraud investigation or sanctions, then in step 1011 the FI 120 records the status of the message as pending, until that status is removed (step 1012), in which case control passes to step 1008 which is performed in the manner described above. In a case where sanctions are applied in step 1012, then control passes through connector B to step 1006 which is performed as described above. On the other hand, if sanctions are blocked (e.g. funds are seized) after step 1012, step 1008 is performed in the above described manner. Also after step 1011 is performed for a case where an investigation is pending, the creditor FI 120 notifies the network 130 that the payment status is pending owing to the investigation (step 1016), and the network 130 makes a record of the same, and notifies the debtor FI 111, which then updates a status of the payment transaction as pending (step 1017). Step 1013 will now be described. In step 1013 the network 130 responds to a timeout by performing step 1014 where the network 130 records a status of the payment as having a creditor timeout status and notifies the debtor FI 111 of the same. That FI 111 then records the status of the payment to timeout with a rejection and reason therefor (step 1015).

### Participant Sign-on/Sign-Off

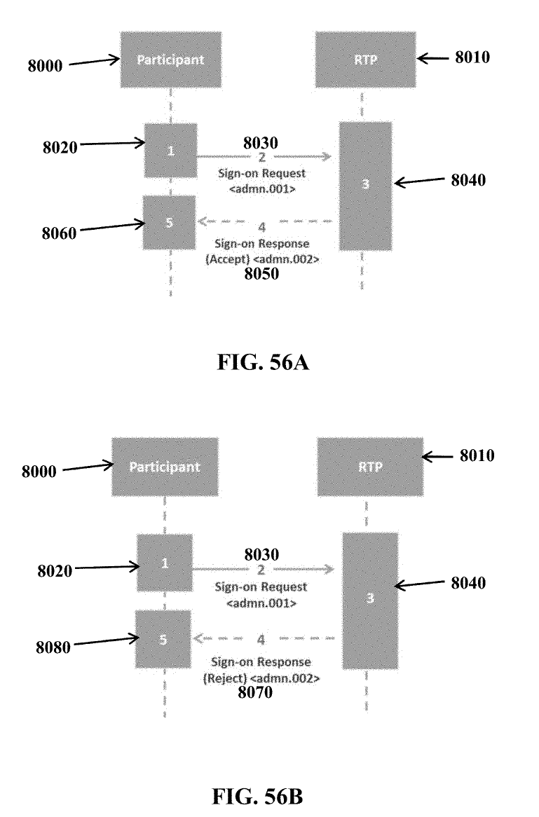

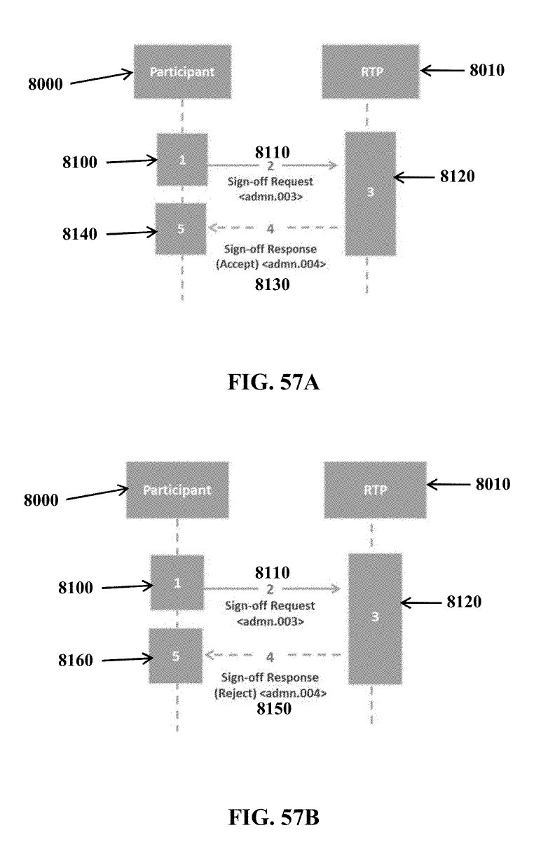

According to an example aspect herein, a participant can be required to sign-on and/or sign-off the real-time payment system or network (see, e.g., 130 of FIG. 1). For example, when a Participant 8000 (i.e., a Debtor FI and/or a Creditor FI), connected either directly or indirectly through, for example, a Third Party Service Provider (TPSP) that provides connectivity services or access to a network, desires to send or receive messages via the real time payment system or network 130, 8010 (“the RTP System”), they can formally Sign-on to the RTP System 8010 (see, e.g., FIGS. 56A-57B). This is achieved by sending a Sign-on Request using the FI's or TPSP's standard network protocol (e.g., MQ, MPLS, or Secure VPN.). Similarly, if a FI or TPSP needs to Sign-off from the RTP System 8010, possibly to undertake system maintenance, the FI or TPSP sends a Sign-off message to the RTP System 8010 over the standard network protocol.

In one example embodiment herein, when an Indirect FI (an FI that is connected to the RTP System through a TPSP) needs to Sign-on or Sign-off from the RTP System, the Participant sends an instruction for the Sign-on or Sign-off, and the TPSP, which provides the FI with connectivity in the RTP System, relays the Sign-on or Sign-off message to the RTP System on the FI's behalf. In one example embodiment, the TPSP relays the Sign-on or Sign-off message to a core processing system of the RTP System (see, e.g., core processing system 131 of FIG. 1). In another example embodiment herein, when a Participant 8000 is signed-on to the RTP System 8010, it uses a single Sign-on message to register for both sending and receiving messages (subject to their provisioned send/receive status). A sign-on indicates that a participant is on the system, and generally does not configure the participant's availability to send/receive certain messages. The single Sign-on message enables full use of the RTP System 8010. When a Participant 8000 is Signed-on, it remains Signed-on until it sends an instruction to Sign-off, as discussed above. In one embodiment, Participants 8000, once signed-on, remain Signed-on indefinitely. In general, there can be some predefined situations where a Participant 8000 can be required to Sign-off of the RTP System 8010.

The Sign-on/Sign-off process is a business level function and is independent of the state of the physical connection to the RTP System. This means that a Participant 8000 can be: (i) Signed-on, with all physical network connections established, (ii) Signed-on, with some physical network connections established, (iii) Signed-on with no physical network connections established (i.e., the physical connection is down), (iv) Signed-off, with all physical network connections established, (v) Signed-off, with some physical network connections established, and/or (vi) Signed-off, with no physical network connections established (i.e., the physical connection is down). The Sign-on status of each Participant 8000 is maintained by the RTP System 8010 and is available for other Participants to query. For example, a Participant may query the Sign-on status (e.g., this query can be done via a UI, System/Application based request, or other mechanisms) of itself or other Participants when the specific Participant believes it may be out of sync with the RTP System (e.g., in the event of a system outage). In one example embodiment, the Sign-on status is maintained by a core processing system of the RTP System (see, e.g., core processing system 131 of FIG. 1). The Sign-on status can also be maintained by the TPSP or, in house, by the Participant 8000. When an FI or TPSP Signs-on or Signs-off, a broadcast System Notification Message (SNM) is sent by the RTP System to all other Participants, advising them of the change of status for the FI or TPSP that has Signed-on or Signed-off. In one example embodiment, a core processing system of the RTP System (e.g., 130) sends the broadcast SNM (see, e.g., core processing system 131 of FIG. 1). The SNM sent as a result of an initial Sign-on for a new FI and/or TPSP informs all other users of the service that the FI and/or TPSP is now available to send and/or receive transactions.

In one example embodiment herein, a directly connected FI or TPSP may have a successful Sign-on to the RTP System. If this is done by a TPSP, all FIs connected by way of the TPSP, are signed on as a result of this Sign-on message. For example, this can be done when the FI or TPSP connects to the RTP System 8010 for the first time. Thereafter, a Sign-on to the RTP System 8010 will only be done if the FI or TPSP has previously Signed-off the RTP System 8010, for example if the Participant 8000 is performing maintenance. FIG. 56A illustrates one example embodiment of a procedure where a direct connection Sign-on is accepted by the RTP System 8010. As shown in FIG. 56A, in step 1 (8020), the FI or TPSP creates a Sign-on Request (admn.001) message containing the TPSP or FI identifier, a Sign-on/off status of “Sign-on”, and the date and time of the Request in accordance with the schema defined in predetermined operating criteria. At step 2 (8030), the FI or TPSP sends the Sign-on Request (admn.001) message to the RTP System 8010 using a predetermined format and message protocol via the FI/TPSP technical connection to the RTP System 8010. At step 3 (8040), the RTP System 8010 (e.g., a core processing system of the RTP System (see, e.g., core processing system 131 of network 130 of FIG. 1)) receives the Sign-on Request and (i) validates that the RTP System is able to process the Sign-on Request (there are no internal System alarms set that would prevent the RTP System from Signing on that FI or TPSP connection), (ii) logs the inward Sign-on Request (admn.001) message in a “Raw Log” in a raw (i.e., unaltered) format (this “Raw Log” is generally stored in the “Back Office,” which will be described in more detail below), (iii) validates the full Sign-on Request (admn.001) message for syntactical correctness in accordance with predetermined operating criteria, (iv) validates that the Sending FI/TPSP has been provisioned on the RTP System 8010 (i.e., if the Sign-on Request (admn.001) message is from a TPSP then the RTP System validates that all the TPSP's connected FIs are provisioned), and (v) validates if the Sending FI/TPSP is currently “Signed-off” the RTP System (if the Sign-on Request (admn.001) message is from a TPSP, then the RTP System validates that all the TPSP's connected FIs are “Signed-off”). If all checks are passed successfully (as in the case of the illustrated example of FIG. 56A), the RTP System 8010 (e.g., the Real Time Payments System 130 of FIG. 1): (i) updates the status of the Technical Connection(s) to “Signed-on”, in either (a) a memory, internally, on a core processing system (e.g., the System hardware holds the status) (see, e.g., core processing system 131 of FIG. 1) or (b) a directory on a separate box or server (e.g., a Technical Connection Availability Status Directory), (ii) creates a Sign-on Response (admn.002) message to be sent to the FI or TPSP connection which is requesting to Sign-on containing the FI/TPSP identifier, a Sign-on status of (Accept) and the date and time of processing the Request for the Sending FI or TPSP, (iii) logs the outward Sign-on Response (admn.002) message in the “Raw Log” in a raw (i.e. unaltered) format, (iv) generates a Sign-on SNM containing an identifier of the Technical Connection(s), FI identifier, Connection name(s), a status of “Signed-on” and the date and time that the Connection(s) were Signed-on (if the Sign-on Request is for all the TPSP FIs, then the RTP System generates a Sign-on SNM for each FI connected to the TPSP), and (v) sends the broadcast Sign-on SNM(s) to all available connections. Thereafter, at step 4 (8050), the RTP System 8010 sends the Sign-on Response (admn.002) message to the connection(s) from which the request was received, and, at step 5 (8060), the original sending connection receives the Sign-on Response and is enabled to send/receive transactions. In one example embodiment, the Sign-on Response (admn.002) message indicates that the Sign-on Request was accepted and thus, the Sign-on to the RTP System was successful. Also, in another example embodiment herein, in sub-step (iv) a notification that a connection is signed off (i.e. TPSP) is provided, and other FIs can infer from a routing table regarding all FIs that are no longer signed-on.

In another example embodiment herein, a directly connected FI or TPSP may have an unsuccessful Sign-on to the RTP System. FIG. 56B illustrates one example embodiment of a procedure where a direct connection Sign-on is rejected by the RTP System 8010. As shown in FIG. 56B, at step 1 (8020), the FI or TPSP creates a Sign-on Request (admn.001) message containing the TPSP or FI identifier, a Sign-on/off status of “Sign-on”, and the date and time of the Request in accordance with the schema defined in predetermined operating criteria. At step 2 (8030), the FI or TPSP sends the Sign-on Request (admn.001) message using a predetermined format and message protocol via the FI/TPSP technical connection to the RTP System 8010. At step 3 (8040), the RTP System 8010 receives the Sign-on Request and generally performs the same functions as discussed above in connection with step 3 (8040) of FIG. 56A (i.e., validations and logging of the inward Sign-on request Message). If any of the validation steps fails (as in the example embodiment of FIG. 56B), the remaining checks and validations from step 3 of FIG. 56A are not carried out and the RTP System 8010: (i) rejects the Sign-on Request (admn.001) Message, (ii) creates a Sign-on Response (admn.002) message containing the Technical Connection identifier, FI identifier, a Sign-on status of (Reject), and the date and time of processing the Request for the FI or TPSP that requested the Sign-on, and (iii) logs the outward Connection Sign-on Response (admn.002) message in the “Raw Log” in a raw (i.e. unaltered) format. Thereafter, at step 4 (8070), the RTP System 8010 sends the Sign-on Response (admn.002) message to the Connection from which the request was received, and, at step 5 (8080), the original Sending FI or TPSP receives the Connection Sign-on Response (admn.002) message. In one example embodiment, the Sign-on or Connection Sign-on Response (admn.002) message indicates that the Sign-on Request failed and thus, the Sign-on to the RTP System was unsuccessful.

In an example embodiment herein, a directly connected FI or TPSP may have a successful Sign-off from the RTP System 8010. If this is done by a TPSP, all connected FIs are signed off as a result of this Sign-off message. Typically, a Sign-off request will only happen if maintenance is required on the connection(s). FIG. 57A illustrates one example embodiment of a procedure where a direct connection Sign-off is accepted by the RTP System 8010. As shown in FIG. 57A, at step 1 (8100), the FI or TPSP formats a Sign-off Request (admn.003) message containing the FI/TPSP identifier, a Sign-on/off status of “Sign-off”, and the date and time of the Request in accordance with the schema defined in predetermined operating criteria. At step 2 (8110), the FI or TPSP then sends the Sign-off Request (admn.003) message using a predetermined format and message protocol via the FI/TPSP technical connection to the RTP System 8010. At step 3 (8120), the RTP System 8010 receives the Sign-off Request and (i) validates that the RTP System is able to process the Request (there are no internal System alarms set that would prevent the RTP System from Signing off that FI or TPSP), (ii) logs the inward Sign-off Request (admn.003) in the “Raw Log” in a raw (i.e. unaltered) format, (iii) validates the full Sign-off Request (admn.003) message for syntactical correctness in accordance with predetermined operating criteria, and (iv) validates if the FI is currently “Signed-on” to the RTP System 8010 (if the Sign-off Request (admn.003) message is from a TPSP then the RTP System validates that all the TPSP's connected FI's are “Signed-on”). If all checks are passed successfully (as in the example embodiment of FIG. 57A), the RTP System 8010: (i) updates the status of the Technical Connection(s) in the Technical Connection Availability Status Directory to Signed-off, (ii) creates a Sign-off Response (admn.004) message containing an identifier of the Technical Connection, the FI identifier, a Sign-off status of (Accept), and the date and time of processing the Request for the FI or TPSP that sent the Sign-off request, (iii) logs the in-progress outward Sign-off Response (admn.004) message in the “Raw Log” in raw (i.e. unaltered) format, (iv) generates a Sign-off SNM containing the Technical Connection identifier, FI identifier, Connection name(s), a status of “Signed-off” and the date and time that the Technical Connection(s) was Signed-off of the RTP System 8010 (if the Sign-off Request is for all the FIs connected to the TPSP's connected FIs, then the RTP System generates a Sign-off SNM for each FI connected to the TPSP), and (v) sends the broadcast Sign-off SNM(s) to all available connections. At step 4 (8130), the RTP System 8010 then sends the Connection Sign-off Response (admn.004) message to the Technical Connection from which the original request was received, and, at step 5 (8140), the original sending connection receives the Sign-off Response and is confirmed as Signed-off from the RTP System 8010. In one example embodiment, the Sign-off or Connection Sign-off Response (admn.004) message indicates that the Sign-off Request was accepted and thus, the Sign-off from the RTP System was successful.

In another example embodiment herein, a directly connected FI or TPSP may have an unsuccessful Sign-off from the RTP System 8010. FIG. 57B illustrates one example embodiment of procedure where a direct connection Sign-off is rejected by the RTP System 8010. As shown in FIG. 57B, at step 1 (8100), the FI or TPSP formats a Sign-off Request (admn.003) message containing the FI/TPSP identifier, a Sign-on/off status of “Sign-off”, and the date and time of the Request in accordance with the schema defined in predetermined operating criteria. At step 2 (8110), the FI or TPSP sends the Sign-off Request (admn.003) message using a predetermined format and message protocol via the FI/TPSP technical connection to the RTP System 8010. At step 3 (8120), the RTP System 8010 receives the Sign-off Request and generally performs the same functions as discussed above in connection with step 3 of FIG. 57A (8120) (i.e., validations and logging of the inward Sign-off request Message). If any of the validation steps fails (as in the example embodiment of FIG. 57B), the remaining checks and validations of step 3 of FIG. 57A are not carried out and the RTP System 8010: (i) rejects the Sign-off Request (admn.003) message, (ii) creates a Sign-off Response (admn.004) message containing the Technical Connection, the FI identifier, a Sign-off status of (Reject), and the date and time of processing the Request for the FI or TPSP that requested the Sign-off, and (iii) logs the outward Connection Sign-off Response (admn.004) message in the “Raw Log” in a raw (i.e. unaltered) format. At step 4 (8150), the RTP System 8010 then sends the Sign-off Response (admn.004) message to the Connection from which the original request was received, and, at step 5 (8160), the original sending connection receives the Sign-off Response and takes corrective action accordingly before trying to resend another Sign-off request. In one example embodiment, the Sign-off or Connection Sign-off Response (admn.004) message indicates that the Sign-off Request failed and thus, the Sign-off from the RTP System was unsuccessful.

In one example embodiment herein and as can be understood in view of the above, an indirectly connected FI can sign on or off of the RTP System 8010 via a TPSP. The process for the indirectly connected FI to sign on or off of the RTP System 8010 via a TPSP is the same as that described above for a directly connected FI. For example, the TPSP, acting on behalf of the indirectly connected FI, is responsible for sending/receiving Sign-on/off requests and response messages as well as routing any resulting SNMs back to the indirectly connected FI Signing-on/off of the RTP System 8010.

### Exception Message Processing

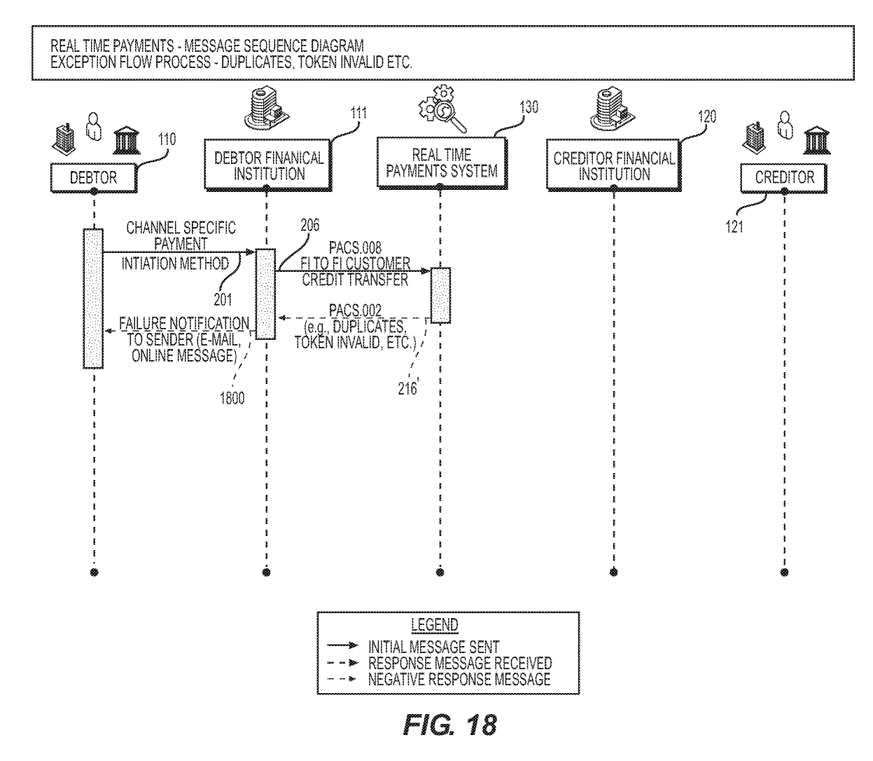

As described above, the transaction system 100 generates various types of exception messages in the event that an exception type of message is detected. FIG. 18 is a further representation of a procedure for doing so. For example, that drawing shows steps 201, 206, and 216′ as explained above regarding FIG. 2, wherein the exception message generated in step 216′ (e.g., a PACS.002 message) is generated in response to the network 130 detecting a duplicate message (e.g., in step 213 of FIG. 2), and/or an invalid token (e.g., step 214 of FIG. 2), and also shows the debtor FI 111 responding to that exception message by providing notification thereof to the debtor station 110 (step 1800) (e.g., in the form of an email, text message, or other type of communication).

In an example embodiment herein, a pacs.002 as an exception message can be employed in relation to both payment and non-payment messages, and error reason codes can be included in exception messages. Also, in some cases (for non-payment messages), exception messages also can be a response message to an original request (e.g., if the end customer has informed the debtor FI to block a request for payment, a pain 013 message can result in a pain.014 exception message being provided, indicating that the customer receiving the request for payment has them blocked).

### Echo Messages

In an example embodiment herein, Echo Message capability is provided. An Echo Message (also referred to as a “Heartbeat Message”), for example, is used to check application responsiveness during periods of no transaction activity. Echo message exchange can be initiated by either the RTP System 8010 (e.g., the Real Time Payment System or network 130) or by a Technical Connection (e.g., a directly connected Financial Institution “FI” or Third Party Service Provider “TPSP”). A recipient party responds to an Echo Request with an Echo Response. In one example embodiment, the RTP System 8010 initiates a message exchange periodically (e.g., every thirty seconds, or three minutes, or the like) or non-periodically (this is a configurable variable on the RTP System) when there has been no message received or sent from a technical end point/connection after a predetermined time period. In one embodiment, a timer is set by the RTP System 8010 when any predetermined activity (e.g., transaction) is initiated. This timer is reset each time an occurrence of the activity is detected by the RTP System 8010. As discussed above, if no activity is detected after a predetermined time period, the timer is triggered, and an Echo Message (or “Heartbeat Message”) is sent. The RTP System 8010 marks the connection as being unavailable if, after a predetermined number of attempts, there is no Echo Response received from the connection, or no other message is received. The configurable parameters (e.g., retry interval and number of retries) are held as system values. In one example embodiment herein, each Technical Connection has its own set of timers and retry counters, which can be maintained internally in the RTP System 8010 in a data structure of a memory within a core processing system (optionally, in one embodiment, the Echo Message can be sent to the core processing system) (see, e.g., core processing system 131 of network 130 of FIG. 1). Each participant can also have their own counters as well. When a Technical Connection is identified by the RTP System as being unavailable, (i) an Alert is generated to, for example, a System Operator to advise the operator that the connection is unavailable, (ii) a SNM is sent to all available Technical Connections to advise them that the identified connection has become unavailable (if a connection for a TPSP becomes unavailable a single SNM is generated to inform the other connections of the TPSP's unavailability; a System routing table can then be referenced to identify which routing number(s) for the specific connection(s) are affected, i.e., are serviced by the TPSP), and (iii) the RTP System continues to send an Echo Request in the above-described manner for retries until a response is received (if at all). The Echo Request Counters and Timers are reset by the RTP System when the RTP System receives: (a) a new message (either a payment or non-payment message), (b) a message response (either a payment or non-payment response message), (c) an Echo Response (from a System initiated Echo Request), and/or (d) an Echo Request from the connection. If a connection has previously been marked as “Unavailable” and subsequently responds to an Echo message, then: (i) the connection is then marked as “Available”, (ii) the Echo Request Counters and Timers are reset, (iii) an Alert is generated to the System Operator to advise the operator that the previously “Unavailable” connection is now “Available”, and (iv) a SNM is sent to all other available Technical Connections to advise them the previously “Unavailable” connection has become “Available” (if a connection for a TPSP becomes “Available,” a single SNM is generated informing all other “Available” System connections of that TPSP's availability; the System routing table can be referenced to identify which routing numbers are affected, i.e., are serviced by the TPSP). The System Operator can have procedures in place to contact directly connected FI's and TPSP's if a predetermined number or constant cycles of “Available” and “Unavailable” messages are received from a FI or TPSP. This would be indicative of some failure in the configuration or the network. The FI or TPSP affected can be contacted and appropriate diagnostics and remedial actions undertaken.

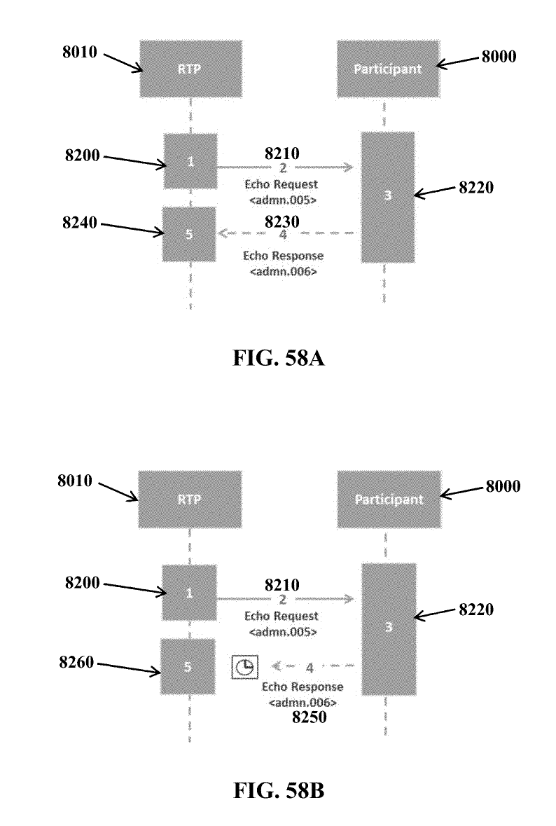

In one example embodiment herein, the RTP System 8010 sends an Echo message to a Technical Connection and receives an Echo Response back from the Technical Connection. FIG. 58A illustrates an example embodiment of an Echo Request procedure initiated by the RTP System 8010, in a case where it is assumed that no message (Echo Request, Echo Response, or other message) has been received over a predetermined interval. In accordance with the embodiment of FIG. 58A, at step 1 (8200), the RTP System 8010 detects that it has not received any messages (request or response) from a Technical Connection (i.e., Participant 8000) within the pre-determined time period. The RTP System 8010 then: (i) creates an Echo Request (admn.005) message containing the Technical Connection identifier, an Echo function code and the date and time the Request message was issued for the applicable connection, (ii) logs the outward Echo Request (admn.005) message in the “Raw Log” in a raw (i.e. unaltered) format, (iii) starts the Echo Request message response Timer for the Technical Connection response, and (iv) increments the Echo Request (admn.005) message Retry Counter for that Technical Connection by a value of ‘1’ (in the illustrated embodiment of FIG. 58A, an Echo Response (admn.005) is received before the Echo Retry Counter exceeds the Echo Retry Counter Max Value). At step 2 (8210), the RTP System 8010 then sends the Echo Request (admn.005) message to the Technical Connection (i.e., Participant 8000). At step 3 (8220), the Technical Connection (i.e., Participant 8000) receives the Echo Request (admn.005) message, formats an Echo Response (admn.006) message, and, at step 4 (8230), sends that latter message to the RTP System 8010. At step 5 (8240), the RTP System 8010 then receives the Echo Response (admn.006) message and: (i) validates the RTP System is able to process the Echo Response (there are no internal System alarms set that would prevent the RTP System from processing the Echo Response for that Technical Connection), (ii) logs the inward Echo Response (admn.006) message in the “Raw Log” in a raw (i.e. unaltered) format, (iii) validates the full Echo Response (admn.006) message for syntactical correctness in accordance with predetermined operating criteria, and (iv) validates that the Sending Technical Connection has been provisioned onto the RTP System. If all checks are passed successfully (as in the example embodiment illustrated in FIG. 58A), the RTP System 8010 checks whether the Technical Connection is marked as “Unavailable”. This status indication is generally held, as discussed above, within a core processing system in a data structure in a memory of the RIP System 8010 (see, e.g., core processing system 131 of FIG. 1). If the Technical Connection is marked as “Unavailable”, the RTP System (a) marks the Technical Connection as “Available”, (b) sends an Alert message to the System Operator (indicating the Technical Connection is now “Available”), and (c) sends a System Notification Message (Technical Connection “Available”) to all other available System connections. This SNM is sent in a case where the Technical Connection was previously unavailable and now becomes available. The RTP System 8010 thereafter clears the Echo Request Timer for that FI/TPSP connection, and clears the Echo Request Retry Counter for that FI/TPSP connection.

In another embodiment, the RTP System 8010 sends an Echo message to a Technical Connection (i.e., Participant 8000) and no response is received back from the Technical Connection. FIG. 58B illustrates an embodiment of an Echo Request initiated by the RTP System 8010, in a case where it is assumed that no message (Echo Request, Echo Response, or other message) has been received over a predetermined interval, at which the RTP System 8010 determines that the Technical Connection is unresponsive. In accordance with the embodiment of FIG. 58B, at step 1 (8200), the RTP System 8010 detects that it has not received any message requests or responses from a Technical Connection (i.e., Participant 8000) within a pre-determined time period that defines a Technical Connection as being unresponsive. The RTP System 8010 then generally performs the same functions as discussed above in connection with step 1 of FIG. 58A (i.e., creating an Echo Request message, logging the outward Echo Request message, etc.). At step 2 (8210), the RTP System 8010 then sends the Echo Request (admn.005) message to the Technical Connection (i.e., Participant 8000). If the RTP System 8010 does not receive an Echo Response (admn.006) message within an Echo Timer interval it re-performs steps (1) and (2) (i.e., 8200 and 8210). If the Echo Request (admn.005) message Retry Counter exceeds the Echo Retry Counter Max Value (as in, for example, step 4 (8250) of the embodiment of FIG. 58B) the RTP System 8010 checks whether the connection is currently marked as “Available”. If yes, the RTP System 8010 (e.g., at step 5 (8260)): (i) marks the Technical Connection as “Unavailable”, (ii) sends an Alert message to the System Operator (Identifying the Technical Connection that is “Unavailable”), and (iii) sends a System Notification Message (Technical Connection “Unavailable”) to all other Participants (if the connection that is unavailable is a TPSP, the SNM informs the other connections of the unavailability of the TPSP's connection; the System routing table can be referenced to identify which FIs are affected (i.e., are serviced by that TPSP)).

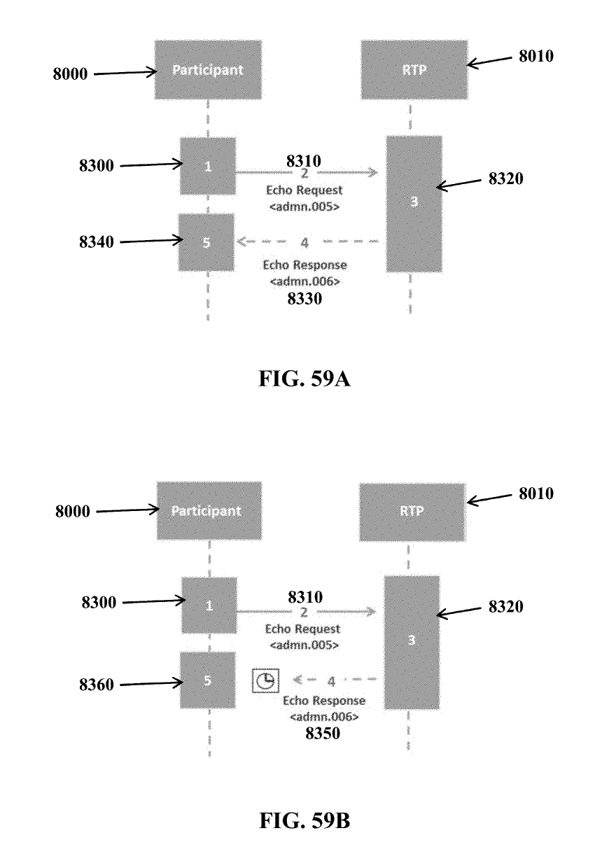

In one example embodiment, a Technical Connection (i.e., Participant 8000) sends an Echo Request message to the RTP System 8010, in a case where it is assumed that no message (Echo Request, Echo Response, or other message) has been received from the RTP System over a predetermined interval, at which the Technical Connection could determine the RTP System is unresponsive. FIG. 59A illustrates an example embodiment of an Echo Request initiated by the Participant 8000 and a response is received from the RTP System 8010. As shown in the embodiment of FIG. 59A, at step 1 (8300), the Technical Connection (i.e., Participant 8000) detects that it has not received any message requests or responses from the RTP System 8010 within a pre-determined time period that defines the RTP System as being unresponsive. The Technical Connection formats an Echo Request (admn.005) message containing the System identifier, the Echo Function code and the date and time the Echo Request message was issued. At step 2 (8310), the Technical Connection (i.e., Participant 8000) sends the Echo Request Message (admn.005) to the RTP System 8010. At step 3 (8320), the RTP System 8010: (i) validates that the RTP System is able to process the Echo Request (admn.005) message (there are no internal System alarms set that would prevent the RTP System from processing the Echo Response for that Technical Connection), (ii) logs the inward Echo Request (admn.005) message in the “Raw Log” in a raw format, (iii) validates the full Echo Request (admn.005) message for syntactical correctness in accordance with predetermined operating criteria, and (iv) validates that the Sending Technical Connection has been provisioned onto the RTP System. If all Validations are passed successfully (as in the example embodiment of FIG. 59A), the RTP System 8010 checks if the Technical Connection was previously “Unavailable” and, if so, the RTP System 8010: (i) marks the Technical Connection as “Available”, (ii) sends an Alert message to the System Operator (indicating that the Connection is now “Available”), and (iii) sends a System Notification Message (indicating that the Technical Connection is now “Available”) to all other connections (if the Technical Connection that is available is a TPSP, the SNM informs the other connections of the availability of the TPSP's connection; the routing table can be referenced to identify which FIs are affected (i.e., which FIs are serviced by the TPSP)). The RTP System 8010 then clears the Echo Request Timer, creates the Echo Response (admn.006) message for the original Sending connection, and logs the outward Echo Response (admn.006) message in raw format. Thereafter, at step 4 (8330), the RTP System 8010 sends the Echo Response (admn.006) message to the Technical Connection (i.e., Participant 8000), and, at step 5 (8340), the Technical Connection (i.e., Participant 8000) receives the Echo Response (admn.006) message and continues processing normally. In one example embodiment, if the Echo Request Timer expires before any response to the original Echo Request is received, a second Echo Request (admn.005) message is generally sent. If, again, the Echo Request Timer expires before any response to the second Echo Request is received, a third Echo Request (admn.005) message is generally sent. However, if, again, the Echo Request Timer expires before any response to the third Echo Request is received, a System Notification Message (indicating that the RTP System is now “Unavailable”) is sent to all other connections.

In another example embodiment, the Technical Connection (i.e., Participant 8000) sends an Echo Request message to the RTP System 8010, in a case where it is assumed that no message (Echo Request, Echo Response, or other message) has been received from the RTP System over a predetermined interval, at which the Technical Connection could determine the RTP System is unresponsive. FIG. 59B illustrates an example embodiment of an Echo Request initiated by the Participant/Connection 8000 and no response is received from the RTP System 8010. As shown in the example embodiment of FIG. 59B, at step 1 (8300), the Technical Connection (i.e., Participant 8000) detects that it has not received any message requests or responses from the RTP System 8010 within a pre-determined time period that defines the RTP System 8010 as being unresponsive. The Technical Connection (i.e., Participant 8000) formats an Echo Request (admn.005) message containing the System identifier, the Echo Function code and the date and time the Echo Request message was issued. At step 2 (8310), the Technical Connection (i.e., Participant 8000) sends the Echo Request Message (admn.005) to the RTP System 8010. At step 3 (8320), the RTP System 8010 generates an Echo Response (admn.006) message. At step 4 (8350), the RTP System 8010 sends the Echo Response (admn.006) message to the Technical Connection (i.e., Participant 8000). However, it does not reach the Technical Connection (i.e., Participant 8000). At step 5 (8360), the Technical Connection (i.e., Participant 8000) does not receive the response to the Echo Request (admn.005) message. The Technical Connection (i.e., Participant 8000) waits for the pre-determined interval and repeats step 1 (8300). If the pre-determined number of retries is exceeded, the Technical Connection (i.e., Participant 8000) performs an Echo Request message Exceeded procedure, such as the one described above, e.g., if no response is received to the original Echo Request, a second Echo Request (admn.005) message is generally sent. If, again, no response is received to the second Echo Request, a third Echo Request (admn.005) message is generally sent. However, if, again, no response is received to the third Echo Request, a System Notification Message (indicating that the RTP System is now “Unavailable”) is sent to all other connections.

In yet another embodiment, in the event that a Third Party Service Provider (TPSP) loses connectivity with one of its FIs from a particular Technical Connection, the TPSP sends a Sign-off (admn.002) message or a “connection unavailable” message to the RTP System on behalf of the FI. This triggers the RTP System to update the FI's availability status and generate SNMs to each directly connected Participant informing of the FI's availability status (as discussed above). When connectivity between the TPSP and the FI is restored, the TPSP sends a Sign-on message to the RTP System on behalf of the FI. This causes the RTP System to update the FI's availability and generate SNMs to send to the other FIs and TPSPs informing them of the change in the FI's availability status.

### Message Types

In an example embodiment herein, robust messaging capability is provided. The payment system supports multiple financial and non-financial message types which can be used to create a variety of transaction flows in support of disparate use cases, and flexible and extensible message formats are employed that are able to adapt to changing needs. This enables payment system flexibility for future needs, provides a platform for product development and innovation, and allows the system to become backward compatible with a network such as the network 130. Messages may be overlaid to provide end-to-end solutions for specific use cases. Extensible messaging includes both financial and non-financial messages, asymmetric products (framework allows FIs to create products independently for senders and receivers), and, within messages there can be fields of data, external links, etc. Messages employed herein also can comply with existing global standard formats (e.g., ISO 20022, ISO 8583, etc.), and have international compatibility (e.g., multi-currency). Related messages can include a Universal Transaction Id which is unique within the payment system for every payment, as well as an identifier of a sending party (if applicable). Example messages include FI to FI messages such as acknowledgements by a receiver, and payment messages. In one example embodiment herein, a “Payment Acknowledgement” message is end-to-end in that it is initiated by an end user and received by another end user. Similarly, a payment message also is end-to-end. An example of a FI to FI message includes a Request for Return of Funds message. Example FI to end user messages include receiver notification messages, sender notification messages, payment successful messages, sender notification payment rejected messages, and sender notification payment under review messages. Example end user to end user messages include requests for payment (e.g., invoice or message), receipt acknowledged and/or payment acknowledged by receiver messages, request for return of funds messages (this can be a FI to FI message, as well as a response to request for return of funds message) and agree to return funds messages. Example third party messages include universal transaction IDs, links to external sources, and contingency payment rule messages. Non-payment messages preferably support value-added services and administration. Related messages can be linked into complex transactions. Messages can carry remittance data and references to external data and processes for extended functionality.

ISO 20022 is a harmonized set of XML messaging standards across major financial services domains (Funds Transfer, Cash, Securities, Trade, Card and Foreign Exchange) based on a shared data dictionary and business process model. Messages are available for the complete end-to-end payments chain; i.e., customer to bank, bank to bank, and reporting. Data definitions can be used as the basis for internal communication needs, and the standard can support real-time messaging.

ISO 8583 is a common interface by which financial transaction card originated messages may be interchanged between acquirers and card issuers. Messages in the standard typically contain information about the value of a transaction, where it originated, the card account number, and bank sort code. Message data fields can be customized, and the standard can support real-time messaging. The standard is used by retail banks, and for almost all credit and debit card transactions, including ATMs.

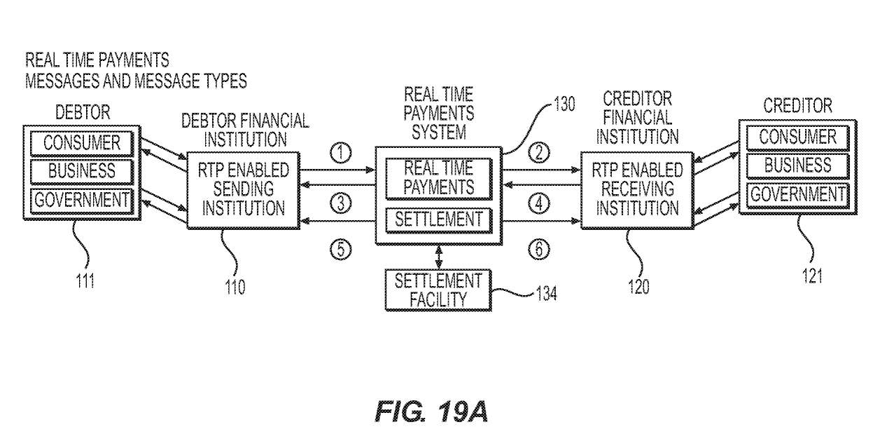

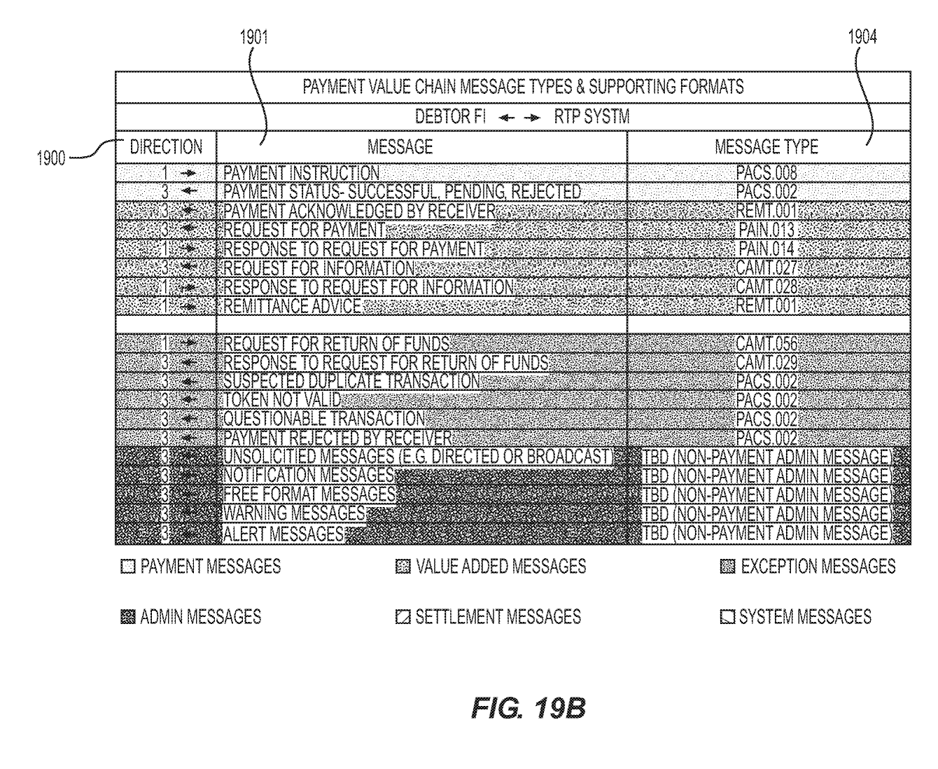

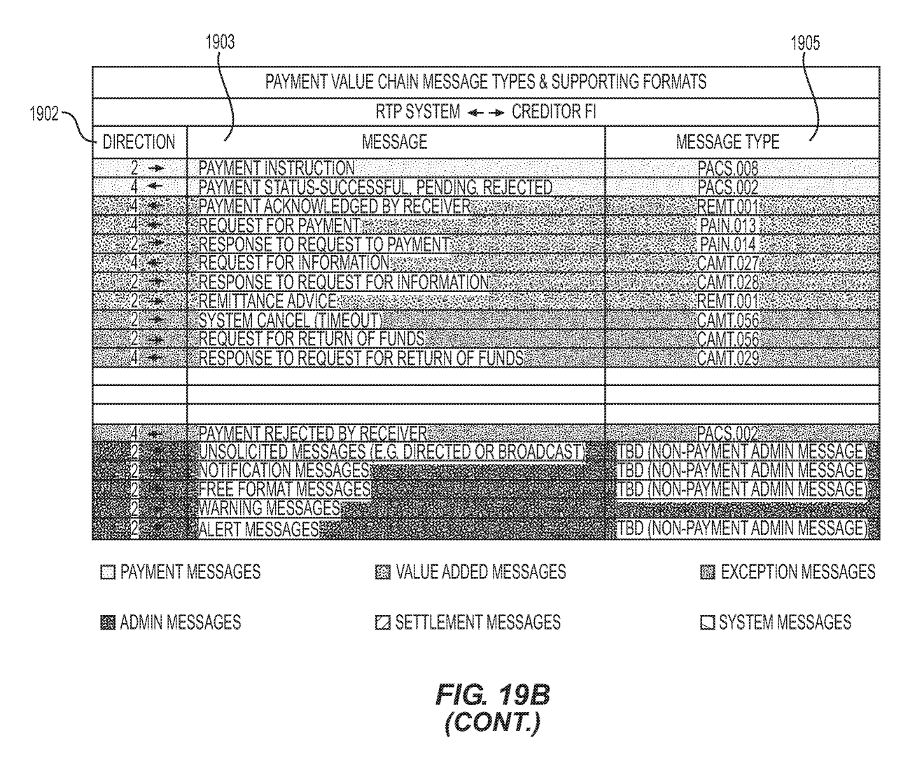

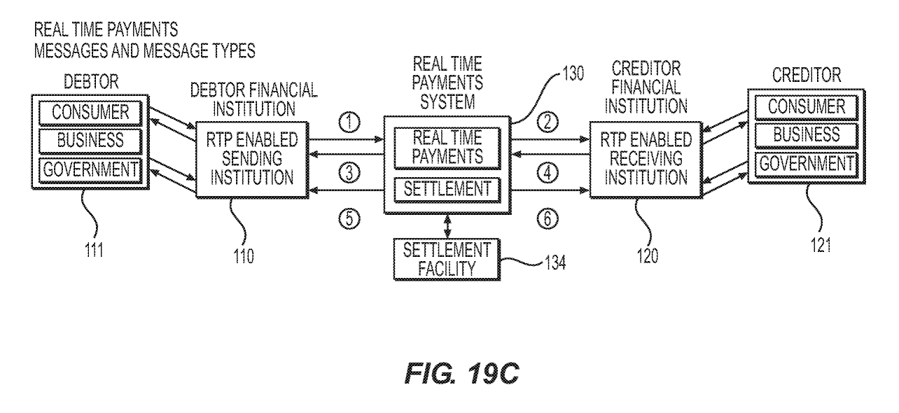

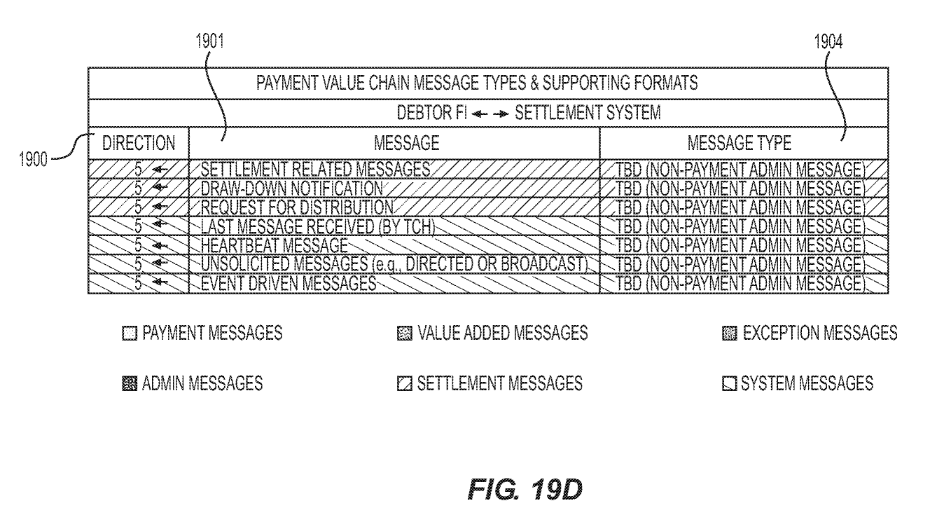

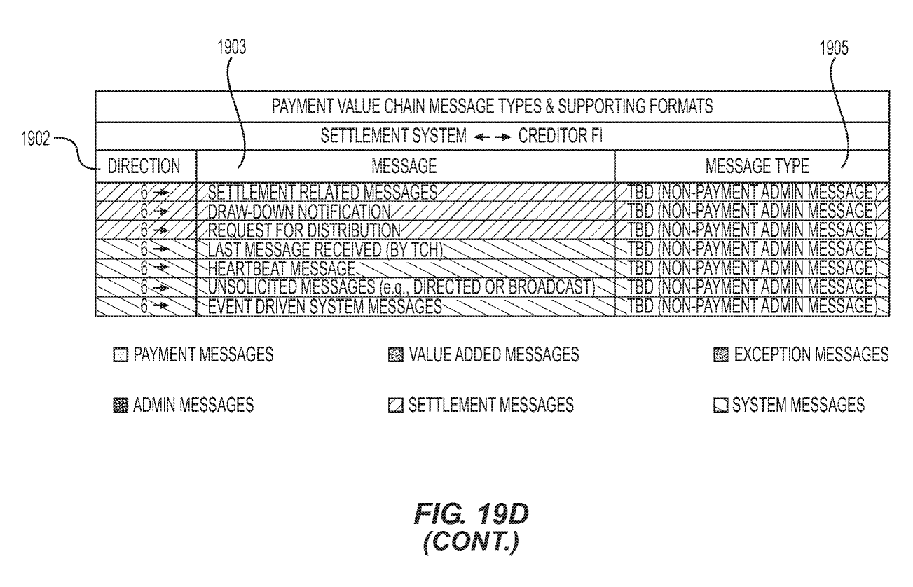

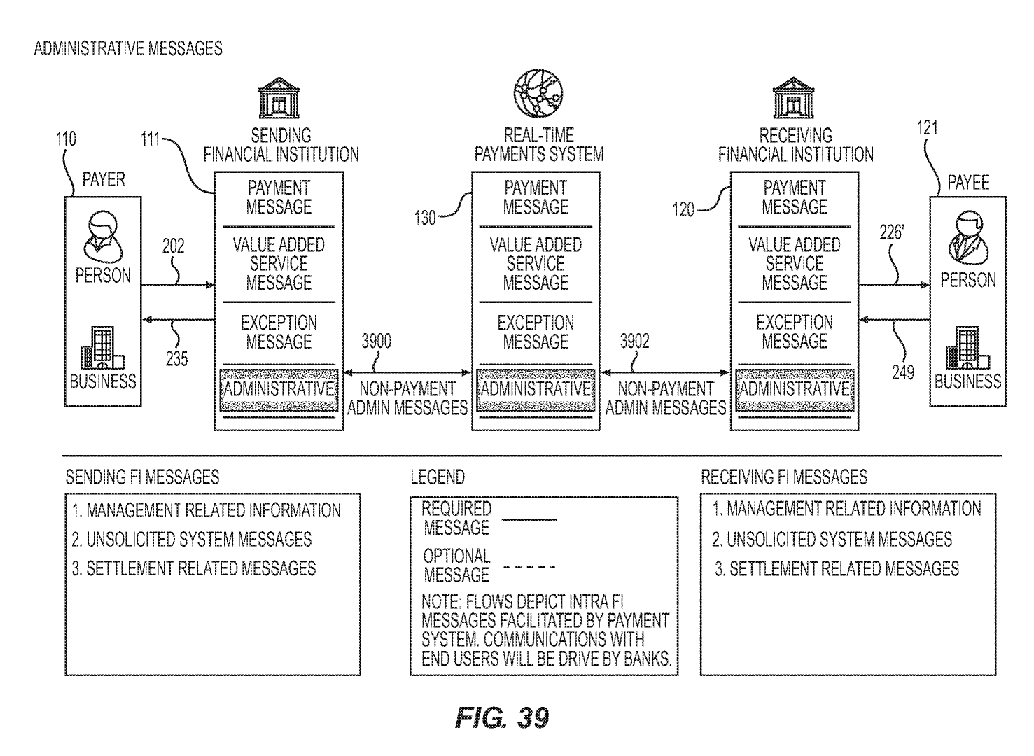

As described above, and referring now to FIG. 39, the overall transaction system 100 herein employs various types of non-payment, administrative messages, such as messages 3900 exchanged between the debtor FI 111 and real time payment system 130, and messages 3902 exchanged between the real time payment system 130 and creditor FI 120. Messages 3900 and 3902 can include, for example, management related information, unsolicited system messages, and settlement related messages. FIGS. 19b and 19d described show at least some administrative types of messages. (It is noted that, in another example embodiment, a request for information can be a camt.026 message instead of a camt.027 message).

FIGS. 19a and 19c are another depiction of the system of FIG. 1, including elements 110, 111, 120, 121, 130, and 120, and FIGS. 19b and 19d shows various messages in columns 1901 and 1903, that are employed in the system according to an example embodiment herein. The types of those messages those messages are indicated in respective columns 1904 and 1905. The “Direction” columns 1900 and 1902 and the numbers shown therein correspond to the same numbers represented in FIG. 19a or 19c, and the arrows associated with those numbers indicate the direction in which the respective messages travel in the system. The message types under columns 1904 and 1905 also are represented in the various flow diagrams herein. The messages are either, for example, payment messages, value added messages, exception messages, administrative messages, settlement messages, or system messages. In another example embodiment, there is no settlement message, and settlement occurs when a pacs.002 response from a creditor FI is provided to network 130). Similarly, request for distribution can be via a user interface versus a message, and can be enacted via Fed Wire.

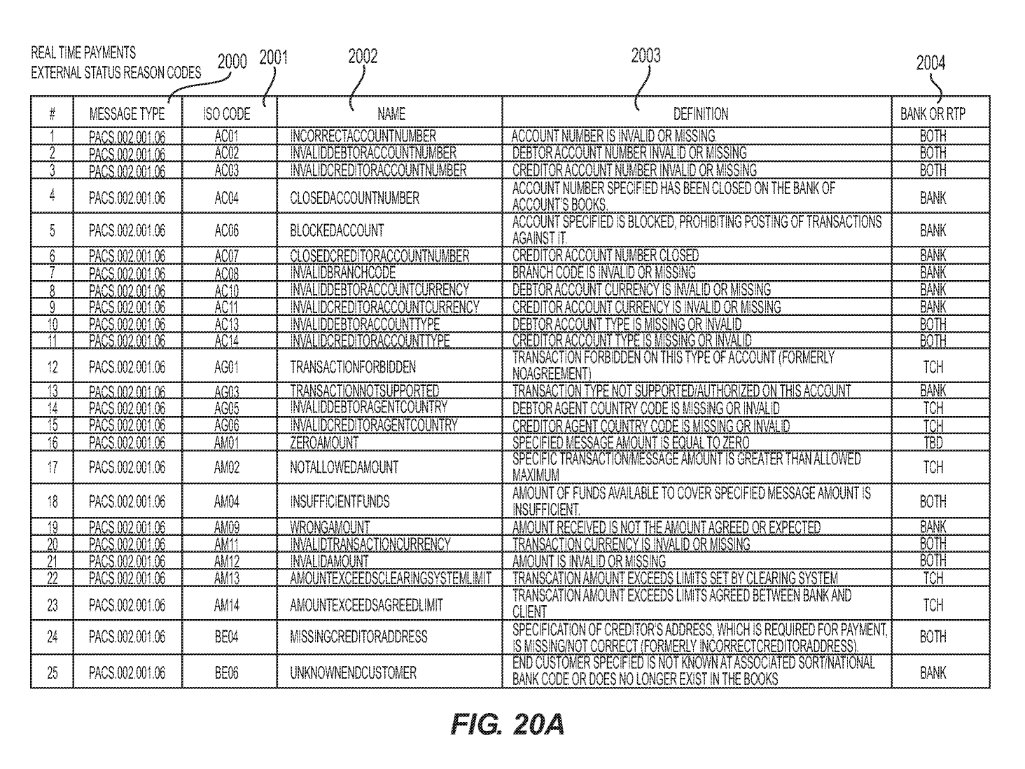

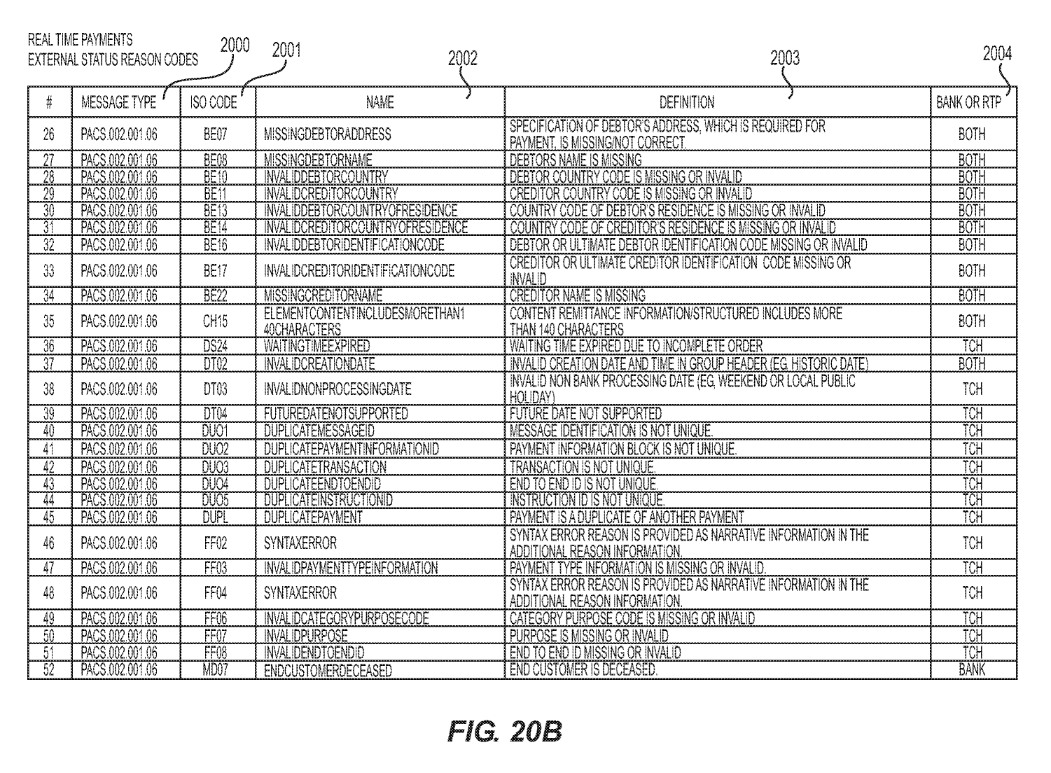

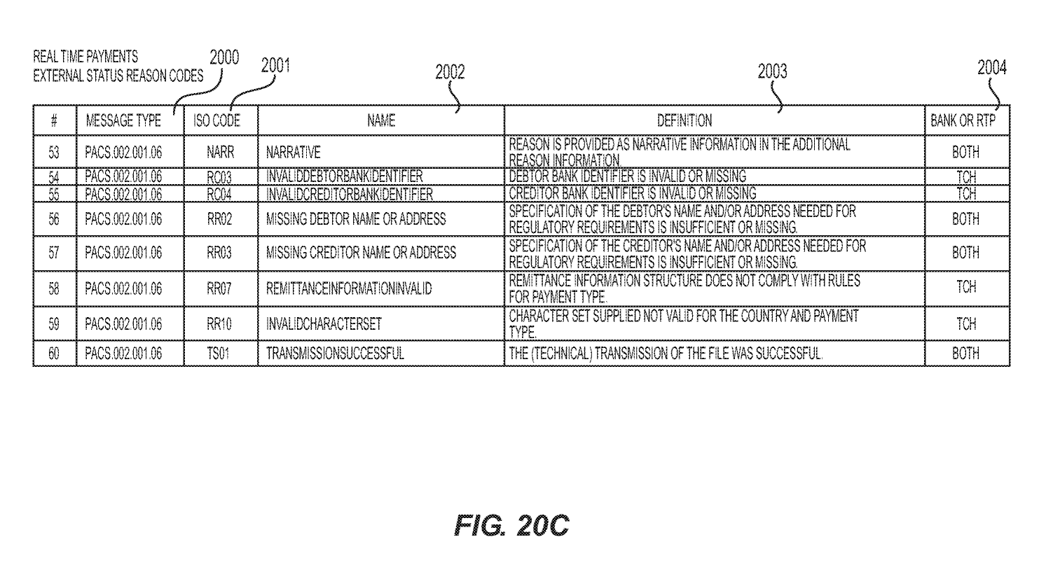

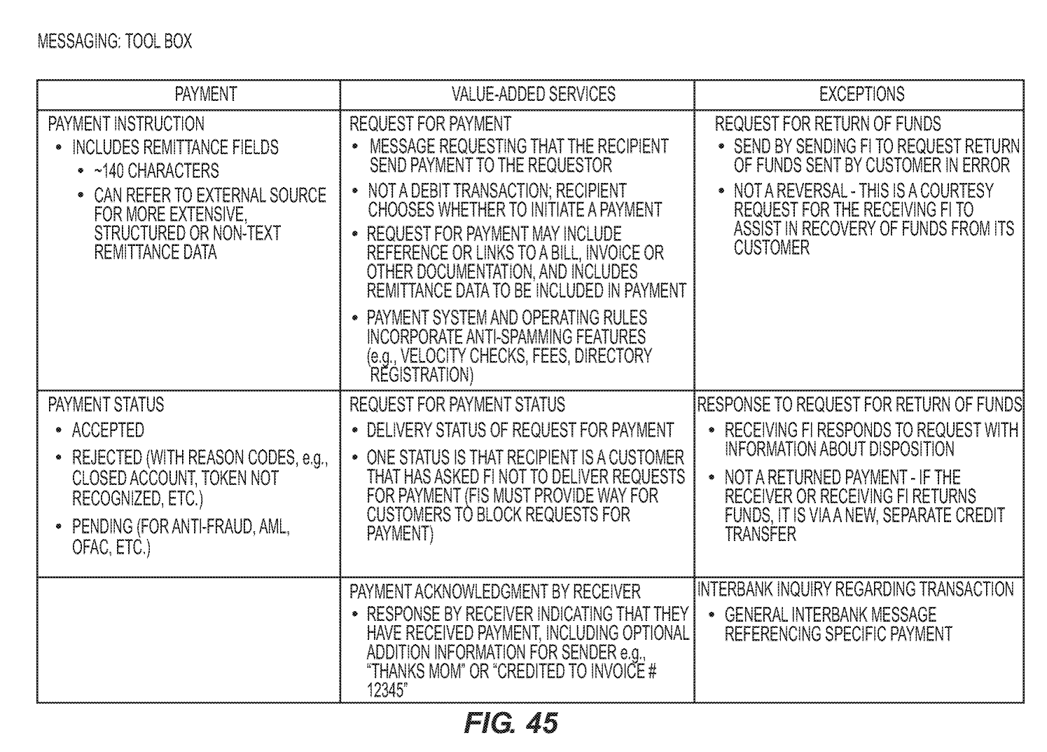

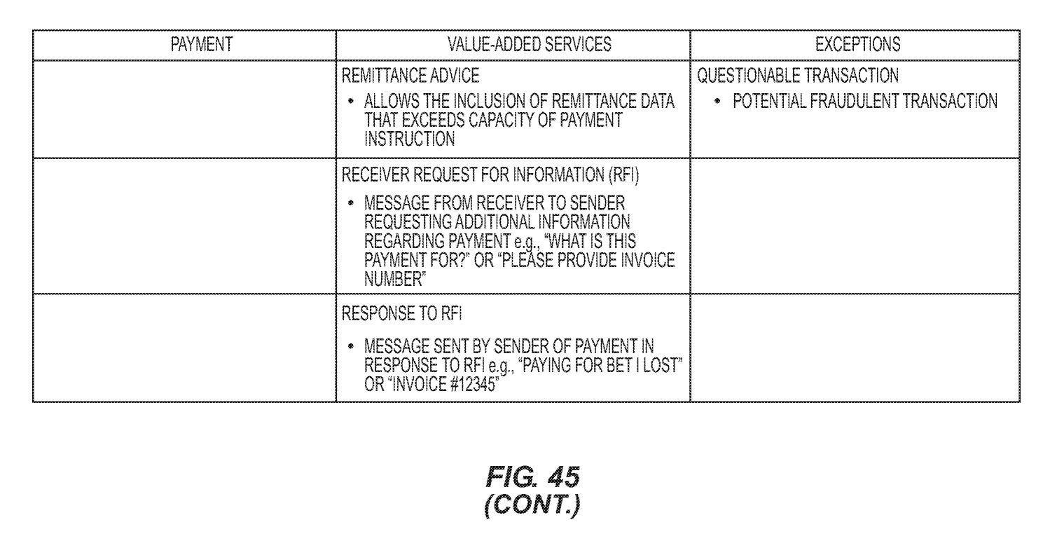

FIGS. 20a-20c show various message types in columns 2000, ISO codes under column 2001, message names under column 2002, definitions of the message types in column 2003, and an indication in column 2004 of whether the message types relate to an FI, network 130, or both, that are employed in the system according to an example embodiment herein. At least some of the message types of those figures correspond to message types represented in FIGS. 19b and 19d. The message types of FIG. 20a-20c are external status reason codes. FIG. 45 shows examples of various types of messages and certain characteristics thereof

In one example embodiment herein, at least some of the various types of messages employed in the system include at least some of the following types of information:
Universal Transaction ID (i.e., a payment id),
a related message ID (e.g., to manage responses and exception messaging) (a message may have several related IDs),
sender identification information,
designation of a business/commercial transaction versus a consumer transaction,
an indicator of whether a payer wants/accepts a return message (e.g., an acknowledgement, RFI, etc.),
a reject reason code,
a loyalty indicator (for merchant loyalty programs, coupons, match with POS geo location, etc.),
a channel indicator (mobile, web, etc.),
a fraud suspect indicator,
a Dynamic risk score,
a currency indication,
a location of bank account(s) (sender and receiver),
a foreign designator including country of account domicile,
a timestamp,
a Geo location indication, and
payment amount (for payment instruction messages).
   Payment instruction messages can include, for example, remittance fields, and 140 characters, although these examples are not limiting.

### System Notification Messages

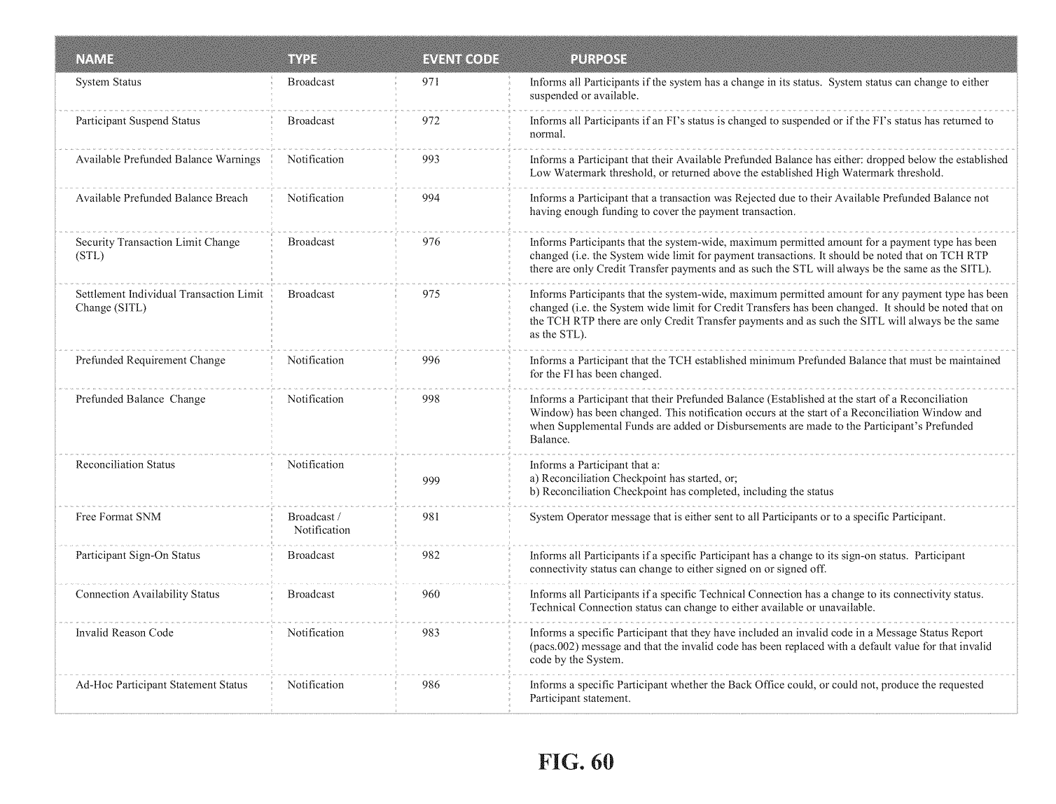

In one embodiment herein, the real time payment system 8010 (e.g., Real Time Payment System or network 130) (“RTP System”) sends information relevant to the operation of the RTP System to Participants via the System Notification Message (SNM) mechanism. There are two types of SNMs: (1) Broadcast SNMs that are sent to all Participants and (2) Notification SNMs that are sent to a specific Participant. The SNM contains the description of the system event being reported and is delivered as an ISO Admi.004 message. An SNM can be generated either by: (i) the RTP System 8010 as a direct result of a system event (e.g., a Technical Connection or an FI becoming unavailable) or as a predefined broadcast message generated by the System Operator (e.g., an Operator of the network 130), or (ii) the System Operator (e.g., an Operator of the network 130) as a free format broadcast message to all Participants or a free format notification message to a specific Participant. An SNM message does not require an SNM Response. SNMs are initially placed on an internal store-and-forward queue, so that they are not lost if there is a connection failure. When there is a route available to send the SNM (which should be there most of the time), the SNM is published to the Participant and then removed from the internal store-and-forward queue. FIG. 60 illustrates various example SNMs that can be utilized by the RTP System 8010. In this regard, when an applicable system event occurs or is detected, this causes the applicable SNM from, for example, FIG. 60 to be generated.

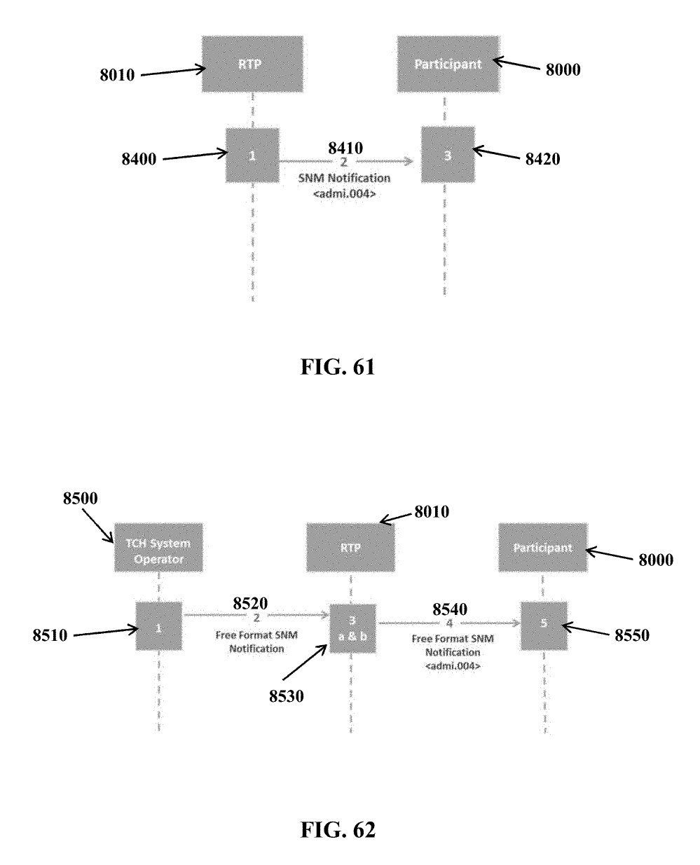

In one example embodiment herein, the real time payment system (“RTP System”) 8010 sends an automated SNM to a Participant 8000. FIG. 61 illustrates an example embodiment of a process for sending an SNM from the RTP System 8010 to the Participant 8000. As shown in FIG. 61, at step 1 (8400), the RTP System 8010 becomes aware that an SNM (admi.004) message has been generated and is available for sending to Participant(s) 8000. In one example embodiment, an SNM (admi.004) message is generated due to (a) a status broadcast that a Participant 8000 is suspended, and/or (b) an administrative message(s). For each Participant 8000, the RTP System 8010: (i) creates an SNM containing the Participant identifier for the Participant receiving the SNM, the event description, and the date and time of issuing the SNM for the Receiving Participant, (ii) cryptographically signs the SNM (admi.004) message, and (iii) logs the outward SNM (admi.004) message in the “Raw Log” in a raw (i.e. unaltered) format. At step 2 (8410), the RTP System 8010 sends the SNM (admi.004) message to the Participant(s) 8000. If for some reason the Participant 8000 cannot be reached, an external queuing delivery mechanism (e.g., IBM MQ) ensures eventual delivery of the message. At step 3 (8420), the Participant 8000 receives the SNM (admi.004) message and performs their SNM received procedures, as appropriate for that particular event description.

In another example embodiment, a System Operator (e.g., a network operator, including a person) manually sends, such as through, for example, a management portal, (i) a SNM to an individual Participant (i.e., a notification SNM) or (ii) a broadcast message to all Participants. FIG. 62 illustrates an example embodiment of a procedure for sending a SNM (either a notification SNM to an individual Participant or a broadcast message to all Participants) from a System Operator 8500 to a Participant(s) 8000. As shown in FIG. 62, at step 1 (8510), the System Operator 8500 creates a free format SNM (admi.004) message (either notification or broadcast SNM) through the System Operator's portal. The free format SNM (admi.004) message (either notification or broadcast SNM) can be created and sent to a Participant(s) 8000 for a variety of reasons, including, for example, to send a notification of a delay in the Reconciliation Window (discussed in more detail below). At step 2 (8520), the System Operator 8500 submits the Free Format SNM (admi.004) message to the real time payment system (i.e., the RTP System 8010). In one example embodiment in which a broadcast SNM is being sent to all Participants 8000, at step 3a (8530), the RTP System 8010 becomes aware that a broadcast SNM has been submitted by the System Operator 8500 and is available to send to Participants 8000. For each directly connected FI and TPSP, the RTP System 8010: (i) creates an SNM (admi.004) message containing the Participant identifier, the event description, and the date and time of issuing the SNM for the Receiving Participant (for each TPSP, a SNM is sent to the TPSP, and the TPSP forwards the SNM to each of its connected FIs), (ii) cryptographically signs the SNM (admi.004) message, and (iii) logs the outward SNM (admi.004) message in the “Raw Log” in a raw (i.e. unaltered) format. Alternatively, in one example embodiment in which a notification SNM is being sent to an individual Participant, at step 3b (8530), the RTP System 8010 becomes aware that a notification SNM (admi.004) message has been submitted by the System Operator 8500 and is available to send to the particular Participant 8000. For this Participant 8000, the RTP System 8010: (i) creates an SNM (admi.004) message containing the Participant identifier, the event description, and the date and time of issuing the SNM for the applicable Participant, (ii) cryptographically signs the SNM (admi.004) message, and (iii) logs the outward SNM (admi.004) message in the “Raw Log” in a raw (i.e. unaltered) format. In either of the embodiments discussed above (i.e., a broadcast SNM or a notification SNM), at step 4 (8540), the RTP System 8010 sends the SNM (admi.004) message to either (i) all Participants 8000 (i.e., a broadcast SNM) or (ii) a specific Participant (i.e., a notification SNM). The broadcast or notification SNM can be sent to the directly connected Participant(s) 8000 via FI's and/or Third Party Service Provider's Technical Connection. If, for some reason, the Participant(s) 8000 cannot be reached, the external queuing delivery mechanism ensures eventual delivery. For example, the external queuing delivery mechanism uses persistent queues that will keep trying to send the broadcast or notification SNM, until the broadcast or notification SNM is delivered to the Participant(s) 8000. Where a notification SNM is for a FI connected to the RTP System 8010 through a TPSP, the SNM is sent to the TPSP endpoint for onward delivery to the FI. In the case of a Broadcast SNM, a single message can be sent to each directly connected Participant 8000. Third Party processors are responsible for sending the broadcast SNM to each of their FIs. At step 5 (8550), the FI(s) (i.e., Participant(s) 8000) receives the SNM (admi.004) message (i.e., broadcast or notification SNM) and performs their SNM received procedures, as appropriate for that particular event description.

### Administrative Messages

Administrative messages can include, by example, the following management messages:
transaction volume type messages:
last message sent, and
unsolicited system messages:
system outage
suspended payments to specific end points
settlement related messages
settlement cycle started
settlement cycle completed
settlement cycle outage
notice of insufficient funding
request for supplemental funding
net settlement position
potential duplicate message
bank indicator to payment system regarding down-time/issues
broadcast message(s)—with capability to send to only a subset of impacted financial institutions
summary archival inquiry
directory of people at financial institutions
unresolved request for payment.
management related information:
transaction volume
unsolicited system messages:
system outage.

At least one or more of the following messaging features, types, contents, functions, and characteristics can be employed in the transaction system 100 herein:
real-time transmission of payment and non-payment messages
non-payment messages support value-added services and administration
all messages include a unique reference ID and sender name
related messages can be linked into complex transactions
messages can carry remittance data and reference to external data and processes for extended functionality
channel indicator (mobile, web, etc.)
currency
type of account—sender (e.g. DDA, trust, prepaid)
foreign payment designator (including, in one embodiment, country of account domicile)
disclosure requirement indicator (e.g., fee disclosure for foreign remittances)
fraud suspect indicator/dynamic risk score (added by network for receiving FIs that use centralized fraud suspect service)
sender discretionary data (optional).

### Administrative Advice Messages

Administration advice messages are used to handle error scenarios that are not covered by other message Request and Response scenarios. Given that Administration Advices can be sent as a result of a message that cannot be parsed or has an incorrect digital signature, they can contain a very limited amount of detailed data. An Administration Advice can be used to, for example, (i) advise a Participant (FI or TPSP) when the real time payment system (e.g., the RTP System 8010) has been unable to verify the Digital Signature of a Request or Response Message, (ii) advise a Participant (FI or TPSP) when the real time payment system has been unable to successfully parse a Request or Response Message, and/or (iii) advise the real time payment system when a Participant (FI) cannot parse an incoming message from the RTP System or when the Digital Signature cannot be verified. In one embodiment, the Administration Advice is sent as an ISO 20022 admi.002 Message and no Response to the message is expected from the receiving party. In all cases where the real time payment system is aware that a signature or schema validation error has occurred, an Alert is raised and a Simple Network Management Protocol (SNMP) event is generated, enabling investigation by a System Operator. In one example embodiment, the Alert is raised and the SNMP event is generated by a core processing system of the real time payment system (see, e.g., core processing system 131 of FIG. 1).

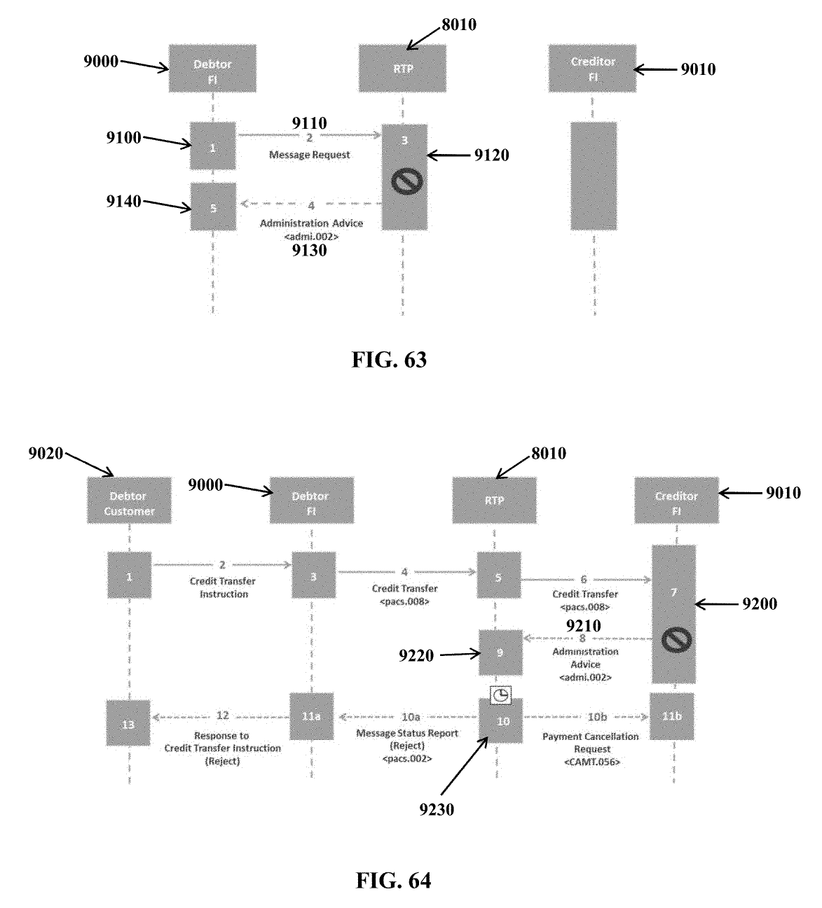

In one example embodiment herein, an Administrative Advice Message is used when a schema validation error occurs. There are generally four different points during the processing of any message where validation of a message may result in failure. These points include: (a) when the real time payment system (the “RTP System”) receives a Message from a Debtor FI, (b) when a Creditor FI receives a Message from the RTP System, (c) when the RTP System receives a Message from a Creditor FI, and/or (d) when a Debtor FI receives a Message from the RTP System. In order to be able to respond appropriately, each condition can be dealt with separately to ensure that a known and manageable position can be maintained. For example, in one example embodiment herein, the RTP System receives a Message Request from a Participant (FI or TPSP) and is unable to perform schema validation. The RTP System creates an Administration Advice (admi.002) message and returns it to the Debtor FI/TPSP, relying only on the knowledge of the Technical Connection on which the Request or Response was received. Since the message cannot be successfully parsed, any data contained in the message is considered suspect. In one example embodiment, schema validation is performed for any messages coming into the RTP System. FIG. 63 illustrates an example embodiment of a procedure in which the real time payment system (“the RTP System” 8010) detects a schema validation error. As shown in FIG. 63, at step 1 (9100), a Debtor FI 9000 generates a request or a response message. At step 2 (9110), the Debtor FI/TPSP 9000 sends the request or response message to the RTP System 8010, abiding by predetermined operating criteria, via the Debtor FI's technical connection to the RTP System 8010 (this may be done by the Debtor FI or on behalf of a Debtor FI by a Third Party Service Provider (TPSP) that is responsible for the message protocol, Technical Connection, or both). At step 3 (9120), the RTP System 8010 receives the Request or Response message and (i) logs the inward Request or Response message in the “Raw Log” in a raw (i.e. unaltered) format, and (ii) validates the Request or Response message for syntactical correctness in accordance with predetermined operating criteria. In the example embodiment of FIG. 63, the RTP System 8010 is unable to syntactically verify the Request or Response message and (i) generates an Administration Advice (admi.002) message, (ii) generates a rejection reason code for a syntax validation error, (iii) inserts the entire received message into an Administration Advice (admi.002) message, which further may include the rejection reason code (iv) cryptographically signs the outward Administration Advice message that is formed, and (v) logs the outward Administration Advice (admi.002) message in the “Raw Log” in a raw (i.e. unaltered) format. At step 4 (9130), the RTP System 8010 sends the Administration Advice (admi.002) message to the original Debtor FI/TPSP 9000, and, at step 5 (9140), the original Debtor FI/TPSP 9000 receives the Administration Advice (admi.002) message and takes the appropriate action, depending on whether the message being returned was a Request or a Response and applicable operating criteria. The original Debtor FI 9000 can conduct an investigation into the reason for the Administration Advice message and take remedial actions.

In another example embodiment herein, a Creditor FI 9010 receives an Unrecognizable Message from the RTP System 8010 (i.e., a Credit Transfer Scenario). In this example embodiment, the Creditor FI/TPSP 9010 receives a message from the RTP System 8010 and is unable to perform schema validation. The Creditor FI/TPSP 9010 discards the received message and sends an Administration Advice (admi.002) message back to the RTP System 8010. In this example embodiment, where the original message was a Credit Transfer (pacs.008) message, the normal timeout processes for a pacs.008 message applies. If the RTP System 8010 does not receive the expected pacs.002 response message from the Creditor FI/TPSP 9010, the RTP System 8010 follows the standard time-out process for a pacs.008 message, as described above. FIG. 64 illustrates one example embodiment of process in which a Creditor FI 9010 detects a schema validation error. In the embodiment of FIG. 64, steps (1) through (6) are performed in accordance with the Credit Transfer (pacs.008) message flow discussed above (see also, e.g., step 201 (step 1 of FIG. 64), step 202 (step 2 of FIG. 64), steps 203-205 (step 3 of FIG. 64), step 206 (step 4 of FIG. 64), steps 210-225 (step 5 of FIG. 64), and step 226 (step 6 of FIG. 64) shown in, for example, FIG. 2). At step 7 (9200), the Creditor FI/TPSP 9010: (i) receives the Credit Transfer (pacs.008) message from the RTP System 8010, (ii) validates the Credit Transfer (pacs.008) message for syntactical correctness (in this example embodiment, it fails), (iii) generates an Administration Advice (admi.002) message, (iv) generates a rejection reason code for a syntax validation error, (v) inserts the entire received message into an Administration Advice (admi.002) message, and (vi) cryptographically signs the Administration Advice (admi.002) message that is formed. At step 8 (9210), the Creditor FI/TPSP 9010 sends the Administration Advice (admi.002) message to the RTP System 8010. At step 9 (9220), the RTP System 8010 receives the Administration Advice (admi.002) message and (i) logs the inward Administration Advice (admi.002) message in the “Raw Log” in a raw (i.e. unaltered) format, (ii) validates the Administration Advice (admi.002) message for syntactical correctness in accordance with predetermined operating criteria, (iii) validates the Administration Advice (admi.002) message for cryptographic correctness (e.g., Digital signature), and (iv) generates an SNMP trap and event to record a schema validation error detected by a Creditor FI (this is done to enable a System Operator investigation of the error). At step 10 (9230), the original Pacs.008 message is then timed out, as no Pacs.002 response message has been received within a predetermined time period, and the RTP System 8010 completes time-out processing (i.e., steps 10a, and 10b to 13) in accordance with the time-out processing described above (see also, e.g., step 251 (steps 10a/11a of FIG. 64), step 253 (step 10b of FIG. 64), step 254 (step 11b of FIG. 64), step 256 (step 12 of FIG. 64), and step 215 (step 13 of FIG. 64) shown in, for example, FIGS. 3 and 12).

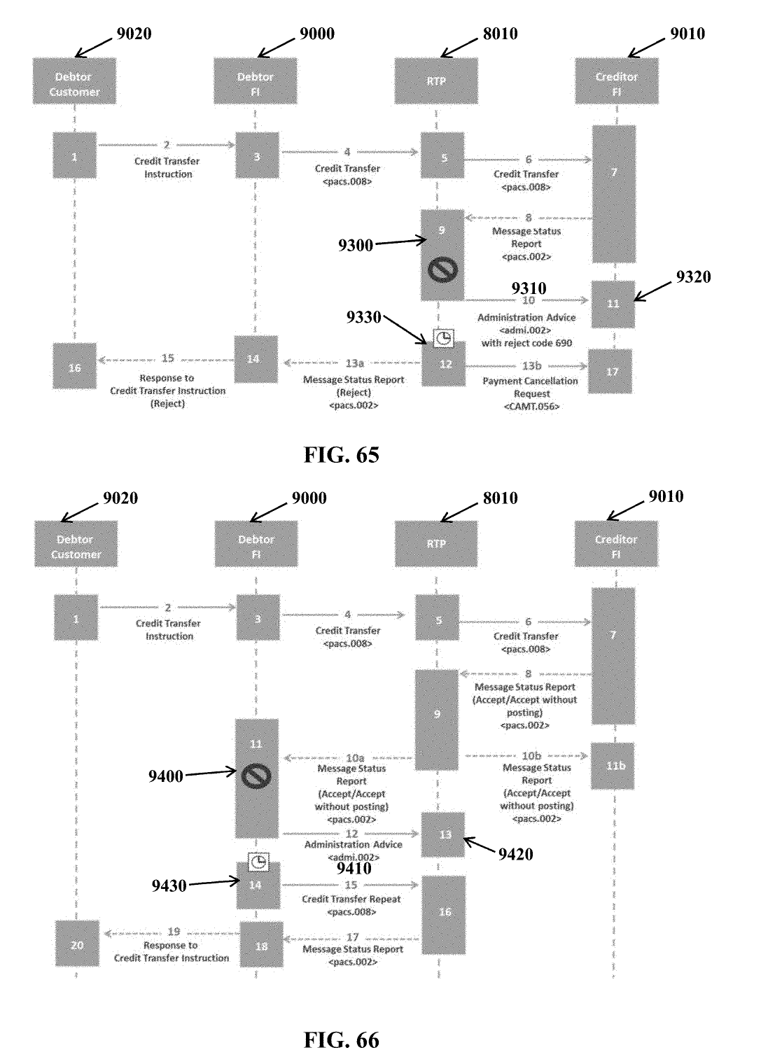

In another example embodiment, the RTP System 8010 receives an Unrecognizable Message from a Creditor FI (i.e., a Credit Transfer Scenario). In this embodiment, the RTP System 8010 receives a message from the Creditor FI/TPSP 9010 and is unable to perform schema validation. The RTP System 8010 sends an Administration Advice (admi.002) message to the Creditor FI/TPSP 9010 in response to that message, in an attempt to validate the message syntax of, for example, a Payment Status Report (pacs.002) message and/or a Response to a Payment Transfer message. In one example embodiment, the RTP System 8010 attempts to validate the message syntax of the particular message, while a core processing system of the RTP System performs, for example, a trusted source and/or format checking (see, e.g., core processing system 131 of FIG. 1). In one specific example, the RTP System 8010 times-out the original Unrecognizable Message (e.g., a pacs.008 message) resulting in, for example, a Payment Cancellation (camt.056) message being sent by the RTP System 8010 to the Creditor FI/TPSP 9010. The Creditor FI/TPSP 9010 treats the Payment Cancellation (camt.056) message as it would for a standard pacs.008 message time-out scenario (see, e.g., FIGS. 3 and 12 and applicable description above). The RTP System 8010 also sends a Message Status Report (pacs.002) message with a time-out rejection reason code to the Debtor FI/TPSP 9020. FIG. 65 illustrates one example embodiment of a process in which the real time payment system (“the RTP System” 8010) detects a schema validation error from a Creditor FI 9010. In the example embodiment of FIG. 65, steps (1) through (8) are performed in accordance with the Credit Transfer flow discussed above (see also, e.g., step 201 (step 1 of FIG. 65), step 202 (step 2 of FIG. 65), steps 203-205 (step 3 of FIG. 65), step 206 (step 4 of FIG. 65), steps 210-225 (step 5 of FIG. 65), and step 226 (step 6 of FIG. 65) shown in, for example, FIGS. 2 and 11). At step 9 (9300), the RTP System 8010 receives a Message Status Report (pacs.002) message from the Creditor FI 9010 (see, e.g., steps 245-247 of FIGS. 2 and 11), and (i) logs the inward Message Status Report (pacs.002) message in the “Raw Log” in a raw (i.e. unaltered) format and (ii) validates the Message Status Report (pacs.002) message for syntactical correctness in accordance with predetermined operating criteria. In this example embodiment, the message fails. Accordingly, the RTP System 8010 creates an Administration Advice (admi.002) message in accordance with predetermined operating criteria, and (i) generates a rejection reason code for a schema validation error, (ii) inserts the entire received message into an Administration Advice (admi.002) message, (iii) cryptographically signs the Administration Advice (admi.002) message that is formed, and (iv) logs the outward Administration Advice (admi.002) message in the “Raw Log” in a raw (i.e. unaltered) format. At step 10 (9310), the RTP System 8010 sends the Administration Advice (admi.002) message to the Creditor FI/TPSP 9010. At step 11 (9320), the Creditor FI/TPSP 9010 receives the Administration Advice (admi.002) message and can perform a remedial procedure according to predetermined operating criteria. At step 12 (9330), the RTP System 8010 times out the original pacs.008 (i.e., the original Credit Transfer message) as no pacs.002 response (i.e., Message Status Report) is deemed to have been received and the RTP System 8010 completes time out processing (i.e., steps (13a) through (17)) as described above (see also, e.g., step 251 (steps 13a/14 of FIG. 65), step 253 (step 13b of FIG. 65), step 254 (step 17 of FIG. 65), step 256 (step 15 of FIG. 65), and step 215 (step 16 of FIG. 65) shown in, for example, FIGS. 3 and 12).

In another example embodiment herein, a Debtor FI 9010 receives an Unrecognizable Message from the RTP System 8010 (i.e., a Credit Transfer Scenario). In this embodiment, the Debtor FI/TPSP 9000 receives a message from the RTP System 8010 and is unable to perform schema validation. The Debtor FI/TPSP 9000 discards the received message and performs a predetermined “Unable to parse Payment status Response” process. In this example embodiment, an original Credit Transfer (pacs.008) message sent by the Debtor FI/TPSP 9000 (see, e.g., FIGS. 2 and 11) times out (e.g., at the debtor FI) and the Debtor FI/TPSP 9000 can send a Repeat Credit Transfer message in order to process the payment. The RTP System 8010 processes the repeat transaction as discussed above. FIG. 66 illustrates an example embodiment of a process in which an Original Debtor FI 9000 detects a schema validation error from the real time payment system (“the RTP System” 8010). In the embodiment of FIG. 66, steps (1) through (10) are performed in accordance with the Credit Transfer (pacs.008) message flow discussed above (however, if there is a duplicate sent by a debtor FI, a duplicate flag/indicator that is used) (see also, e.g., step 201 (step 1 of FIG. 66), step 202 (step 2 of FIG. 66), steps 203-205 (step 3 of FIG. 66), step 206 (step 4 of FIG. 66), steps 210-225 (step 5 of FIG. 66), step 226 (step 6 of FIG. 66), steps 227 and 243 (step 7 of FIG. 66), step 247 (step 8 of FIG. 66), steps 236 and 238 (step 9 of FIG. 66), and steps 235 and 239 (steps 10a/10b of FIG. 66) shown in, for example, FIGS. 2 and 12). At step 11 (9400), the Debtor FI 9000 receives a Message Status Report (pacs.002) message from the RTP System 8010 (see, e.g., steps 235 and 239 of FIGS. 2 and 11) and (i) logs the inward Message Status Report (pacs.002) message in the “Raw Log” in a raw (i.e. unaltered) format, (ii) validates the Message Status Report (pacs.002) message for syntactical correctness in accordance with predetermined operating criteria, (iii) generates an Administration Advice (amdi.002) message, (iv) generates a rejection reason code for a syntax validation error, and (v) inserts the entire received message into an Administration Advice (admi.002) message. In another example embodiment herein, in cases where the Debtor FI 9000 can read the pacs.002 message, no admi.002 message is sent.

At step 12 (9410), the Debtor FI 9000 sends the Administration Advice (admi.002) message that is formed to the RTP System 8010. At step 13 (9420), the RTP System 8010 receives the Administration Advice (admi.002) message and (i) logs the Administration Advice (admi.002) message in the “Raw Log” in a raw (i.e. unaltered) format, (ii) validates the Administration Advice (admi.002) message for syntactical correctness, (iii) validates the Administration Advice (admi.002) message for cryptographic correctness (e.g., Digital Signature), and (iv) issues an SNMP trap and generates an event to record a schema validation error detected by a Debtor FI for investigation by the System Operator. At step 14 (9430), the Debtor FI 9000 times out the original pacs.008 message (i.e., the original Credit Transfer message) as no pacs.002 response (i.e., Message Status Report) is deemed to have been received and submits a repeat transaction, in accordance with time-out processing (i.e., steps (15) to (20)) as described above (see also, e.g., step 206 (step 15 of FIG. 66), steps 210-225 (step 16 of FIG. 66), steps 234 and 239 (step 17 of FIG. 66), step 235 (steps 18 and 19 of FIG. 66), and step 215 (step 20 of FIG. 66) shown in, for example, FIG. 2).

In one example embodiment herein, an Administrative Advice Message is used when a signature validation error occurs. There are generally four different points during the processing of any message where the Signature Validation of a message may result in failure. These points include: (a) when the RTP System receives a message from the Debtor FI, (b) when the Creditor FI receives a message from the RTP System, (c) when the RTP System receives a message from the Creditor FI, and/or (d) when the Debtor FI receives a message from the RTP System.

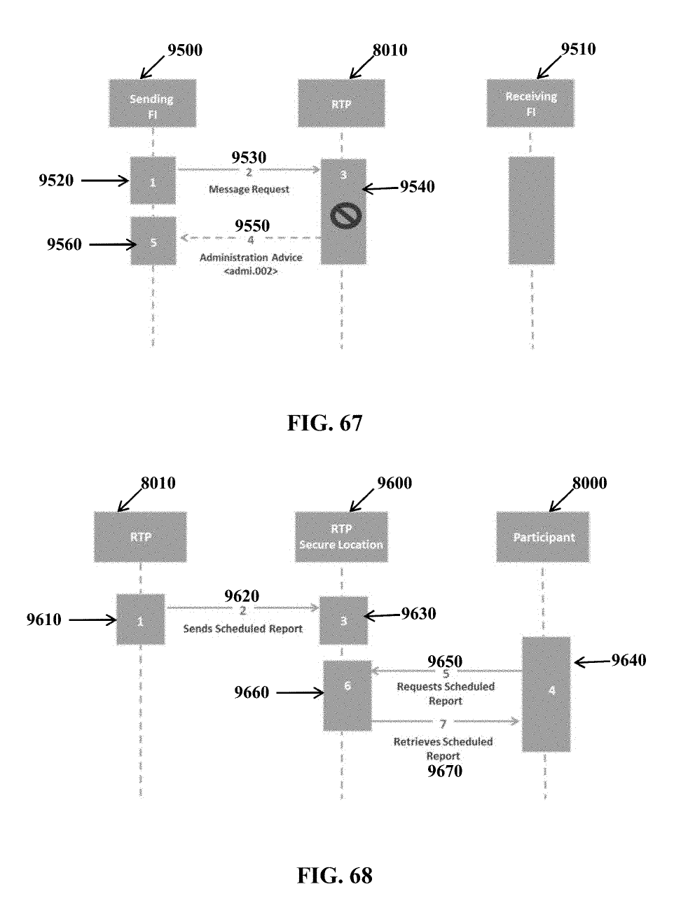

In one example embodiment herein, the RTP System 8010 receives an Unverifiable Signature from a Sending Participant 8000. In this example embodiment, the RTP System 8010 receives a Message Request (e.g., pacs.008) from a Participant 8000, but is unable to perform Signature Verification. The RTP System 8010 creates an Administration Advice (admi.002) message and returns the message to the original Sending Participant 8000. FIG. 67 illustrates one example embodiment of a process in which the real time payment system (“the RTP System” 8010) detects a Signature Validation Error. As shown in FIG. 67, at step 1 (9520), the Sending FI 9500 receives a Message instruction from a customer and prepares a Message Request or a Message Response to be sent to the RTP System 8010. In one example embodiment, a Message Request or Message Response is prepared in response to any type of Message instruction received from a customer. At step 2 (9530), the Sending FI 9500 or TPSP (on the FI's behalf) sends the prepared Message Request or Message Response to the RTP System 8010, using a predetermined message format and protocol. At step 3 (9540), the RTP System 8010 receives the Message Request or Response and (i) logs the Message Request or Response in the “Raw Log” in a raw (i.e. unaltered) format, (ii) validates the Message Request or Response for syntactical correctness, and (iii) validates the Message Request or Response for cryptographic correctness (Digital Signature). In the example embodiment of FIG. 67, the RTP System 8010 is unable to verify the Signature of the Message Request or Response. Thereafter, the RTP System 8010 (i) generates an Administration Advice (admi.002) message, (ii) generates a rejection reason code for a signature validation error, (iii) inserts the entire received message into an Administration Advice (admi.002) message, (iv) cryptographically signs the Administration Advice (admi.002) message that is formed, and (v) logs the outward Administration Advice (admi.002) message Response in the “Raw Log” in a raw (i.e. unaltered) format. At step 4 (9550), the RTP System 8010 sends the Administration Advice (admi.002) message to the Participant 9500 (FI or TPSP) that sent the message, and, at step 5 (9560), the Sending Participant 9500 (FI or TPSP) receives the Administration Advice (admi.002) message and takes the appropriate action, depending on whether the message being returned was a Message Request (e.g., for Sending Participants) or a Message Response (e.g., for Receiving Participants). The Sending Participant 9500 can conduct an investigation into the reason for the Administration Advice message.

In another example embodiment herein, a Receiving Participant receives an Unverifiable Signature from the RTP System. In this embodiment, the Receiving Participant receives a Credit Transfer (pacs.008) message from the RTP System, but the Receiving Participant is unable to validate the signature. The Receiving Participant returns an Administration Advice (admi.002) message (indicating rejection due to signature verification error) to the RTP System. The remainder of the transaction flow is identical to the flow and description above for the schema validation error (see, e.g., steps 7-13 of FIG. 64).

In another example embodiment herein, the RTP System receives an Unverifiable Signature from a Creditor FI (i.e., a Credit Transfer Message Scenario). In this example embodiment, the RTP System receives a message from the Creditor FI/TPSP, but is unable to validate the Signature. The RTP System sends an Administration Advice (admi.002) message to the Creditor FI/TPSP. In the example of a Credit Transfer (pacs.008) message, the RTP System then times-out the original Credit Transfer (pacs.008) message and sends a Payment Cancellation (camt.056) message to the Creditor FI/TPSP (in addition to the Administration Advice message). The Creditor FI/TPSP treats the Payment Cancellation message as it would a normal pacs.008 message time-out scenario. Also, the RTP System sends a Message Status Report (pacs.002) message with a Signature Validation rejection reason code to the original Debtor FI/TPSP. The transaction flow is identical to the flow and description above for the schema validation error (see, e.g., steps 9-16 of FIG. 65).

In yet another example embodiment herein, a Debtor FI receives an Unverifiable Signature from the RTP System (i.e., a Credit Transfer Scenario). In this example embodiment, the Debtor FI/TPSP receives a message from the RTP System, but the Debtor FI/TPSP is unable to perform Signature Verification. The Debtor FI/TPSP discards the received message and performs a predetermined “Unable to Verify Signature on Payment Status Response” process, including sending an Administration Admin (admi.002) message to the RTP System. In a Credit Transfer message scenario, the Credit Transfer (pacs.008) message from the Debtor FI/TPSP has been processed by the Creditor FI, and the Creditor FI has sent a Message Status Report (pacs.002 message) to the RTP System. However, the Debtor FI/TPSP is unable to perform Signature Verification on a Message Status Report (pacs.002 message) sent from the RTP System to the Debtor FI/TPSP. In such a case, the original Sending Participant (Debtor FI/TPSP) may, if they choose, send a repeat Credit Transfer (pacs.008) message. The transaction flow is identical to the flow and description above for the schema validation error (see, e.g., steps 11-20 of FIG. 66).

### Bulk Messaging

In an example embodiment herein, bulk messages can be employed. By example, low value, urgent payments can be aggregated and sent together for convenience and efficiency (e.g., this can be useful in scenarios such as payments of temporary employee wages, emergency disbursements, etc.). The bulking functionality can be performed at a FI level at the network 130, or in other elements of the transaction system 100.

### Payment Scenario Contexts

The methods and system described herein can be employed to conduct real-time payments in many different scenarios. By example, they can be employed in a business to person context, such as, for example, to pay employee wages, emergency payroll to temporary or full time staff, emergency cash advances, urgent business to consumer contexts (e.g., disaster relief, completing a supply chain event in a last minute purchase order, avoiding consequences of a non-payment event), complaint resolution for disputing charges/services with or without corporate disbursements, patient and/or provider billing of medical and/or healthcare bills, payment of student loans, to issue refunds to consumer, small check settlement, net metering or green farming to issue energy credits to consumers, retirement rollovers, timely trade processing, etc. Other examples may involve high value ad hoc payments such as large, one-time payments (e.g., insurance claims, legal settlements, etc.), or low value ad hoc payments (e.g., small one-time payments (e.g., temporary employee wages, emergency payroll, insurance premium payments, etc.)). Payments can be made available within a predetermined amount of time (e.g., within minutes, hours, etc.). Payments can also be recurring with or without a prearranged payment amount. Payments can also be made between the government and a consumer (e.g., taxes, fines, license registration/renewals, emergency funding to disaster victims, vendor/supplier payments, social security, welfare, and/or other entitlements payments, student loans, etc.)

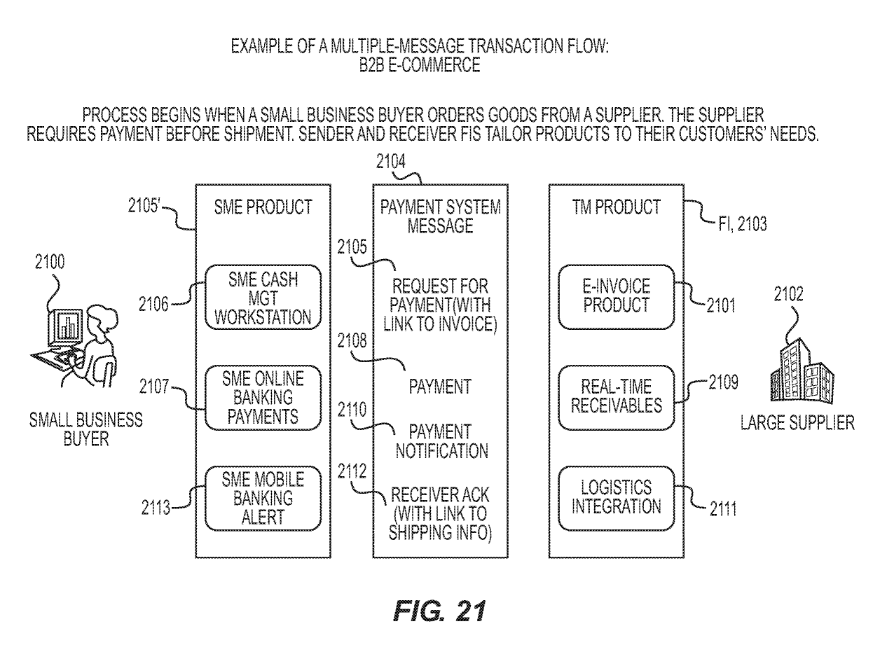

FIG. 21 is an example of an application/scenario for the payment system described herein. In this example, a small business (small market entity) 2100 desires to order goods from a supplier 2102. The small business 2100 may electronically send a purchase order (“P.O.”) for the desired goods to the seller or supplier 2102 via payment system 2104 (which can include, for example, network 130). The supplier 2102 can decline the received purchase order. Alternatively, in response to the received purchase order, the supplier 2102, by way of its FI 2103, forwards an electronic invoice 2101 to payment system 2104 (which can include, for example, network 130) which then provides a request for payment message 2105 that, in one example embodiment herein includes a link to the invoice and/or the purchase order, to a FI 2105′ associated with the small business 2100. In one example embodiment herein, the message 2105 is received at a cash management workstation 2106. In response to the message, the FI 2105′ generates a payment transaction 2108 to pay the amount requested in the invoice 2101 (e.g., the payment transaction 2108 can be generated in response to a request from the buyer 2100 using an online banking platform 2107), and the payment transaction 2108 is provided to the system 2104 and then forwarded to the FI 2103, such as at a real time receivables module 2109. The FI 2105′ also can generate a payment notification 2110 which is provided by way of the system 2104 to a logistics integration module 2111 of FI 2103, which then responds by forwarding an acknowledgement (ACK) message (e.g., payment acknowledgement message) 2112 that, in one example embodiment herein, includes a link to shipping information relating to the purchased items. The message 2112 is provided by way of the system 2104 to the FI 2105, where, in the illustrate example, it is received at a mobile banking alert module 2113, which can then notify the buyer 2100 that the payment was acknowledged. In one example embodiment herein, a minimum standard authenticated application programming interface (API) can be used to plug-in to any business software (e.g., e-commerce, ARP, etc.) employed herein. The authenticated API allows for both the buyer and seller (i.e., supplier) to enter the payment system (i.e., network 130) efficiently, while ensuring secure authentication of the users within the system. Benefits of the authenticated API include, for example, simplified vendor/customer workflows, maximization of data access, integration of payments in the business process (e.g., delivery of goods, e-commerce purchase), allowing small business access to the payment system, forming a foundation for addition plug-ins and/or innovations, safer environment via a secure authentication which can build trust between participants, and/or allowing for flexibility for future development.

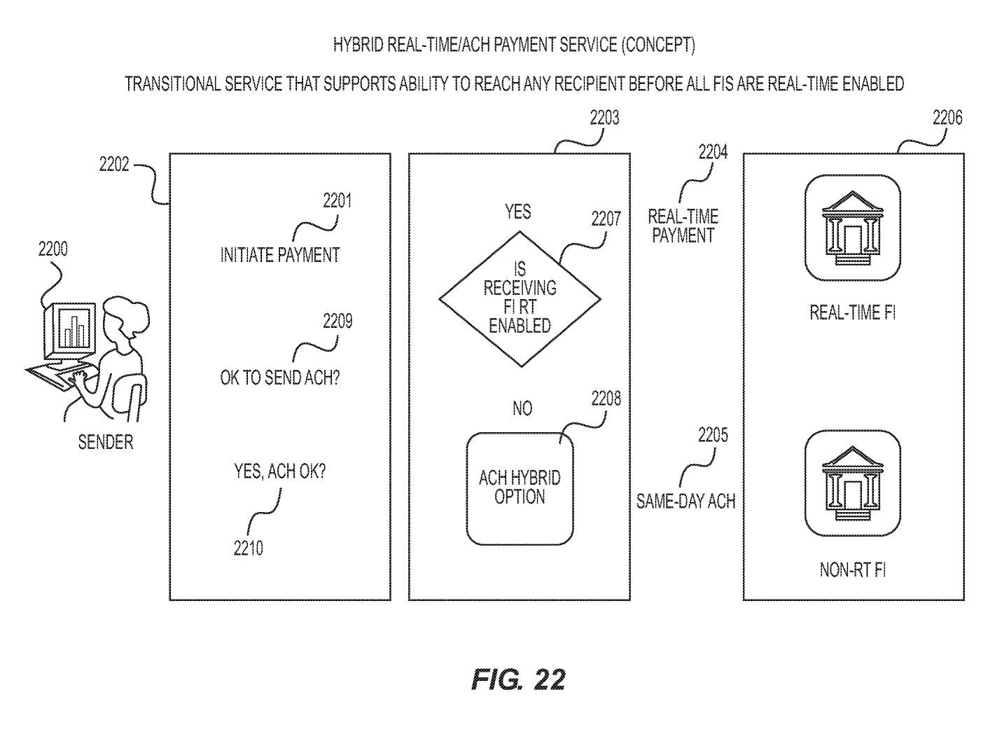

FIG. 22 shows an example of a hybrid real time payment procedure.

That procedure determines whether a receiving FI 2206 is subscribed for participating in the real time payment service, and can involve similar procedures such as those relating to steps 429-431 of FIG. 4. In FIG. 22, a sender 2200 initiates a payment transaction 2201 via a FI 2202, which then provides the transaction 2201 to the payment network 2203 (which can include network 130), which then determines whether a receiving FI 2206 identified in the transaction 2201 has subscribed to real time payments service (e.g., this can be performed by correlating an identifier of the FI included in the transaction 2201 with corresponding information stored in the network 2203 indicating whether the receiving FI 2206 is subscribed). If it is determined that the receiving FI 2206 has subscribed to the service (“Yes” in step 2207), then a real time payment transaction 2204 is provided to the FI 2206. On the other hand, in a case where it is determined that the receiving FI 2206 is not subscribed to the service (“No” in step 2207), then a hybrid option 2208 is performed where the network 2203 communicates a message 2209 to the FI 2202 inquiring as to whether the payment transaction 2201 can be forwarded to the receiving FI 2206 via an alternate payment method. Where such a transaction is approved (e.g., this may occur in response to FI 2202 receiving an approval from sender 2200, which is notified of the query by FI 2202), an approval message 2210 is provided from the FI 2202 to the network 2203, which then provides payment message 2205 to the receiving FI 2206 by the alternate method (e.g., in one example this is performed on the same day as when the payment was initiated, using a conventional ACH transaction).

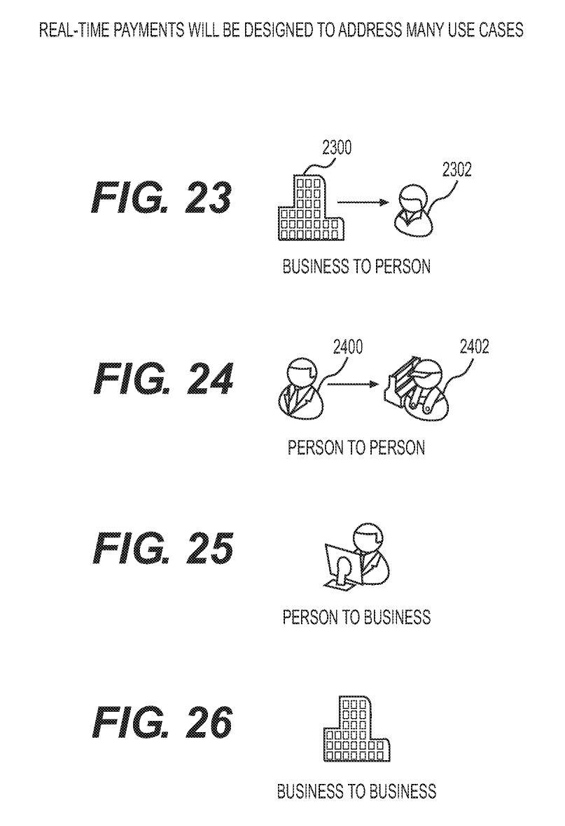

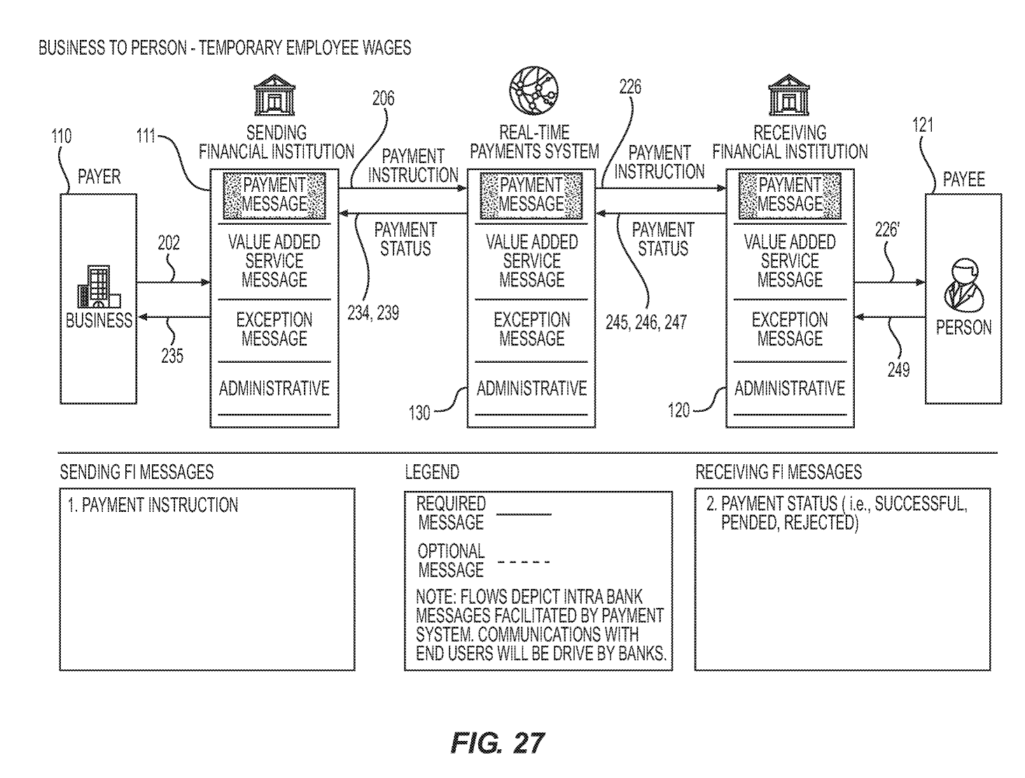

FIG. 23 represents a business 2300 to person 2302 scenario. FIG. 27 represents another example of a business to person context, such as a case where a payment is made of a temporary employee's wages. For example, a payment request like that described above in connection with step 202 of FIG. 2 is provided from a payer station 110 to FI 111 (step 202), which FI 111 then generates a payment instruction in step 206 and provides it to the real time payment system 130. The real time payment system 130 then provides a payment instruction in step 226 to FI 120, which then can notify payee (or creditor) station 121 of the status of the payment (e.g., via text message, email, an online message or other form of communication) (see step 226′). The station 121 can then acknowledge receipt of that notification (step 249) to the FI 120, which then sends to the debtor FI 111 an indication of the payment status (e.g., a rejection or negative status indication in step 245, a pending status indication in step 246, or an accept status indication in step 247). The real time payment system 130 then provides an indication of the status (e.g., a rejection in the case of step 234 or an accepted or pending status in the case of step 239) to the FI 111, which can then send an indication of that status to the debtor station 110 (step 235).

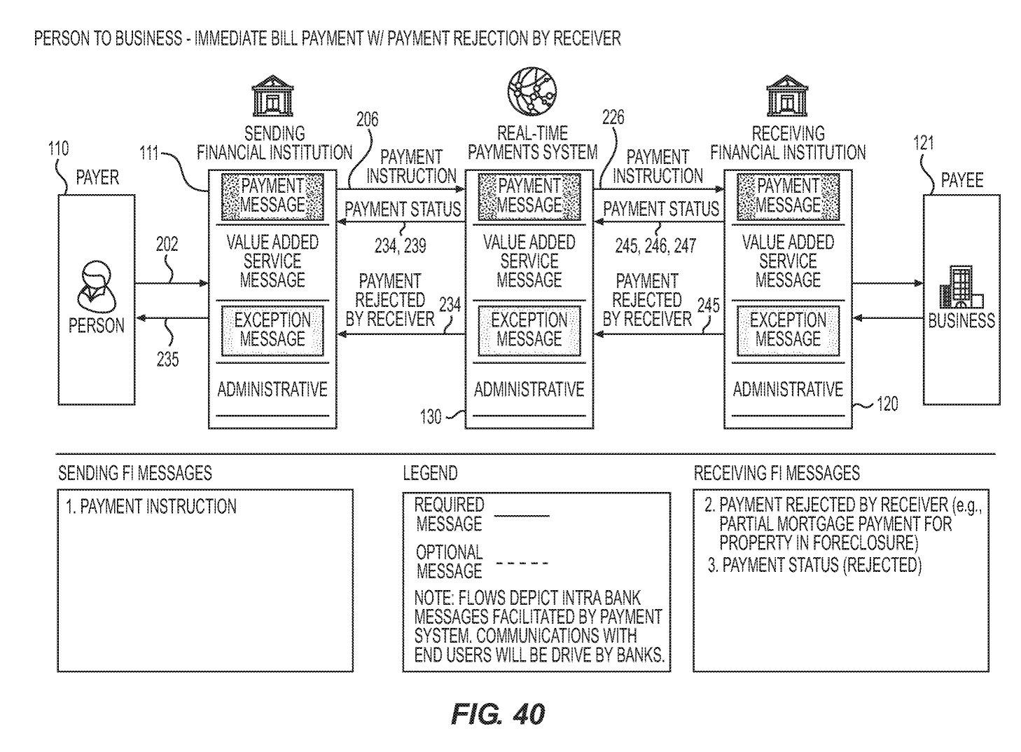

FIG. 40 shows the same elements as those represented in FIG. 27 (for convenience, those elements are not repeated again here), and also represents a process for rejecting a payment instruction. For example, after deciding to reject a payment instruction (such as in the manner described for step 243 of FIG. 2), the creditor FI 120 issues a payment rejected message to the network 130 in step 245, and the network 130 then forwards that message to the debtor FI 111 in step 234.

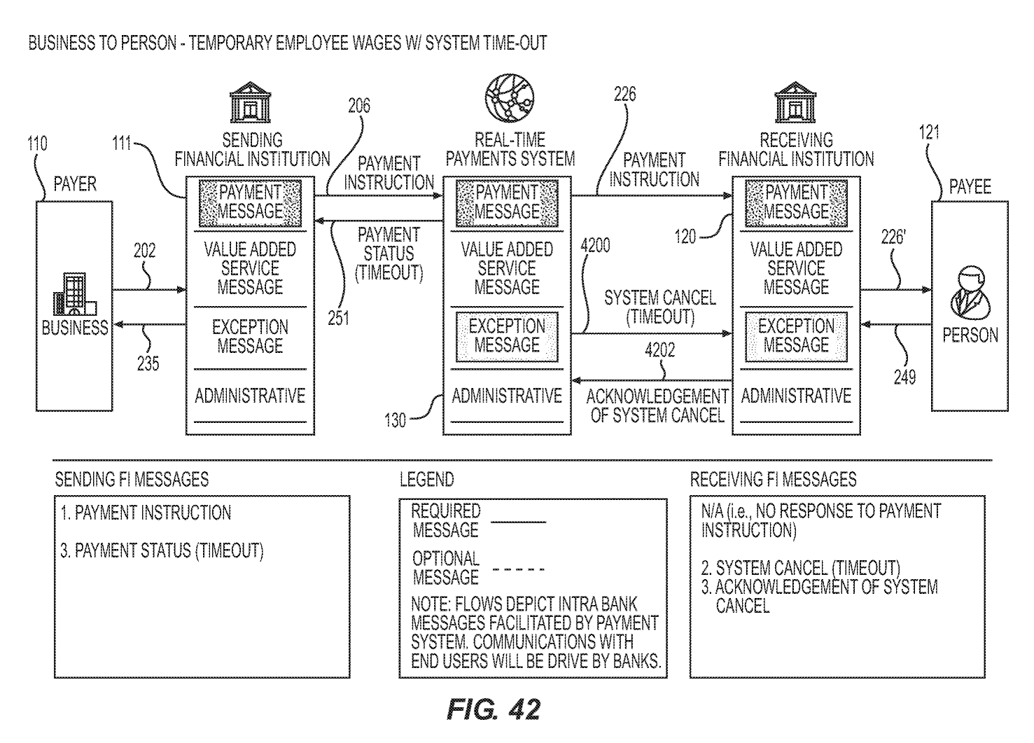

FIG. 42 shows an example where timeouts are employed with regard to payment instructions. This is example shows a business to person scenario in the context of a payment for temporary employee wages (although of course this example is not limiting). This example includes steps 206 and 226 as described above for FIG. 27. After sending the payment instruction in step 226, the network 130 determines that it has not received a response (e.g., such as a pacs.002 or remt.001 message) thereto within a predetermined time period (see, e.g., step 252 of FIG. 2), and thus detects a timeout. As a result, the network 130 forwards a payment status time-out message to the debtor FI 111 (step 251), which then can provide a payment reject message to the debtor station 110. Also in response to detecting the timeout, the network 130 sends a system cancel (timeout) message to the creditor FI 120 (step 4200), which then sends back an acknowledgement of that message to the network 130 in step 4202.

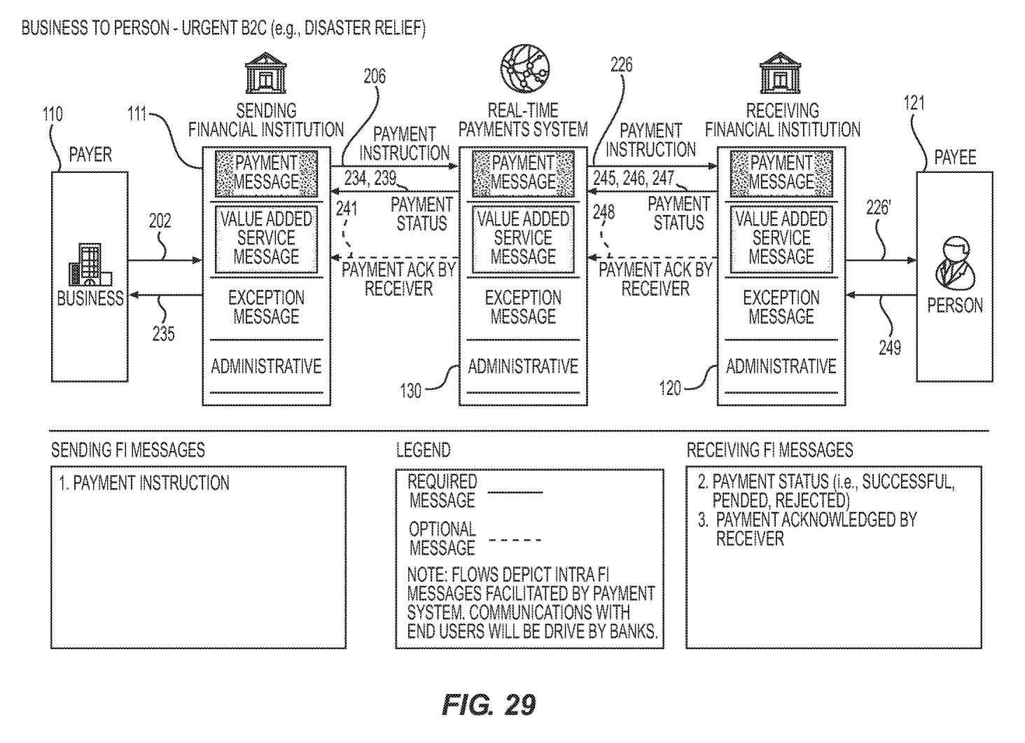

FIG. 29 is another example representation of a business to person scenario, such as, for example, an urgent disaster relief payment process. FIG. 29 shows the same steps as those described above for FIG. 27 (although for convenience they are not further repeated here) for making a payment. In addition, the figure represents that payee station 121 can optionally provide an acknowledgement to the real time payment system 130, indicating that the payment instruction provided in step 226 was received (step 248). The real time payment system 130 then provides the acknowledgement to the debtor station 110 in step 241. Steps 241 and 248 are like those of FIG. 2.

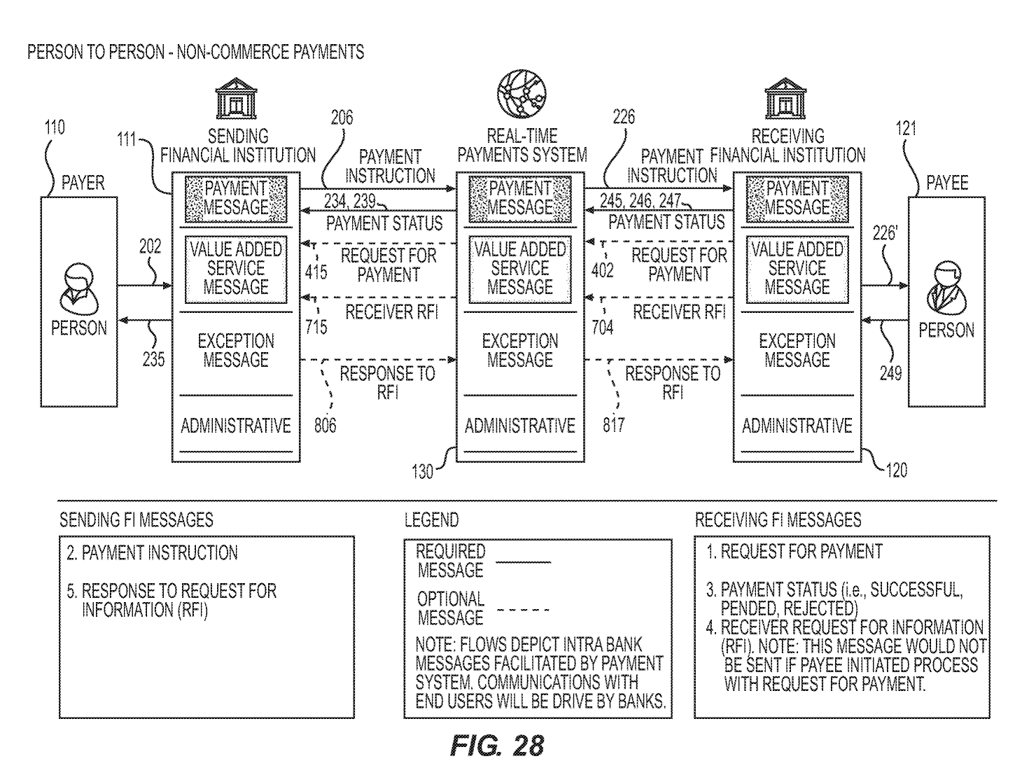

As another example, the methods and system described herein can be employed to conduct real-time payments in a person to person context. By example only, they can be employed to effect non-commerce payments (e.g., rent payments to a roommate, shared payments between friends or colleagues, emergency funds for a child or family member, cross-border payments, etc.), to perform urgent Account-to-Account transfers (e.g., to fund investments or purchases), to pay for informal services (e.g., babysitting, lawn care, etc.), and the like. Payments can be made available within a predetermined amount of time (e.g., within seconds, minutes, etc.). FIG. 24 represents a person 2400 to person 2402 scenario. FIG. 28 also represents a person to person context for non-commerce payments, and shows the same steps as those described above for FIG. 27 (although for convenience they are not further repeated here) for making a payment, but in a person to person context. In addition, the figure represents that payee station 121 can optionally request that the payment be paid, in which case a request for payment is provided from creditor FI 120 to the real time payment system 130 in step 402, and the real time payment system 130 responds by providing a corresponding request for payment to the debtor FI 111 in step 415. Steps 402 and 415 are like those of FIG. 4. Also, the payee station 121 can optionally request information (e.g., inquiring as to an invoice, or the purpose of a payment, etc.), in which case a request for information is provided from creditor FI 120 to the real time payment system 130 in step 704, and the real time payment system 130 responds by providing a corresponding request for information to the debtor FI 111 in step 715. Steps 704 and 715 are like those of FIG. 7. The debtor FI 111 then can provide the requested information in a response in step 806, to the real time payment system 130 (step 806), and the real time payment system 130 can then provide the information to the creditor FI 120 in step 817. Steps 806 and 817 are like those of FIG. 8. In one example embodiment herein, an alias directory can be employed, where, before a payment is made, the debtor station 110 (and payer) is presented with the name of the payee before deciding whether or not to make the payment. This can help prevent accidental payments and keying errors. The name can be an actual name or an alias of the actual name.

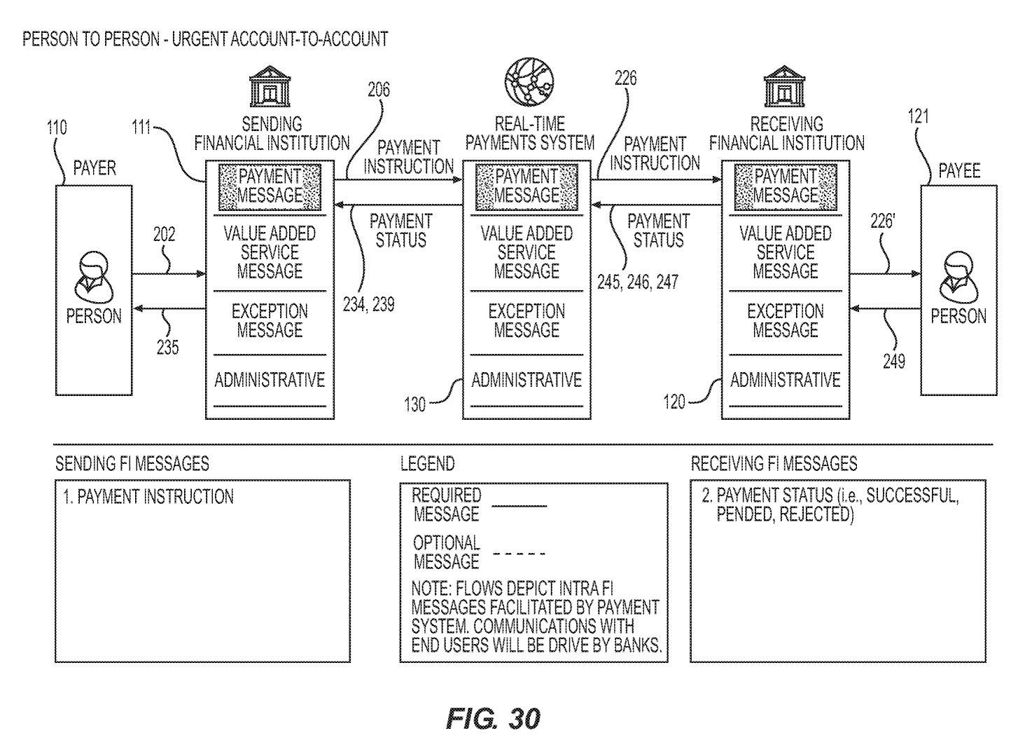

FIG. 30 represents a further example of a person to person context, such as a case where an urgent account-to-account payment is made. For example, a payment request like that described above in connection with step 202 of FIG. 2 is provided from a payer station 110 to FI 111 (step 202), which FI 111 then generates a payment instruction in step 206 and provides it to the real time payment system 130. The real time payment system 130 then provides a payment instruction in step 226 to FI 120, which then can notify payee (or creditor) station 121 of the status of the payment (e.g., via text message, email, an online message or other form of communication) (see step 226′). The station 121 can then acknowledge receipt of that notification (step 249) to the FI 120, which then sends to the real time payment system 130 an indication of the payment status (e.g., a rejection or negative status indication in step 245, a pending status indication in step 246, or an accept status indication in step 247). The real time payment system 130 then provides an indication of the status (e.g., a rejection in the case of step 234 or an accepted or pending status in the case of step 239) to the FI 111, which can then send an indication of that status to the debtor station 110 (step 235).

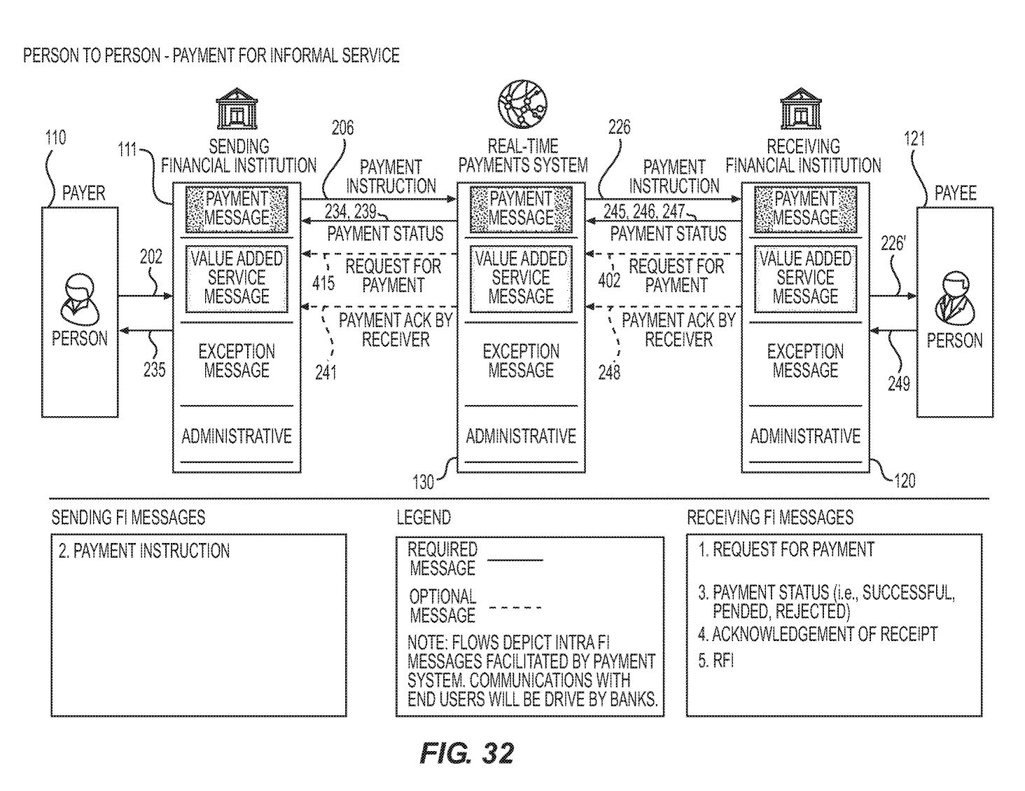

FIG. 32 represents still a further person to person context, such as for payment for an informal service. FIG. 32 shows the same steps as those described above for FIG. 27 (although for convenience they are not further repeated here) for making a payment, but in a person to person context. In addition, the figure represents that payee station 121 can optionally request that the payment be paid, in which case a request for payment is provided from creditor FI 120 to the real time payment system 130 in step 402, and the real time payment system 130 responds by providing a corresponding request for payment to the debtor FI 111 in step 415. Steps 402 and 415 are like those of FIG. 4. Also, the FI 120 can optionally provide an acknowledgement that the payment was received, to the real time payment system 130, in step 248, wherein the real time payment system 130 can then provide the acknowledgement to the FI 111 in step 241. Steps 241 and 248 are like those of FIG. 2.

As another example, the methods and system described herein can be employed to conduct real-time payments in a person to business context. By example only, they can be employed to conduct immediate bill payments with acknowledgments or receipts, to perform e-commerce purchases, and the like. Payments in this context may be time critical, such as, for example, stock purchases, last minute bill payments for utility services, credit cards, insurance, etc., emergency bill payments to prevent, for example, service or utilities disconnection, etc. Payments can be made available within a predetermined amount of time (e.g., within seconds, minutes, or hours, etc.). FIG. 25 represents a person to business scenario.

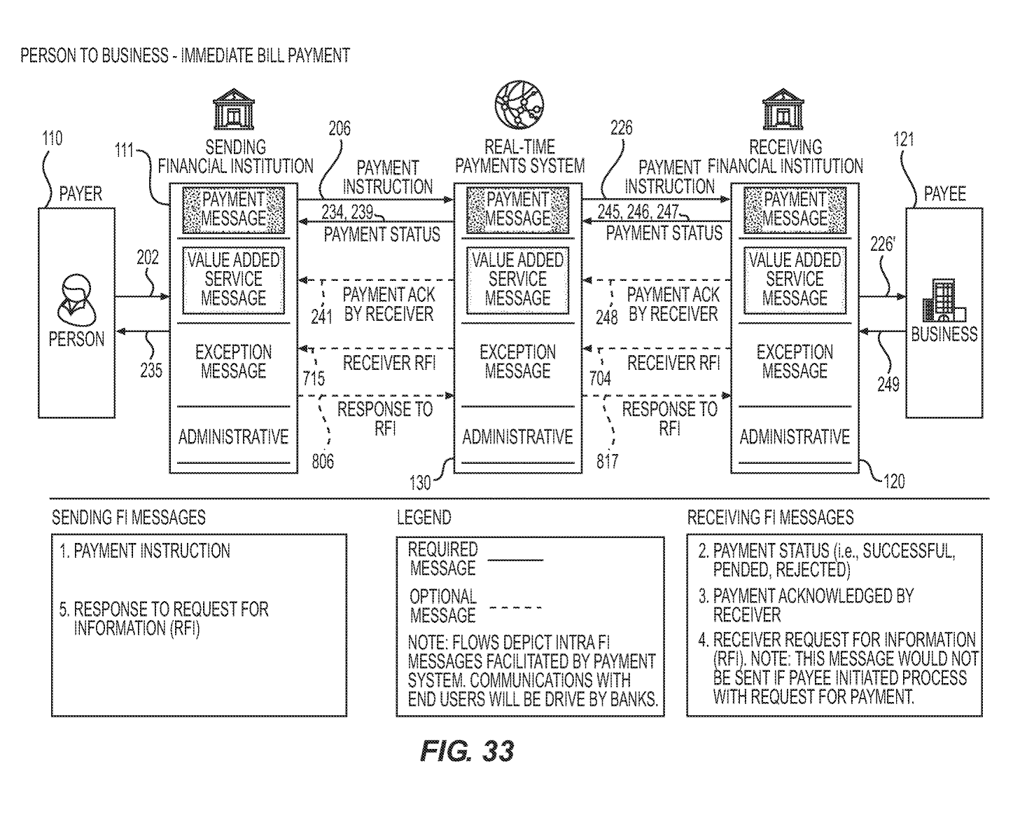

FIG. 33 represents a person to business context, such as for an immediate bill payment. FIG. 33 shows the same steps as those described above for FIG. 27 (although for convenience they are not further repeated here) for making a payment, but in a person to business context. In addition, the figure represents that the FI 120 can optionally provide an acknowledgement that the payment was received, to the real time payment system 130, in step 248, wherein the real time payment system 130 can then provide the acknowledgement to the FI 111 in step 241. Steps 241 and 248 are like those of FIG. 2. Also, the payee station 121 can optionally request information, in which case a request for information is provided from creditor FI 120 to the real time payment system 130 in step 704, and the real time payment system 130 responds by providing a corresponding request for information to the debtor FI 111 in step 715. Steps 704 and 715 are like those of FIG. 7. The debtor FI 111 then can provide the requested information in a response in step 806, to the real time payment system 130 (step 806), and the real time payment system 130 can then provide the information to the creditor FI 120 in step 817. Steps 806 and 817 are like those of FIG. 8. In example one embodiment herein, a consumer (i.e., debtor) can be notified of a late payment or the consequences of not making an immediate payment via the real-time payments system. In this example embodiment, the consumer can be offered an opportunity to make an immediate payment to the creditor at the time of the payment message or notification, or within an allowed period/grace period before any consequences occur. Such a system can, for example, stop the consequences of late payment and/or avoid late fees. In one example embodiment, if used before past due time periods, this can be used as a mechanism to incentivize quicker payments to manage cash flows by payees offering a discount to payers by remitting payments early. Also, in one example embodiment herein, an alias directory can be employed, where, before a payment is made, the debtor station 110 (and payer) is presented with the name of the payee before deciding whether or not to make the payment. This can help prevent accidental payments and keying errors. The name can be an actual name or an alias of the actual name.

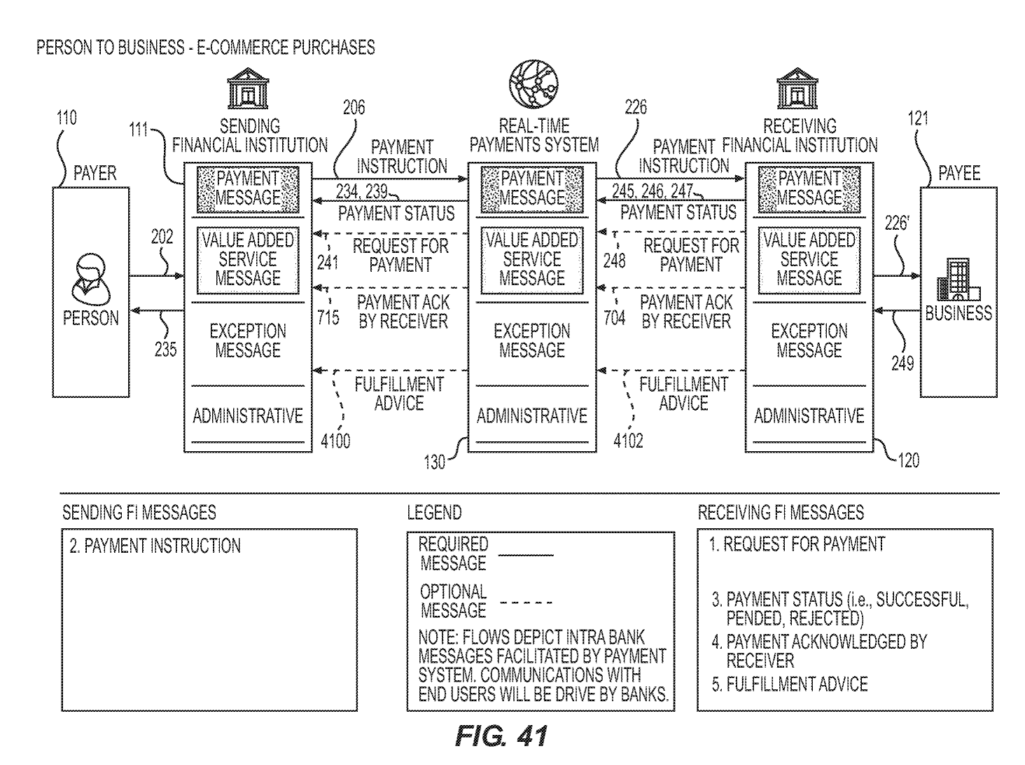

FIG. 41 represents another person to business context, such as for an e-commerce or point-of-sale (POS) payment. FIG. 41 shows the same steps as those described above for FIG. 33 (although for convenience they are not further repeated here) for making a payment. In addition, the figure represents that the creditor FI 120 can provide fulfillment advice to the real time payment system 130 (step 4102), and the real time payment system 130 can then provide that advice to the debtor FI 111 in step 4100. In another example embodiment herein, the advice can be a Remt.001 message and serve as an invoice.

In still a further example, the methods and system described herein can be employed to conduct real-time payments in a business to business context. By example only, they can be employed to effect just in time payments to suppliers, to perform immediate bill payments with acknowledgments of receipt, effecting cash concentration to single account (e.g., headquarters) from multiple case receptacles (e.g., franchises), and the like. Payments in this context may be time critical one time payments between businesses, such as, for example, just-in-time supplier payments, emergency bill payments, etc. Payments can be made available within a predetermined amount of time (e.g., within minutes). FIG. 26 represents a business to business scenario.

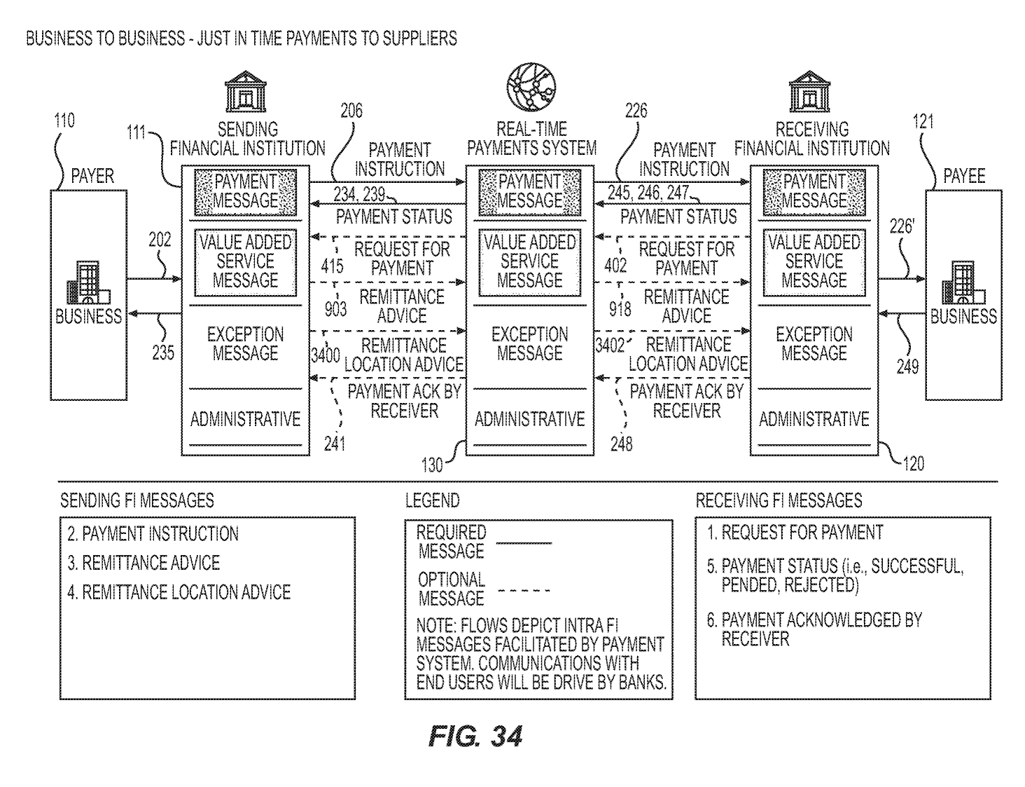

FIG. 34 represents a business to business scenario, such as a just in time payment to a supplier. FIG. 34 shows the same steps as those described above for FIG. 27 (although for convenience they are not further repeated here) for making a payment, but in a business to business context. In addition, the figure represents that payee station 121 can optionally request that the payment be paid, in which case a request for payment is provided from creditor FI 120 to the real time payment system 130 in step 402, and the real time payment system 130 responds by providing a corresponding request for payment to the debtor FI 111 in step 415. Steps 402 and 415 are like those of FIG. 4. Also, the debtor station 110 can optionally provide remittance advice to the real time payment system 130 in step 903, and remittance location advice to the real time payment system 130 in step 3400. The real time payment system 130 forwards remittance advice to the FI 120 in step 918, and also can forward the remittance location advice to the FI 120 in step 3402. Steps 903 and 918 are like those of FIG. 9. Additionally, the creditor FI 120 can provide an acknowledgement of any of the payment, the remittance advice, and/or the remittance location advice, to the real time payment system 130 in step 248, in which case the acknowledgement is provided by the real time payment system 130 to FI 111 (step 241). Steps 241 and 248 are like those of FIG. 2. In another example embodiment herein, the remittance advice can be a Remt.001 message and serve as an invoice.

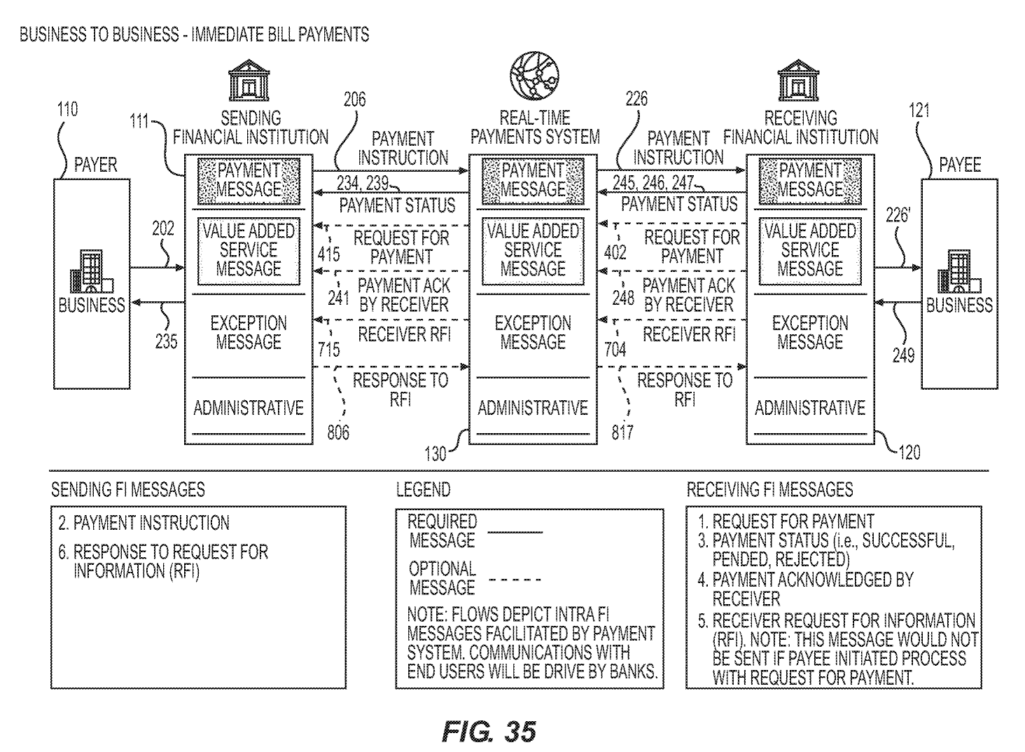

FIG. 35 represents a business to business context, such as for an immediate bill payment. FIG. 35 shows the same steps as those described above for FIG. 27 (although for convenience they are not further repeated here) for making a payment, but in a business to business context. In addition, the figure represents that the FI 120 can optionally provide an acknowledgement that the payment was received, to the real time payment system 130, in step 248, wherein the real time payment system 130 can then provide the acknowledgement to the FI 111 in step 241. Steps 241 and 248 are like those of FIG. 2. Also, the payee station 121 can optionally request information, in which case a request for information is provided from creditor FI 120 to the real time payment system 130 in step 704, and the real time payment system 130 responds by providing a corresponding request for information to the debtor FI 111 in step 715. Steps 704 and 715 are like those of FIG. 7. The debtor FI 111 then can provide the requested information in a response in step 806, to the real time payment system 130 (step 806), and the real time payment system 130 can then provide the information to the creditor FI 120 in step 817. Steps 806 and 817 are like those of FIG. 8. Also, in addition, the figure represents that payee station 121 can optionally request that the payment be paid, in which case a request for payment is provided from creditor FI 120 to the real time payment system 130 in step 402, and the real time payment system 130 responds by providing a corresponding request for payment to the debtor FI 111 in step 415. Steps 402 and 415 are like those of FIG. 4. In another example embodiment herein, an invoice (e.g., remt.001 message) can be provided when associated with a pain.013 message.

The system has many additional capabilities, such as those described herein above and others as well. For example, the transaction system 100 herein also can employ anti-spam measures to prevent the sender from broadcasting a massive number of requests to dupe receivers into sending funds. For example, this can be accomplished by charging a fee and/or by tracking through fraud monitoring tools, centrally and at FIs, for all requests for payments. Also, in one example embodiment herein, a sending or receiving FI can be made liable for information in remittance data that may indicate illegal activity (e.g., the remittance data mentions a sanctioned individual or company). Provided that the payment is not being sent or received by a person or entity on a prohibited list, the FI would not be required to block or reject the transaction under regulatory requirements. The FI may, however, be required to file a suspicious activity report within 30 days if the content of a message indicates a potential relationship to illicit activity.

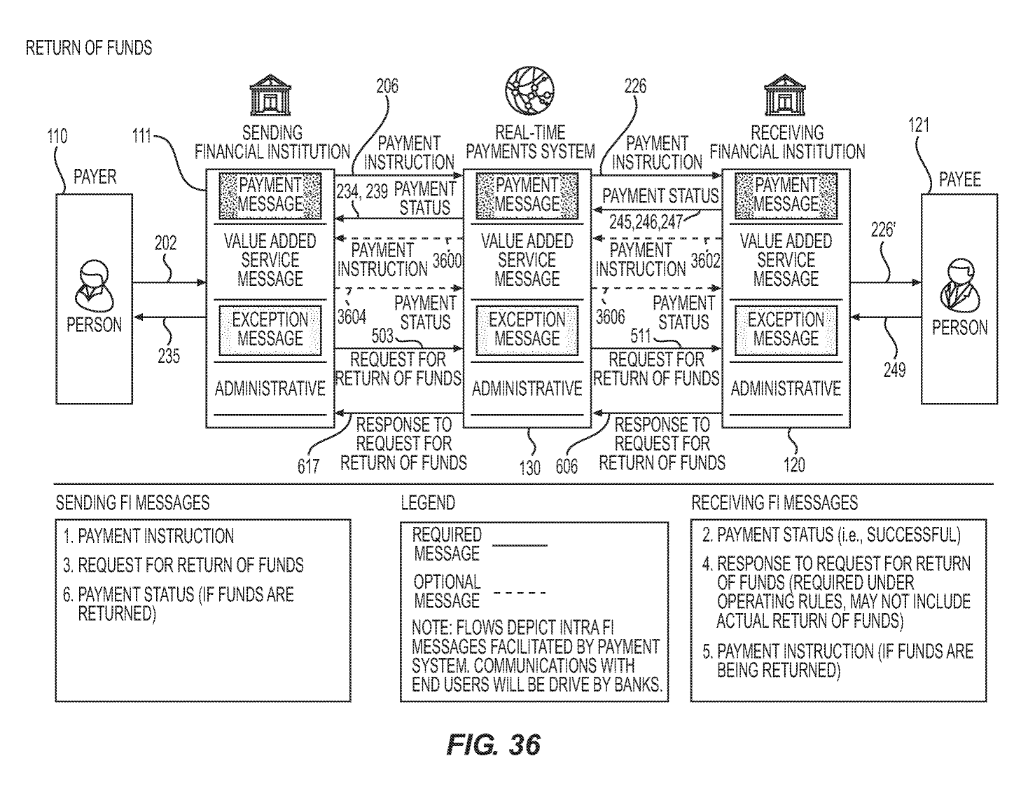

As another example capability of the transaction system 100, as described above, in one example embodiment it has a capability for returning funds that were paid. Referring to FIG. 36, for example, the same steps as those described above for FIG. 27 (although for convenience they are not further repeated here) for making a payment. A return of funds can be requested by the debtor FI 111 to the real time payment system 130 (step 503), which requests a return of funds from the creditor FI 120 in step 511. Steps 503 and 511 are like those steps of FIG. 5. The FI 120 can then respond by providing a response to the request in step 606, wherein the response can include the requested funds, a status, and/or an acknowledgement of the request. The response is then provided from the real time payment system 130 to the debtor FI 111 in step 617. Also, the creditor FI 120 can provide a return of the requested funds optionally in a separate payment instruction message in step 3602, to the real time payment system 130, which then provides the message to the debtor FI 111 in step 3600. In addition, the figure represents that the FI 111 can optionally provide an indication of the status of whether that message was accepted, rejected, or is pending (step 3604), to the real time payment system 130, which then provides the indication to the creditor FI 120 in step 3606.

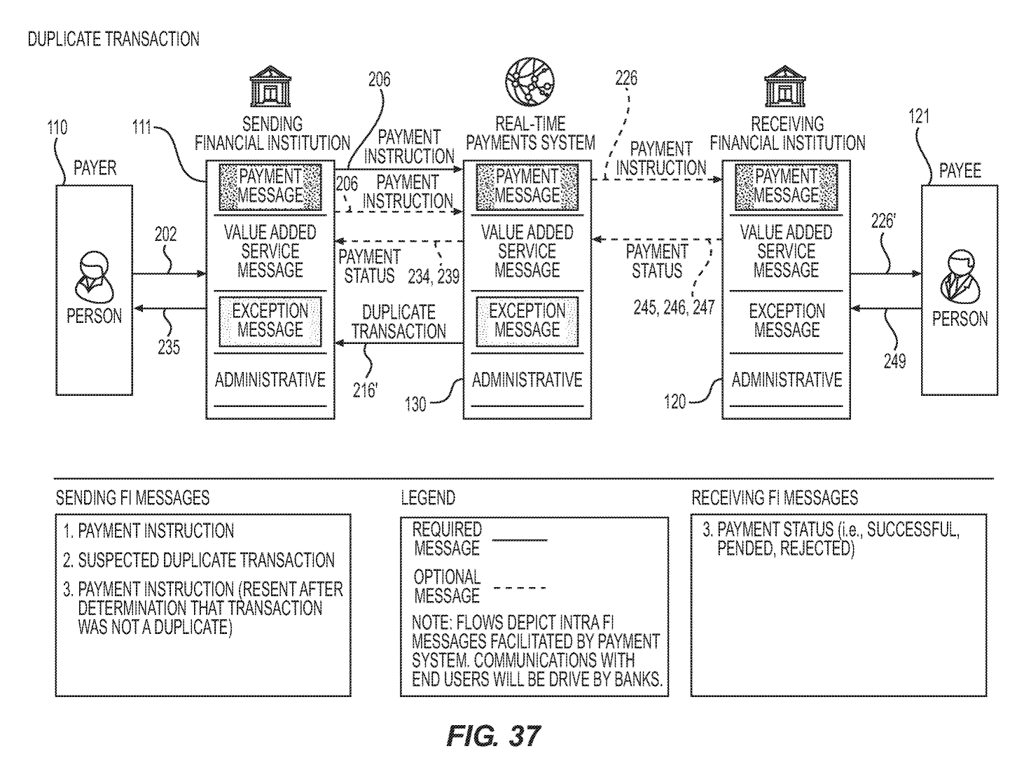

Also, as described above in connection with various flow diagrams, duplicate transactions are detected so they are prevented from being fully processed. FIG. 37 represents an example of such a scenario, wherein the same steps as those described above for FIG. 27 (although for convenience they are not further repeated here) are performed for making a payment. The real time payment system 130 responds to receiving a payment instruction sent in step 206 by recognizing that it is a possible duplicate transaction (e.g., such as in steps 212 and 213 of FIG. 2), and forwards an indication to the debtor FI 111 indicative of that detection (step 216′). The debtor FI 111 can then reexamine the transaction, and, if it is determined that the original payment instruction is not duplicative, then the FI 111 can forward another payment instruction (see, e.g., a second instance of step 206 shown in dashed lines), whereafter the method then proceeds therefrom as described above. According to another example embodiment herein, in a case where a duplicate transaction is detected, the system rejects it as a duplicate. If the duplicate was submitted by the debtor FI with a duplicate flag, the system sends the end result of the original transaction to the debtor. Every time the debtor FI sends that same transaction, it will continue to be responded to with a duplicate rejection or with the original result if the duplicate flag is included.

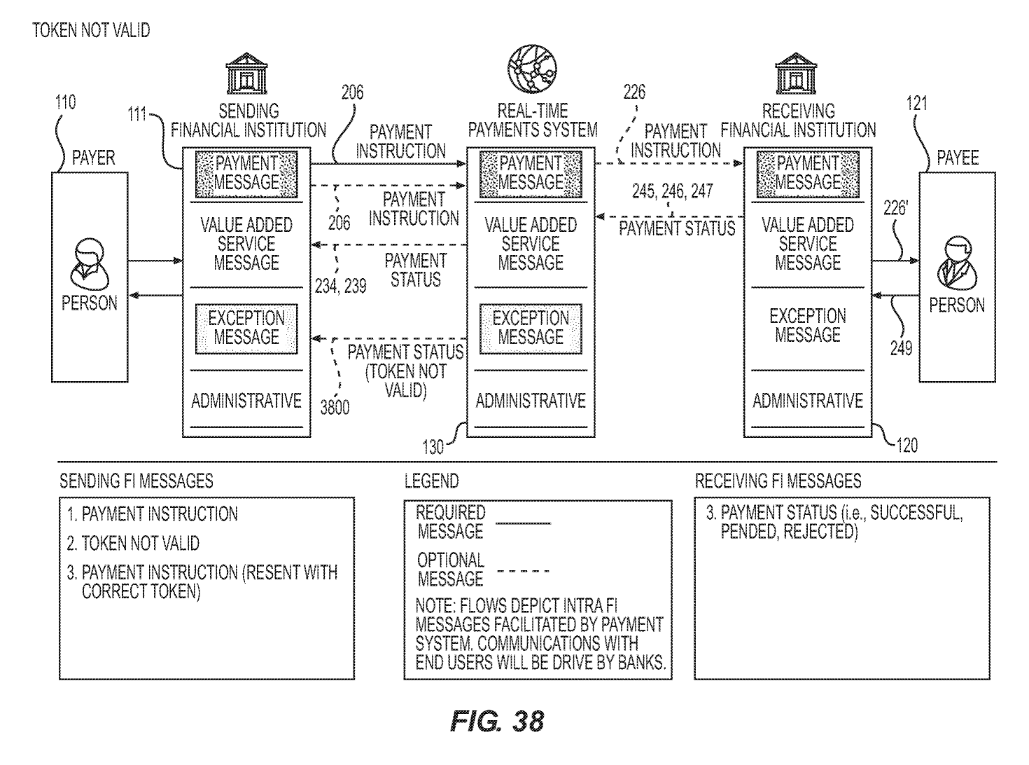

Also as described above in connection with various flow diagrams, invalid tokens are detected. FIG. 38 represents an example of such a scenario, wherein the same steps as those described above for FIG. 27 (although for convenience they are not further repeated here) are performed for making a payment. The real time payment system 130 responds to receiving a payment instruction sent in step 206 by determining whether the instruction includes invalid token(s). For example, that determination can be performed in accordance with steps 214 and 215 of FIG. 2). Where the token(s) is determined to be invalid, then a status message indicating that the token(s) is not valid is provided by the real time payment system 130 to FI 111 in step 3800. In one example embodiment, step 3800 can be the same as the exception message step 216′ of FIG. 2. The debtor FI 111 can then reexamine the transaction, and include a valid token(s) in another payment instruction (see, e.g., a second instance of step 206 shown in dashed lines), whereafter the method then proceeds therefrom as described above.

### Fraud Detection

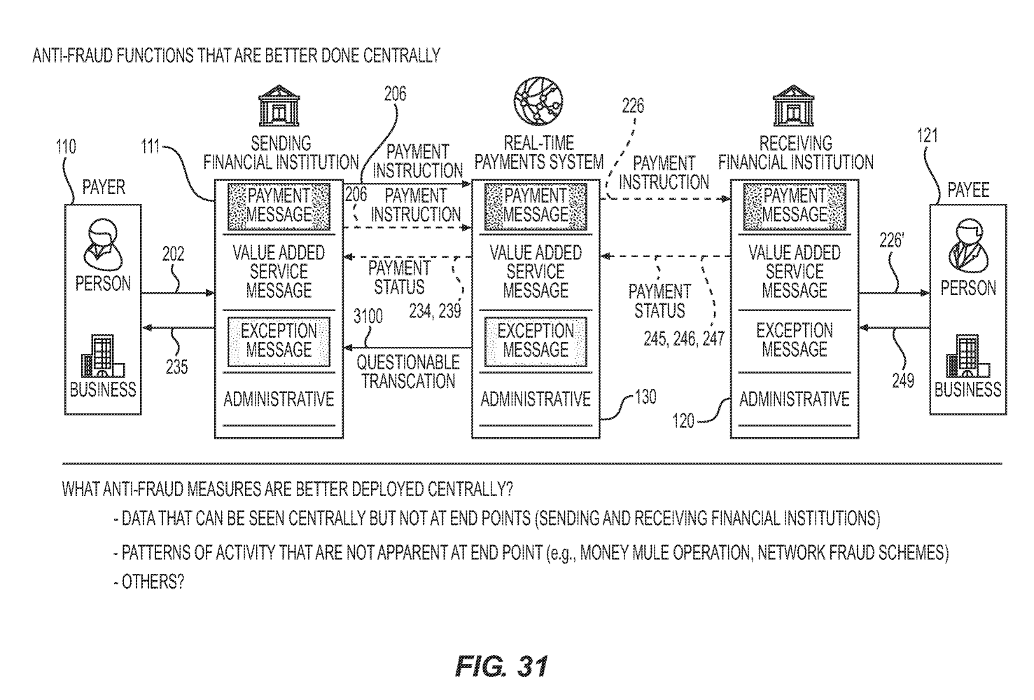

Still another capability of the system herein is fraud detection. FIG. 31 represents an example of such a scenario, wherein the same steps as those described above for FIG. 27 (although for convenience they are not further repeated here) are performed for making a payment. The real time payment system 130 responds to receiving a payment instruction sent in step 206 (solid line) by determining whether the instruction is possibly fraudulent. For example, that determination can be performed in accordance with any suitable technique for detecting a fraudulent transaction. Where the payment instruction is determined to be possibly fraudulent, then a status message indicating that the transaction is questionable is provided by the real time payment system 130 to FI 111 in step 3100. The debtor FI 111 can then reexamine the transaction, and can send another payment instruction (see, e.g., a second instance of step 206 shown in dashed lines), such as in a case where the FI 111 determines that the original transaction was not fraudulent. The method then proceeds as described above. According to another example embodiment herein, a FI can have an opportunity to intervene before the transaction is completed.

Thus, fraud detection can be performed at a central facility, such as at the real time payment system (network) 130, which is in a unique position within the overall transaction system 100 to be able to detect activity between sending and receiving points. For example, the real time payment system 130 can evaluate transactions passing therethrough to detect predetermined patterns indicative of possible fraud, in real-time, and can then notify the FIs about the possible fraud so that they can take this into account when, for example, running their own fraud algorithms. The determination can involve a heuristic model, in one example embodiment herein, although other models may be used instead. As an example of fraud detection, the real time payment system 130 can recognize that a single recipient is being sent payment transactions from multiple senders, and that a single sender is sending payment transactions to multiple recipients. If those activities are recognized by the real time payment system 130 as being indicative of possible fraudulent activity, then the real time payment system 130 can take action such as suspending the transaction and notifying FIs in real-time in the above-described manner.

### Real Time Payment Reports

The real time payment system 8010 can provide reports that can be generated and made available to Participants 8000 on a scheduled basis (e.g., on a daily, weekly, or monthly basis or as part of a reconciliation checkpoint or an unscheduled, as-needed basis). For example, types of reports that can be generated include a Detailed Payment Reconciliation Report, a Participant Reconciliation Report, a Participant Prefunded Balance Report, a Payment Volume and/or Payment Value Report, a Non-Value Message Report, an Hourly Transaction Report, a Reject Report, and a Performance Report. In one example embodiment, a Detailed Payment Reconciliation Report is run at the end of a Reconciliation Window to detail a basic sub-set of the information included in every transaction sent and received for a particular Reconciliation Cycle. This type of report is generally available to, for example, a System Operator (e.g., a network operator) and/or a Participant(s). The Detailed Payment Reconciliation Report will generally exclude any transactions that were rejected. The Detailed Payment Reconciliation Report generally includes one or more of the following: Sender Participant ID, Participant Name, Reconciliation Window, Receiver Participant ID, Transaction(s) (e.g., grouped by Sender Participant ID versus Receiver Participant ID), Instruction ID, Status (e.g., Accept or Accepted without Posting), Amount, and/or Date/Time stamp from message. In another example embodiment, a Participant Reconciliation Report is generated at the end of a Reconciliation Window, which allows for a Participant to periodically reconcile their activities with those of the RTP System to ensure that both are in sync. This type of report is generally available to, for example, a System Operator (e.g., a network operator) and/or a Participant(s). For example, to assist with an FI's reconciliation process, at the end of every defined Reconciliation Window, a Participant Reconciliation Report will be created to provide the FI with the pertinent data that the FI will need to complete their reconciliation activity. The Participant Reconciliation Report generally includes one or more of the following: Participant ID, Participant Name, Reconciliation Window ID, Pre-Funded Balance, Net Position, Number of Supplementary Funding Transactions, Gross Value of Supplementary Funding, Number of Drawdowns, Gross Value of Drawdowns, Number of Outward/Inward Transactions (i.e., Credits sent/received), and/or Value of Outward/Inward Transactions. In another example embodiment, a Participant Prefunded Balance Report is generated for a System Operator (e.g., a network operator). The Participant Prefunded Balance Report is generally run at the end of a Reconciliation Window to provide (at the Participant level) a list of each Participants' beginning and ending balances during the immediately preceding Reconciliation Window. Additionally, in one example embodiment, if the Funding Agent for the Participant(s) is someone other than the FI Participant(s), then the name of the Funding Participant will also be on the report so that the report can be organized by either Participant or the Funding Agent. Table 1 illustrates an exemplary format for a Participant Prefunded Balance Report according to one example embodiment herein:

TABLE 1

| | | | | Funding | | |
|---|---|---|---|---|---|---|
| Settlement | Participant | Participant | Funding | Agent | Opening | Closing |
| Window ID | ID | Name | Agent ID | Name | Balance | Balance |
| STMNT- | 3367695302 | Bank A | 3367695302 | Bank A | $1,000,000 | $560,000 |
| 2017-010301 | | | | | | |
| | 2027777686 | Bank B | 3367695308 | Bank D | $250,000 | $590,000 |
| | 2126129201 | Bank C | 3367695308 | Bank D | $750,000 | $850,000 |
| TOTAL | | | | | $2,000,000 | $2,000,000 |

In yet another example embodiment, a Payment Volume and/or Payment Value Report is generated on, for example, a daily basis. This type of report is generally available to, for example, a System Operator (e.g., a network operator), a Participant(s), and/or a TPSP. The Payment Volume and/or Payment Value Report generally includes one or more of the following: Participant ID (for Participant Level report), Participant Name (for Participant Level report), Date/Time, Total Volume of Payment Transactions Sent and/or Received, Total Volume of Payments by Status (of those sent), Total Volume of Payments by Status (of those received), Total Value of Payments Sent, Total Value of Payments Received, and/or Participant Debit/Credit Position. In another example embodiment, a Non-Value Message Report is generated on, for example, a daily basis. This type of report is generally available to, for example, a System Operator (e.g., a network operator) and/or a Participant(s). The Non-Value Message Report generally includes one or more of the following: Participant ID (for Participant Level report), Participant Name (for Participant Level report), Date/Time, Total Volume of Non-Payment Messages Sent and/or Received, Total Volume of Non-Payment Messages Sent by type, and/or Total Volume of Non-Payment Messages Received by type. In yet another example embodiment, an Hourly Transaction Report is generated for a System Operator (e.g., a network operator) on, for example, an hourly basis. The Hourly Transaction Report generally includes data related to the volume of transactions by message type. In another example embodiment, a Reject Report is generated on, for example, a monthly basis. This type of report is generally available to, for example, a System Operator (e.g., a network operator) and/or a Participant(s). The Reject Report generally includes one or more of the following: Participant ID (for Participant Level report), Participant Name (for Participant Level report), a Summary Section of, for example, the Total Number of Transactions (e.g., Total Number of Transactions Accepted (%), Total Number of Transactions Rejected (%), Total Number of Transactions Accepted Without Posting (%), and/or Total Number of Transactions Rejected by Reason Code (with %)), and/or a Detailed Payment Transactions Section of, for example, an Instruction ID, a Settlement Cycle ID, Status, a Create Date/Time, a Payment Type, a Rejected Reason Code, and/or Sending/Receiving Participant Information. In yet another example embodiment, a Performance Report is generated at, for example, the end of a Reconciliation Window and/or monthly. This type of report is generally available to, for example, a System Operator (e.g., a network operator) and/or a Participant(s). The Performance Report generally includes one or more of the following: Participant ID, Participant Name, Date/Time range, and/or a Funding Summary (e.g., the total number of funding during the period, the average amount in the Settlement Account over the period, the lowest Settlement Account Balance, and/or the highest Settlement Account Balance. FIG. 68 illustrates one example embodiment of a process for sending a report from the real time payment system (“the RTP System”) 8010 to a Participant 8000 (i.e., a scheduled report). As shown in FIG. 68, at step 1 (9610), the RTP System 8010 (e.g., network) becomes aware that a scheduled report needs to be generated (e.g., at the end of a Reconciliation Cycle or at the end of the day). Once generated, that report becomes available for Participant retrieval and/or download. For each Participant 8000, the RTP System 8010: (i) creates the report, including the Participant identifier, the report detail, and the date and time of report creation, and (ii) logs the creation of the report in raw format. At step 2 (9620), the RTP System 8010 sends the report to a Secure File Location 9600. In one embodiment, this Secure File Location 9600 is on a separate server (e.g., in the network) at a specified data center, where secure access to this separate server is provided to allow for retrieval of the report(s). At step 3 (9630), the Secure File Location 9600 stores the generated report. At step 4 (9640), the Participant 8000 can retrieve the scheduled report (e.g., it could be retrieved via a Participant Portal or File Transfer Service). At step 5 (9650), the Participant 8000 submits a request to retrieve the scheduled report from the Secure File Location 9600. At step 6 (9660), the Secure File Location 9600 makes the report available to the Participant 8000, and, at step 7 (9670), the Participant 8000 retrieves (and/or downloads) the report. In one example embodiment, a Participant Report will only show information in which the participant is a party or counterparty. In another example embodiment, a System Operator can see all generated reports in aggregate and at the participant level.

### Real Time Payment Inquiries

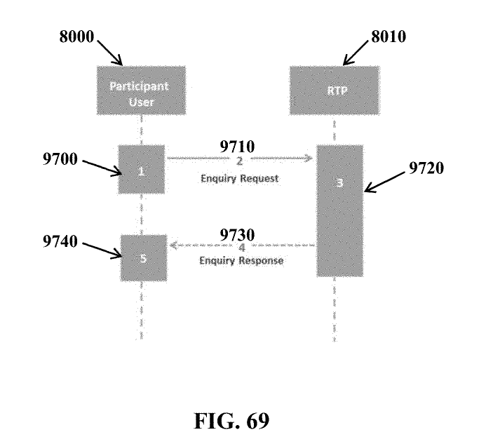

The real time payment system 8010 also provides an ability to conduct Inquiries, according to an example embodiment herein. The Inquiry functionality is available to, for example, a Participant and/or a System Operator (e.g., a network operator). In one example embodiment, an Inquiry Request is made via a Management Console and/or a Participant portal. In one example embodiment, Participants that conduct an Inquiry can only view their own data and thus, will only retrieve and view transactions in which they were a counterparty, while a System Operator can retrieve and view all FI Participants' data (e.g., for both a specific participant and across all participants). FIG. 69 illustrates an embodiment of an Inquiry Request process from a Participant 8000. As shown in FIG. 69, at step 1 (9700), a Participant User 8000 creates an Inquiry request (e.g., with predetermined or adhoc inquiry parameters for the chosen inquiry) for submission to the real time payment system (“the RTP System” 8010). At step 2 (9710), the Participant User 8000 submits the Inquiry request to the RTP System 8010. At step 3 (9720), the RTP System 8010 receives the Inquiry request and performs the following activities: (a) validates that the RTP System 8010 is able to process the Inquiry Request based on predetermined operating criteria, (b) logs the inward Request in raw format, (c) validates the Request for syntactical correctness, (d) creates the Inquiry response for the Participant User 8000, containing the relevant Inquiry data filtered by the Inquiry parameters passed in the request, and (e) logs the creation of the Inquiry response. At step 4 (9730), the RTP System 8010 sends the Inquiry Response to the Participant User 8000, and, at step 5 (9740), the Participant User 8000 that submitted the request, receives the Inquiry Response on the Participant (or Management) portal. In one example embodiment, the Inquiry Response (e.g., the Report and Inquiry Specification Value message response) generally includes one or more of the following data: Instruction ID (or equivalent), Date, Final Status, Value (if payment transaction), and/or Sender/Receiver. In another example embodiment, types of Inquiry Requests include Inquiries on Payment Transactions, Inquiries on Non-Payment Transactions, Reconciliation Window Status, Reconciliation Window Summary, Retrieving SNMs sent to a Participant, Retrieving Sign-on Status of a Single Participant, and/or Retrieving a List of Participants Not Able to Transact. For example, in one embodiment, an Inquiry on Payment Transactions is requested by either a Participant or a System Operator. With an Inquiry on Payment Transactions, the RTP System generally provides the ability to search a transaction(s) based on one or more of the following parameters: Instruction ID, Participant ID, Routing Number, Currency, Amount, Transaction Status, Date Range, Settlement Cycle ID, and/or Reject Reason Code. In another example embodiment, an Inquiry on Non-Payment Transactions is requested by either a Participant or a System Operator. With an Inquiry on Non-Payment Transactions, the RTP System generally provides the ability to search a transaction(s) based on one or more of the following parameters: Instruction ID (or equivalent), Participant ID, Routing Number, Amount, Transaction Status, Date Range, and/or Reject Reason Code. In another example embodiment, an Inquiry on Reconciliation Window Status is requested by either a Participant or a System Operator. This type of inquiry generally provides information regarding the status of past or future Reconciliation Windows. In one example embodiment, the Inquiry Request on Reconciliation Window Status specifies a date range that can span up to a maximum of, for example, 46 calendar days, but no more than, for example, 31 days ahead of the Inquiry Request date. The Inquiry Response to the Reconciliation Window Status Request generally includes one or more of the following: Reconciliation Window Start Date, Reconciliation Window End Date, Reconciliation Window ID, and/or Reconciliation Window Status (e.g., Due, Cut-off, Processing, Complete, Delayed, Failed, etc.). In another example embodiment, an Inquiry on Reconciliation Window Summary is requested by either a Participant or a System Operator. This type of inquiry generally provides summary results of a specific Reconciliation Window. In one example embodiment, a Participant that requests such an Inquiry can only see their own data, while (i) an FI that requests such an Inquiry can see data relating to all of their Participants, (ii) a TPSP that requests such an Inquiry can only see data for those participants that have granted them access, and (iii) a System Operator that requests such an Inquiry can see data relating to all of the Participants. The Inquiry Response to the Reconciliation Window Summary Request generally includes one or more of the following: FI name, Participant ID (as applicable), Participant Name (as applicable), Settlement Cycle ID, Settlement Cycle Date, Settlement Cycle Time Stamp (Start Time/End Time), Settlement Status (e.g., In Process, Complete, Failed, Scheduled, Delayed, Suspended, etc.), Total Value of all payments processed in the settlement cycle, Total Number of all payments processed in the settlement cycle, Total Number of Transactions Accepted (but only those transactions received after the settlement cycle was initiated), Total Number of Transactions Rejected (but only those transactions received after the settlement cycle was initiated), and/or Total Number of Transactions Pending (but only those transactions received after the settlement cycle was initiated). In yet another example embodiment, an Inquiry to Retrieve SNMs sent to a Participant is requested by either a Participant or a System Operator. This type of Inquiry allows for the Participant and/or the System Operator to retrieve details of all SNMs sent to a Participant (or themselves). In general, the Response to the Inquiry to Retrieve SNMs sent to a Participant includes one or more of the following: Participant ID, Participant Name, and/or a List of all SNMs sent to a Participant (including, for example, the type of message and time stamp). In another example embodiment, an Inquiry to Retrieve the Sign-on Status of a Single Participant is requested by either a Participant or a System Operator. This type of Inquiry provides the Sign-on Status at the Participant level. In general, the Response to the Inquiry to Retrieve the Sign-on Status of a Single Participant includes one or more of the following: availability status of every, or a chosen, Participant within the RTP System and/or the Participant(s)'s Sign-on Status (e.g., Available, Unavailable, Signed-off, Suspended, Connection Unavailable, etc.). In yet another example embodiment, an Inquiry to Retrieve a List of Participants Not Able to Transact is requested by a System Operator. This type of Inquiry generally returns a list of all Participants who are, for example, Signed-off, Suspended, and/or Connection Unavailable. In general, the Response to the Inquiry to Retrieve a List of Participants Not Able to Transact includes one or more of the following: Participant ID, Participant Name, Reason why Participant is offline (e.g., Participant suspended or Participant's system offline), Date/Time since Participant was unavailable, and/or the Participants' availability history (e.g., Date/Time of last outage, Reason for outage, etc.).

### Real-Time Payments are Useful to Customers

The transaction system 100 is convenient in that it can enable consumers to pay each other directly from their existing accounts using online or mobile banking platforms. The system maintains account data privacy and is easy to use. For example, the system can route payments based on tokens that, in one example, are not used to debit accounts, so that senders and receivers will not need to provide complex, sensitive bank account details to other parties. The system also provides cost savings in that it provides a less costly alternative to costly funds transfers, check cashing services and last-minute bill payments. Additionally, the system provides certainty in that senders and receivers can be provided with immediate notifications of payment, and risks of returned payments are reduced because sending financial institutions can immediately verify sufficient funds. The system also is safe in that sending and receiving financial institutions, which have existing relationships with their customers, are responsible for authentication, in one example embodiment herein. Moreover, the system provides for effective cash management in that is has the ability to send and receive payments immediately, giving customers more control over cash flow, which can be useful for cash-constrained small businesses and consumers.

The system herein also supports superior and safer P2P payments, and provides comprehensive digital payment capability. In the system herein, customers can use their existing bank accounts to send and receive payments, whereas other types of non-bank MSP providers typically require customers to establish new accounts, which can be inconvenient during enrollment. Customers of the system herein can fund directly from their bank accounts, without requiring the sharing of sensitive data to payment recipients and recipient banks. For customers of typical non-bank MSP providers, on the other hand, customers must provide banking credentials, and MSP verification must be effected via, for example, a bank website or payment system. With regard to initiating payments, customers can use their existing bank login information, and bank verification/identification are employed for security, according to one example embodiment herein. For typical non-bank MSP providers, on the other hand, a customer must establish a separate login for MSP payment initiation. As for clearing and settlement, in one example embodiment of the system herein, immediate debit and push credit with real time availability to the payment receiver are provided, essentially in all cases. For typical non-bank MSP providers, on the other hand, a debit card or use of a network may be required to effect external payments. Also, no cash outs are required in the system herein, since funds are transferred directly and immediately to a customer's bank account, whereas in typical MSP systems, customers must pull funds from the MSP account into their bank account, which can take a day or longer to be effected.

### Sample Business Requirements

In one example embodiment herein, the system complies with predetermined business requirements. For example, with respect to credit transfers, in one example embodiment all payments originated by a payer are not permitted to be taken back from the receiver, and instead the payer can request the return of a payment made in error. This provides payment certainty for receivers.

The real time payment system herein can provide for 24/7 payments, provides real time access to payment status information for both senders and receivers, and immediate availability of funds for receivers. In one example embodiment herein, one of the business rules is that receiving FIs must be able to accept or reject most payments in seconds, and to resolve exceptions flagged for risk management and compliance review within a reasonable time (e.g., 2 hours). Also, receivers are to have access to funds for accepted payments substantially immediately (i.e., no holds).

Other example business requirements are that there is real time exchange of financial and non-financial messages that support a variety of use cases (i.e., messages are in real time), masked routing (e.g., tokens) is preferably employed (although not necessarily required) to initiate payments instead of account numbers. Also, ISO standard formats and internationally consistent transaction flows preferably are employed, to provide global compatibility, and messages must include all relevant data for risk management and compliance. This supports anti-fraud, anti-money laundering and sanctions compliance processes.

For safety, additional business requirements can be employed. For example, in one example there is a system-wide limit on transaction sizes, and sending FIs can set lower limits for origination. A settlement approach that mitigates material risk of loss can be employed. In one example embodiment herein, intra-day net settlement and the use of position limits and pre-funding reduce settlement risk. Additionally, as described above, tokenization of bank account numbers protects account data. FIs that cannot meet a threshold for initiating payments may be able to participate as “receive-only” FIs. Separate minimum threshold levels (around security requirements) can be defined for those participants that are receive, send, RFP and PSP. Thus, in one example a minimum threshold of security and privacy protection can be required of participating FIs.

In one example embodiment herein, there are certain payment system requirements for participants. For example, participating FIs should have functionality supported by the IT infrastructure of the payment system, and there can be certain operating rules and procedures as well. For example, requirements can be placed on participants in the real-time payment system that are not directly implemented by the IT infrastructure of the payment system. This can be in the form of policies, rules, standards, and service level agreements implemented through payment system governance.

In one example herein, FIs can be required to operate on a 24/7/365 basis, to accept and reject payments automatically on that basis, and to have the ability to perform necessary risk management and compliance functions, such as customer authentication, authorization, regulatory compliance screening, and anti-fraud screening 24/7 (which may be automated or outsourced). FIs also can be required to provide real-time access to payment status information for senders and receivers, so that senders and receivers can have complete, timely information about the status of real-time payments.

FIs also can be required to accept or reject a majority of payments (e.g., 95%+) within seconds, and all payments in a reasonable time, and to make immediate notification of payment to senders and receivers, or provide a channel for senders and receivers to inquire about payment status and receive an immediate response. FIs can be required to integrate accurate real-time payment status inquiry, notification, and feedback into online and mobile banking services.

Receiving FIs can be required to provide immediate availability of funds to recipients on a 24/7/365 basis, or at least make funds available to receivers within seconds for any accepted payment. Payments can be rejected for risk management, or an inability to post or legal compliance. Payments may be held for review for a reasonable time only when necessary for risk management and legal compliance purposes, and after review FIs must accept or reject payments, not withhold availability, in one example requirement.

FIs also can be required to employ limits on transaction value, which can be updated periodically based on objective criteria. Policies and processes can be provided to set sender FI value limits for transactions and to apply them to payment origination, and risk management policies and processes can be employed to accept payments up to a system-wide transaction value limit. FIs can be required to have an ability to identify potential structuring of transactions to avoid transaction limits.

Sending FIs can be required to have policies and processes for handling customer claims for unauthorized transfers and funds sent in error, and receiving FI can be required to have policies and processes for responding to requests to reclaim funds sent in error, and FIs can be required to have processes to request a return of erroneous payments, and an inter-FI process including electronic messaging to support requests for return of funds sent in error. FIs can be required to create and operate a token vault, although in other cases, FIs may elect or not elect to do so, and the vault can be operated by, e.g., network 130.

In other example, a token vault can be outsourced to a third party, to integrate tokenization into products and services, and educate customers on tokenization. FIs can be required to have an ability to initiate payments based on an alias instead of account numbers, and enable senders to initiate payments using an alias for the receiver such as a telephone number or email address, or the like.

Elements such as, for example, a central infrastructure or the RTP system, can be required to have an approach that mitigates material risk of loss, and a settlement process and legal framework that reduce or eliminate potential for settlement failure. FIs can be required to monitor, manage, and fund settlement pools or net settlement across all settlement windows, develop a process to respond to situations where settlement exposure has reached its limit, use tokens to protect account data, such as a unique code in lieu of an account number that cannot be used to debit the account.

For participating FIs, most security and data protection requirements apply across channels and products, not to a specific payment system, in one example embodiment herein. FIs also can be required to support risk management and regulatory compliance, and to support anti-fraud, anti-money laundering, and OFAC/sanctions compliance processes.

There also may be certain requirements placed on FIs such as, for example, practices and procedures for financial institutions participating in the real-time payment system that are not dictated by payment system requirements and operating rules.

Also in one example embodiment herein, there may be certain operator requirements placed on an operator of the core payments system, above and beyond day to day operation and maintenance of the IT infrastructure of the payment system, such as operator policies and procedures. An operator can be, for example, an entity responsible for operating the transaction system 100, a subset thereof, or the network 100.

An operator can be required to establish limits on the value of transactions cleared through the transaction system 100, and rules for a process for revising the transaction value limits (sending FIs can set lower value limits for their customers, and receiving FIs cannot set a transaction limit lower than the system-wide limit, in one example. In one example, there is a $25,000 per transaction initial limit, which can be raised over time.

An operator also can be required to provide data collection and reporting to support future value limit revisions, provide rules and procedures establishing a legal basis for payment finality (e.g., rules do not provide a basis for sending FIs to reclaim funds from receiving FIs for unauthorized payments (only sending FI has obligation to verify payment authorization, in one example)).

An operator can be required to support FI processes that prevent errors in sending payments, and for the transmission of messages requesting a return of funds and responses to such requests. An operator can be required to provide utilities to reduce sending errors (e.g., duplicate checking), operate inter-FI settlement, and establish and manage exposure limits for participating FIs.

An operator also can be required to act as a token services provider (TSP), and support third-party token vaults and FIs acting as their own token vaults, or work with a third party service to do so. An operator can be required also to provide centralized fraud and AML, monitoring to complement processes at participating FIs. Additionally, an operator can be required to coordinate with international standards groups and payment system operators in other countries to ensure compatibility with the transaction system 100, and to provide immediate transmission of payment status messages, and real-time access to payment status information to FIs. An operator also can be required to provide centralized fraud and AML monitoring to support receiving FI decision-making.

The network 130 also can have various capabilities, in example embodiments herein. For example, the system can support for frequent intraday net settlement, including evening and weekend, and have an ability to apply limits on settlement exposure on an individual FI basis, including the ability to reject or suspend payments submitted by FIs that have reached their limit, and notify FIs that are approaching limits. In other example embodiments herein, the system can support transaction-by-transaction settlements.

The network 130 also can have an ability to administer a pre-funded settlement pool, an ability to process and route tokenized payments and other messages, and an ability to route payments based on either alias or RT/Account Number. The network 130 also in one example can support any type of character-based alias (not just a telephone number of email address), and have an ability to accommodate an alias registry, registry maintenance, and unambiguous routing for multi-owner accounts and multi-account owners.

The network 130, in one example, also meets standards for data security and privacy protection appropriate for a retail payment market utility, has an ability to reject transactions that exceed a system-wide limit on the value of transactions, an ability to change the value limit, and an ability to establish different limits by type of payment.

Moreover, the network 130 can employ message formats that carry all data required for regulatory compliance, and employ tokenization in a manner that does not obscure data required for risk management and compliance such as anti-fraud, anti-money laundering, and sanctions compliance. Message formats and processes can be globally compatible, and in one example are in accordance ISO 20022 message formats. The network 130 also can support real-time delivery of payment status information to and from FIs, including payment messages, and ACK/NAC and disposition messages (success, fail or pending).

Also, various elements of the transaction system 100 may be required, in one example herein, to comply with certain business rules for real-time exchange of financial and non-financial messages that support a variety of use cases. For example, sending FIs can be required to adhere to standard formats and usage rules for payment and non-payment messages, receiving FIs can be required to make all relevant information from payment and non-payment messages available to receivers, and receiving FIs can be required to act on administrative messages. FIs also can create products, services and processes to create, deliver, and respond to payment, non-payment, and administrative messages.

### Security

The system herein has robust security capability that limits the ability to initiate payments, non-payment messages, and access to data to only authorized persons or applications. This reduces exposure to fraud or data breaches, and prevents incidents that undermine trust in the payments system. Security can be multi-factor, multi-layered security for immediate payments, and any participating FI should meet minimum access standards based on industry standard security principles.

Preferably, the system herein has mechanisms that limit the ability of unauthorized persons or applications to initiate payments, non-payment messages, and access data, so as to reduce exposure to fraud or data breaches. This can prevent incidents that undermine trust in the payments system. In one example embodiment herein, multi-factor, multi-layered security is provided to protect immediate payments, and participating FIs meet minimum access standards based on industry standard security principles. Authentication and payment authorization can be provided. Authentication verifies that a payer is an actual authentic payer and has access to account. Payment authorization verifies that authenticated payer is making a true payment, and, in some embodiments, can provide non-repudiation protection for FIs. Existing authentication standards and/or security framework/standards used by the industry can be employed, such as, for example, FFIEC guidelines, OCC guidelines, NIST CyberSecurity Framework and various standards, or FISMA. Assessments and certifications also can be employed, such as, for example, SOC1/SOC2 assessments, shared assessment SIG & AUP, ISO27001 certifications, SSAE16 certifications, penetration tests and 3rd party attestations. Authentication ensures that sending financial institutions have taken adequate measures to ensure that every payment submitted to the real-time payment system is duly authorized by an authenticated customer. Authentication provides verification that a payer is whom they claim to be and should have access to an account, and can include multi-factor authentication with secure tokens, or other automated fraud management.

Threats and countermeasures are constantly evolving. As such, it is possible that a static standard may become obsolete. Thus, security involves more than just payments initiation. For example, in a credit push system, the sender's financial institution may be required to verify the identity of the sender. Typically, a sender's FI (particularly in a credit “push” scenario) is in the best position to verify a sender's identity because of the existing relationship therebetween and “know your customer” obligations. A sending FI generally bears possible liability for unauthorized transactions and therefore has an incentive to employ effective online and mobile banking security.

According to an example embodiment herein, participating FIs should meet a minimum level of security and privacy protection appropriate for a retail payment market utility. The payment system may include FIs that receive but do not send payments.

The system also can have certain operating rules and procedures, such as, for example, rules that reference external security and privacy standards, rules requiring that all FIs meet data protection standards, and that sending FIs meet rigorous standards for sender authentication and payment authorization. Compliance with security and privacy standards preferably is auditable and audited. Security standards do not unnecessarily restrict usability.

With respect to operator requirements, an operator may be required to administer compliance with security and privacy requirements, and, with regard to financial institutions, security and data protection requirements may apply across channels and products, not to a specific payment system.

### Tiered Approach to Minimum Requirements Based on Participation

Not all financial initiations may wish to participate in real-time payments at the same level (i.e., some will send and receive real-time payments, while others will only receive). Some institutions will carry greater inherent risk due to participation and volume of payments. In one example embodiment herein, a tiered approach is employed that matches minimum level of requirements with potential for risk within the system. For example, a Tier 2 involves large financial institutions with substantial volume and participating as a sender, and a tier 1 involves small and midsize financial institutions with low to moderate volume and participating as a sender. All Participants in the system may not be sending real-time payments, but may have the capability to receive payments. Tier 2 has a higher level of security, tier 1 has a next, lesser level of security, and the remaining participants may have a lesser level of security. Minimum requirements for risk control will be associated with the activities that a financial institution is offering and be additive in nature for each increasing level of potential risk.

The centralized utility analyzes network level data to identify and report potential fraudulent behavior (e.g., detect anomalous send/receive activity; excessive complaints, etc.). Participating financial institutions should comply with regulatory requirements, and report fraudulent behavior to the operator of the network 130 and/or the sending financial institutions. Participating institutions also should be able to react to alerts from the centralized activity monitoring utility. Participating financial institutions that also send payments also should comply with requirements for all participating financial institutions, have at least a two factor authentication, require registration of customers sending payments, and be able to perform real-time fraud and risk screening for payments being originated. Participating financial institutions that allow customers to make requests for payment should comply with requirements for all participating sending and receiving financial institutions, make warranties and representations that requests for payment are for legitimate purposes, screen and monitor requests for payment initiators, with the ability to identify abusive or fraudulent use, and take corrective actions including suspension of initiator access to the network. Such institutions also should be able to respond to network reports of abuse of requests for payment.

Participating financial institutions that allow for third party payments, or payment service provided (PSPs), should comply with requirements for all participating sending and receiving financial institutions that allow customers to initiate requests for payment, make warranties and representations that the third party is abiding by rules for payment origination, apply the same requirements to third party payment services that are applied to financial institutions that send real-time payments and allow requests for payment. Such institutions also should follow FFIEC guidelines regarding third party relationships. The network 130 has an ability to enforce rules against FIs and third parties, including an ability to levy fines and suspend activity on the network. FIs should not allow third parties to originate volume greater than their financial resources can support in the case of third party failure.

### Sample Minimum Information System Requirements for all Participating Financial Institutions

Any institution that participates in the system may comply with the following requirements:

1. The organization complies with the following end user authentication requirements: FFIEC guidelines including authentication guidance published in 2005: http://www.ffiec.gov/pdf/authentication_guidance.pdf and it's supplement published in 2011: http://www.ffiec.gov/pdf/auth-its-final %206-22-11%20(ffiec %20formated).pdf

2. The organization may have 3rd party attestation by having penetration test on an annual basis of their customer authentication platform.

3. The organization may have “Opportunistic TLS” enabled for email communication over the Internet.

Tier Financial Institution Minimum Requirements

In addition to the requirements for all participants in the system, any Tier Financial Institution participants also can be required to meet the following requirements:

1. Receive payments only;

2. Send and receive payments;

3. Ability to send RFP; and/or

4. Support PSP.

Tier 1 Financial Institution Minimum Requirements

In addition to the requirements for all participants in the system, any Tier 1 participants also can be required to meet the following incremental requirements:

1. The organization must have SOC1 and/or SOC2 and/or Shared Assessment AUP and/or ISO27001 certification and/or SSAE16 certification along with penetration test and FFIEC compliance on an annual basis of their customer authentication platform.

2. The organization will retain authentication logs for users who authenticate through their environment prior to acting as sender for at least 60 days.

Tier 2 Financial Institution Minimum Requirements

In addition to the requirements for all participants in the system and Tier 1 requirements, any Tier 2 participants can be required to meet the following incremental requirements:

1. Proof that periodic vulnerability scan is performed on the customer authentication platform.

2. Proof that a SDLC process exists where static and dynamic code analysis is performed on the customer authentication application.

### Support for Risk Management and Regulatory Compliance

In one example herein, support for anti-fraud, anti-money laundering and OFAC/sanctions compliance process is provided. For example, payment system requirements may be such that a message format carries all data required for regulatory compliance, and tokenization may be required to not obscure data required for risk management and compliance such as anti-fraud, anti-money laundering and sanctions compliance process. Operating rules and procedures may require that a sending FI provide data required for regulatory compliance by a receiving FI, and operator requirements may provide centralized fraud and AML monitoring to complement processes at participating FIs. Moreover, financial institutions may be required to establish policies and processes to obtain data required for regulatory compliance in the payment initiation process, and automated anti-fraud screening can be required to meet expectation to accept or reject payments in seconds or minutes.

### Fraud Prevention and Mitigation

Various types of fraud may happen in a credit push system, such as, for example, an account take over, money mule operations, fraudulently inserted payments, fraudulent solicitations (e.g., spam, phishing, credential stealing malware etc.), or other types of fraud. Fraud detection can be provided at the network, financial institutions, and/or third party processors, and can occur in flight/real time, by post hock analysis and detection, or by holding transaction/message records for analysis.

In one example embodiment herein, anti-fraud functions are performed centrally, such as at the network 130. The network 130 can process data that is central in the system, versus at end points (sending and receiving financial institutions). Patterns of activity that are not apparent at an end point (e.g., money mule operations, network fraud schemes, etc.), can be detected. The network 130 also can be a centralized utility that provides offerings for financial institutions that choose not to perform complete anti-fraud in house, and can perform analytics/business intelligence to support fraud prevention.

### Security and Fraud Mitigation

Security and risk management requirements are associated with specific real-time payment activities, such as receiving real-time payments, sending real-time payments, allowing customers to send request for payment messages, providing access to third party payment service providers to send real-time payment, and providing a real-time payment directory service. With the exception of receiving real-time payment, there is no existing framework that can be utilized to define all security requirements for financial institutions offering that service. As such, there is a need to establish a governance process for creating, maintaining, updating, monitoring, and enforcing security requirements.

Example embodiments described herein can mitigate fraud by employing a centralized utility (e.g., network 130) that can analyze network level data to identify and report potential fraudulent behavior to origination and receive points, and enable the exchange of information between financial institutions regarding fraudulent activity. Also, in one example herein, a tiered approach is taken to address threats, based on participation. For example, financial institutions may not participate in real-time payments at the same level (e.g., some may participate at a level where by both can send and receive real-time payments, while others will only receive such payments, and some institutions may carry great inherent risk owing to participation level and volume of payments covered). As such, risk control may be associated with the activities that a financial institution is offering and be additive in nature based on level of participation.

Preferably, the centralized utility (e.g., network 130) that analyzes network level data to identify and report potential fraudulent behavior can detect anomalous sending and receiving activity with alerts to the financial institutions that are impacted, perform velocity checks on origination, receive, and request for payment volumes, and be able to detect patterns that indicate potential network fraud or money mule activity. To address fraud mitigation needs of a real-time system, the centralized utility can analyze network level data to identify and report potential fraudulent behavior to origination and receive points, and serve as a platform to allow for the exchange of information between financial institutions regarding fraudulent activity.

Preferably, the utility also can provide alerts with reason codes upon the detection of anomalous activity for impacted financial institutions, provide access to network data to augment financial institution fraud detection and risk management, and perform fraud analytics to provide regular fraud reporting to participating financial institutions. Also, preferably the utility can track complaints of excessive abuse of request for real time payments and send notification to a receiver's FI, can support the exchange of reported fraud incidents among financial institutions, and can provide payment data elements to support receiving FI risk management, such as by providing data on origination channel and device ID, and accommodating geolocation data for a sender. The utility preferably also can provide data to support sending FI risk management, such as, for example, data specifying an age of receiving accounts.

Participating financial institutions may be required to comply with FFIEC guidelines as applied through a regulator examination, report fraudulent behavior to an entity responsible for the network 130 and/or to sending financial institutions, and react to alerts from a centralized activity monitoring utility.

Participating financial institutions that also send payments also may be required to comply with requirements for all participating financial institutions, have a minimum of two factor authentication (as defined through a real-time payments governance process), require registration of customers sending payments, conduct real-time fraud screening for payments being originated thereby, have a capability to assign risk based sending value limits to customers, and avoid the use of including active hyperlinks (as defined by a real-time payments governance process) in payment and non-payment messages.

Also in one example herein, participating financial institutions that allow customers to make requests for payment must comply with requirements for all participating sending and receiving financial institutions, make warranties and representations that requests for payment are for legitimate purposes, comply with requirements similar to those for origination of ACH debits (determined through a governance process), and financial institutions must be able to respond to network reports of abuse of requests for payment, and have the ability to suspend users' access to the network.

Participating financial institutions that allow for third party payments and/or payment service providers (PSPs) may be required to comply with requirements for all participating sending and receiving financial institutions that allow customers to initiate requests for payment, provide warranties and representations that the third party is abiding by rules for payment origination, apply the same requirements to third party payment services that are applied to financial institutions that send real-time payments and allow requests for payment (as applicable), and follow FFIEC guidelines regarding third party relationships. Additionally, such financial institutions also should have a capability to enforce rules against FIs and third parties, including an ability to levy fines and suspend activities on the network. The financial institutions also should not allow third parties to originate volumes greater than their financial resources can support in the case of third party failures.

Security measures also can be taken regarding requirements for directory services. As an example, it may be required that a directory service cannot store account information (i.e., it should store tokens only), and have a robust entry maintenance process to ensure that entries are reliable and updated on a timely basis. Ideally, directory services have the ability to allow customers to change their alias affiliation through their registrars, aliases can be registered only in the directory through a financial institution or third party sponsored by a financial institution, and the registrar is responsible for maintaining aliases by providing a process to verify the identity of an alias owner, and by providing warranties and representations that aliases are associated with correct accounts. Preferably, directory access is restricted to financial institutions for the purposes of routing payments (i.e., no direct third party is permitted access to the directory), and industry standard data protection is complied with as it applies to financial institution data processors. Other requirements may include that the directory service must be able to provide the name and address of the receiver to the sending FI to support error prevention, risk management and regulatory compliance (e.g., OFAC screening, AML), and must have a robust entry maintenance process to ensure that entries are reliable and updated on a timely basis.

The payment system herein is useful in that, in one example embodiment herein, it processes credits only versus debits, and thus privacy protection is maintained. A transaction is generated and sent through the network 130 from a sending institution upon that institution receiving instructions from a payer, and only if the payer has sufficient funds available to cover the transaction value and has been duly authenticated (e.g., at the sending financial institution).

The use of a credit “push only” model addresses funds availability and risk management concerns (e.g., insufficient funds, payment authorization, multi-party authentication, etc.), and offers transparency and control for end users. Any case can be addressed by credit push, such as, for example, a business to person application, a person to person application, a person to business application, and a business to business application. In one, non-limiting example embodiment herein, debits are not employed in the method herein because current debit and credit card payment systems work well for existing debit use cases, and requests for payments followed by credit transfer might be a superior form of debit. A credit transfer system is inherently safer than a payment system that allows a payee to debit a payer. Each credit push may have an authorization or an action taken by the payer versus a debit that could be done without authorization. Even if hacked, the amount vulnerable is limited to merely the amount of funds in each account.

In the system herein, a debit capability can be emulated using a request to pay from a payee to a payer, wherein the payee initiates a request for payment from the payer, the payer receives a notification of the request for payment and authorizes a credit transfer to the payee. This approach gives the payer a level of control over the payment process. A credit push only model addresses funds availability and risk management concerns. For example, for a sending institution, there is a risk that a fraudulent transaction is attempted to be initiated by a fraudster. The sending bank can verify that there are sufficient funds available to cover the transaction, and that the payer has authenticated itself. In a debit pull situation, on the other hand, a bank initiating a transaction for a payee does not necessarily know the payer, or whether the payer has funds sufficient to cover a transaction. Also in a debit pull situation, advanced fraud protection mechanisms typically cannot be employed (e.g., transaction analytics, pattern recognition, etc.). Funds also are not made immediately available.

As described above, in one example embodiment the system has the ability to send or receive payments on a 24/7 basis, provides immediate notification to senders and receivers, immediate fund availability to recipients on a 24/7 basis, and employs an extensive set of payment and non-payment messages. The system provides payment certainty for receivers, a process to request the return of erroneous payments, and, in one example embodiment, also employs value limits on transactions updated periodically based on predetermined criteria. Settlement is performed in a manner that mitigates material risk of loss, and preferably tokenization of all account data is employed such that payments can be initiated using an alias accounting/routing number. A threshold level of security can be required to provide privacy protection of all participating financial institutions.

### Real-Time Payments—Immediate Availability of Funds for Receivers

In one example embodiment herein, a receiving FI can be required to make payments available immediately to the extent possible, and to comply with all applicable laws (e.g., AML, OFAC) and necessary risk management processes (fraud monitoring). For example, funds can be made available immediately, within seconds, minutes, hours, multiple times daily, at the end of the day, and can be tied to settlement, in some embodiments. Availability exceptions are a small fraction of total payments. This provides consistent expectations for payees and payers, allows for an expanded number of use cases, and limits confusion for payers and payees. Pre-screening transactions at the network level can minimize exceptions (e.g. AML, OFAC, fraud suspects), and notifications can be provided to payees for transactions that cannot be immediately screened.

### Transaction Value Limits

In one example embodiment, payment value limits are employed to mitigate risk. For example, a pre-determined value limit on transactions is employed to limit exposure to credit or liquidity risk between sending and receiving banks. This has the advantage of limiting the amount of credit, settlement, and/or liquidity risk, and reduces potential risk from fraud events.

System-wide transaction value limits (e.g., $25,000) can be employed based on risk tolerances of institutions and research into use cases. Sending FIs also may impose origination limits (e.g., lower limits) per day or per transaction or on some other predetermined basis. In one example, a receiving FI cannot impose a lower limit on its receivers, and there is a process for updating limits based on objective criteria, such as, for example, periodic evaluations (e.g., analyzing transaction data, model settlement risk, survey unmet needs, etc.), and automatic triggers are employed when limits are exceeded (e.g., transaction thresholds, loss rates, or the like). In example embodiments herein, payment transactions can be evaluated at a sending and/or receiving FI, at the network 130, and/or at another element of the transaction system 100, to determine whether a payment amount specified in the transaction equals or exceeds the limit. If the limit is equaled or exceeded, then the evaluating element can provide an alert indicative thereof to the sending and/or receiving FI or another element of the transaction system 100, and, in one example embodiment herein, the transaction is discontinued/not effected.

FIs also may manage sending limits based on, for example, customer segments and use cases, structuring of multiple transactions to circumvent limits, and overall customer activity. In certain countries, certain value limits are employed. For example, Poland employs a limit at $27,500 or 100,000 zt, in Japan transactions over $842,500 or ¥100 million are diverted to real time gross settlement, and in South Africa there is a limit of $430,000 or ZAR 5 Million until 16:00 hr, and $21,500 or ZAR 250,000 during non-business hours. In the UK there is a limit of $155,000.

Setting a payments limit mitigates exposure to fraud, credit, and liquidity risk while still enabling customers to benefit from real-time payments. A limit on transactions can help prevent minor errors and challenges associated with new systems. A limit also can mitigate credit/liquidity risk for banks and reduce fraud risk. An initial limit of, for example, $25,000 allows most customers to benefit from real-time payments as follows:

P2P transfers: a threshold high enough to cover transfers to family for emergencies,

P2B ad-hoc: a limit still covers emergency bill payments. Covers many stock purchases and will cover more as limits migrate over time,

B2B ad-hoc: a threshold covers most small business just-in-time supplier payments and some emergency bill payments, but may cover more if the limit migrates over time,

B2P ad-hoc high value: a limit covers many insurance claims or legal settlements, but could cover more if the limit migrates over time,

B2B ad-hoc low value: a limit covers temporary employee wages and emergency payroll, since they are individual transactions.

Limits can be raised incrementally where deemed appropriate.

### Settlement and Settlement Risk Mitigation

Effective settlement risk management mechanism(s) ensure that a payer has funds available to settle a transaction/credit to a payee (e.g., pre-funding or funds not available to payee until after settlement). Such management is useful because it provides improved customer experience in the event of a FI failure, fraud, etc. Such a mechanism decreases a receiving financial institution's risk, and insures overall integrity and trust of the payment system. In one embodiment, settlement cycles can be on a real-time transaction-by-transaction basis, although in other embodiments settlement cycles can be at a predetermined time, such as, e.g., the end of day, multiple times/day, in real-time, etc. Interbank settlement should effectively eliminate material risk to receiving FIs that sending FIs will not meet their obligation to settle. For net settlement systems. Pre-funding of the settlement pool eliminates the risk that a FI will not settle. Settling more frequently can limit the buildup of large unsettled debit positions.

According to an example aspect herein, FI settlement accounts are pre-funded. As pointed out above, prefunding of settlement pools mitigates the risk of unsettled positions. Also, different settlement mechanisms can be employed for large credit worthy FIs versus smaller and non-credit worthy FIs.

There are several models for settlement management that can be considered while balancing funds availability needs. For example, in a PIN/Debit system, funds in a payer's account are captured immediately, and may become available in a payee account in 2-3 days. Settlement typically occurs one time per day. In Japan, real-time funds availability is provided, as is end of day settlement for non-RTGS payments (over maximum value). In Korea there is immediate fund availability, and deferred net settlement (next day). In India there is real-time funds availability, and end of day net settlement. In China there is funds availability within 20 seconds, and deferred net settlement. Each of those is a daily settlement model.

Multiple per day settlement models also exist. For example, with respect to funds availability, in Chile a receiving bank must respond within 10 seconds, and there are settlements two times per day through RTGS. In Sweden there is near real-time (within 15 seconds) funds availability, and multiple deferred central bank settlements per day. In South Africa funds availability is within 60 seconds, and there is deferred net settlement (hourly during the business day). In Denmark, funds availability is in near real-time (1-10 seconds), and there is Net, intraday settlement. Singapore has near real-time (seconds) funds availability, and deferred settlement 2 times per day (with intention of increasing cycles as system matures). In the United Kingdom for funds availability there is 15 second confirmation, posting within 2 hours, and deferred net settlement, 3 times per day. These models do not clear and settle on a transaction by transaction basis in real-time, as in an example embodiment of the present application.

Real Time settlement management systems also exist. For example, in Brazil 97% of funds are released in less than one minute, and there is continuous net settlement. In Switzerland there is purported real-time funds availability and real-time settlement. In Mexico funds availability occurs within a maximum of one minute and 5 seconds, end-to-end. Poland has near real-time (seconds) funds availability, and immediate settlement.

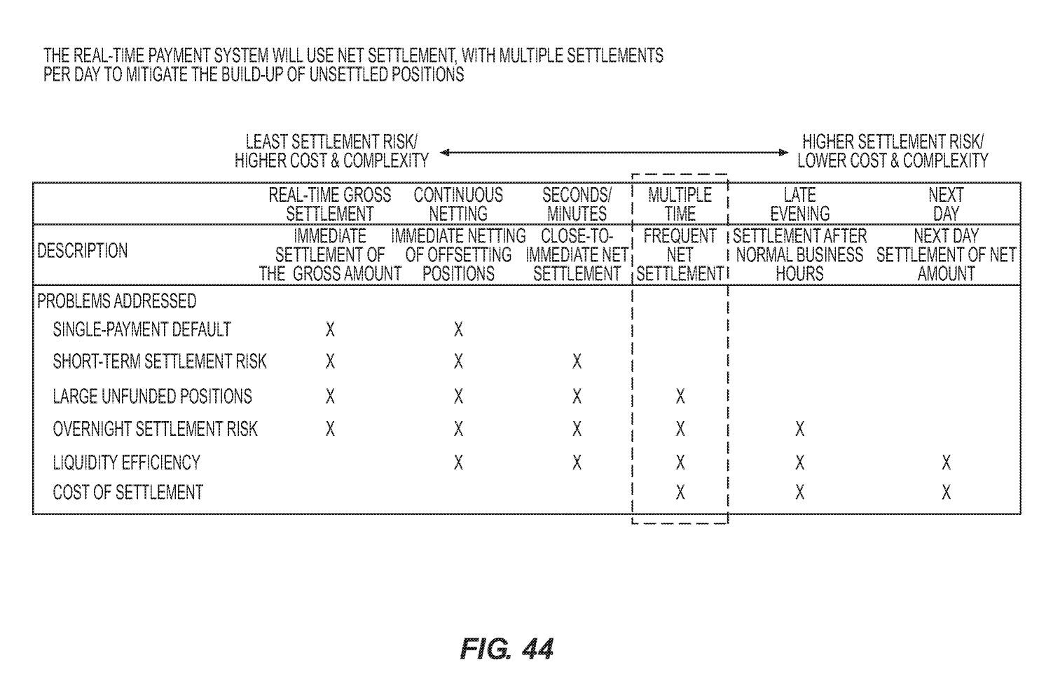

In one example embodiment herein, the real-time payment system employs pre-funding of accounts and net settlement, with multiple settlements per day to mitigate the build-up of unsettled positions, although this example is not limiting. Indeed, other types of settlement can be employed, such as, without limitation, any of the types represented in FIG. 44. Settlement can be performed or at least partially be effected by, for example, the settlement facility 134 and or settlement system 133 of FIG. 1.

As pointed out above, settlement herein can employ a hybrid approach to mitigate risk of default, including a pre-funded account and allowance for qualified FIs to carry an unfunded net debit position. Regarding prefunding, financial institutions (e.g., 111 and 120) can deposit a full or partial settlement obligation amount in cash into one or more settlement accounts prior to a clearing, and the pre-funded balance is used to settle net positions at scheduled times. The account(s) can be maintained by, for example, a settlement facility such as facility 134 or service 133, or at another location. With respect to a multilateral net debit cap, in one example herein there is a limit on the net unfunded settlement position for participating FIs across all counterparties, and the net unfunded settlement position is the amount by which the net debit position exceeds an FI's balance in the pre-funded settlement account. Clearing can be suspended when the net unfunded debit position reaches the net debit cap. Also, in one example herein the limit is based on credit risk criteria pre-established through, for example, a governance process. It may happen that an FI may have a zero net debit cap, which means that the FI must pre-fund its entire settlement position. Conversely, if an FI has a zero balance in the pre-funded settlement account, its multilateral net debit cap represents its entire settlement capacity. FIs can deposit funds into the pre-funded settlement account to initiate payments that exceed their net debit cap. Loss-sharing agreements can be employed wherein remaining participants cover losses in the event of a settlement default; for example, a loss sharing formula established through governance process.

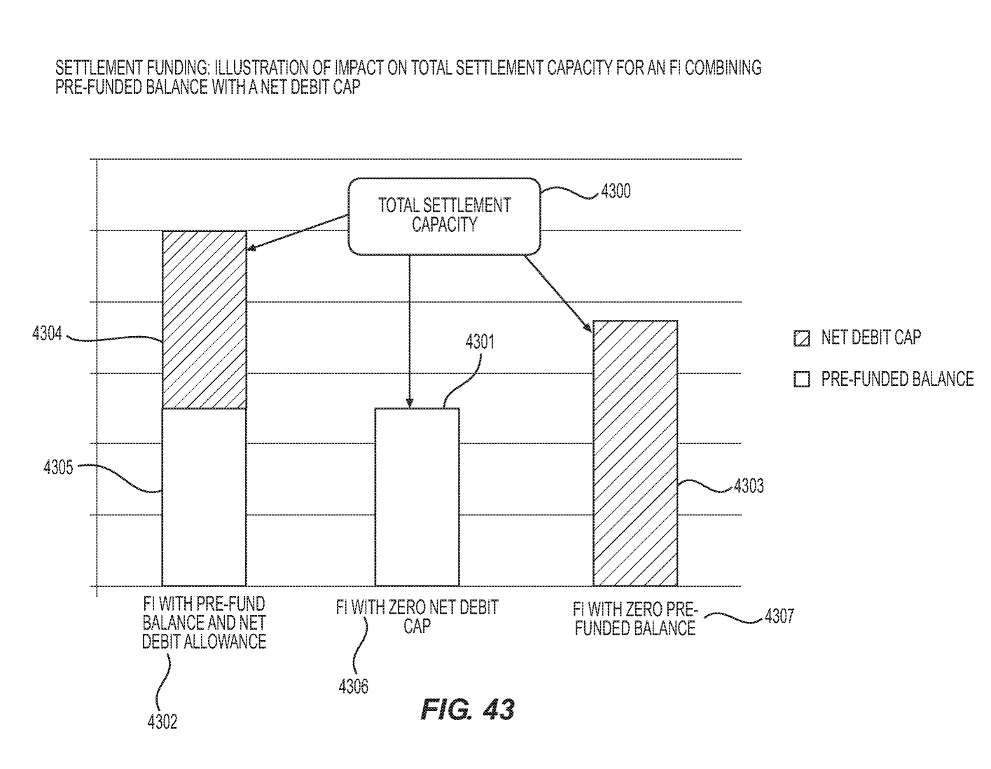

FIG. 43 represents an example of the impact on a total settlement capacity 4300 for a FI, in a case where pre-funding is employed in conjunction with a net debit cap, or where only one of those is employed. FIG. 43 shows a situation 4302 where a FI has a pre-funded balance 4305 in a settlement account and a net debit cap 4304, a situation 4306 where a FI has a zero net debit cap and a prefunded balance 4301 in a settlement account, and a situation 4307 where a FI has a zero pre-funded balance and a net debit cap 4303 in a settlement account. Thus, for example, for situation 4302, if the debit allowance 4304 is $1,000,000, and the pre-funded balance 4305 is $1,000,000, and the applicable FI requests settlement in the amount of $2,000,000 or less, then settlement will occur (although the FI may be required to replenish the pre-funded amount). However, assuming the amount of balance 4301 is $1,000,000, settlement for $2,000,000 would not take place in scenario 4306 because the balance is exceeded. Also, assuming the net debit cap 4303 is $1,600,000 in scenario 4307, then a settlement in the amount of $2,000,000 also would not take place because the cap is exceeded. However, settlement for an amount of $1,600,000 or less would take place in scenario 4307. In another example embodiment herein, movement is tracked towards a combination of the prefunded balance and the debit cap at the transaction level (clearing). In that embodiment, transactions are not cleared that would place a FI in a position where it would not be able to settle (i.e., go beyond the FI's prefunded and debit cap combined). This approach eliminates any settlement risk based on transaction activity and essentially limits settlement risk to occurrences of bank failure.

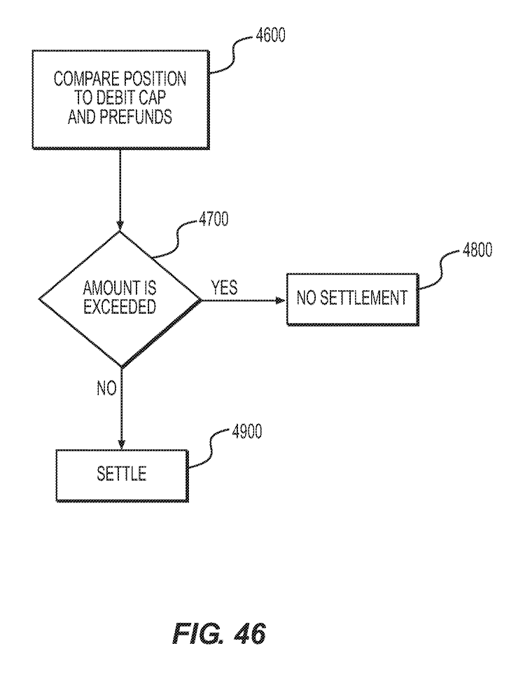

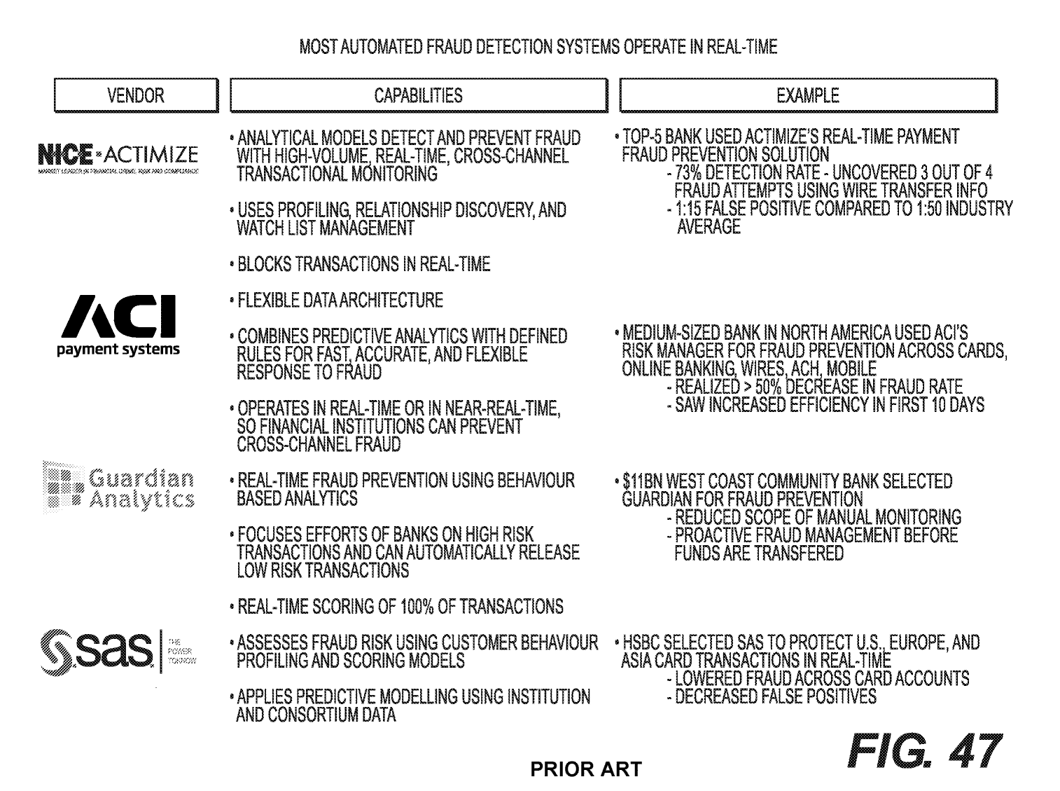

As can be understood in view hereof, and referring to FIG. 46, a method herein includes the settlement service 133 comparing (step 4600) a financial position of at least one FI (e.g., a position of the FI resulting from conducting transactions, such as, without limitation, payment transactions according to the methods herein) to a combination of a value of a pre-funded balance (if any) in a settlement account and a value of a net debit cap (if any). Also, the service 133 can recognize when an unfunded settlement position has reached a predetermined net debit cap (which can be unilateral and based on a particular FI, or multilateral based on multiple FIs), and then effect settlement multiple times per day in order to reduce the positions below the cap (or it can employ any other settlement mechanism such as those of FIG. 44, to reduce the positions). Thus, if it is determined that the combination of the net debit cap and pre-funded amount is exceeded in step 4700 (“Yes in step 4700), then settlement is suspended (step 4800). Otherwise, if the combination is determined not to be exceeded in step 4700 (“No” in step 4700), then settlement occurs in step 4900. That step can be effected according to any predetermined settlement technique, such as, for example, settlement multiple times per day or using any other suitable settlement technique (e.g., including, without limitation, any of those represented in FIG. 44).

Also, in accordance with an example embodiment herein, in the case of multiple settlements, the frequency thereof can be determined to avoid a predetermined level of unsettled net debit positions on the part of FIs, and to prevent large unfunded positions. For example, the settlement service 133 and/or settlement facility 134 can evaluate whether the unsettled positions of all participating FIs, or a subset thereof, exceeds a predetermined threshold (e.g., 10% of the FIs have unsettled debit positions exceeding a predetermined threshold amount). If the threshold is exceeded, then the service 133 and/or facility 134 can increase the frequency at which settlements occur and/or schedule and conduct one or more additional settlements that were not previously scheduled. In the event losses occur owing to one or more FIs not funding their unfunded positions in time, then the losses can be shared (funded) between multiple FIs, based on predetermined criteria.

In another example embodiment herein, settlement can occur in real-time through a prefunded settlement account with a prefunded requirement for each participating FI, as opposed to the hybrid approach discussed above. In this embodiment, the real time payment system 5000 (“the RTP System”) determines the prefunded requirement for each participating FI that sends payments (see, e.g., FIG. 48). FI's that only receive payments will not have a prefunded requirement. The prefunding requirement is an amount that is the minimum level of funding required to be provided by each participating FI before the participating FI can begin sending payments. In one example embodiment, prior to on-boarding a participating FI, the RTP System 5000 (e.g., network) determines the specific FI's prefunded requirement. This determination takes into account, for example, the volume and the value of payments that the specific participating FI is anticipated to send through the RTP System. The minimum prefunded requirement for a participating FI can also increase or decrease over time. In one example embodiment, each participating FI is required to deposit the prefunded requirement into a prefunded settlement account (the participant's “opening prefunded balance”), which is a special deposit account established at a Real Time Payment (“RTP”) Prefunded Account Bank, including, for example, the Federal Reserve Bank of New York (FRBNY). Once the prefunded requirement is deposited by the participating FI(s) in the prefunded settlement account, the RTP System is notified of the deposit and can track the prefunded balance for each participating FI. FIG. 48 illustrates one example embodiment of the real time payment (RTP) System 5000 with five participating banks (Banks A through E) that each have a specific prefunded requirement and/or opening prefunded balance, and the specific deposit account (i.e., “RTP Settlement Account”) 5001 with the RTP Prefunded Account Bank (i.e., the Federal Reserve Bank of New York (FRBNY)) As shown in FIG. 48, each participating FI (Banks A through E) is allocated a specific position by the RTP system 5000 that can be verified by the RTP System for a requested Credit Transfer. In one example embodiment herein, the RTP System not only verifies the position for a requested Credit Transfer, but this is the position against which the core processing system considers to determine whether the bank originating the credit transfer has enough funds to cover the transaction. If the value of the transaction exceeds the funds available, the transaction will be rejected. The balance for the RTP Settlement Account 5001 is the total amount of each of the participating FIs prefunded requirement. This balance for the RTP Settlement Account 5001 only changes if the participating FI transfers additional funds, i.e., into or out of the RTP Settlement Account 5001, as discussed in more detail below.

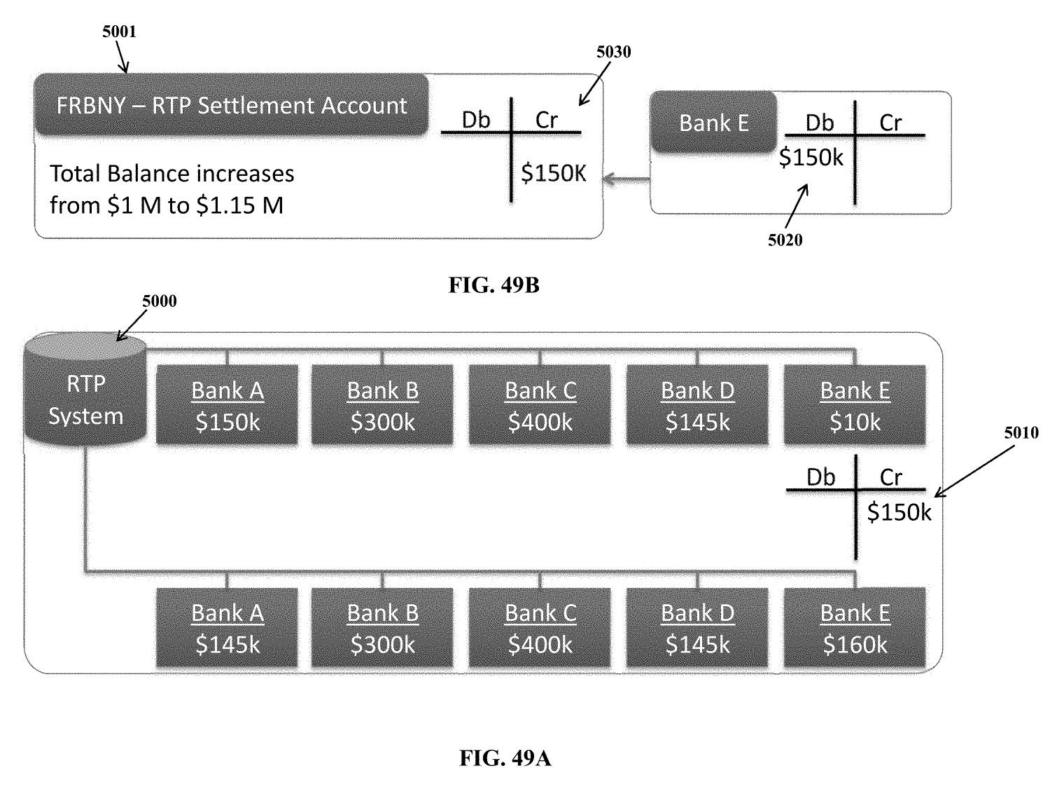

In accordance with one example embodiment herein, after each participating FI has transferred its prefunded requirement or “opening prefunded balance” to the RTP Settlement Account 5001, the participating FI is permitted to transfer additional funds to the prefunded settlement account. There is no limit on the amount that a participating FI can add as supplemental prefunding, and participating FI's are able to add supplemental funds throughout the day until the end-of-day closing procedure begins. For example, in one embodiment, participating FI's can add supplemental funds while Fed Wire, or any other funding mechanism that allows for funds to be placed in a respective account, is open. In another example embodiment herein, participating FI's are able to borrow funds across other FI's while Fed Wire, or any other applicable funding mechanism, is down. FIGS. 49A and 49B illustrate one embodiment of the real time payment (RTP) System 5000 with the five participating banks of FIG. 48 (Banks A through E) in which Bank E deposits or adds supplemental funds of $150,000. As shown in FIG. 49A, Bank E's allocated opening prefunded balance of $10K is credited with the $150,000 of supplemental funds by the RTP System 5000, such that Bank E's prefunded balance is now allocated to $160,000 (see, e.g., credit (CR) 5010). As shown in FIG. 49B, the balance for the RTP Settlement Account 5001 is also increased or credited by the amount of the supplement funds added by Bank E (see, e.g., credit (CR) 5030), while Bank E is debited the amount of the supplemental funds (see, e.g., debit (DB) 5020 added into the RTP Settlement Account 5001. In one embodiment, the supplemental funds are sent by Bank E (or a Funding Agent) via Fed Wire to the RTP Settlement Account 5001. In this embodiment, Bank E's position does not need to be debited the amount of the supplemental funds sent to the RTP Settlement Account 5001.

Funding within the RTP System 5000 (e.g., network) is provided by Funding FIs and Funding Agents (i.e., FIs that provide liquidity and request liquidity disbursements for a Non-Funding FI; however, Funding FIs can also request a disbursement). Funding FIs and Funding Agents are also referred to as “Funding Participants” herein. As noted above, participating Is that only receive payments do not have a prefunded requirement and, thus, do not fund. However, receive-only participating Hs may still be Funding FIs to the extent that they request liquidity disbursements to their own account at the RIP Prefunded Account Bank and/or a Fed Account (e.g., Fed Wire). For example, in one embodiment, disbursements are sent from the RTP Account to a Fed Account registered by the Participant via Fed Wire. A Funding Agent funds for one or more Non-Funding Hs in an amount equal to each of its Non-Funding FIs' prefunded requirements, which funds are applied by the RTP System 5000 (e.g., network) as separate opening positions (“opening prefunded balances”) for each of the agent's Non-Funding FIs. Any supplemental funding that the Funding Agent may provide or any disbursements the agent receives are designated by the Funding Agent and applied by the RTP System 5000 (e.g., network) to the prefunded settlement account of a particular Non-Funding FI.

As discussed above, Funding Participants prefund the prefunded requirement in a RTP System 5000 (e.g., network) operated account at the RTP Prefunded Account Bank 5001 (e.g., the Federal Reserve Bank of New York (FRBNY)) for themselves (in the case of a Funding FI) or on behalf of their respective Non-Funding FIs (in the case of a Funding Agent). The RTP System 5000 (e.g., network) is notified of the value of the prefunded amount supplied by each Funding Participant and this value is recorded as the Opening Prefunded Balance, which is the initial spending limit that the participating Ft can have within the RTP System 5000 (e.g., network) (see, e.g., FIG. 48). As payment transactions are sent and received by a participating FI, the participating FI's Net Position is increased or decreased accordingly. A participating FI's Prefunded Balance at any point in time is its Opening Prefunded Balance plus its Net Position. If a transaction would cause a participating FI's Prefunded Balance to be less than zero, the transaction is rejected by the RTP System 5000 (e.g., network). It is therefore not possible for a participating FI to default or for the service to carry any inter-bank settlement risk as each transaction is settled in real time with prefunded funds held within the Real Time Prefunded Account 5001.

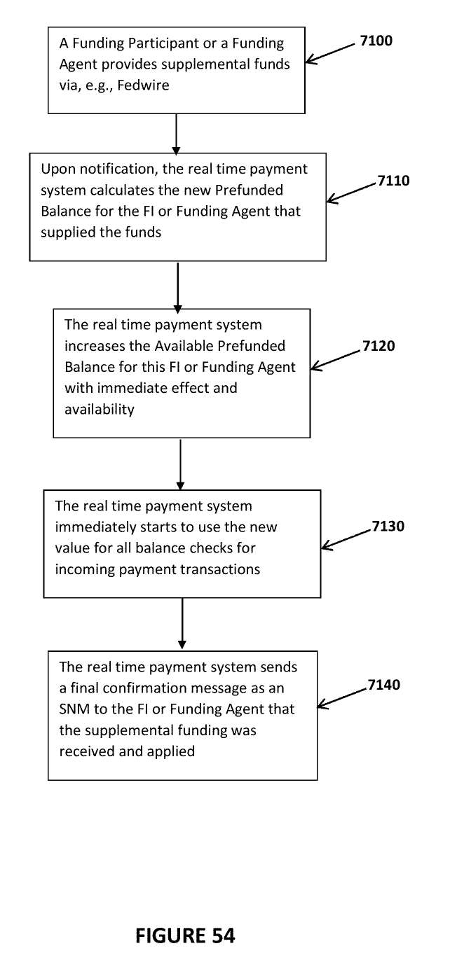

A Funding Participant (either for itself or on behalf of an FI) can provide additional, or supplemental, funding into the Real Time Prefunded Account 5001 and thereby increase its or its FI's Prefunded Balance at any time, such as during Fed Wire operating hours (see, e.g., FIGS. 49A and 49B). FIG. 54 illustrates an example embodiment of a Supplemental Funding process in which a Funding FI or a Funding Agent places additional funds into the Real Time Prefunded Account 5001. As shown in the embodiment of FIG. 54, at step 7100, a Funding Agent or Participant FI provides supplemental funds to the Real Time Prefunded Account 5001 via, for example, Fed Wire. At step 7110, the RTP System 5000 is notified of the supplemental funding provided by the specific Funding Agent or Participant FI, and the RTP System 5000 calculates the new Prefunded Balance for the applicable FI or Funding Agent that supplied the funds, resulting from the addition. At step 7120, the RTP System 5000 increases the Available Prefunded Balance in the Real Time Prefunded Account 5001 for this FI or Funding Agent with immediate effect and availability. At step 7130, the RTP System 5000 immediately starts to use the new value for all balance checks for incoming transactions (e.g., when determining funds available for credit transfers or refund requests). In one example embodiment herein, every transaction that gets settled (e.g., sent and/or received) decreases or increases the available prefunded balance, and hence, the balance against which additional transactions are cleared. At step 7140, the RTP System 5000 sends a confirmation message as an SNM to the FI or Funding Agent for which the supplemental funding was received and applied.

In one example embodiment herein, pooled or non-pooled funding can be provided. Small banks may lack a high level of liquidity, and may obtain funding from one or more larger banks. Also each bank may be required to maintain a certain level of funding in a RTP account, or, funds can be pooled together from across banks in the account.

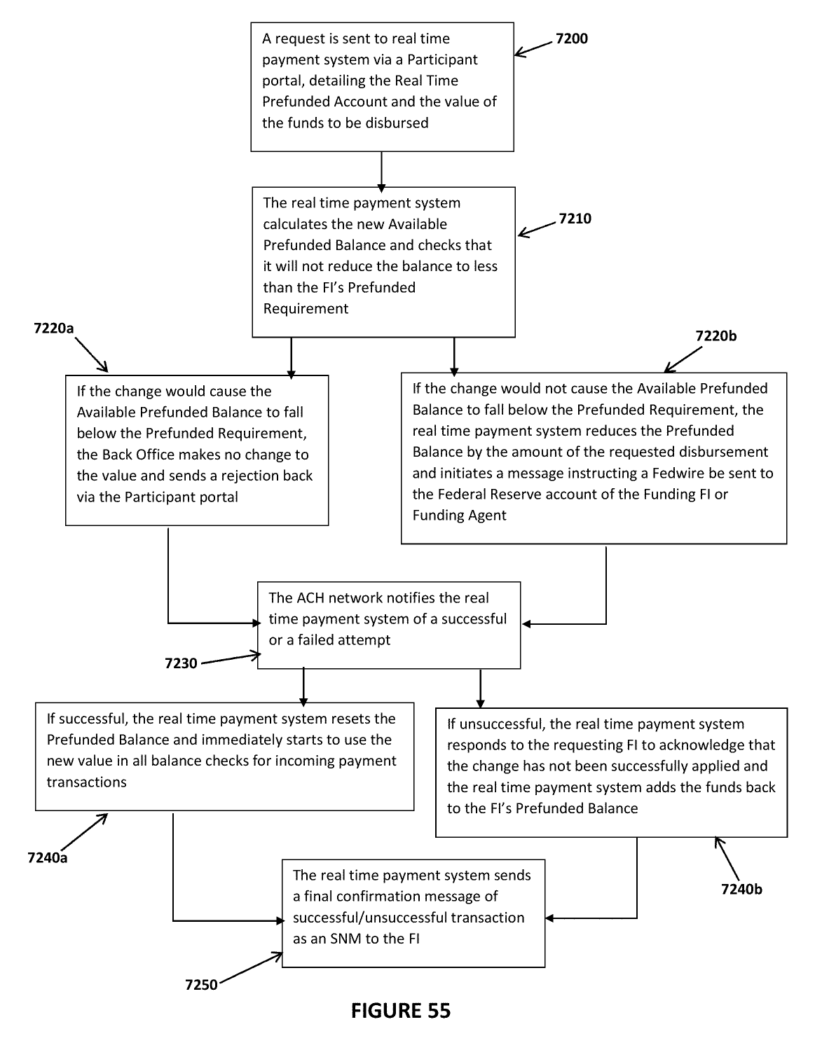

A Funding Participant (either for itself or on behalf of an FI) can request a disbursement from the Real Time Prefunded Account 5001 to remove excess liquidity related to its or its FI's Prefunded Balance. Disbursement requests can be subject to certain business rules that ensure each participating FI's Prefunded Balance remains sufficient to cover its expected payment activity. FIG. 55 illustrates an example embodiment of a process of Disbursement (drawdown) of Funds in which a Funding Participant or Funding Agent submits a request to disburse funds from the Real Time Prefunded Account 5001. As shown in the embodiment of FIG. 55, at step 7200, a request is sent from the participant to the RTP System 5000 via, for example, a participant portal, detailing the Real Time Prefunded Account 5001 and the value of the funds to be dispersed. At step 7210, the RTP System 5000 calculates the new Available Prefunded Balance that will result from the reduction of funds, and checks that the balance will not be reduced to less than the applicable FI's Prefunded Requirement. Once this check is done by the RTP System 5000, if the change would cause the Available Prefunded Balance to fall below the Prefunded Requirement, the RTP System (e.g., Back Office, described below) makes no change to the value and sends a rejection back via, for example, the participant portal (step 7220a). If, on the other hand, after the check described above, the change would not cause the Available Prefunded Balance to fall below the Prefunded Requirement, the RTP System 5000 reduces the Prefunded Balance by the amount of the requested disbursement and initiates a message instructing that the value of the disbursement be sent via, for example, a Fed Wire, to the Federal Reserve Account of the Funding FI or Funding Agent (step 7220b). After either step 7220a or 7220b is conducted, a notification of a successful or failed attempt is sent by the RTP System 5000 to the particular Funding Participant (step 7230). If successful, at step 7240a, the RTP System 5000 resets the Prefunded Balance and immediately starts to use the new value in all balance checks for incoming payment transactions. In one example embodiment herein, the RTP System 5000 resets the Prefunded Balance before the request is sent from the participant to the RTP System 5000 via, for example, the participant portal. In this embodiment, by resetting the Prefunded Balance in this manner, the particular Participant will not be able to spend funds that it does not have. If unsuccessful, at step 7240b, the RTP System 5000 responds to the requesting FI to acknowledge that the disbursement cannot be made. In one example embodiment herein, if the RTP System 5000 has reset the Prefunded Balance before the request is sent from the participant to the RTP System 5000 via, for example, the participant portal, the RTP System 5000 will increase the available prefunded balance by the amount of the disbursement that was not made. At step 7250, the RTP System 5000 sends a confirmation message of the successful or unsuccessful transaction as an SNM to the applicable FI. In one embodiment, the RTP System 5000 includes a database server (e.g., Back Office) that information (e.g., each participating FI's Available Prefunded Balance) is written to/from a core processing system (see, e.g., core processing system 131 of FIG. 1). The core processing system maintains this information in a memory, but once a transaction is complete, the information is written into an analytical database. After a predetermined time period (e.g., every thirty (30) seconds), information from the analytical database is written to the Back Office database. In one example embodiment, the Back Office database, core processing system, and analytical database are all components of the RTP System 5000 (and/or the RTP System 130).

Funding Participants can view their Prefunded Balance at any time using, for example, a participant portal or through a system to system message. Funding Agents also can view both their Prefunded Balance (if they have one) and the Available Prefunded Balances for the FIs that they are supporting. In one example embodiment herein, an FI and/or a Funding Agent can inquire about their Prefunded Balance. In another example embodiment, a System Operator can inquire about an FI funding position (see, e.g., the Real Time Payment Inquiries, discussed above). In one example embodiment, an Inquiry is sent by a Funding Participant(s) and/or a System Operator to the RTP System 5000 with regard to the Prefunded Balances recorded within the RTP System 5000. The RTP System 5000 returns the results of the Inquiry (i.e., the current Prefunded Balance(s)) to the specific Funding Participant(s) and/or System Operator for viewing, but the results returned reflect the latest position as recorded within the RTP System 5000 (e.g., may have up to a thirty second delay). The returned Inquiry results, for example, show one or more of the following: (i) the current Reconciliation Window, which will be discussed in further detail below, (ii) the Opening Prefunded Balance for that FI, (iii) the prefunded requirement for the FI, (iv) the Prefunded Balance for the FI, (v) supplemental funds added by the FI since the last Reconciliation Checkpoint, which will be discussed in further detail below, (vi) disbursements made by the FI since the last Reconciliation Checkpoint, (vii) the Low and High Watermark thresholds for the FI, which will be discussed in more detail below, and (viii) the latest Net Position for that FI. Each of the foregoing is determined by the RTP System 5000 in response to the Inquiry, before being returned. See also, e.g., the Real Time Payment Inquiries, discussed above.

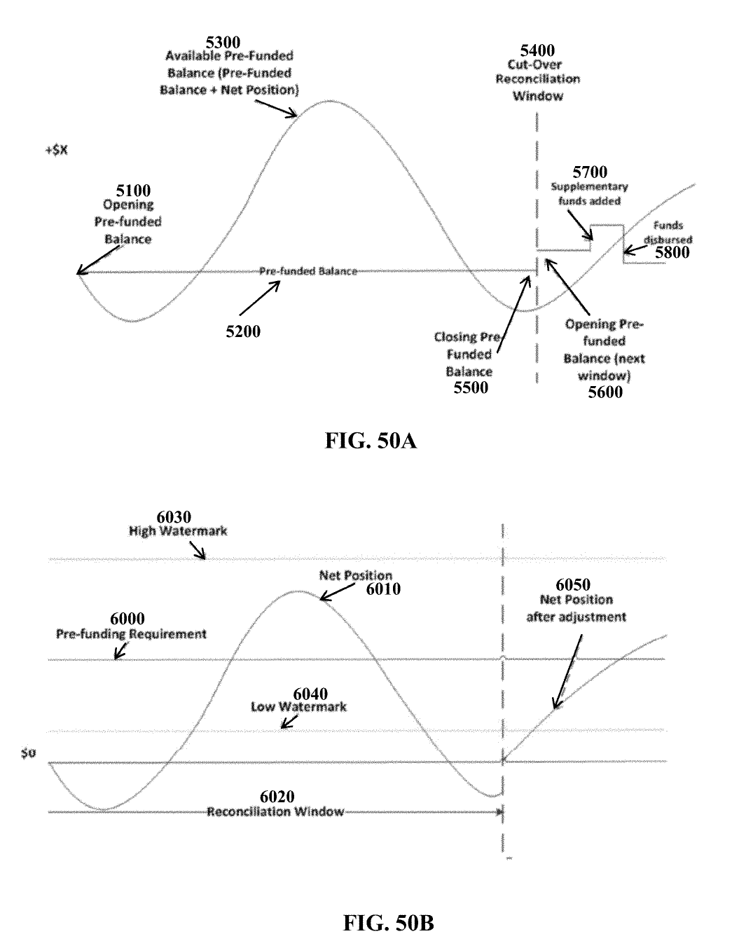

While a Funding Participant (for itself or for other FIs) may provide supplemental funding or maintain a balance in the Real Time Prefunded Account 5001 in an amount that exceeds a FI's prefunded requirement, the Funding Participant is expected to maintain a minimum Prefunded Balance equivalent to its prefunded requirement in order to ensure the viability of its on-going participation in the RTP System 5000. While a FI's Prefunded Balance may be permitted to go below its prefunded requirement at certain times due to its current payment activity, the FI's ability to send payments is not stopped. Payments are only rejected if the Debtor FI's overall Prefunded Balance is insufficient to settle the payment. For example, a payment will be rejected in the Debtor FI's overall Prefunded Balance reaches a value of zero. However, it is expected that at the end of a Reconciliation Window (described below) for each participating FI, the FI or its Funding Agent will provide supplemental funding to bring the FI's Available Prefunded Balance back to the amount of its prefunded requirement if at the time of the Reconciliation Window, the FI's Available Prefunded Balance is less than the FI's prefunded requirement. In particular, for example, FIGS. 50A and 50B illustrate example embodiments of how the Net Position 6010 and/or Available Prefunded Balance 5300 for a FI can vary as payments are sent and received through a Reconciliation Window 6020.

For example, FIG. 50A illustrates a particular FI's Available Prefunded Balance 5300 (higher curve) during a single day, while FIG. 50B illustrates the particular FI's Net Position 6010 (lower curve) during the same day. The values illustrated in FIGS. 50A and 50B generally represent the values for the accounts of the particular FIs in the RTP System 5000 of FIG. 49A. As shown in FIG. 50A, the FI has supplied its Prefunded Balance 5200, which is initially the FI's Opening Prefunded Balance 5100. As discussed above, as payment transactions are sent and/or received, the Net Position 6010 (lower curve) and Available Prefunded Balance 5300 (higher curve) are updated (i.e., by increasing or decreasing accordingly). For example, in one example embodiment, as discussed above, every transaction that gets settled (e.g., sent and/or received) decreases or increases the Available Prefunded Balance, and hence, the balance against which additional transactions are cleared. At a predetermined time, a Reconciliation Checkpoint 5400 occurs, and a Closing Prefunded Balance 5500 is determined. This Closing Prefunded Balance 5500 is the Opening Prefunded Balance 5100 plus any supplemental funds added or any disbursements subtracted, as well as any net transaction activity (e.g., credit transfers sent and/or received). In FIG. 50A, the Opening Prefunded Balance 5100 is the same as the Closing Prefunded Balance 5500. Also, at the Reconciliation Checkpoint 5400, an Opening Prefunded Balance 5600 of a new Reconciliation Window 6020 is calculated (which may or may not differ from the Closing Prefunded Balance 5500), and a Net Position 6050 is reset to a value of zero. For example, in one embodiment, an Opening Prefunded Balance 5600 of a new Reconciliation Window 6020 is calculated based on the transactions preceding the new Reconciliation Window 6020, which includes, for example, the closing balance at the end of the preceding Reconciliation Window and the balance available when cut over to the new Reconciliation Window 6020. Adding supplemental funds (5700) and disbursements (5800) also affect the Available Prefunded Balance 5300, 5600 as shown in FIGS. 50A and 50B. At any point in time, the Available Prefunded Balance 5300 is calculated as the Opening Prefunded Balance 5100 plus the Net Position 6010 plus supplemental funds (5700) added up to that point in time since the start of the Reconciliation Window 6020, minus disbursements (5800) taken since the start of the Reconciliation Window 6020 until the point in time. A Low Watermark 6040 and a High Watermark 6030 for each participating FI are held by the RTP System 5000. These watermarks are predetermined amounts established by the participating FI that can be set as, for example, currency values or as a percentage of the Prefunded Balance 5200 at the opening of the current Reconciliation Window 6020. The Low Watermark 6040 indicates that a participating FI's Prefunded Balance 5300 has reached a predetermined “low” level, below its Prefunded Requirement 6000, at which the Participant elects to be notified (in order to manage its Available Prefunded Balance 5300). The High Watermark 6030 indicates that a participating FI's Prefunded Balance 5300 has returned to a predetermined level after having gone below to the Low Watermark level 6040, such that the High Watermark can act as a reset for the Low Watermark. In another example embodiment herein, the High Watermark notifies the participant if they have excess liquidity in the system. In the event that a payment causes an FI to have a Prefunded Balance 5300 that is less than its Low Watermark 6040, a warning message is sent by, for example, the RTP System 5000 to the FI and/or its Funding Agent, advising that additional funds need to be added to the Real Time Prefunded Account 5001. In one example, transactions are not rejected at this point, provided that the FI's Prefunded Balance is not less than the amount of any payments that the FI sends. In the event that a participating FI's Available Prefunded Balance 5300 reaches its High Watermark 6030 following a Low Watermark warning, a message is sent to the FI and/or its Funding Agent, to indicate that the FI's Available Prefunded Balance 5300 has returned to a predetermined level.

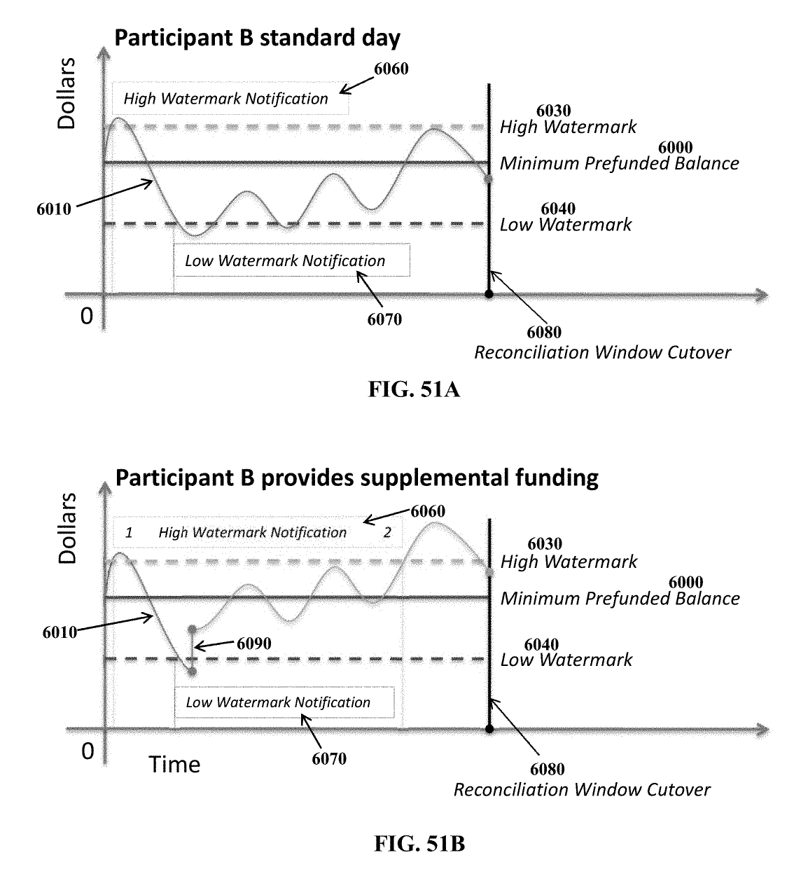

In accordance with another example embodiment herein, FIGS. 51A and 51B illustrate examples of (i) a standard day for a participating FI (Participant B) (FIG. 51A), and (ii) a day with supplemental funding for the same participating FI (Participant B) (FIG. 51B). As shown in FIG. 51A, during the standard day, the FI's prefunded balance 6010 varies throughout the day with every debit or Credit Transfer. As shown in FIG. 51B, with supplemental funding 6090, once the FI's prefunded balance 6010 is below the Low Watermark 6040, a Low Watermark Notification 6070 is sent to the FI, which is then able to provide supplemental funding 6090. The Low Watermark Notification 6070 allows for the participating FI to keep sufficient funds within the prefunded balance, by, for example, providing supplemental funding, to ensure that all Credit Transfers and/or payment transactions are able to be completed during the day. A High Watermark Notification 6060 is sent if the FI's prefunded balance 6010 passes over the High Watermark 6030. As further shown in FIGS. 51A and 51B, a Reconciliation Window Cutover 6080, which is generally at the end of the day (e.g., at a predetermined time), is a point at which the participating FI's prefunded balance 6010 is checked to ensure that the balance remains at or above the minimum prefunded balance 6000 for the specific FI. As FIGS. 50A, 50B, 51A and 51B illustrate, each participant FI's settlement position can be tracked within the RTP System 5000 in real-time.

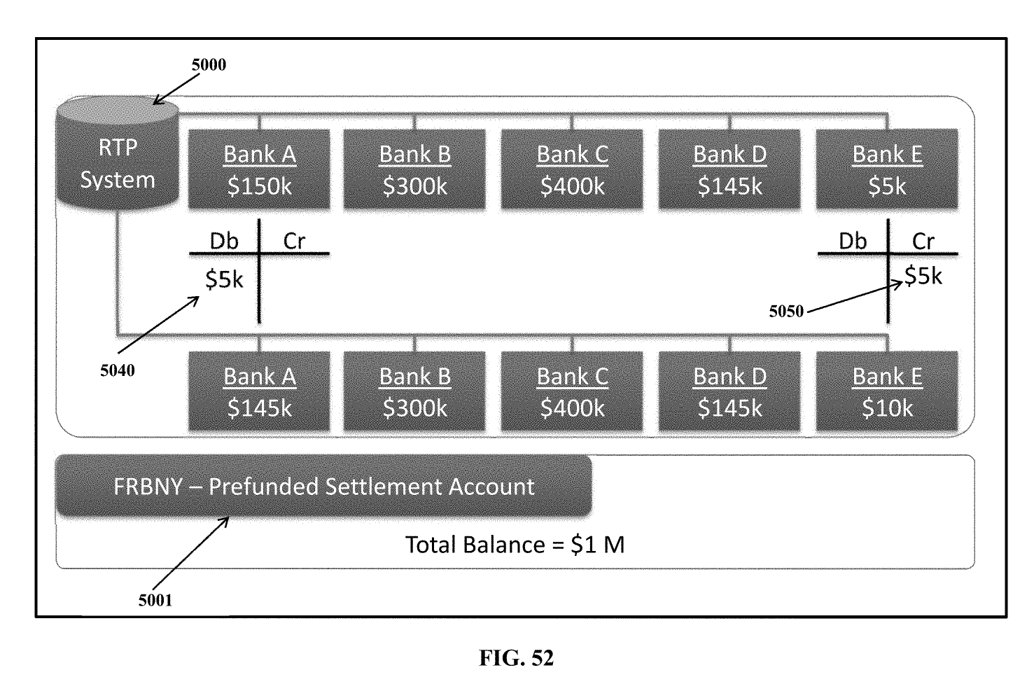

In accordance with another example embodiment herein, inter-bank settlement can be conducted with the Real Time Prefunded Account 5001. For example, all payments in the RTP System 5000 are either rejected without settlement or settled with finality. In particular, when a payment is sent to the RTP System, such as through the real time payment-process flow of FIG. 2, a check is performed by the RTP System 5000 to determine if the Debtor FI's Prefunded Balance is sufficient to settle the payment. If the balance is insufficient, the RTP System 5000 rejects the payment and it is not settled. If the balance is sufficient, the RTP System 5000 sends the payment (i.e., pacs.008 message) to the Creditor FI. In one example embodiment herein, before sending the payment, the RTP System debits the Debtor FI's position in the amount of the payment. If the RTP System does not debit the Debtor FI's position first, it is possible that the Debtor FI could initiate a payment that they ultimately would not have the funds to support. Upon receipt of the payment message (pacs.008) from the RTP System 5000, the Creditor FI can respond with, e.g., at least one of three responses: (i) Accepted, (ii) Accepted without Posting, or (iii) Rejected (see, e.g., FIG. 2 and discussion with respect thereto above). If the Creditor FI responds with a reject message, the payment is not settled. In one example embodiment herein, if the Creditor FI rejects the payment message and the Debtor FI's position was first debited by the RTP System before sending any payment, the Debtor FI is returned the funds that were debited against their position. If the Creditor FI responds with “Accepted” or “Accepted without Posting,” the RTP System 5000 settles the payment in real-time through simultaneous debit to the Debtor FI's Net Position and credit to the Creditor FI's Net Position in the amount of the payment, within the RTP Prefunded Settlement Account 5001. In one example embodiment herein, as discussed above, the Debtor FI's position is debited by the RTP System, before sending any payment. Accordingly, with this embodiment, once the Creditor FI “accepts” or “accepts without posting” the payment message, at this point, just the Creditor FI's position is credited in the amount of the payment. In one example embodiment herein, each transaction cleared only adjusts the FI's position on the RTP System. Thus, in accordance with this embodiment, funds are not officially moving within the RTP Prefunded Settlement Account 5001. FIG. 52 illustrates an exemplary real-time settlement through the RTP Prefunded Settlement Account 5001. As represented in the embodiment of FIG. 52, a participating FI (Bank A) sends a Credit Transfer message (pacs.008) for a payment of $5,000 to another participating FI (Bank E) by way of the RTP System 5000. Upon receipt of the Credit Transfer message, the RTP System 5000 verifies Bank A's position. If Bank A's position is sufficient to effect the payment to Bank E, Bank E is provided with the payment message (pacs.008), and, as discussed above, Bank E can either accept, accept without posting, or reject the payment. In the embodiment of FIG. 52, Bank E accepts the payment message and thus, Bank E's position is updated and credited with the $5,000 payment (see, e.g., credit (CR) 5050). By accepting the payment message, an accepted payment status message (pacs.002) or response is sent by Bank E and received by the RTP System 5000. The RTP System 5000 can then update Bank A's position (i.e., prefunded balance) by deducting or debiting the $5,000 payment for Bank A's position (see, e.g., debit (Db) 5040). As represented in FIG. 52, throughout the real-time settlement process that results in the payment between Bank A and Bank E, the Prefunded Settlement Account 5001 held by the RTP Prefunded Account Bank (e.g., the Federal Reserve Bank of New York (FRBNY)) remains unchanged. In one example embodiment herein, if the Creditor FI (i.e., Bank E) has previously breached the Low Watermark and the current transaction, discussed above, will return the Creditor FI to normal (i.e., the available prefunded balance goes at or above the High Watermark), a system notification message (SNM) is sent by the RTP System 5000 to the Creditor FI and an alert is generated for the system operator. If the Creditor FI is using a Funding Agent, then the SNM can be sent to the Funding Agent as well or in lieu thereof

Such settlement for “accepted” and “accepted without posting” payments is final and irrevocable, in one example embodiment herein. In another example embodiment herein, a Creditor FI that has “Accepted without Posting” a payment, and ultimately determines that it does not have sufficient funds available to provide the payment to the Creditor, must return the funds related to the payment, to the extent that such return is not prohibited by law, to the Debtor FI. The funds associated with these inter-bank settlements are guaranteed by virtue of the funds held in the Real Time Prefunded Account 5001. The RTP System 5000 is the “account of record” and the FI Net Position as recorded within the RTP System 5000 and applied to the FI's Prefunded Balance constitutes a formal representation of the funding positions for each FI across the service. In one example embodiment herein, if a Creditor FI has “Accepted without Posting” a payment, settlement happens to transfer the funds, but a Bank can indicate that the funds will not be available until after validating (i.e., checking) that the funds are indeed available. Thereafter, in this embodiment, the payment (a) is sent if the funding is available, or (b) is not sent if the funding is not available, and a message is sent to return the funds.

In one example embodiment herein, the RTP System 5000 provides a regular Reconciliation Checkpoint as part of the real time settlement process. In this embodiment, the RTP System 5000 tracks payment processing and creates reconcilable positions for FIs related to their payment activity for defined periods of time, referred to herein as Reconciliation Windows (see, e.g., FIGS. 50A, 50B, 51A and 51B). All transactions received by the RTP System 5000 are allocated to a Reconciliation Window during which they are received. For Payment messages, for example, a Reconciliation Window ID is added by the RTP System 5000 to the Credit Transfer message (pacs.008 messages) sent to the Creditor FI's by the RTP System 5000. A subsequent Payment Status Report message (pacs.002 message) returned to the Debtor FI by the RTP System 5000 also includes the Reconciliation Window ID, corresponding to when it was processed, and this Reconciliation Window ID is added to the message by the RTP System 5000. This is done so both parties know in which Reconciliation Window each message in the transaction was processed.

At a predetermined time, a cutover (i.e., close) of a Reconciliation Window occurs, and this immediately causes the current Reconciliation Window ID to be incremented by the RTP System 5000, and all new transactions received by the RTP System 5000 from that point or until the next cutover, are allocated to a new window. Transactions that were in process but not completed by the time of cutover are deemed to complete within the old window. In the context of a real time payment, the cutover of a Reconciliation Window triggers the Reconciliation Checkpoint function. As part of this function, a Reconciliation File for the RTP System 5000 is generated by the RTP System 5000. The Reconciliation File, which is generally created at the end of each Reconciliation Window, includes, for example, a list of every transaction conducted during the particular Reconciliation Window. Along with the Reconciliation File, a Reconciliation Report (see, e.g., the Real Time Payment Reports, discussed above) is also generated for each FI, which contains the Reconciliation start and end timestamp, their Opening and Closing Prefunded Balances for the window, their Net Position at cutover of the Reconciliation Window and a summary of the transaction histories for all incoming and outgoing transactions (accepted and rejected) including the total volume and value of any supplementary funding to and disbursements from the Real Time Prefunded Account 5001 for the FI within that window. In one example embodiment, a Reconciliation Report (e.g., SNM999 message) with the information described above, is generated by the RTP System 5000 for each FI (see, e.g., the Real Time Payment Reports, discussed above). If the Low Watermark and High Watermark are pre-defined as currency (e.g., dollar) values, these remain the same at Reconciliation cut-over. However, if the Watermarks are based on a percentage of the Prefunded Balance, these can be recalculated as pre-defined percentages of the Opening Prefunded Balance of the new Reconciliation Window. In one example, at the Reconciliation Checkpoint, the Closing Balance is calculated as follows: the Closing Pre-Funded Balance=Opening Pre-funded Balance+Net Position+Top-ups (i.e., Supplemental Funds added)−Drawdowns (i.e., Disbursements). The running of the reconciliation checkpoints does not disrupt payment processing and settlement, which continues uninterrupted throughout the process. Reconciliation Window cutover normally happens as a pre-configured scheduled event, but closure can also be triggered manually or otherwise, depending on applicable operating criteria. A window closure can be delayed or cancelled automatically or manually.

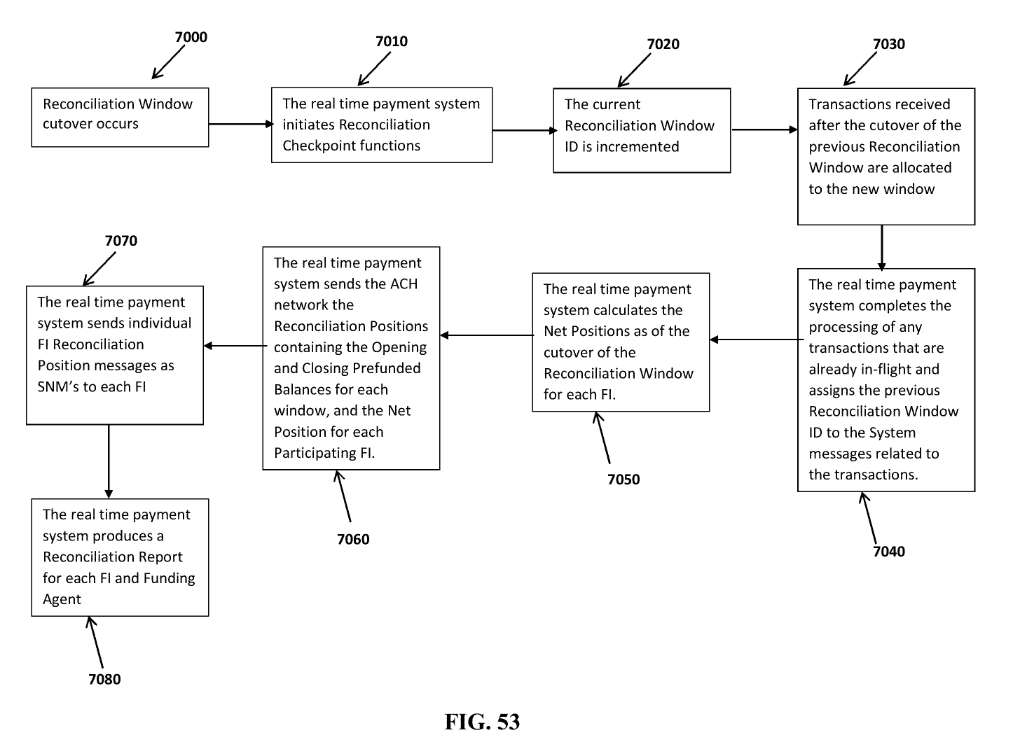

FIG. 53 illustrates an exemplary embodiment of the process of a Reconciliation Checkpoint use case. In one example, this Reconciliation Checkpoint use case is automatically triggered when a Reconciliation Window cutover takes place (step 7000), which happens either because a predetermined time is reached (e.g., as defined in an Internal Reconciliation Window Calendar), or through manual intervention. As shown in FIG. 53, once the Reconciliation Window cutover occurs (step 7000), the RTP System 5000 initiates Reconciliation Checkpoint functions (step 7010), and the current Reconciliation Window ID is incremented (step 7020) by a predetermined value. Any transaction received after the cutover of the previous Reconciliation Window is allocated to a new window (step 7030). The RTP System 5000 then completes the processing of any transactions which are already in-flight (i.e., not completed before the cutover) and assigns the previous Reconciliation Window ID (in which the transaction was initiated) to messages sent by the RTP System 5000 related to those transactions (step 7040). The RTP System 5000 then calculates the Net Positions that existed at the time of the cutover of the Reconciliation Window for each FI (step 7050). The RTP System 5000 then sends to, for example, the network, the Reconciliation Positions (at the cutover) containing the Opening and Closing Prefunded Balances of each Participant for each window, and the Net Position for each Participant (step 7060). This information generally includes the following detail for each FI: (i) the Reconciliation Window ID, (ii) the Participant ID, (iii) for each Outward accepted credit transaction, the counterparty Participant ID, the Transaction ID, and the amount of the credit transfer during the applicable window, and (iv) for each Inward accepted credit transaction, the counterparty Participant ID, the Transaction ID, and the amount of the credit transfer during the applicable window. Thereafter, the RTP System 5000 sends individual FI Reconciliation Position messages (e.g., a Summary version of each Reconciliation Message (e.g., SNM999 message)) as SNM's to each FI (step 7070), and the RTP System 5000 produces a Reconciliation Report for each FI and Funding Agent (step 7080) (see also, e.g., the Real Time Payment Reports, discussed above). The Reconciliation Report for each FI and/or Funding Agent generally includes the following detail: (i) the Reconciliation Window start date and time, (ii) the Reconciliation Window end date and time, (iii) the FI Opening Prefunded Balance at the start of the Reconciliation Window, (iv) the FI Closing Prefunded Balance at the end of the Reconciliation Window, (v) the total number and value of supplemental funding into the Real Time Prefunded Account during the applicable window, (vi) the total number and value of disbursements from the Real Time Prefunded Account during the applicable window, (vii) the Net Position at the end of the Reconciliation Window, (viii) the total number and value of credit transfers received and accepted by the FI (credits) during the applicable window, (ix) the total number and value of credit transfers sent by the FI and accepted by other FI's (debits) during the applicable window, (x) the total number and value of credit transfers received and rejected by the FI during the applicable window, and (xi) the total number and value of credit transfers sent by the FI and rejected by other FI's during the applicable window. In one example embodiment, the RTP System 5000 further tracks a record of all of the information described above, to enable this information to be reported. See also e.g., the Real Time Payment Reports, discussed above.

### Tokenization

Regarding tokenization, that involves use of a unique code that can only be used to post transactions to an account. It can be useful because a payer does not receive a payee's account data, and there is no need for a PCI-type of security for a payer. Tokens are safe even if exposed in a cyber-attack. Also, mass payment fraud is more difficult to execute.

Tokenization can be provided in a dynamic versus static manner. Tokenization is a preferred approach to secure mobile and e-commerce payments using credit and debit cards. Tokenization substitutes a limited-use random number (secure digital token) for a customer's account number so that the sensitive information remains safe. Even if compromised, the token is of limited or no use to cybercriminals. Tokenization as used in the example embodiments herein can involve various aspects. For example, one is a dynamic token, in which the token for each transaction is unique rendering the token itself unusable for any other transaction. Another is a static token, wherein the same token is used for multiple transactions, but may be restricted to prevent unauthorized use (e.g., credit only, single merchant). Still another is a domain restriction, that provides further fraud reduction by limiting token use to a certain digital wallet, merchant, channel (e.g., e-commerce), amount, transaction type (e.g. credit or debit) or expiration date. For a token vault, bank (or multi-bank) vaults create tokens, perform customer authentication and provision tokens to digital wallets or directories.

Regarding directory services, by virtue of the directory and use of tokens, senders can initiate payments using an alias (e.g., a phone number, email, or other code, etc.) which is used to retrieve bank routing information from a database. As such, receivers do not need to provide account numbers to senders, and senders do not assume a risk of holding receivers account numbers.

Optional Travel Rule and/or Regulatory Requirements

Various elements of the transaction system 100 may be required, in one example herein, to comply with certain travel-related rules and/or regulatory requirements. For example, a financial institution can be required to include in a transmittal order for any funds for a transfer of $3,000 or more, the following:
a name of the transmitter (the party requesting the transfer), and, if the payment is ordered from an account, the account number of the transmittor
an address of the transmittor
an amount of the transmittal order
a date of the transmittal order
an identity of the recipient's financial institution.

A transmittor's financial institution can receive with the transmittal order (from the transmittor):
a name and address of the recipient
an account number of the recipient
any other specific identifier of the recipient
either the name and address or the numerical identifier of the transmittor's financial institution.

Travel rules and/or regulatory requirements may apply in B2B transactions, for example.

It also generally applies to bill payments initiated by a business. Such rules can be subject to certain exceptions, such as an “electronic funds transfer” governed by Regulation E (i.e., a transfer that a consumer initiates from his or her account), and situations where both the transmitter and the recipient (i.e., the beneficial recipient of the funds) are any of the following:
a domestic bank;
a wholly owned domestic subsidiary of a domestic bank;
a domestic broker or dealer in securities;
a wholly owned domestic subsidiary of a domestic broker or dealer in securities;
a domestic futures commission merchant or an introducing broker in commodities;
a wholly owned domestic subsidiary of a domestic futures commission merchant or an introducing broker in commodities;
the United States;
a Federal agency or instrumentality;
a state or local government;
a state or local agency or instrumentality; or
a domestic mutual fund.

### Additional System Information

The real-time payment system herein is a platform for financial institutions to develop novel, compelling, and commercially viable products and services for their customers. The system is adaptable to meet the changing needs associated with market expectations and risk environments that are prone to change over time. The system supports robust, flexible data models and message types and has an architecture that supports modular service integration. In one example embodiment herein, the system has global compatibility, and, consistent with domestic U.S. requirements, the system adheres to widely used global standards (e.g., ISO 20022) and the processes/conventions used by real-time payment systems in other countries to facility future interoperability, and to ease the implementation burden for multi-national banks and companies.

As described above, the transaction system 100 herein, in one example embodiment, employs “Credit Push” payments where customers can send payments directly from their existing accounts, providing greater customer engagement and transparency than alternative payment services. The transaction system 100 also, in one example, employs standard but extensible message formats, and supports independent product development by financial institutions through powerful, flexible standards while ensuring that the overall end-to-end process is consistent and reliable. Real-time messaging also is provided with “bank-grade” security, in that is provided financial institutions with tools to create a superior customer experience in applications such as mobile banking, P2P transfers, bill payments, just-in-time B2B transactions, etc. The transaction system 100 also uses integrated tokenization and directory services to eliminate need for customers to share sensitive account information or know routing details of recipients. The transaction system 100 thus is fundamentally safer, more-convenient, and more-capable than existing payment systems.

In the foregoing description, example aspects are described with reference to several example embodiments. Accordingly, the specification should be regarded as illustrative, rather than restrictive. Similarly, the figures illustrated in the drawings, which highlight the functionality and advantages of the example embodiments, are presented for example purposes only. The architecture of the example embodiments is sufficiently flexible and configurable, such that it may be utilized (and navigated) in ways other than those shown in the accompanying figures.

Software embodiments may be provided as a sequence of instructions, or software, which may be stored on an article of manufacture, e.g., a computer-readable medium having instructions. The instructions on the computer-readable medium may be used to program a computer system or other electronic device. The computer-readable medium may include, but is not limited to, floppy diskettes, optical disks, CD-ROMs, and magneto-optical disks or other types of media suitable for storing electronic instructions.

The techniques described herein, when performed using a computer system, are not limited to any particular software configuration. They may find applicability in any computing or processing environment. The terms “computer-readable medium” and “memory” refer to any medium that is capable of storing, encoding, or transmitting a sequence of instructions for execution by a computer system and that causes the computer system to perform any technique described herein. Furthermore, it is common in the art to speak of software, in one form or another (e.g., program, procedure, process, application, logic, and so on) as taking an action or causing a result. Such expressions are merely a shorthand way of stating that the execution of the software by a computer system causes the processor to perform an action to produce a result. In other embodiments, functions performed by software can instead be performed by hardcoded modules, and thus the example embodiments herein are not limited only for use with stored software programs. In addition, it is not necessary that processes described herein be performed with a computer system, and instead they can be performed, in whole or in part, by a human operator.

It should be noted that, although described in the context of a healthcare billing and payment environment, the scope of the invention is not limited for use in that environment only, and also can be used for transactions involving other environments as well, including, for example and without limitation, any suitable type of environment involving bill presentment and payment.

Although example aspects have been described in certain specific embodiments, many additional modifications and variations would be apparent to those skilled in the art. It thus should be understood that the example embodiments may be practiced in ways other than those specifically described. Again, the present example embodiments should be considered in all respects as illustrative and not restrictive.

It is also noted that similar reference numerals shown in the various figures represent the same elements, in one example embodiment herein. However, in another example embodiment herein the elements need not necessarily be the same and each separate figure can represent its own respective embodiment.

What is claimed is:

1. A method for conducting a real-time payment settlement transaction, comprising:
determining a prefunded requirement for one or more creditor financial institutions and one or more debtor financial institutions;
storing a prefunded balance, based on a prefunded payment received in a separate funding account, for each of (i) the one or more creditor financial institutions and (ii) the one or more debtor financial institutions;
receiving an electronic request for payment message from at least one of the creditor financial institutions, and forwarding the electronic request for payment message to at least one of the debtor financial institution, the electronic request for payment message requesting that a payment be made to the at least one creditor financial institution;
receiving, from the at least one debtor financial institution, an electronic payment transaction message, the electronic payment transaction message including information specifying an amount of payment requested in the electronic request for payment message;
comparing the amount of payment requested in the electronic payment transaction message to the prefunded balance of the at least one debtor financial institution; and
determining whether to perform a real-time financial settlement transaction based on a result of the comparing.

2. The method of claim 1, further comprising:
forwarding the electronic payment transaction message to the at least one creditor financial institution such that the amount of payment is credited to a position of the at least one creditor financial institution in real-time, when the amount of payment requested in the electronic request for payment message is less than the prefunded balance of the at least one debtor financial institution.

3. The method of claim 1, further comprising:
updating the prefunded balance for at least one of (i) the one or more creditor financial institutions and (ii) the one or more debtor financial institutions based on supplemental funds received in the separate funding account from the at least one of (i) the one or more creditor financial institutions and (ii) the one or more debtor financial institutions.

4. The method of claim 3, wherein the at least one of (i) the one or more creditor financial institutions and (ii) the one or more debtor financial institutions provides the supplemental funds in response to a Low Watermark notification.

5. The method of claim 4, further comprising:
sending the Low Watermark notification when the prefunded balance of at least one of (i) the one or more creditor financial institutions and (ii) the one or more debtor financial institutions is below a predetermined value of a Low Watermark.

6. The method of claim 1, further comprising:
sending a High Watermark notification when the prefunded balance of at least one of (i) the one or more creditor financial institutions and (ii) the one or more debtor financial institutions is above a predetermined value of a High Watermark.

7. The method of claim 6, wherein the High Watermark indicates that the prefunded balance of the at least one of (i) the one or more creditor financial institutions and (ii) the one or more debtor financial institutions has returned to a predetermined normal level after going down to a Low Watermark level.

8. The method of claim 1, further comprising:
receiving a request for a disbursement from a respective prefunded balance from at least one of (i) the one or more creditor financial institutions and (ii) the one or more debtor financial institutions.

9. The method of claim 1, further comprising:
calculating a Net Position for each of (i) the one or more creditor financial institutions and (ii) the one or more debtor financial institutions, each Net Position being based upon the prefunded balance of each of the respective financial institutions and any payments credited or debited to a position of the respective financial institution.

10. The method of claim 9, wherein the Net Position is calculated during a Reconciliation Window, with the Reconciliation Window being a predetermined time frame in which payments transactions occur for each of (i) the one or more creditor financial institutions and (ii) the one or more debtor financial institutions.

11. The method of claim 10, further comprising:
checking the prefunded balance of each of (i) the one or more creditor financial institutions and (ii) the one or more debtor financial institutions at a Reconciliation Window Cut-Over that occurs at the end of the Reconciliation Window.

12. The method of claim 11, further comprising:
allocating any payment transactions received after the Reconciliation Window Cut-Over to a next Reconciliation Window.

13. The method of claim 1, further comprising:
receiving a notification of the prefunded payment received in the separate funding account for each of (i) the one or more creditor financial institutions and (ii) the one or more debtor financial institutions.

14. The method of claim 1, further comprising:
receiving an electronic request for return of funds message from the at least one debtor financial institution, the electronic request for return of funds message requesting that the amount of payment be returned to the at least one debtor financial institution; and
forwarding the electronic request for return of funds message to the at least one creditor financial institution.

15. The method of claim 14, wherein for at least one of the electronic request for payment message, the electronic payment transaction message, and the electronic request for return of funds message, correlating at least one token included in the message to a bank account number and routing number, wherein the message is forwarded based on at least the routing number.

16. The method of claim 14, further comprising:
receiving an electronic return of funds message from the at least one creditor financial institution and forwarding that message to the at least one debtor financial institution, the electronic return of funds message including information specifying payment of the amount of payment requested in the electronic request for return of funds message.

17. The method of claim 1, further comprising:
receiving at least one of a pending status message, an accepted status message, an accepted without posting status message, and a rejected status message from the at least one creditor financial institution, in relation to the electronic payment transaction message.

18. The method of claim 1, further comprising:
receiving a request for information message from the at least one creditor financial institution and forwarding that message to the at least one debtor financial institution, the request for information message requesting that the at least one creditor financial institution be provided with predetermined information; and
receiving, from the at least one debtor financial institution, a responsive message to the request for information message, and forwarding the responsive message to the at least one creditor financial institution, the responsive message including the predetermined information.

19. The method of claim 1, further comprising:
receiving a remittance advice message including remittance advice from the at least one debtor financial institution and forwarding the remittance advice message to the at least one creditor financial institution.

20. The method of claim 1, further comprising:
generating a report that includes data relating to at least one of (i) one or more participants, (ii) one or more transactions, (iii) a reconciliation window, (iv) a prefunded balance, and (v) a net position, wherein the report is generated on at least one of a scheduled basis, an on-demand basis, and an end of a reconciliation window.

21. The method of claim 1, further comprising:
conducting an inquiry to retrieve stored data relating to at least one of (i) one or more participants, (ii) one or more transactions, and (iii) a reconciliation window, wherein the inquiry is conducted based on a request of at least one of a participant and a system operator.

22. A method for performing a real-time financial settlement, comprising:
storing a prefunded balance of a prefunded settlement account;
receiving an electronic request for payment message from a first financial institution, and forwarding the electronic request for payment message to a second financial institution, the electronic request for payment message requesting that a payment be made to the first financial institution;
comparing the amount of payment requested in the electronic request for payment message to the prefunded balance of the prefunded settlement account;
determining whether to perform a real-time financial settlement transaction based on a result of the comparing; and
performing a financial settlement where it is determined that the amount of payment requested in the electronic request for payment message is not greater than the prefunded balance of the prefunded settlement account,
wherein the financial settlement is performed in real-time.

23. The method of claim 22, further comprising:
increasing the prefunded balance of the prefunded settlement account based on supplemental funds received in the prefunded settlement account.

24. The method of claim 23, wherein the supplemental funds are provided in response to a Low Watermark notification.

25. The method of claim 24, further comprising:
sending the Low Watermark notification when the prefunded balance of the prefunded settlement account is below a predetermined value of a Low Watermark.

26. The method of claim 22, further comprising:
sending a High Watermark notification when the prefunded balance of the prefunded settlement account is above a predetermined value of a High Watermark.

27. The method of claim 26, wherein the High Watermark indicates that the prefunded balance of the prefunded settlement account has returned to a predetermined normal level after going down to a Low Watermark level.

28. The method of claim 22, further comprising:
receiving a request for a disbursement from the prefunded settlement account.

29. The method of claim 22, further comprising:
calculating a Net Position for each of the first financial institution and the second financial institution, each Net Position being based upon a prefunded balance of each of the respective financial institutions and any payments credited or debited to a position of the respective financial institution.

30. The method of claim 29, wherein the Net Position is calculated during a Reconciliation Window, with the Reconciliation Window being a predetermined time frame in which payments transactions occur for each of the first financial institution and the second financial institution.

31. The method of claim 30, further comprising:
checking the prefunded balance for each of the first financial institution and the second financial institution at a Reconciliation Window Cut-Over that occurs at the end of the Reconciliation Window.

32. The method of claim 31, further comprising:
allocating any payment transactions received after the Reconciliation Window Cut-Over to a next Reconciliation Window.

33. The method of claim 22, further comprising:
receiving a notification of a prefunded payment received by the prefunded settlement account.

34. The method of claim 22, further comprising:
generating a report that includes data relating to at least one of (i) one or more participants, (ii) one or more transactions, (iii) a reconciliation window, (iv) a prefunded balance, and (v) a net position, wherein the report is generated on at least one of a scheduled basis, an on-demand basis, and an end of a reconciliation window.

35. The method of claim 22, further comprising:
conducting an inquiry to retrieve stored data relating to at least one of (i) one or more participants, (ii) one or more transactions, and (iii) a reconciliation window, wherein the inquiry is conducted based on a request of at least one of a participant and a system operator.

36. A system for conducting a real-time payment settlement transaction, comprising:
a memory storing a computer program; and
a computer processor, operating under control of the program stored in the memory, to:
store a prefunded balance for each of (i) one or more creditor financial institutions and (ii) one or more debtor financial institutions;
receive an electronic request for payment message from at least one of the creditor financial institutions, and forwarding the electronic request for payment message to at least one of the debtor financial institutions, the electronic request for payment message requesting that a payment be made to the at least one creditor financial institution;
receive, from the at least one debtor financial institution, an electronic payment transaction message, the electronic payment transaction message including information specifying an amount of payment requested in the electronic request for payment message;
compare the amount of payment requested in the electronic payment transaction message to the prefunded balance of the at least one debtor financial institution; and
determine whether to perform a real-time financial settlement transaction based on a result of the comparing.

37. The system of claim 36, wherein the computer processor further operates under control of the program stored in the memory to increase an amount of the prefunded balance based on supplemental funds received from one or more of the financial institutions.

38. The system of claim 36, wherein the computer processor further operates under control of the program stored in the memory to calculate a Net Position for each of (i) the one or more creditor financial institutions and (ii) the one or more debtor financial institutions, each Net Position being based upon the prefunded balance of each of the respective financial institutions and any payments credited or debited to a position of the respective financial institution.

39. The system of claim 38, wherein the Net Position is calculated during a Reconciliation Window, with the Reconciliation Window being a predetermined time frame in which payments transactions occur for each of (i) the one or more creditor financial institutions and (ii) the one or more debtor financial institutions.

40. The system of claim 36, wherein the computer processor further operates under control of the program stored in the memory to generate a report that includes data relating to at least one of (i) one or more participants, (ii) one or more transactions, (iii) a reconciliation window, (iv) a prefunded balance, and (v) a net position, wherein the report is generated on at least one of a scheduled basis, an on-demand basis, and an end of a reconciliation window.

41. The system of claim 36, wherein the computer processor further operates under control of the program stored in the memory to conduct an inquiry to retrieve stored data relating to at least one of (i) one or more participants, (ii) one or more transactions, and (iii) a reconciliation window, wherein the inquiry is conducted based on a request of at least one of a participant and a system operator.
